(19) United States
(12) Patent Application Publication
(10) Pub. No.: US 2026/0363289 A1
(43) Pub. Date: Nov. 19, 2026

(54) FORMULATED FOOD PRODUCTS

(71) Applicant: VitaKey Inc., Washington, DC (US)

(72) Inventors: Aaron C. Anselmo, Chapel Hill, NC (US); Anant S. Balijepalli, Durham, NC (US); Emily E. Bonacquisti, Chapel Hill, NC (US); Andrew D. Christenson, Raleigh, NC (US); Joshua K. DeGennaro, Cary, NC (US); Seo Yeon Kim, Apex, NC (US); Kevin M. Luo, Raleigh, NC (US); James D. Sievert, Pittsboro, NC (US); Andrea Stamp, Brookline, MA (US); Ana Jaklenec, Lexington, MA (US); Catherine B. Reynolds, Mountain Brook, AL (US); Robert S. Langer, Newton, MA (US)

(21) Appl. No.: 19/121,900

(22) PCT Filed: Oct. 19, 2023
(86) PCT No.: PCT/US2023/035546

§ 371 Date: Apr. 17, 2025

Related U.S. Application Data
(60) Provisional application No. 63/417,670, filed on Oct. 19, 2022.
(60) Provisional application No. 63/486,590, filed on Feb. 23, 2023.
(60) Provisional application No. 63/487,165, filed on Feb. 27, 2023.
(60) Provisional application No. 63/459,570, filed on Apr. 14, 2023.

(51) Int. Cl. A23P 10/30; A23K 40/30; A23L 27/00

(52) U.S. Cl. CPC A23P 10/30; A23K 40/30; A23L 27/72; A23L 27/88

(57) ABSTRACT

An extended release preparation includes a carrier component and a payload component, the payload component being encapsulated in the carrier component, the carrier and/or payload component including at least one extended release component, and the payload component including at least one macronutrient component.

### CROSS-REFERENCE TO RELATED APPLICATIONS

The present application claims priority to U.S. Provisional Patent Application No. 63/417,670, filed on Oct. 19, 2022; U.S. Provisional Patent Application No. 63/486,590, filed on Feb. 23, 2023; U.S. Provisional Patent Application No. 63/487,165, filed on Feb. 27, 2023; and U.S. Provisional Patent Application No. 63/459,570, filed on Apr. 14, 2023. Each of the above-referenced applications are herein incorporated by reference.

### TECHNICAL FIELD

The present disclosure is generally related to food and/or beverage compositions (e.g., formulated meals, formulated foods, formulated beverages, formulated supplements, and/or their nutritional constituents, etc.; e.g., formulated ingestibles) and technologies (e.g., methods of preparation, use, etc.) relating thereto.

### BACKGROUND

The health benefits of formulated foods, formulated beverages, formulated supplements, and their nutritional constituents to mammals such as humans have been studied for several decades. However, in many cases, the challenges associated with controlled delivery, absorption, nutrient absorption, and energy acquisition from formulated meals and/or formulated foods and/or formulated beverages and/or formulated supplements and/or their nutritional constituents remain unsolved. As such, meals and/or foods and/or beverages and/or supplements and/or their nutritional constituents have yet to realize their full potential.

### SUMMARY

A food and/or beverage compositions (e.g., formulated ingestibles) can be included in a supplement, a food, a supplemented (i.e., fortified) food product, a beverage, a supplemented (i.e., fortified) beverage product, a powder, or a supplemented (i.e., fortified) powder product intended to confer health benefits.

Popular food and/or beverage compositions (e.g., formulated ingestibles) include protein shakes, dry powders (e.g., baby formula, protein powder, drink mixes, coffee grinds), Meal Ready-to-Eat (MRE), Meal Ready-to-Drink (RTD), electrolyte beverages, sports beverages, hard seltzers (alcoholic seltzers), dry foods (e.g., rice, pasta), water, medical foods (e.g., Ready-to-drink low phenylalanine medical food), supplements, beer, wine, soda, coffee, fermented foods and beverages (e.g., yogurt, beer, etc.); for example, MREs, Gatorade, Truly, Ensure, PKU Sphere Liquid, etc.

In some embodiments, the present disclosure provides technologies (e.g., food and/or beverage compositions, such as formulated ingestibles) that involve utilizing energy sources (e.g., macronutrients) such as carbohydrates, fats, ketones and proteins to confer health benefits and provide energy (e.g., calories, Joules) acquisition.

In some embodiments, the present disclosure provides technologies (e.g., food and/or beverage compositions such as formulated ingestibles) in which nutrients (e.g., antioxidants, electrolytes, flavonoids, micronutrients, minerals, polyphenols, prebiotics, vitamins, etc.) are provided as a preparation that is compatible, for example, with an ingestible item or material such as a supplement, and/or a food or nutrient source, and/or a beverage, consumed by a human or an animal (e.g., a domesticated animal such as a chicken, a cow, a dog, etc.).

In some embodiments, the present disclosure provides technologies (e.g., and/or food and/or beverage compositions, such as (e.g., formulated ingestibles) in which one or more nutrients (e.g., macronutrients and/or micronutrients), which in some embodiments may be or comprise one or more amino acids, polypeptides (e.g., peptides or proteins), elements, lipids (e.g., fats, fatty acids, short-chain fatty acids, etc.), saccharides (e.g., a mono- or poly-saccharide, such as sugars, a carbohydrates, etc., which may in some embodiments be or comprise dietary fiber such as prebiotic fiber), minerals (e.g., electrolytes, salts, etc.), carotenoids, ketone bodies, polyphenols (e.g., flavonoids), vitamins, probiotics (bacteria, yeast, etc.), postbiotics (e.g., short-chain fatty acids, lactic acid, etc.), etc., and/or which may act, for example, as an antioxidant, a circadian rhythm modulator, a nootropic, a nutraceutical, a source of energy, etc. are provided as a preparation that is compatible, for example, with an ingestible item or material such as a supplement, and/or a food or nutrient, and/or a beverage, consumed by a human or an animal (e.g., a chicken, a cow, a dog, etc.).

In some embodiments, provided food and/or beverage compositions (e.g., formulated ingestibles) achieve one or more advantages for macronutrients/calorie sources/energy sources (e.g., proteins, carbohydrates, fats) such as stability, extended shelf-life, controlled residence time, controlled absorption, controlling the spatial distribution in the gastrointestinal tract, controlled coverage of the surface area in the gastrointestinal tract, controlled release, sustained release, increased absorption after ingestion, increased bioavailability, controlled satiety, decreased gastrointestinal discomfort and compatibility with other materials.

Disclosed herein, among other things, are compositions and methods for manufacture, maintenance (e.g., storage, stability, etc.), incorporation (e.g., addition to food, addition to beverages, addition to supplements, addition to products, etc.) and/or use (e.g., administration or delivery) of food and/or beverage compositions (e.g., formulated ingestibles).

In some cases, food and/or beverage compositions (e.g., formulated ingestibles) provided herein may comprise, for example, one or more antioxidants, macronutrients, micronutrients, polyphenols, fatty acids, ketones, minerals, electrolytes, prebiotics, probiotics, vitamins, or combinations thereof.

In some embodiments, provided food and/or beverage compositions (e.g., formulated ingestibles) are characterized by one or more of the following advantages: (i) improved absorption and/or bioavailability of payloads, (ii) improved shelf-life and resistance to degradation at decreased temperatures (e.g., −80 °C, −20 °C, and/or 4 °C), elevated temperatures (e.g., 22 °C, 25 °C, 30 °C, 35 °C, and/or 40 °C), in food and/or food products, in beverages and/or beverage products, in supplements, in dry powders, in the presence of high relative humidity (e.g., up to 100%) or moisture, or a combination thereof; (iii) prolonged residence time or transit time in the gastrointestinal tract or gastrointestinal tract compartments, (iv) controlled release or sustained release of payload components in the gastrointestinal tract, (v) controlled spatial distribution of payloads in and/or on the gastrointestinal tract, (vi) controlled concentration of payloads in the gastrointestinal tract (e.g., in the stomach, in the intestines, at the epithelial surface, in the mucus, etc.); (vii) improved shelf-life in food or beverage matrices (e.g., protein bars, dry powders, milk powders, whey powders, yogurt, drinkable yogurt, water, etc.); (viii) improved compatibility with other components of nutraceutical products and/or compositions that include them (e.g., supplements, foods, drinks, or other edible materials), (ix) stability of particles and payload in an aqueous liquid against heat, acid, protons, salt, light, water, oxidation, and/or elevated temperatures; (x) improved payload resistance to losses during manufacturing processes such as pasteurization, shear mixing, elevated pressurized processes, elevated temperature processes, etc.; (xi) stability of payloads in, or as, a dry powder against heat, acid, protons, salt, light, water, moisture, humidity, oxidation, antimicrobial peptides, and/or elevated temperatures; (xii) tunable properties including size, coating thickness, morphology, geometry, loading, dose, interactions with the surrounding environment, and release conditions, etc.; (xiii) improved anti-caking, anti-clumping, anti-agglomerating, and/or anti-aggregating functionality at elevated temperatures; (xiv) maintenance and preservation of composition morphology (e.g., particle geometry) when exposed to typically degrading conditions, such as: decreased temperatures (e.g., −80 °C, −20 °C, and/or 4 °C), elevated temperatures (e.g., 22 °C, 25 °C, 30 °C, 35 °C, and/or 40 °C), in foods and/or food products, in beverages and/or beverage products, in supplements, in dry powders, in the presence of high relative humidity (e.g., up to 100%) or moisture, or a combination thereof; (xii) mitigation of changes to taste, texture, or scents upon addition, storage, or ingestion of the food and/or beverage compositions (e.g., formulated ingestibles); (xiii) controlled satiety.

As disclosed herein, food and/or beverage compositions (e.g., formulated ingestibles) may be used to confer health benefits in a human or animal. For example, food and/or beverage compositions (e.g., formulated ingestibles) may be administered to a human or animal to contribute in providing sustained nutrition over periods of time, increasing absorption of nutrients (e.g., macronutrients, micronutrients, flavonoids, etc.), decreasing gastrointestinal discomfort, increased bioavailability nutrients (e.g., macronutrients, micronutrients, flavonoids, etc.), controlling satiety, enhancing and/or controlling energy acquisition, and/or supporting bowel movements, etc.

Without being bound by any theory, food and/or beverage compositions (e.g., formulated ingestibles) confer health benefits, may do so by prolonging or extending the absorption time of nutrients, prolonging or extending the gastrointestinal residence time of nutrients, controlling the surface area or volume that nutrients have access to in the gastrointestinal tract, controlling the rate at which the payloads release from the food and/or beverage compositions (e.g., formulated ingestibles), increasing the absorption or bioavailability of nutrients, controlling payload spatial interactions within the host (e.g., controlled concentration of nutrients in the stomach and/or intestines, controlled concentration of nutrients at the epithelial surface, controlled concentration of nutrients in the mucus, controlled residence time of nutrients in the gastrointestinal tract), and/or concentration of nutrients in the gastrointestinal tract, or controlling interactions between payload and gastrointestinal environments. Accordingly, these approaches may be useful in conferring health benefits (e.g., controlled satiety, controlled fullness, controlled feeling of fullness, improved distribution of energy/nutrients over time, increased overall energy acquisition, increased overall nutrient acquisition, increased bioavailability, reduced frequency of meal intake, etc.).

Alternatively or additionally, in some embodiments, provided food and/or beverage compositions (e.g., formulated ingestibles) may be used to accelerate, prolong, and/or extend the absorption time of nutrients. Controlling food and/or beverage (e.g., formulated ingestibles) absorption time in the gastrointestinal tract may be beneficial to organisms (e.g., animals, e.g., humans) due to various mechanisms (e.g., controlled absorption time of nutrients in the stomach and/or intestines, controlled concentration of nutrients in the stomach and/or intestines, controlled concentration of nutrients at the epithelial surface, controlled concentration of nutrients in the mucus, increased energy acquisition, controlled energy acquisition, increased nutrient acquisition, controlled nutrient acquisition, reduced frequency of meal intake, etc.).

Still further alternatively or additionally, in some embodiments, provided food and/or beverage compositions (e.g., formulated ingestibles) may be used to accelerate, prolong, and/or extend the residence time of nutrients. Controlling food and/or beverage (e.g., formulated ingestibles) residence time in the gastrointestinal tract may be beneficial to organisms (e.g., animals, e.g., humans) due to various mechanisms (e.g., controlled absorption time of nutrients in the stomach and/or intestines, controlled concentration of nutrients in the stomach and/or intestines, controlled concentration of nutrients at the epithelial surface, controlled concentration of nutrients in the mucus, increased energy acquisition, increased nutrient acquisition, reduced frequency of meal intake, etc.).

Still further alternatively or additionally, in some embodiments, provided food and/or beverage compositions (e.g., formulated ingestibles) may be used to control the surface area or volume that nutrients have access to in the gastrointestinal tract. Controlling food and/or beverage compositions' (e.g., formulated ingestibles') spatial interactions with host-tissues in the gastrointestinal tract may be beneficial to organisms (e.g., animals, e.g., humans) due to various mechanisms (e.g., controlled satiety, controlled fullness, controlled feeling of fullness, controlled concentration of nutrients in the stomach and/or intestines, controlled concentration of nutrients at the epithelial surface, controlled concentration of nutrients in the mucus, controlled residence time of nutrients in the gastrointestinal tract, etc.).

Still further alternatively or additionally, in some embodiments, provided food and/or beverage compositions (e.g., formulated ingestibles) may be used to control the rate of release of nutrients and/or payloads. Controlling nutrient and/or payload release rate from food and/or beverage compositions (e.g., formulated ingestibles) may be beneficial to organisms (e.g., animals, e.g., humans) due to various mechanisms (e.g., controlled absorption time of nutrients in the stomach and/or intestines, controlled concentration of nutrients in the stomach and/or intestines, controlled concentration of nutrients at the epithelial surface, controlled concentration of nutrients in the mucus, increased energy acquisition, increased nutrient acquisition, increased bioavailability of energy sources or nutrients, reduced frequency of meal intake, etc.).

Still further alternatively or additionally, in some embodiments, provided food and/or beverage compositions (e.g., formulated ingestibles) may be used to increase the bioavailability of nutrients. Increased bioavailability of nutrients may be beneficial to organisms (e.g., animals, e.g., humans) due to various mechanisms (e.g., increased energy acquisition, increased nutrient acquisition, reduced frequency of meal intake, etc.).

Still further alternatively or additionally, in some embodiments, provided food and/or beverage compositions (e.g., formulated ingestibles) may be used to increase the concentration of nutrients and/or payloads in various sections and areas in the gastrointestinal tract (e.g., stomach, small intestines, large intestines, epithelial surface, mucus, lumen, etc.). Controlling concentration of nutrients and/or payloads in the gastrointestinal tract may be beneficial to organisms (e.g., animals, e.g., humans) due to various mechanisms (e.g., increased energy acquisition, increased nutrient acquisition, reduced frequency of meal intake, etc.).

The present disclosure provides an insight that one challenge in using food and/or beverage compositions (e.g., formulated ingestibles) may be achieving nutrient and/or payload stability after host ingestion due to nutrient and/or payload sensitivity (e.g., chemical degradation) in various physiological conditions (e.g., stomach, stomach acids, low pH, bile salts, bile, etc.), which may (i) reduce nutrient and/or payload amount, (ii) reduce benefits outlined above (e.g., reduced bioavailability, reduced energy acquisition, reduced nutrient acquisition, etc.), or both (i) and (ii).

The present disclosure further provides an insight that a challenge in using food and/or beverage compositions (e.g., formulated ingestibles) may be achieving sufficient control over nutrient and/or payload release, absorption, residence time, gastrointestinal concentration, absorption time, and/or bioavailability, etc. within the host organism after ingestion, which may (i) reduce nutrient and/or payload amount, (ii) reduce control over nutrient and/or payload absorption, (iii) reduce benefits outlined above (e.g., reduced bioavailability, reduced energy acquisition, reduced nutrient acquisition, etc.), or (i), (ii), and/or (iii) and combinations thereof.

The present disclosure further provides an insight that a challenge in using food and/or beverage compositions (e.g., formulated ingestibles) may be achieving sufficient nutrient and/or payload dose in various supplement, food and/or beverage formats (e.g., a sufficient number of nutrients to confer health benefits in a host) in conditions that these products are often stored in (e.g., high water activity, high humidity, high moisture, high temperatures, high oxygen, etc.), which may (i) reduce nutrient and/or payload amount, (ii) reduce control over nutrient and/or payload absorption, (iii) reduce benefits outlined above (e.g., reduced bioavailability, reduced energy acquisition, reduced nutrient acquisition, etc.), or (i), (ii), and/or (iii) and combinations thereof.

The present disclosure further observes that some or all of these challenges are often presented together in a food and/or beverage composition (e.g., formulated ingestibles) that has been stored in an unfavorable condition, and is then subsequently ingested by the consumer/host. A food and/or beverage composition (e.g., formulated ingestibles) will face multiple challenges in series and/or in parallel that reduce nutrient and/or payload stability and reduce control over nutrient and/or payload release, spatial interactions with host-tissues, bioavailability, absorption, residence time, etc.

The present disclosure provides technologies that address these challenges, e.g., that can preserve and maintain these features (individually and/or in combination) throughout the lifetime of a food and/or beverage composition (e.g., formulated ingestibles).

The present disclosure appreciates that preserving nutrient and/or payload stability in food and/or beverage compositions (e.g., formulated ingestibles) can be important at least because many of the beneficial functions provided by nutrients require their stability (e.g., energy acquisition, etc.).

When considering ideal conditions for food and/or beverage compositions (e.g., formulated ingestibles) that can withstand challenges encountered throughout the lifetime (e.g., as ingredients, during processing, during manufacturing, incorporation into consumer products, shelf-storage, ingestion, digestion, etc.), the present disclosure appreciates that effective technologies desirably confer prevention, limitation, mitigation, and/or control interactions with the surrounding environment (which may change throughout the lifetime of the food and/or beverage composition).

When considering surrounding environments with which a food and/or beverage composition (or components thereof) may interact, possibilities include the food and/or beverage itself (e.g., a particular unit or portion of a composition is exposed to and/or in contact with other units or portions of the composition), one or more particular constituents of the food and/or beverage composition, shelf-storage conditions, manufacturing conditions, the environmental conditions after the food and/or beverage is unsealed/opened, physiological environment within a host that ingests the composition, etc.

The present disclosure appreciates that nutrient and/or payload stability can impact microbiome functions (e.g., metabolite secretion, colonization) of microbiome constituents that confer health benefits; thus, in some embodiments, provided compositions that are or include a food and/or beverage compositions may further include one or more, promoters that increase metabolite secretion and/or improve microbiome colonization and/or improve microbiome survival.

The present disclosure further appreciates that controlling the spatiotemporal concentrations of nutrients and/or payloads may impact certain food and/or beverage composition (e.g., formulated ingestibles) functions (e.g., extending payload absorption time, extending payload retention time, controlling payload spatial interactions within the host, controlling payload release rate, increasing or decreasing payload absorption, increasing or decreasing payload concentrations within the host, etc.) that confer desired or intended health benefits (e.g., controlled satiety, controlled fullness, controlled feeling of fullness, controlled concentration of nutrients in the stomach and/or intestines, controlled concentration of nutrients at the epithelial surface, controlled concentration of nutrients in the mucus, controlled residence time of nutrients in the gastrointestinal tract, controlled absorption time of nutrients in the stomach and/or intestine, increased energy acquisition, increased nutrient acquisition, increase bioavailability, reduced frequency of meal intake, etc.); thus, in some embodiments, provided food and/or beverage compositions may comprise one or more constituents that ensure control over nutrient and/or payload spatiotemporal concentration, for example during processing, manufacturing, storage, ingestion, and/or digestion.

The present disclosure further appreciates that nutrient and/or payload stability can impact certain food and/or beverage composition (e.g., formulated ingestibles) functions (e.g., extending payload absorption time, extending payload retention time, controlling payload spatial interactions within the host, controlling payload release rate, increasing or decreasing payload absorption, increasing or decreasing payload concentrations within the host, etc.) that confer desired or intended health benefits (e.g., controlled satiety, controlled fullness, controlled feeling of fullness, controlled concentration of nutrients in the stomach and/or intestines, controlled concentration of nutrients at the epithelial surface, controlled concentration of nutrients in the mucus, controlled residence time of nutrients in the gastrointestinal tract, controlled absorption time of nutrients in the stomach and/or intestine, increased energy acquisition, increased nutrient acquisition, increase bioavailability, reduced frequency of meal intake, etc.); thus, in some embodiments, provided food and/or beverage compositions may comprise promoters that, for example, increase payload stability, modulate the environment to favor payload stability, or combinations thereof.

The present disclosure provides an insight that including sufficient amounts of provided food and/or beverage composition(s) (e.g., formulated ingestibles) in consumer products, or otherwise delivering them to a host, can have beneficial impacts including, for example, (e.g., extending payload absorption time, extending payload retention time, controlling payload spatial interactions within the host, controlling payload release rate, increasing or decreasing payload absorption, increasing or decreasing payload concentrations within the host, etc.), some or all of which may confer health benefits.

In some embodiments, attributes of certain provided technologies food and/or beverage compositions (e.g., formulated ingestibles), including specifically performance (e.g., controlled release, controlled absorption, controlled residence time, controlled concentration) following ingestion provide important benefits (e.g., controlled satiety, controlled fullness, controlled feeling of fullness, controlled concentration of nutrients in the stomach and/or intestines, controlled concentration of nutrients at the epithelial surface, controlled concentration of nutrients in the mucus, controlled residence time of nutrients in the gastrointestinal tract, controlled absorption time of nutrients in the stomach and/or intestine, increased energy acquisition, increased nutrient acquisition, increase bioavailability, reduced frequency of meal intake, etc.) not otherwise achieved.

In some embodiments, the present disclosure provides food and/or beverage compositions (e.g., formulated ingestibles) that are or comprise a particle preparation, wherein particles of the particle preparation comprise (i) an encapsulant component; and (ii) a payload component, wherein the encapsulant component comprises a protein, carbohydrate, fat, or other nutrient that is compatible with supplement, food, beverage, and/or physiological fluid/environments (e.g., stomach acids, stomach, intestines, etc.); and the payload component comprises nutrient and wherein the preparation achieves one or more of: (i) protection (maintenance/preservation of nutrient stability) of the payload in supplements, foods, beverages, and/or physiological fluids/environment (e.g., stomach acids, stomach, intestines, etc.), and/or processing/manufacturing environments (e.g., high pressure pasteurization, high temperature pasteurization, etc.); (ii) one or more delivery functions (e.g., extending payload absorption time, extending payload retention time, controlling payload spatial interactions within the host, controlling payload release rate, increasing or decreasing payload absorption, increasing or decreasing payload concentrations within the host, etc.) that confer food and/or beverage composition health benefits (e.g., controlled satiety, controlled fullness, controlled feeling of fullness, controlled concentration of nutrients in the stomach and/or intestines, controlled concentration of nutrients at the epithelial surface, controlled concentration of nutrients in the mucus, controlled residence time of nutrients in the gastrointestinal tract, controlled absorption of time nutrients in the stomach and/or intestine, increased energy acquisition, increased nutrient acquisition, increase bioavailability, reduced frequency of meal intake, etc.). In some such embodiments, the composition and/or the particle preparation is characterized in that the payload component shows increased stability (e.g., is protected against one or more of degradation, oxidation, pressure, other physical and/or chemical changes) when exposed to one or more environmental conditions such as, for example, heat, acid, protons, pasteurization, shear, high pressure, salt, light, water, oxidation, antimicrobial peptides, elevated temperatures, and/or in the context of a complex material. Alternatively or additionally, in some such embodiments, the compositions and/or the particle preparation is characterized in that it enables controlled release of the payload component in the host's gastrointestinal tract (e.g., esophagus, stomach, small intestine, large intestine, etc.). Alternatively or additionally, in some such embodiments, the compositions and/or the particle preparation is characterized in that it enables sustained release of the payload component in the host's gastrointestinal tract (e.g., esophagus, stomach, small intestine, large intestine, etc.). Alternatively or additionally, in some such embodiments, the compositions and/or the particle preparation is characterized in that it retention time of the payload component in the host's gastrointestinal tract is controlled (e.g., esophagus, stomach, small intestine, large intestine, etc.). Alternatively or additionally, in some such embodiments, the compositions and/or the particle preparation is characterized in that payload absorption in the host's gastrointestinal tract is controlled (e.g., esophagus, stomach, small intestine, large intestine, etc.). Alternatively or additionally, in some such embodiments, the compositions and/or the particle preparation is characterized in that payload spatiotemporal association within the host's gastrointestinal tract is controlled (e.g., esophagus, stomach, small intestine, large intestine, etc.). Alternatively or additionally, in some such embodiments, the compositions and/or the particle preparation is characterized in that it controls the payload concentration in the host's gastrointestinal tract (e.g., esophagus, stomach, small intestine, large intestine, etc.).

In certain embodiments, the present disclosure provides human and/or animal consumable compositions (e.g., supplement products, food products, powder products, beverage products, liquid products, etc.) comprising disclosed food and/or beverage compositions (e.g., formulated ingestibles), at least one nutrient, or a combination thereof. In some instances, food and/or beverage compositions (e.g., formulated ingestibles) further comprise at least one nutraceutical. In some embodiments, nutrient components (for example, nutrient payloads) comprise one or more nutraceuticals.

In some cases, humans may be a prenatal human, infant, toddler, child, teenager, adolescent, young adult, adult, geriatric, medical patient, athlete, student, etc.

In some cases, animals may be an agricultural animal (e.g., a horse, a cow, a camel, a goat, a sheep, a fish, a crab, etc.), a pet (e.g., a dog, a cat, a fish, a duck, etc.), and/or a wild animal (e.g., a raccoon, a deer, a moose, a bear, a whale, an ant, a bee, a wasp, etc.).

In many embodiments, provided compositions are edible (i.e., consumable by eating). In some aspects, an edible composition may be a powder or slurry that is mixed with food (e.g., a freshly prepared meal, a pre-prepared meal, etc.) prior to consumption.

In many embodiments, provided compositions are drinkable (i.e., amenable to consumption by drinking). In some aspects, a drinkable composition may be a powder or slurry that is mixed with a beverage (e.g., water, a protein shake, etc.) prior to consumption.

In some aspects, the present disclosure provides methods for preparing a nutrient and/or nutraceutical payload component. In some such embodiments, a provided methods may comprise steps of: (i) formulation (e.g., encapsulation, association, and/or complexation with materials); (ii) post-formulation processing (e.g., drying, characterization, additions of excipients, etc.); (iii) storage (e.g., bagging in aluminum sachets, addition of nitrogen or vacuum environments, etc.); (iv) combination with or as supplements and/or foods and/or beverages; (v) methods to ingestions (e.g., swallowing as a capsule, addition to other existing food and/or beverages); or (vi) a combination of (i), (ii), (iii), (iv), and (v).

In some aspects, the disclosure provides food and/or beverage compositions (e.g., formulated ingestibles) and/or nutrient payloads, which may in some embodiments have been prepared by a method described herein.

In some aspects, the present disclosure provides food and/or beverage compositions (e.g., formulated ingestibles) comprising a carrier component and a payload component, wherein the payload component is associated with (e.g., encapsulated in, adhered to, dispersed in) the carrier component; and wherein the payload component comprises: (i) a nutrient component; (ii) a nutrient that the payload utilizes for functional performance (e.g., extending payload absorption time, extending payload retention time, controlling payload spatial interactions within the host, controlling payload release rate, increasing or decreasing payload absorption, increasing or decreasing payload concentrations within the host, etc.) within the host; (iii) a component that modulates the environment (e.g., food matrix, liquid environment, physiological fluid, tissue/organ such as stomach, etc.) to preserve or maintain nutrient stability and/or delivery functions; (iv) one or more other payload component(s), or (iv) a combination of (i), (ii), (iii), or (iv).

In some embodiments, provided food and/or beverage compositions (e.g., formulated ingestibles) are or comprise particles (e.g., microparticles) that include a matrix component (e.g., a polymer component) and a payload component (e.g., nutrients, macronutrients, micronutrients, proteins, carbohydrates, fats, vitamins, minerals, ketones, polyphenols, etc.). In some instances, one or more layers of matrix components are present.

In some embodiments, a matrix component is or comprises a hydrophobic component. In some instances, a hydrophobic component is or comprises a sugar, a polysaccharide, a carbohydrate, an oil, a fat, a wax, a protein, or a combination thereof. In some instances, a matrix component comprises a salt (e.g., calcium carbonate). In some instances, a matrix component comprises a surfactant (e.g., sodium dodecyl sulfate). In some instances, a matrix component comprises a polymer (e.g., polyvinyl alcohol). In some instances, one or more layers of payload components are present.

In some embodiments, a matrix component is or comprises a hydrophilic component. In some instances, a hydrophilic component is or comprises a sugar, a polysaccharide, a carbohydrate, an oil, a fat, a wax, a protein, or a combination thereof. In some instances, a matrix component comprises a salt (e.g., sodium chloride). In some instances, a matrix component comprises a surfactant (e.g., sodium dodecyl sulfate). In some instances, one or more layers of payload components are present.

In some embodiments, a matrix component is or comprises a amphiphilic component. In some instances, a amphiphilic component is or comprises a sugar, a polysaccharide, a carbohydrate, an oil, a fat, a wax, a protein, or a combination thereof. In some instances, a matrix component comprises a salt (e.g., sodium chloride). In some instances, a matrix component comprises a surfactant (e.g., sodium dodecyl sulfate). In some instances, one or more layers of payload components are present.

In some instances, a matrix component comprises a biocompatible material. In some instances a biocompatible material is or comprises a sugar, a polysaccharide, a carbohydrate, an oil, a fat, a wax, a lipid, a protein, an amino acid, a peptide, or a combination thereof. In some instances, a matrix component comprises a salt (e.g., calcium carbonate). In some instances, a matrix component comprises a surfactant (e.g., sodium dodecyl sulfate).

In some cases, a matrix component further comprises one or more nutrient (e.g., antioxidants, flavonoids, polyphenols, vitamins, minerals, micronutrients, prebiotics, electrolytes) payloads.

The present disclosure provides technologies for making and/or characterizing matrix components comprising encapsulants described herein, and/or compositions that include them. In some embodiments, the disclosed processes and methodologies to generate matrices include extrusion, granulation, extrusion-based methods, melt processing, shear-based granulation methods, lyophilization, atomization, prilling, spray chilling, and/or spray congealing methods.

In some embodiments, the carrier component comprises at least one carbohydrate, at least one polymer, and/or at least one lipid.

In some embodiments, disclosed nutrient components comprise a nutrient selected from the group consisting of: a naturally-occurring nutrient, and a nutrient prepared by any method described herein; a commercially-available nutrient, and a nutrient prepared by any method described herein; a commercially-available nutrient preparation (e.g., freeze-dried, or already-formulated nutrients), and a nutrient prepared by any method described herein. As such, in some embodiments according to the present disclosure, disclosed nutrient components comprise a commercially-available nutrient powder that includes a carrier or matrix component that is then further encapsulated in a carrier, as described herein. In such embodiments, an inner carrier containing the nutrient is itself encapsulated in one or more outer encapsulant layers or carriers.

In another aspect, the present embodiments are directed to a method of promoting health or longevity in a human, the method comprising: providing an effective amount of the any preparation as described herein.

In some embodiments, a provided composition may be or comprise one or more particles; typically, a population of particles (e.g., a particle preparation). In some embodiments, a particle or population thereof is characterized by its diameter (e.g., average diameter). A particle “diameter” (i.e., a particle size) is the longest distance from one end of the particle to another end of the particle. In some embodiments, food and/or beverage compositions (e.g., formulated ingestibles) are or comprise particles with a distribution of particle diameters (e.g., D[3,2], D[4,3], etc.). In some embodiments, food and/or beverage compositions (e.g., formulated ingestibles) are or comprise particles with a distribution of particle diameters (e.g., D[3,2], D[4,3], etc.) of up to about 1 nm, up to about 100 nm, up to about 500 nm, up to about 1 μm, up to about 10 μm, up to about 100 μm, up to about 500 μm, up to about 1 mm, up to about 1 mm, up to about 10 mm, or up to about 50 mm.

In some embodiments, food and/or beverage compositions (e.g., formulated ingestibles) may include particle preparations that include particles with one or more of a variety of shapes or forms, for example, having a cross-section shape of a circle, an oval, a triangle, a square, a hexagon, or an irregular shape. In some embodiments, food and/or beverage compositions (e.g., formulated ingestibles) comprise particles (e.g., nanoparticles, microparticles), wherein a significant percentage (e.g., a majority) of particles have a common shape. In some embodiments, food and/or beverage compositions (e.g., formulated ingestibles) are or comprise particles of various such shapes in combination.

In some embodiments, food and/or beverage compositions (e.g., formulated ingestibles) may include individual constituents that self-assemble into particle preparations upon exposure to a specific environment (e.g., food matrix, beverage matrix, physiological fluid, stomach acids, bile salts, temperature, etc.). Food and/or beverage compositions (e.g., formulated ingestibles) that self-assemble into particle preparations upon introduction into specific environments include any shape or form, for example, having a cross-section shape of a circle, an oval, a triangle, a square, a hexagon, or an irregular shape. In some embodiments, food and/or beverage compositions (e.g., formulated ingestibles) comprise particles (e.g., nanoparticles, microparticles), wherein a majority of particles have a common shape. In some embodiments, food and/or beverage compositions (e.g., formulated ingestibles) are or comprise particles of various such shapes in combination.

In some embodiments, provided food and/or beverage compositions (e.g., formulated ingestibles) are characterized by having a layered structure, e.g., wherein adjacent layers have different chemical structures.

In some embodiments, provided food and/or beverage compositions (e.g., formulated ingestibles) are characterized by having multiple polymer components, wherein the food and/or beverage compositions (e.g., formulated ingestibles) may be additionally encapsulated with a separate polymer component.

In some embodiments, the compositions (e.g., formulated ingestibles) provided by the present disclosure include a first layer that is or comprises a nutrient and/or a second nutrient and a second layer that is or comprises a different nutrient and/or the same nutrient. For example, in some particular embodiments, a nutrient material may be or comprise proteins and/or carbohydrates; in some embodiments, the protein may be encapsulated within the carbohydrate; in some embodiments, the carbohydrate may be encapsulated within the protein; in some embodiments, the carbohydrate may be encapsulated within the same or a distinct carbohydrate. In some embodiments, the carbohydrate may be encapsulated within a mixture of protein and carbohydrates. In some embodiments, the layers are reversed.

In some such embodiments, the composition and/or the preparation is characterized in that the payload component shows increased stability (e.g., is protected against one or more of degradation, oxidation, pressure, other physical and/or chemical changes) when exposed to one or more environmental conditions such as, for example, heat, acid, protons, pasteurization, shear, high pressure, salt, light, water, oxidation, antimicrobial peptides, elevated temperatures, and/or in the context of a complex material.

Food and/or beverage compositions (e.g., formulated ingestibles) comprising enhanced stability provides benefits over existing comparable products, among other things because enhanced stability will extend shelf-life.

In some embodiments, the present disclosure provides technologies for manufacturing provided food and/or beverage compositions (e.g., formulated ingestibles) that increase payload stability during and/or following manufacturing (thereby minimizing payload losses in food and/or beverage products). Thus, the present disclosure provides technologies with a variety of advantages.

In some embodiments, the present disclosure provides technologies for manufacturing provided food and/or beverage compositions (e.g., formulated ingestibles) that increase shelf-life following manufacturing (thereby minimizing payload losses in food and/or beverage products). Thus, the present disclosure provides technologies with a variety of advantages.

Food and/or beverage compositions (e.g., formulated ingestibles) comprising enhanced shelf-life provides benefits over existing products, among other things because extended shelf-life will provide longer-duration of product lifetime.

In some embodiments, the present disclosure provides technologies for manufacturing provided food and/or beverage compositions (e.g., formulated ingestibles) that increase shelf-life time following manufacturing (thereby minimizing payload losses in food and/or beverage products). Thus, the present disclosure provides technologies with a variety of advantages.

In some such embodiments, the compositions and/or the particle preparation is characterized in that it enables controlled release of the payload component in the host's gastrointestinal tract (e.g., esophagus, stomach, small intestine, large intestine, etc.).

Food and/or beverage compositions (e.g., formulated ingestibles) comprising controlled release of payloads have benefits over existing products, among other things because controlled payload release will provide methods to improve or extend nutrient absorption.

In some embodiments, the present disclosure provides technologies for manufacturing provided food and/or beverage compositions (e.g., formulated ingestibles) that provide controlled release of payloads following manufacturing (thereby ensuring that products containing compositions can provide controlled delivery of nutrients). Thus, the present disclosure provides technologies with a variety of advantages.

In some such embodiments, the compositions and/or the particle preparation is characterized in that it enables sustained release of the payload component in the host's gastrointestinal tract (e.g., esophagus, stomach, small intestine, large intestine, etc.).

Food and/or beverage compositions (e.g., formulated ingestibles) comprising sustained release of payloads have benefits over existing products, among other things because sustained payload release will provide methods to improve or extend nutrient absorption.

In some embodiments, the present disclosure provides technologies for manufacturing provided food and/or beverage compositions (e.g., formulated ingestibles) that provide sustained release of payloads following manufacturing (thereby ensuring that products containing compositions can provide sustained delivery of nutrients). Thus, the present disclosure provides technologies with a variety of advantages.

In some such embodiments, the compositions and/or the particle preparation is characterized in that it enables extended retention time of the payload component in the host's gastrointestinal tract is (e.g., esophagus, stomach, small intestine, large intestine, etc.).

Food and/or beverage compositions (e.g., formulated ingestibles) comprising extended retention time of payloads have benefits over existing products, among other things because extended retention of payloads will provide methods to improve or extend nutrient absorption.

In some embodiments, the present disclosure provides technologies for manufacturing provided food and/or beverage compositions (e.g., formulated ingestibles) that provide extended retention time of payloads following manufacturing (thereby ensuring that products containing compositions can provide sustained delivery of nutrients). Thus, the present disclosure provides technologies with a variety of advantages.

In some such embodiments, the compositions and/or the particle preparation is characterized in that payload absorption in the host's gastrointestinal tract is controlled (e.g., esophagus, stomach, small intestine, large intestine, etc.).

Food and/or beverage compositions (e.g., formulated ingestibles) comprising controlled payload absorption have benefits over existing products, among other things because controlled absorption of payloads will provide methods to improve or extend nutrient absorption, energy acquisition, and/or decreasing overfortification.

In some embodiments, the present disclosure provides technologies for manufacturing provided food and/or beverage compositions (e.g., formulated ingestibles) that provide controlled absorption of payloads following manufacturing (thereby ensuring that products containing compositions can control nutrient absorption). Thus, the present disclosure provides technologies with a variety of advantages.

In some such embodiments, the compositions and/or the particle preparation is characterized in that payload spatiotemporal association within the host's gastrointestinal tract is controlled (e.g., esophagus, stomach, small intestine, large intestine, etc.).

Food and/or beverage compositions (e.g., formulated ingestibles) comprising controlled payload spatial association within the host's gastrointestinal tract have benefits over existing products, among other things because controlled payload spatial association within the host's gastrointestinal tract will provide methods to improve or extend satiety.

In some embodiments, the present disclosure provides technologies for manufacturing provided food and/or beverage compositions (e.g., formulated ingestibles) that provide controlled payload spatial association within the host's gastrointestinal tract following manufacturing (thereby ensuring that products containing compositions can control satiety). Thus, the present disclosure provides technologies with a variety of advantages.

In some such embodiments, the compositions and/or the particle preparation is characterized in that it controls the payload concentration in the host's gastrointestinal tract (e.g., esophagus, stomach, small intestine, large intestine, etc.).

Food and/or beverage compositions (e.g., formulated ingestibles) comprising controlled payload concentrations within the host's gastrointestinal tract have benefits over existing products, among other things because controlled payload concentrations within the host's gastrointestinal tract will provide methods to control nutrient absorption and/or increase bioavailability.

In some embodiments, the present disclosure provides technologies for manufacturing provided food and/or beverage compositions (e.g., formulated ingestibles) that provide controlled payload concentration within the host's gastrointestinal tract following manufacturing (thereby ensuring that products containing compositions can control nutrient acquisition and/or energy acquisition from foods and/or beverages). Thus, the present disclosure provides technologies with a variety of advantages.

In some embodiments, the present disclosure provides food and/or beverage compositions (e.g., formulated ingestibles) with resistance (e.g., mitigation of nutrient degradation) to stomach acids, simulated gastric fluids, proton-rich liquids, or low-pH (e.g., less than a pH of 3) fluids and/or liquids and/or beverages. The present disclosed food and/or beverage compositions (e.g., formulated ingestibles), therefore, may provide benefits over existing products, among other things because acidic solutions lead to nutrient degradation or impair nutrient absorption after ingestion, and/or upon contact with the stomach and/or stomach fluids and/or upon contact with beverages. Thus, the present disclosure provides technologies with a variety of advantages.

In some embodiments, the present disclosure provides food and/or beverage compositions (e.g., formulated ingestibles) with resistance (e.g., mitigation of nutrient degradation) to intestinal fluids, bile salts, bile, or neutral-pH (e.g., greater than pH of 5 but lower than pH of 9) fluids and/or liquids and/or beverages. The present disclosed food and/or beverage compositions (e.g., formulated ingestibles), therefore, may provide benefits over existing products, among other things because neutral solutions lead to nutrient degradation or impair nutrient absorption after ingestion, and/or upon contact with the intestines and/or intestinal fluids and/or upon contact with beverages. Thus, the present disclosure provides technologies with a variety of advantages.

In some embodiments, the present disclosure provides food and/or beverage compositions (e.g., formulated ingestibles) for stability in supplements, foods and/or beverages at elevated temperatures, water activities, humidity and/or moisture. This provides benefits over existing products, among other things because these conditions lead to rapid nutrient degradation after incorporation with products and during shelf-storage. Thus, the present disclosure provides technologies with a variety of advantages.

In some embodiments, the present disclosure provides particular insight that identifies the source of a limitation associated with certain current food and/or beverage compositions (e.g., formulated ingestibles) in that food and/or beverage compositions do not provide control over: 1) extending payload absorption time; 2) extending payload retention time; 3) controlling payload spatial interactions within the host; 4) payload release rate; 5) increasing or decreasing payload absorption; 6) increasing or decreasing payload concentrations within the host, which lead to limitations in being able to create and implement food and/or beverage products capable of controlling: 1) satiety; 2) fullness; 3) feeling of fullness; 4) concentration of nutrients in the stomach and/or intestines; 5) concentration of nutrients at the epithelial surface; 6) concentration of nutrients in the mucus; 7) residence time of nutrients in the gastrointestinal tract; 8) absorption time of nutrients in the stomach and/or intestine; 9) increased energy acquisition; 10) increased nutrient acquisition; 11) increase bioavailability; 12) reduced frequency of meal intake.

Without wishing to be bound by theory, many presently available food and/or beverage products cannot achieve control over nutrient and therefore lack various benefits provided by the present disclosure. Technologies provided herein enable delivery and delivery functions when individually ingested, and/or when combined with or into a multitude of food and/or beverage and/or powder products in the areas of supplements, foods, and/or beverages.

In some cases, a bile-responsive, pH-responsive, and/or microbiome-responsive encapsulating component can facilitate location-specific release of the nutrients into the stomach and/or small and/or large intestines by leveraging the physiological or environmental differences in stomach and intestinal fluids, tissues and/or organs.

In some cases, a temperature-responsive encapsulant is more readily processed at lower temperatures (e.g., glass transition temperature) through addition of payloads or plasticizers. In some embodiments, payloads alone can lower the glass transition temperature of temperature-responsive polymers. Collectively, this facilitates manufacturing and processing approaches at lower temperatures, since encapsulant component and payload component can more easily transition from flowable homogenous liquid states to solid states (e.g., particles).

In some instances, a provided food and/or beverage composition (e.g., formulated ingestibles) provides increased shelf-life in beverages at 4 °C, 18 °C, 25 °C, 30 °C, 35 °C.

In some instances, a provided food and/or beverage composition (e.g., formulated ingestibles) provides increased shelf-life in dry powders at −20 °C, 4 °C, 18 °C, 25 °C, 30 °C, 35 °C.

In some instances, a provided food and/or beverage composition (e.g., formulated ingestibles) provides increased shelf-life in food matrices at −20 °C, 4 °C, 18 °C, 25 °C, 30 °C, 35 °C.

In some instances, a provided food and/or beverage composition (e.g., formulated ingestibles) provides increased shelf-life prior to incorporation into any matrix at −20 °C, 4 °C, 18 °C, 25 °C, 30 °C, 35 °C.

In some instances, a provided food and/or beverage composition (e.g., formulated ingestibles) provides increased shelf-life in capsules and/or tablets and/or pills at −20 °C, 4 °C, 18 °C, 25 °C, 30 °C, 35 °C.

In some embodiments, a provided food and/or beverage compositions (e.g., formulated ingestibles) may be or is effective at protecting payload components (e.g., nutrient payload component) and/or encapsulant components (e.g., a nutrient encapsulant) against a physical change, a chemical change, or both (e.g., degradation, oxidation, hydrolysis, isomerization, fragmentation, or a combination thereof).

In some embodiments, a provided food and/or beverage compositions (e.g., formulated ingestibles) may be or remain stable, e.g., to store for a particular period of time under particular conditions.

For example, in some embodiments, 99% of a payload and/or encapsulant component present in a provided composition at a particular point in time remains present, and/or one or more size characteristics (e.g., average diameter and/or one or more features of size distribution of a particle composition) remains stable throughout a period of time during which the composition is maintained under particular conditions. For example, a payload component present in a provided composition may remain stable in a dry powder form for a period of time. In some embodiments, a payload component present in a provided composition may remain stable for a period of time when dispersed within solid food (at chilled, room temperature, and/or elevated temperatures). In some embodiments, a payload component present in a provided composition may remain stable for a period of time when dispersed within a beverage (at chilled, room temperature, and/or elevated temperatures). In some embodiments, a payload component present in a provided composition may remain stable for a period of time when dispersed within an acidic solution (for example, at a pH<3).

In some embodiments, the period of time is at least 2, 3, 4, 5, 6, 7, 8, 9, 10, 11, 12, 13, 14, 15, 16, 17, 18, 19, 20, 21, 22, 23, 24 weeks or more, and/or at least about 1, 2, 3, 4, 5, 6, 7, 8, 9, 10, 11, 12 months or more, and/or at least about 1, 2, 3, 4, 5 years or more.

In some such embodiments, the particular conditions comprise ambient temperature. In some such embodiments, the particular conditions comprise elevated (above ambient) temperature. Alternatively or additionally, in some embodiments, the particular conditions comprise aqueous conditions (e.g., aqueous liquid conditions). In some embodiments, the period of time is at least two months and the particular conditions comprise ambient temperature.

In some embodiments, stability comprises mitigation, limitation, or prevention of chemical degradation of nutrient payloads and/or nutrient encapsulants.

In some embodiments, stability comprises maintenance of delivery functions (e.g., extending payload absorption time, extending payload retention time, controlling payload spatial interactions within the host, payload release rate, increasing or decreasing payload absorption, increasing or decreasing payload concentrations within the host, etc.) of provided food and/or beverage compositions (e.g., formulated ingestibles) and/or nutrient payloads and/or nutrient encapsulants.

In some embodiments, stability comprises maintenance of conferred health benefits (e.g., controlled satiety, controlled fullness, controlled feeling of fullness, controlled concentration of nutrients in the stomach and/or intestines, controlled concentration of nutrients at the epithelial surface, controlled concentration of nutrients in the mucus, controlled residence time of nutrients in the gastrointestinal tract, controlled absorption time of nutrients in the stomach and/or intestine, increased energy acquisition, increased nutrient acquisition, increase bioavailability, reduced frequency of meal intake, etc.) for food and/or beverage compositions (e.g., formulated ingestibles) and/or nutrient payloads and/or nutrient encapsulants.

In some embodiments, food and/or beverage compositions (e.g., formulated ingestibles) exhibit improved anti-caking, anti-clumping, anti-agglomerating, and/or anti-aggregating performance to enable incorporation into food and/or beverage products (e.g., food, liquid beverages, dry powders, etc.).

In some embodiments, a food and/or beverage composition (e.g., formulated ingestibles) may further comprise an excipient component (e.g., an anti-caking component, an anti-clumping component, a plasticizer, an anti-agglomerating component, and/or an anti-aggregating component [e.g., any of an excipient comprising microcrystalline cellulose, starches, calcium carbonate, etc.], wherein an excipient component is at least about 99 wt %, at least about 90 wt %, at least about 85 wt %, at least about 80 wt %, at least about 75 wt %, at least about 70 wt %, at least about 65 wt %, at least about 60 wt %, at least about 55 wt %, at least about 50 wt %, at least about 45 wt %, at least about 40 wt %, at least about 35 wt %, at least about 30 wt %, at least about 25 wt %, at least about 20 wt %, at least about 15 wt %, at least about 10 wt %, at least about 5 wt %, at least about 1 wt %, at least about 0.8 wt %, at least about 0.5 wt %, at least about 0.1 wt % of a food and/or beverage composition.

The disclosed food and/or beverage composition (e.g., formulated ingestibles) may be particularly useful for stabilizing nutrient payloads and/or encapsulant payloads, and maintaining delivery functions (e.g., extending payload absorption time, extending payload retention time, controlling payload spatial interactions within the host, payload release rate, increasing or decreasing payload absorption, increasing or decreasing payload concentrations within the host, etc.), and enabling the associated health benefits (e.g., controlled satiety, controlled fullness, controlled feeling of fullness, controlled concentration of nutrients in the stomach and/or intestines, controlled concentration of nutrients at the epithelial surface, controlled concentration of nutrients in the mucus, controlled residence time of nutrients in the gastrointestinal tract, controlled absorption time of nutrients in the stomach and/or intestine, increased energy acquisition, increased nutrient acquisition, increase bioavailability, reduced frequency of meal intake, etc.) in consumable compositions (e.g., a food product, a beverage product, an animal-consumable product, dry powders, supplements, etc.), where food and/or beverages components typically lose stability, delivery functions, and the associated health benefits.

In certain embodiments, the present disclosure provides consumable compositions (e.g., a food product, a beverage product, an animal-consumable product, dry powders, a supplement, etc.)

In some aspects, provided food and/or beverage composition (e.g., formulated ingestibles) may are or may be useful for improving health or longevity in humans and/or animals. In some aspects, provided consumable compositions are or may be useful for improving health or longevity in humans and/or animals.

In some aspects, consumable compositions comprising food and/or beverage composition (e.g., formulated ingestibles) may be edible. In some aspects, an edible composition may be a protein bar, a cereal, a protein powder, a milk powder, a salad dressing, a nutritional supplement, a baby formula, a smoothie, a yogurt, an ice cream, a sachet, a spice, a food additive, a candy, a sprinkle packet, a pet food, an agricultural seed, a dry powder, and/or a fertilizer.

In some aspects, consumable compositions comprising food and/or beverage composition (e.g., formulated ingestibles) are drinkable. In some aspects, a drinkable composition may be a sports drink, beer, wine, tea, coffee, milk, juice, water, yogurt, soda, carbonated water, or a liquid pharmaceutical formulation.

In some embodiments, enhanced stability, maintenance of delivery functions, and/or conferring health benefits are maintained after storage (e.g., with or within a consumable composition) in a freezer (−85 °C to 0 °C), a refrigerator (1-10 °C), or atmospheric temperature (−10 °C-40 °C) for time periods between 0-1 week, 0-1 month, 0-1 year or 1-5 years.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWING

FIG. 1 shows, in a non-limiting example, a schematic of exemplary core-shell preparations which may comprise carrier components, payload components, food components, excipient components, matrix preparations, core components, shell components, and combinations thereof. Additionally, or alternatively, exemplary core-shell preparations may comprise a particle comprising at least one carrier component, at least one payload component, at least one core component, at least one shell component, at least one food component, at least one excipient component, at least one matrix component, at least one matrix preparation, or a combination thereof.

FIG. 2 shows, in a non-limiting example, a schematic of exemplary core-shell preparations with multiple layers which may comprise carrier components, payload components, food components, excipient components, matrix preparations, core components, shell components, and combinations thereof. Additionally, or alternatively, exemplary multi-layer core-shell preparations may comprise a particle comprising at least one core-shell preparation, at least one carrier component, at least one payload component, at least one core component, at least one shell component, at least one food component, at least one excipient component, at least one matrix component, at least one matrix preparation, or a combination thereof.

FIG. 3 shows, in a non-limiting example, a schematic of exemplary matrix preparations which may comprise carrier components, payload components, food components, excipient components, core-shell preparations, matrix components, solute components, and combinations thereof. Additionally, or alternatively, exemplary matrix preparations may comprise a particle comprising at least one carrier component, at least one payload component, at least one food component, at least one excipient component, at least one core-shell preparation, at least one matrix component, at least one solute component, and combinations thereof.

FIGS. 4A and 4B show, in a non-limiting example, brightfield micrographs of exemplary encapsulated macronutrient compositions comprising a core component (e.g., sucrose) and a shell component (e.g., zein).

FIGS. 5A and 5B show, in a non-limiting example, photographs of exemplary encapsulated micronutrient compositions comprising a solute component (e.g., riboflavin) and matrix component (e.g., gelatin).

FIGS. 6A and 6B show, in a non-limiting example, photographs of exemplary encapsulated micronutrient compositions, further characterized as a matrix preparation. In this non-limiting example, a solute component comprising a payload component (e.g., whey protein isolate) and a matrix component (e.g., gelatin) are prepared and further coated with a shell component (e.g., cellulose acetate phthalate).

FIGS. 7A and 7B show, in a non-limiting example, brightfield micrographs of food composition(s) characterized as core-shell preparations with multiple layers comprising food components, excipient components, core components, shell components, and/or combinations thereof. In this non-limiting example, a matrix preparation comprising a payload component (e.g., whey protein isolate) and matrix component (e.g., gelatin) are further coated with a shell component (e.g., cellulose acetate phthalate), with a secondary shell component applied (e.g., Zein).

FIG. 8 shows, in a non-limiting example, a schematic of a method used to apply a coating to a food and/or beverage composition, referred to herein as “coating”.

FIG. 9 shows, in a non-limiting example, a schematic of a method used to create a matrix food and/or beverage composition, referred to herein as “matrix”.

FIG. 10 shows, in a non-limiting example, a schematic of a method used to characterize dissolution and/or release of food and/or beverage composition, referred to herein as “dissolution” and/or “release”.

FIGS. 11A-11D present, in a non-limiting example, 4 theoretical release profiles (concentration of food component vs incubation period) of one or more food component(s) from one or more food and/or beverage composition(s).

FIG. 12 presents, in a non-limiting example, a plot of glucose release (mg/dL or mg/dL/min) over time, indicating release of glucose payload from food and/or beverage compositions (e.g., with exemplary food and/or beverage compositions (core-shell preparation encapsulating sucrose coated with 10% zein)).

FIGS. 13A and 13B present, in a non-limiting example, a plot of glucose release (mg/dL or mg/dL/min) over time, indicating release of glucose payload from food and/or beverage compositions (e.g., with exemplary food and/or beverage compositions (core-shell preparation encapsulating sucrose coated with 10% zein, 2.5% glyceryl monostearate, 1% propylene glycol)) at 37 °C for 60 minutes.

FIGS. 14A and 14B present, in a non-limiting example, a plot of whey protein isolate release (mg/dL or mg/dL/min) over time, indicating release of whey payload from food and/or beverage compositions (e.g., with exemplary food and/or beverage compositions (core-shell preparation encapsulating whey protein isolate within a matrix of gelatin, further coated with 15% (w/v) cellulose acetate phthalate in acetone) at 20 °C for 90 minutes.

FIGS. 15A and 15B show, in a non-limiting example that food and/or beverage compositions demonstrate low (<0.20) water activity and low moisture content at 25 °C.

FIGS. 16A-16D illustrate, in a non-limiting example, brightfield micrographs of food and/or beverage compositions (e.g., alginate/whey beads, gelatin/whey beads, and/or sucrose/amylose beads) blended homogeneously with commercially available food product (e.g., MRE, Ensure), imparting minimal change to visible appearance (e.g., color and texture).

FIGS. 17A-17D illustrate, in a non-limiting example, brightfield micrographs of the stability of food and/or beverage compositions (e.g., alginate/whey beads, gelatin/whey beads, and/or sucrose/amylose beads) when blended homogenously with water. Morphological changes are observed following a 1-hour incubation period.

FIG. 18 shows, in a non-limiting example, that food and/or beverage compositions (e.g., with exemplary food and/or beverage compositions (core-shell preparation encapsulating whey protein isolate within a matrix of gelatin, further coated with 15% (w/v) cellulose acetate phthalate in acetone) demonstrate triggered release functionality.

FIGS. 19A-19D present, in a non-limiting example, that matrix preparation(s) and selection of matrix component(s) influences release of one or more food component(s). FIG. 19A: illustrates release of 10% (w/v) whey protein isolate from 5% (w/v) agarose matrix preparation(s) comprising 2% (w/v) sodium carboxymethylcellulose (white squares), 1% (w/v) tween-60 (grey squares), and 2% (w/v) poly(acrylic acid) (black squares). FIG. 19B: illustrates a comparison of modeled first-order release rate of 10% (w/v) whey protein isolate from 5% (w/v) agarose matrix preparation(s) comprising 2% (w/v) sodium carboxymethylcellulose (white), 1% (w/v) tween-60 (grey), and 2% (w/v) poly(acrylic acid) (black). FIG. 19C: illustrates release of either unformulated whey (open circle) or 5% (w/w) or 10% (w/w) whey protein isolate from formulation(s) comprising: 5% (w/v) agarose and 1% (w/v) hydroxypropyl methylcellulose (black squares), 80% (w/w) hydrogenated soy oil and 15% (w/w) soy lecithin (black circles), 75% (w/w) candelilla wax and 15% (w/w) Gelucire 50/13 (black triangles), and 70% (w/w) 27-Stearine, 12.5% (w/w) β-sitosterol, and 12.5% (w/w) γ-oryzanol (black diamonds). FIG. 19D: illustrates a comparison of modeled first-order release rate of either unformulated whey (black) or 5% (w/w) or 10% (w/w) whey protein isolate from formulation(s) comprising: 5% (w/v) agarose and 1% (w/v) hydroxypropyl methylcellulose (dark grey), 80% (w/w) hydrogenated soy oil and 15% (w/w) soy lecithin (medium grey), 75% (w/w) candelilla wax and 15% (w/w) Gelucire 50/13 (light grey), and 70% (w/w) 27-Stearine, 12.5% (w/w) β-sitosterol, and 12.5% (w/w) γ-oryzanol (white).

FIG. 20 shows, in a non-limiting example, a schematic of exemplary core-shell preparations which may comprise carrier components, payload components, food components, excipient components, matrix preparations, core components, shell components, and combinations thereof. Additionally, or alternatively, exemplary core-shell preparations may comprise a particle comprising at least one carrier component, at least one payload component, at least one core component, at least one shell component, at least one food component, at least one excipient component, at least one matrix component, at least one matrix preparation, or a combination thereof.

FIG. 21 shows, in a non-limiting example, a schematic of exemplary core-shell preparations with multiple layers which may comprise carrier components, payload components, food components, excipient components, matrix preparations, core components, shell components, and combinations thereof. Additionally, or alternatively, exemplary multi-layer core-shell preparations may comprise a particle comprising at least one core-shell preparation, at least one carrier component, at least one payload component, at least one core component, at least one shell component, at least one food component, at least one excipient component, at least one matrix component, at least one matrix preparation, or a combination thereof.

FIG. 22 shows, in a non-limiting example, a schematic of exemplary matrix preparations which may comprise carrier components, payload components, food components, excipient components, core-shell preparations, matrix components, solute components, and combinations thereof. Additionally, or alternatively, exemplary matrix preparations may comprise a particle comprising at least one carrier component, at least one payload component, at least one food component, at least one excipient component, at least one core-shell preparation, at least one matrix component, at least one solute component, and combinations thereof.

FIG. 23 shows, in a non-limiting example, a comparison of unformulated carbohydrate powder and food composition(s) comprising carbohydrate(s) as component(s) of matrix composition(s) and/or core-shell preparation(s). (A) Unformulated glucose; (B) sucrose-amylose matrix preparation(s) encapsulated in Zein; (C) 60% (w/v) glucose encapsulated in 2% (w/v) pectin; (D) 1% (w/v) inulin encapsulated in 2% (w/v) agarose, (E) 10% (w/v) calcium caseinate and 1% (w/v) inulin encapsulated in 2% (w/v) sodium alginate.

FIG. 24 shows, in a non-limiting example, a comparison of unformulated protein and food composition(s) comprising protein(s) as component(s) of matrix composition(s) and/or core-shell preparation(s). (A) Unformulated whey protein isolate (WPI) powder; (B) 20% (w/v) whey protein isolate encapsulated in 80% (w/v) beeswax, (C) whey protein (5% w/v) encapsulated in 80% (w/v) fully hydrogenated soy oil and Tween 80 (15% w/v); (D) whey protein (10% w/v) encapsulated in 3% (w/v) agarose and 1% (w/v) chitosan.

FIG. 25 shows, in a non-limiting example, a comparison of unformulated lipid and food composition(s) comprising lipid(s) as component(s) of matrix composition(s) and/or core-shell preparation(s). (A) Unformulated oleic acid (OLEA); (B) 80% (w/v) oleic acid in ethyl cellulose (20% w/v); (C) 80% (w/v) oleic acid in carnauba wax (20% w/v); (D) 80% (w/v) oleic acid in ethyl cellulose (20% w/v); (E) 80% (w/v) oleic acid in ethyl cellulose (20% w/v) with a polymeric coating.

FIG. 26 illustrates, in a non-limiting example, several exemplary release profiles of carbohydrate(s) encapsulated within one or more food composition(s) in phosphate buffered saline, pH 7.4, 37 °C. Food composition(s) characterized as matrix preparation(s) are colored light grey, while those characterized as core-shell preparations wherein the core component(s) are further characterized as matrix preparation(s) are colored dark grey. (A) Release of glucose from food composition(s) over time; each line represents an average of 3 dissolution experiments for a distinct food composition (e.g., distinct component(s) and concentration(s)) comprising glucose. (B) First order release rates modeled from glucose release of distinct food composition(s) sorted from fastest release (top) to slowest release (bottom).

FIG. 27 illustrates, in a non-limiting example, several exemplary release profiles of protein(s) encapsulated within one or more food composition(s) in phosphate buffered saline, pH 7.4, 37 °C. Food composition(s) characterized as matrix preparation(s) are colored light grey, while those characterized as core-shell preparations wherein the core component(s) are further characterized as matrix preparation(s) are colored dark grey. (A) Release of whey from food composition(s) overtime; each line represents an average of 3 dissolution experiments for a distinct food composition (e.g., distinct component(s) and concentration(s)) comprising whey. (B) First order release rates modeled from whey release of distinct food composition(s) sorted from fastest release (top) to slowest release (bottom).

FIG. 28 illustrates, in a non-limiting example, several exemplary release profiles of lipid(s) encapsulated within one or more food composition(s) in phosphate buffered saline, pH 7.4, 37 °C. Food composition(s) characterized as matrix preparation(s) are colored light grey. (A) Release of oleic acid from food composition(s) over time; each line represents an average of 3 dissolution experiments for a distinct food composition (e.g., distinct component(s) and concentration(s)) comprising oleic acid. (B) First order release rates modeled from oleic acid release of distinct food composition(s) sorted from fastest release (top) to slowest release (bottom).

FIG. 29 illustrates, in a non-limiting example, a comparison of unformulated flavonoid (e.g., polyphenol) and formulated flavonoid (e.g., polyphenol) in food composition(s) as components of matrix preparation(s) and/or core-shell preparation(s), as well as release profile(s) of encapsulated flavonoid(s). (A) Unformulated cyanidin chloride powder. (B) Matrix preparation comprising glucose. (C) core-shell preparation wherein core component(s) comprise glucose and shell component(s) comprise cyanidin chloride. (D) Release of cyanidin chloride from core-shell preparation in phosphate buffered saline, pH 7.4, 37 °C.

FIG. 30 illustrates, in a non-limiting example, a comparison of unformulated carbohydrate and formulated carbohydrate in food composition(s) as components of matrix preparation(s) and/or core-shell preparation(s), as well as release profile(s) of encapsulated carbohydrate(s). (A) Unformulated inulin powder. (B) Matrix preparation comprising inulin. (C) Release of inulin from matrix preparation in phosphate buffered saline, pH 7.4, 37 °C.

FIG. 31 shows, in a non-limiting example, cross-sectional micrographs of food composition(s). (A) Cross-section of zein-coated sucrose particle preparation(s); (B) Cross-section of glucose 60% (w/v) encapsulated in pectin 1.5% (w/v); (C) Surface of glucose (10% w/v) encapsulated in 3% (w/v) agarose and 1% (w/v) inulin; (D) Surface of 20% (w/v) calcium caseinate encapsulated in 1% (w/v) inulin and 2.5% (w/v) alginate; (E) Cross-section of whey (5% w/v) in 80% (w/v) soy wax and 15% (w/v) tween-80 further encapsulated in a shell component comprising cellulose acetate phthalate; (F) Cross-section of whey (20% w/v) in 80% (w/v) beeswax; (G) 15% (w/v) glucose and 10% (w/v) whey protein isolate encapsulated in 3% (w/v) agarose, 0.1% (w/v) kappa carrageenan, and 0.1% (w/v) locust bean gum, encapsulated in a shell component comprising cellulose acetate phthalate; (H) Cross-section of 80% (w/v) oleic acid encapsulated in ethyl cellulose (20% w/v); (I) Cross-section of 80% (w/v) oleic acid encapsulated in candelilla wax (20% w/v); (J) Cross-section of 80% (W/v) oleic acid in ethyl cellulose (20% w/v) encapsulated in a shell component comprising cellulose acetate phthalate.

FIG. 32 shows, in a non-limiting example, a schematic of a method used to create a core-shell food and/or beverage composition, referred to herein as “core-shell”.

FIG. 33 shows, in a non-limiting example, that core-shell preparation(s) control the release of one or more food component(s). (A) Micrograph depicting uncoated sucrose-containing matrix preparation(s); (B) Zein-coated sucrose-containing matrix preparations. (C) Release of glucose from coated particle preparation(s) (white circles) is slower than uncoated particle preparations (black circles); (D) Unformulated whey protein isolate; (E) Whey protein isolate encapsulated in a core-shell preparation comprising a shell component of chitosan polyphosphate; (F) Chitosan-coated food composition(s) release faster in simulated intestinal fluid (squares) vs. simulated gastric fluid (circles). (G) Release of whey protein from several distinct core-shell preparation(s); each line corresponds to the average (n=3) release of whey protein over time for a distinct core-shell preparation wherein the core component further comprises a matrix preparation (light grey curves) compared to average (n=3) release of whey protein over time for a similar matrix preparation without shell component (dark grey curve). (H) Photograph of core-shell preparation wherein the core component further comprises a matrix preparation comprising agarose and whey protein and the shell component further comprises a matrix preparation comprising zein and cyanidin chloride.

FIG. 34 shows, in a non-limiting example, a schematic of a method used to create a matrix food and/or beverage composition, referred to herein as “matrix”.

FIG. 35 shows, in a non-limiting example, that matrix preparation(s) control the release of one or more food component(s). (A) Photograph and release profile(s) in 10 mM phosphate buffered saline, pH 7.4 of unformulated whey protein isolate; (B) Photograph and release profile(s) in 10 mM phosphate buffered saline, pH 7.4 of 10% (w/v) whey protein isolate, 65% (w/v) oleic acid encapsulated in ethyl cellulose (25% w/v); (C) Photograph and release profile(s) in 10 mM phosphate buffered saline, pH 7.4 of 10% (w/v) whey protein isolate, 1.9% (w/v) chitosan encapsulated in genipin (0.1% w/v)’ (D) Photograph and release profile(s) in 10 mM phosphate buffered saline, pH 7.4 of 10% (w/v) whey protein isolate encapsulated 3% (w/v) agarose and 1% (w/v) chitosan.

FIG. 36 shows, in a non-limiting example, that, in some instances, core-shell preparation(s) comprise encapsulated matrix preparation(s). (A) 10% (w/v) whey protein isolate, 65% (w/v) oleic acid encapsulated in 10% (w/v) carnauba wax and 15% (w/v) ethyl cellulose, further encapsulated in a shell component comprising cellulose acetate phthalate; (B) 60% (w/v) glucose encapsulated in 2% (w/v) pectin, further encapsulated in a shell component comprising cellulose acetate phthalate.

FIG. 37 shows, in a non-limiting example, a schematic of a method used to characterize dissolution and/or release of food and/or beverage composition, referred to herein as “dissolution” and/or “release”.

FIG. 38 shows, in a non-limiting example, exemplary release environment(s). (A) 92% sucrose/8% amylose (circle) vs. 92% sucrose/8% amylose encapsulated in 10% w/v zein (square) food composition(s) exhibiting release in 10 mM phosphate buffered saline pH 7.4 with 1% (w/v) hydroxypropyl methylcellulose; (B) Whey protein isolate (10% w/v) encapsulated in 75% (w/v) cetyl ester wax and 15% (w/v) span 80 exhibiting release in 10 mM phosphate buffered saline pH 7.4; (C) 10% (w/v) whey protein isolate encapsulated in 75% (w/v) CITREM and 15% (w/v) carnauba wax exhibiting release in (hollow triangle) simulated intestinal fluid vs simulated gastric fluid (filled triangle).

FIG. 39 shows, in a non-limiting example, food composition(s) comprising pH-responsive shell component(s). (A) Release of 5% (w/v) whey protein isolate encapsulated in 80% (w/v) fully hydrogenated soybean oil and 15% (w/v) Kolliphor P188 with cellulose acetate phthalate coating in simulated intestinal fluid (hollow circle) vs Eudragit E PO coating in simulated intestinal fluid (filled square); (B) Release of 15% (w/v) whey protein isolate encapsulated in 3% (w/v) agarose, 1% (w/v) kappa carrageenan, and 1% (w/v) locust bean gum with cellulose acetate phthalate coating in simulated gastric fluid (filled diamond) vs. with Eudragit E PO coating in simulated intestinal fluid (filled diamond).

FIG. 40 presents, in a non-limiting example, 4 theoretical release profiles (concentration of food component vs incubation period) of one or more food component(s) from one or more food and/or beverage composition(s).

FIG. 41 presents, in a non-limiting example, that choice of food component(s) influences release of one or more food component(s). Release of whey protein isolate from 5% (w/v) agarose matrix preparation(s) comprising sodium carboxymethylcellulose (2% w/v) (white squares), tween-60 (1% w/v) (grey), and poly(acrylic acid) (2% w/v) (black squares).

FIG. 42 presents, in a non-limiting example, that concentration of food component(s) influences release of one or more food component(s). Release of whey protein isolate from formulations comprising varying amounts of candelilla wax and gelucire 50/13 (w/v): 75%/15%, (white circle), 85%/5% (gray circle), and 80%/15% (black circle).

FIG. 43 presents, in a non-limiting example, that matrix component(s) influence release of one or more food component(s). Release of whey protein isolate from formulations of different matrix component(s): 5% (w/v) agarose and 1% (w/v) hydroxypropylmethyl cellulose (white triangle); 75% (w/v) cetyl ester wax and 15% (w/v) Span 80 (gray triangle); 60% (w/v) 27-stearine, 15% (w/v) β-sitosterol w/v, and 10% (w/v) γ-oryzanol (black triangle).

FIG. 44 shows, in a non-limiting example that food and/or beverage compositions demonstrate low (<0.20) water activity and low moisture content at 25 °C.

FIG. 45 illustrates, in a non-limiting example, brightfield micrographs of food and/or beverage compositions (e.g., alginate/whey beads, gelatin/whey beads, and/or sucrose/amylose beads) blended homogeneously with commercially available food product (e.g., MRE, Ensure, water), imparting minimal change and/or discernable change to visible appearance (e.g., color and texture).

### DETAILED DESCRIPTION OF CERTAIN EMBODIMENTS

Section headings used herein are for organizational purposes only and are not to be construed as limiting the subject matter described.

### A. CERTAIN TERMINOLOGY

Unless defined otherwise, technical and scientific terms used herein have the same meaning as is commonly understood to which the claimed subject matter belongs. In the event that there are a plurality of definitions for terms herein, those in this section prevail.

It is to be understood that the general description and the detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Definition of standard chemistry terms may be found in reference works, including but not limited to, Carey and Sundberg “Advanced Organic Chemistry 4th Ed.” Vols. A (2000) and B (2001), Plenum Press, New York.

As used herein, the symbol “<” means less than or fewer than. As used herein, the symbol “>” means more than.

As used herein, the term “about” or “approximately” means within 10%, preferably within 10%, and more preferably within 5% of a given value or range.

Ambient: The term “ambient”, as used herein, refers to a typical indoor (e.g., climate-controlled) temperature, usually within a range of about 18 °C to about 32 °C, and/or typical indoor (e.g., climate-controlled) humidity, usually within a range of about 30% to 50%. In some embodiments, ambient temperature is within a range of about 20 °C to about 30 °C. In some embodiments, ambient temperature is 25±5 °C. In some embodiments, ambient temperature is approximately 21 °C. In some embodiments, ambient temperature is 18 °C. In some embodiments, ambient temperature is 19 °C. In some embodiments, ambient temperature is 20 °C. In some embodiments, ambient temperature is 21 °C. In some embodiments, ambient temperature is 22 °C. In some embodiments, ambient temperature is 23 °C. In some embodiments, ambient temperature is 24 °C. In some embodiments, ambient temperature is 25 °C. In some embodiments, ambient temperature is 26 °C. In some embodiments, ambient temperature is 27 °C. In some embodiments, ambient temperature is 28 °C. In some embodiments, ambient temperature is 29 °C. In some embodiments, ambient temperature is 30 °C. In some embodiments, ambient may be used to describe outdoor conditions, and may include temperatures ranging from about 15 °C to about 40 °C, or from about 25 °C to about 40 °C. In some embodiments, ambient humidity is within a range of about 35% to about 45%. In some embodiments, ambient temperature is 35%. In some embodiments, ambient temperature is 36%. In some embodiments, ambient temperature is 37%. In some embodiments, ambient temperature is 38%. In some embodiments, ambient temperature is 39%. In some embodiments, ambient temperature is 40%. In some embodiments, ambient temperature is 41%. In some embodiments, ambient temperature is 42%. In some embodiments, ambient temperature is 43%. In some embodiments, ambient temperature is 44%. In some embodiments, ambient temperature is 45%.

Beverage: As used herein, the term “beverage” is used to refer to a potable liquid (e.g., that can be ingested, swallowed, drunk, or consumed by a person or animal without material risk to the person or animal). For example, beverage can be or comprise beer, juice, milk, a sports drink, tea, water, soda, yogurt, etc. In some embodiments, a “beverage” may be or comprise a pharmaceutical formulation in liquid form.

Biocompatible: As used herein, the term “biocompatible” is used to describe a characteristic of not causing significant detectable harm to living tissue when placed in contact therewith e.g., in vivo. In certain embodiments, materials are “biocompatible” if they are not significantly toxic to cells, e.g., when contacted therewith in a relevant amount and/or under relevant conditions such as over a relevant period of time. In certain embodiments, materials are “biocompatible” if their addition to cells in vitro results in less than or equal to 20% cell death, and/or their administration in vivo does not induce significant inflammation or other adverse effects.

Comparable: As used herein, the term “comparable” refers to two or more agents, entities, situations, sets of conditions, etc., that may not be identical to one another but that are sufficiently similar to permit comparison therebetween so that one skilled in the art will appreciate that conclusions may reasonably be drawn based on differences or similarities observed. In some embodiments, comparable sets of conditions, circumstances, individuals, or populations are characterized by a plurality of substantially identical features and one or a small number of varied features. Those of ordinary skill in the art will understand, in context, what degree of identity is required in any given circumstance for two or more such agents, entities, situations, sets of conditions, etc. to be considered comparable. For example, those of ordinary skill in the art will appreciate that sets of circumstances, individuals, or populations are comparable to one another when characterized by a sufficient number and type of substantially identical features to warrant a reasonable conclusion that differences in results obtained or phenomena observed under or with different sets of circumstances, individuals, or populations are caused by or indicative of the variation in those features that are varied.

Degradation: As used herein, the term “degradation” refers to a change in chemical structure and often involves breakage of at least one chemical bond. To say that a chemical compound is degraded typically means that the chemical structure of the chemical compound has changed (e.g., a chemical bond is broken). Common mechanisms of degradation include, for example, oxidation, hydrolysis, isomerization, fragmentation, or a combination thereof.

Delivery: As used herein, the term “delivery” is used to refer to the carrying and/or deposition and/or moving of nutrients (e.g., macronutrients, micronutrients, ketones, flavanols, prebiotics, etc.) and/or encapsulants to particular location (e.g., into and/or throughout the body). In some instances, for example, delivery may refer to payload delivery to the epithelial cells in the gastrointestinal tract. In some instances, for example, delivery may refer to payload delivery to into the blood stream (e.g., systemic absorption). In some instances, for example, delivery may refer to ingestion at the point of consumption for a shelf-stable food composition containing a nutrient payload.

Diameter: As used herein, the term “diameter” is used to refer to the longest distance from one end of a particle to another end of the particle. Those skilled in the art will appreciate that a variety of techniques are available for use in characterizing particle diameters (i.e., particle sizes). In some instances, for example, size of particles (e.g., diameter of particles) can be measured by a Coulter Counter. In some instances, for example, size of particles (e.g., diameter of particles) can be measured by a Malvern Mastersizer. In some embodiments, a population of particles is characterized by an average size (e.g., D[3,2], D[4,3], etc.) and/or by particular characteristics of size distribution (e.g., absence of particles above or below particular sizes [e.g., Dv10, Dv20, Dv30, Dv40, Dv50, Dv60, Dv70, Dv80, Dv90, Dv99, etc.], a unimodal, bimodal, or multimodal distribution, etc.).

Dispersity: As used herein, the term “dispersity” is used to refer to the breadth of particle size distribution relative to the average particle size. In some instances, for example, size of particles (e.g., diameter of particles) can be measured by a Coulter Counter. In some instances, for example, size of particles (e.g., diameter of particles) can be measured by a Malvern Mastersizer. In some embodiments, the population of particles is characterized by, for example, an average size (e.g., Dv50) and, for example, a corresponding standard deviation. In some instances, the dispersity of a population of particles refers to double (e.g., 2-fold) the ratio of standard deviation (e.g., σ) to average particle diameter (e.g., Dv50).

Encapsulant: As used herein, the term “encapsulant” is used to refer to anything that is used to encapsulate a payload. For example, in many embodiments of the present disclosure, a payload component (e.g., a nutrient component) is described as being encapsulated by an encapsulant (e.g., polymer component, food component, material component, etc.).

Encapsulated: As used herein, the term “encapsulated” is used to refer to a characteristic of being physically associated with, and in some embodiments partly or wholly covered or coated. For example, in many embodiments of the present disclosure, a payload component (e.g., a microbe component and/or a nutrient component) is described as being encapsulated by a polymer component.

Food: As used herein, the term “food” is used to refer to an edible solid (e.g., that can be ingested, swallowed, chewed, or consumed by a person or animal without material risk to the person or animal). For example, food can be or comprise agricultural seed, baby formula, bread, candy, capsule, cake, cereal, chip, cookie, dry powder, fertilizer, food additive, ice cream, kefir, nutrition supplement, packaged food, pet feed, pet food, protein bar, protein powder, sachet, salad dressing, smoothie, spice, sprinkle packet, tablet, yogurt, etc. In some embodiments, a “food” may be or comprise a pharmaceutical formulation in solid form. In some embodiments, a “food” may generally refer to a food and/or beverage product. In some embodiments, a “food” may generally refer to an edible object that is intended to confer a benefit (e.g., health, energy, nutrition, performance, well-being) on one or more animal(s).

Food Compositions: As used herein, the term “food compositions” is used to refer to an edible solid (e.g., that can be ingested, swallowed, chewed, or consumed by a person or animal without material risk to the person or animal) or an ingestible liquid (e.g., that can be ingested, swallowed, drank, or consumed by a person or animal without material risk to the person or animal) that provides health benefits resulting from controlled release, absorption, spatial access, concentration, and/or residence time of nutrients. For example, food compositions can be or comprise agricultural seed, dry powders, supplements, solid foods, beverages and/or drinks, etc. In some embodiments, a “food composition” may be or comprise a pharmaceutical formulation in solid form. In some embodiments, a “food composition” may be or comprise a pharmaceutical formulation in liquid form. In some embodiments, a “food composition” may generally refer to a food and/or beverage product. In some embodiments, a “food composition” may generally refer to an edible object that is intended to confer a benefit (e.g., health, energy, nutrition, performance, well-being) on one or more animal(s). Example food compositions (e.g., formulated ingestibles) include protein shakes, dry powders (e.g., baby formula, protein powder, drink mixes, coffee grinds), Meal Ready-to-Eat (MRE), Meal Ready-to-Drink (RTD), electrolyte beverages, sports beverages, hard seltzers (alcoholic seltzers), dry foods (e.g., rice, pasta), water, medical foods (e.g., Ready-to-drink low phenylalanine medical food), supplements, beer, wine, soda, coffee, fermented foods and beverages (e.g., yogurt, beer, etc.); for example, MREs, Gatorade, Truly, Ensure, PKU Sphere Liquid, etc.

Food and Beverage Compositions: As used herein, the term “food and beverage compositions” is used to refer to an edible solid (e.g., that can be ingested, swallowed, chewed, or consumed by a person or animal without material risk to the person or animal) or an ingestible liquid (e.g., that can be ingested, swallowed, drank, or consumed by a person or animal without material risk to the person or animal) that provides health benefits resulting from controlled release, absorption, spatial access, concentration, and/or residence time of nutrients. For example, food and beverage compositions can be or comprise agricultural seed, dry powders, supplements, solid foods, beverages and/or drinks, etc. In some embodiments, a “food and beverage composition” may be or comprise a pharmaceutical formulation in solid form. In some embodiments, a “food and beverage composition” may be or comprise a pharmaceutical formulation in liquid form. In some embodiments, a “food and beverage composition” may generally refer to a food and/or beverage product. In some embodiments, a “food and beverage composition” may generally refer to an edible object that is intended to confer a benefit (e.g., health, energy, nutrition, performance, well-being) on one or more animal(s). Example food and beverage compositions (e.g., formulated ingestibles) include protein shakes, dry powders (e.g., baby formula, protein powder, drink mixes, coffee grinds), Meal Ready-to-Eat (MRE), Meal Ready-to-Drink (RTD), electrolyte beverages, sports beverages, hard seltzers (alcoholic seltzers), dry foods (e.g., rice, pasta), water, medical foods (e.g., Ready-to-drink low phenylalanine medical food), supplements, beer, wine, soda, coffee, fermented foods and beverages (e.g., yogurt, beer, etc.); for example, MREs, Gatorade, Truly, Ensure, PKU Sphere Liquid, etc.

Formulated Beverages: As used herein, the term “formulated beverages” is used to refer to an ingestible liquid (e.g., that can be ingested, swallowed, drank, or consumed by a person or animal without material risk to the person or animal) that provides health benefits resulting from controlled release, absorption, spatial access, concentration, and/or residence time of nutrients. Examples include protein shakes, coffee, Meal Ready-to-Drink (RTD), electrolyte beverages, sports beverages, hard seltzers (alcoholic seltzers), water, medical foods (e.g., Ready-to-drink low phenylalanine medical food), supplements, beer, wine, soda, fermented foods and beverages (e.g., yogurt, beer, etc.);

Formulated Foods: As used herein, the term “formulated foods” is used to refer to an edible solid (e.g., that can be ingested, swallowed, chewed, or consumed by a person or animal without material risk to the person or animal) that provides health benefits resulting from controlled release, absorption, spatial access, concentration, and/or residence time of nutrients. Examples include dry powders (e.g., baby formula, protein powder, drink mixes), Meal Ready-to-Eat (MRE), yogurt, cheese, freshly prepared meals, frozen meals, etc.

Formulated Ingestibles: As used herein, the term “formulated ingestibles” is used to refer to an edible dosage form (e.g., that can be ingested, drank, swallowed, chewed, or consumed by a person or animal without material risk to the person or animal) such as a pill, capsule, tablet, etc. that provides health benefits resulting from controlled release, absorption, spatial access, concentration, and/or residence time of nutrients.

Formulated Meals: As used herein, the term “formulated meals” is used to refer to a solid meals (e.g., that can be ingested, swallowed, chewed, or consumed by a person or animal without material risk to the person or animal) such as microwavable meals, freshly prepared meals, frozen meals, MREs, etc., that provides health benefits resulting from controlled release, absorption, spatial access, concentration, and/or residence time of nutrients.

Formulated Supplements: As used herein, the term “formulated supplements” is used to refer to an edible dosage form (e.g., that can be ingested, swallowed, chewed, or consumed by a person or animal without material risk to the person or animal) such as a pill, capsule, tablet, etc. that provides health benefits resulting from controlled release, absorption, spatial access, concentration, and/or residence time of nutrients.

Hard Seltzers: As used herein, the term “hard seltzer” is used to refer to an ingestible liquid that contains alcohol and carbonated water.

HLB: As used herein, the term “HLB” is used to refer to the hydrophilic lipophilic balance that is an inherent property of, for example, a nonionic surfactant. In some instances, the HLB value of a given non-ionic surfactant is obtained from a commonly accessible tabular source. In some embodiments, non-ionic surfactants characterized as having a low HLB value (e.g., <8) are compatible emulsifiers for lipid systems. In some embodiments, nonionic surfactants characterized as having a high HLB value (e.g., >15) are compatible emulsifiers for aqueous systems. In some embodiments, non-ionic surfactants characterized as having an intermediate HLB value (e.g., >8 and <15) are compatible emulsifiers with both lipid and aqueous systems.

Homogenous: As used herein, the term “homogenous” means of substantially uniform structure and/or composition throughout.

Hydrophobic: As used herein, the term “hydrophobic” is used to refer to the propensity of a material to reject association, chemically and/or physically, with water. In some instances, a material characterized as being hydrophobic is biologically derived and/or synthetically derived. In some instances, a material characterized as being hydrophobic is a lipid, protein, and/or carbohydrate. In some instances, a material characterized as being hydrophobic is a polymer and/or small molecule. Alternatively, or additionally, in some embodiments, composites, mixtures, blends, or super-structures of several materials are collectively referred to as hydrophobic based on their observed propensity to reject association, chemically and/or physically, with water.

Incorporation: As used herein, the term “incorporation” is used to refer to a characteristic of being physically associated with, and in some embodiments, dispersed within, embedded within, or mixed in a bulk material (e.g., a lipid matrix component).

Layer: As used herein, the term “layer” typically refers to a material disposed above or below a distinguishable material. In some embodiments, a particular entity or preparation (e.g., particle preparation) is described as “layered” if it is prepared via a process in which a first material is laid down and then a second material is applied atop or underneath the first material (e.g., as by dipping or spraying, etc); in some such embodiments, physical or chemical distinctness of layers may be maintained over time, whereas in some such embodiments, physical or chemical distinctness of layers may decay over time, at least at layer interface(s). Alternatively or additionally, in some embodiments, a particular sample or preparation may be described as layered, independent of its mode of preparation, so long as at a particular point in time and/or using a particular mode of assessment, distinct materials can be identified in a layered structure. In some embodiments, a “layered” particle may include one or more layers that wholly encapsulate a material below. In some embodiments, a “layered” particle may include one or more layers that does not wholly encapsulate a material below. In some embodiments, at least one layer of a layered preparation is or comprises a polymer, e.g., a hydrophobic polymer or hydrophilic polymer. In some embodiments, each layer of a layered preparation is or comprises a polymer, e.g., a pH responsive polymer or a temperature-responsive polymer.

Lipid: As used herein, the term “lipid” is used to refer to a class of chemical structures characterized as hydrophobic materials. In some instances, a lipid material is derived from a biological source. In other instances, a lipid material is derived from a synthetic source. In some instances, a lipid is comprised of one or more aliphatic alcohols and/or acids linked by glycerol and/or glycol moieties. In other instances, a lipid is comprised of aliphatic chains, linear conjugated, aromatic, and/or cyclic aliphatic moieties. In some embodiments, a lipid refers to a pure chemical entity. In other embodiments, a lipid refers to a mixture of several pure chemical entities. For example, lipids include, but are not limited to: paraffin wax, montan wax, microcrystalline wax, polyethylene wax, petrolatum wax, ozokerite wax, ceresin wax, beeswax, lanolin wax, spermaceti wax, tallow wax, lac wax, chinese insect wax, ambergris wax, soy wax, carnauba wax, candelilla wax, coconut wax, palm kernel wax, rice bran wax, butyric acid, n-butanol, pentanoic acid, n-pentanol, hexanoic acid, n-hexanol, heptanoic acid, n-heptanol, caprylic acid, n-octanol, nonanoic acid, n-nonanol, capric acid, n-decanol, lauric acid, n-dodecanol, myristic acid, n-tetradecanol, palmitic acid, n-hexadecanol, stearic acid, n-octadecanol, arachidonic acid, n-icosanol, fatty alcohol monoglyceride ethers, fatty acid monoglyceride esters, fatty alcohol diglyceride ethers, fatty acid diglyceride esters, fatty alcohol triglyceride ethers, fatty acid triglyceride esters, fatty alcohol glycol monoether, fatty acid glycol monoesters, fatty alcohol glycol diethers, fatty acid glycol diesters, fatty alcohol poly(glycerol) ethers, fatty acid poly(glycerol) esters, fatty alcohol poly(glycol) ethers, fatty acid poly(glycol) esters, coconut oil, corn oil, cottonseed oil, olive oil, palm oil, peanut oil, rapeseed oil, safflower oil, sesame oil, soybean oil, sunflower oil, almond oil, pine nut oil, cashew oil, fully hydrogenated palm oil, partially hydrogenated palm oil, fully hydrogenated sunflower oil, partially hydrogenated sunflower oil, fully hydrogenated soybean oil, partially hydrogenated soybean oil, fully hydrogenated vegetable oil, partially hydrogenated vegetable oil, fully hydrogenated cottonseed oil, partially hydrogenated cottonseed oil, cholesterol, cholenic acid, ursolic acid, or betulinic acid.

Lyophilized: As used herein, the term “lyophilized” is used to refer to the end product of a process by which water is removed from a material via sublimation. In some instances, prior to sublimation of water, the material is cooled to <−10 °C, <−20 °C, <−30 °C, <−40 °C, <−50 °C, <−60 °C, and/or <−70 °C. In some instances, prior to the sublimation of water, the pressure is lowered to <200 torr, <150 torr, <100 torr, <50 torr, <10 torr, <5 torr, and/or <1 torr. Those skilled in the art recognize that the cooling temperature and pressure influence the physicochemical properties of the end product; it is understood that “lyophilized” encompasses all suitable manners of cooling and vacuum protocol.

Medical Foods: As used herein, the term “medical foods” is used to refer to an edible dosage form (e.g., that can be ingested, swallowed, chewed, or consumed by a person or animal without material risk to the person or animal) such as a pill, capsule, tablet, etc. that provides health benefits resulting from controlled release, absorption, spatial access, concentration, and/or residence time of nutrients.

Nutraceutical: As used herein, the terms “nutraceutical” or “nutraceutical composition” refer to a substance or material that is or comprises a nutraceutical agent (e.g., a nutraceutical). Those skilled in the art will be aware of a variety of agents understood in the art to be nutraceutical agents such as, for example, agents that are or comprise one or more antioxidants, macronutrients, micronutrients, minerals, prebiotics, probiotics, probiotic powders, probiotic ingredients, probiotic food ingredients, probiotic supplement ingredients, prebiotics, vitamins, or combinations thereof. In some embodiments, a nutraceutical is or comprises a carotenoid compound such as alpha-lipoic acid, astaxanthin, adonixanthin, adonirubin, beta-carotene, coenzyme Q10, lutein, lycopene, or zeaxanthin. In some embodiments, a nutraceutical is or comprises a vitamin such as vitamin D. In many embodiments, a nutraceutical agent is a natural product, and in certain such embodiments it is a product produced by plants. Many nutraceutical agents are compounds that have been reported or demonstrated to confer a benefit or provide protection against a disease in an animal or a plant. In some cases, nutraceuticals may be used to improve health, delay the aging process, protect against chronic diseases, increase life expectancy, or support the structure or function of the body of an animal, such as a human, a pet animal, an agricultural animal, or another domesticated animal. As such, as used in the present disclosure, the terms “nutraceutical composition,” “food preparation,” “food composition,” “particle preparation,” etc. may all be generally understood to describe compositions, preparations, and/or particles that include one or more food components (for example, encapsulated food component(s)).

Nutrient: As used herein, the term “nutrient” is used to refer to a nutraceutical, a macronutrient, a carbohydrate, a sugar, a polysaccharide, a dietary fiber, a fat, a fatty acid, a lipid, a short-chain fatty acid, a protein, an amino acid, a peptide, a micronutrient, a vitamin, a mineral, a carotenoid, an element, a ketone body, a prebiotic, a probiotic, a postbiotic, a bacteria, a yeast, a polyphenol, a flavonoid, an antioxidant, an electrolyte, a salt, a circadian rhythm modulator, a supplement, a nootropic, and/or a source of energy.

Overfortification: As used herein, the term “overfortification” is used to addition of a nutrient in excess of a label claim, due to expected nutrient degradation or loss of stability during manufacturing, processing, and/or shelf-life. This additional amount of nutrient is used to account for losses during manufacturing, processing, and/or shelf-life to still meet the nutrient label claim.

Particle: As used herein, the term “particle” is used to refer to a discrete physical entity, typically having a size (e.g., a longest cross-section, such as a diameter) within a range. For example, a particle can have a size of about 5-3000 μm, about 5-2000 μm, about 5-1000 μm, about 5-500 μm, about 5-50 μm, about 5-300 μm, about 5-200 μm, about 5-100 μm, about 5-50 μm, about 5-25 μm, or about 5-10 μm. In some embodiments, a particle may describe or include animal pellets ranging in size up to 1 mm, 5 mm, 10 mm, 25 mm, and even about 50 mm (about 2 inches) in diameter. A “particle” is not limited to a particular shape or form, for example, having a cross-section shape of a sphere, an oval, a triangle, a square, a hexagon, or an irregular shape. In some cases, particles can be solid particles. In some cases, particles can be liquid particles. In some cases, particles can be gel or gel-like particles. In some cases, particles may have a particle-in-particle structure wherein a layer of one material (e.g., one type of polymer component) encapsulates another material (e.g., another type of polymer component, which may itself encapsulate yet another, or rather may be or comprise a “core”—e.g., a polymer matrix core—of the particle).

Parts per million (ppm): As used herein, 1 ppm (“parts per million”) is equivalent to 1 milligram per liter (mg/L) or 1 milligram per kilogram (mg/kg).

Payload: In general, the term “payload”, as used herein, refers to an agent that may be delivered or transported by association with another entity. In some embodiments, such association may be or include a covalent linkage; in some embodiments such association may be or include non-covalent interaction(s). In some embodiments, association may be direct; in some embodiments, association may be indirect. The term “payload” is not limited to a particular chemical identity or type; for example, in some embodiments, a payload may be or comprise, for example, an entity of any chemical class including, for example, a nutrient, a lipid, a metal, a nucleic acid, a polypeptide, a saccharide (e.g., a polysaccharide), small molecule, or a combination or complex thereof. In some embodiments, a nutrient may include a lipid, a saccharide, a protein, etc. In some embodiments, a payload may be or comprise a biological modifier, a detectable agent (e.g., a dye, a fluorophore, a radiolabel, etc.), a detecting agent, a nutrient, a therapeutic agent, etc., or a combination thereof. In some embodiments, a payload may be or comprise a cell or organism, or a fraction, extract, or component thereof. In some embodiments, a payload may be or comprise a natural product in that it is found in and/or is obtained from nature; alternatively or additionally, in some embodiments, the term may be used to refer to one or more entities that is man-made in that it is designed, engineered, and/or produced through action of the hand of man and/or is not found in nature. In some embodiments, a payload may be or comprise an agent in isolated or pure form; in some embodiments, such agent may be in crude form.

pH Responsive: The term “pH-responsive” is used to refer to certain polymer component(s) as described herein, and in particular means that the relevant polymer component is characterized in that one or more aspects of its structure or arrangement is altered when exposed to a change in pH condition (e.g., to a particular pH and/or to a pH change of particular magnitude). In some embodiments, a polymer component is considered to be “pH-responsive” if, when the relevant polymer component is associated with a payload component in a particle preparation as described herein, the particle preparation releases the payload component under specific pH condition(s). In some embodiments, >90% of payload component is released from a particle preparation that includes a pH-responsive polymer component within 15 minutes when the particle preparation is exposed to a particular defined pH condition (e.g., within a range of defined pH values and/or at a specific pH value); in some embodiments, such release results when such contacting occurs at temperatures between 33-40 °C, and in aqueous-based buffers of ionic strength ranging from 0.001-0.151 M (e.g., water, simulated gastric fluid, gastric fluid, simulated intestinal fluid, intestinal fluid) with osmolality between 1-615 mOsm/kg. In some embodiments, a pH-responsive polymer component is one that degrades when exposed to a particular pH or pH change. Alternatively or additionally, in some embodiments, a pH-responsive polymer component is one that becomes soluble, or significantly (e.g., (e.g., by at least about 5%) increases its solubility when exposed to a particular pH level, or pH change. In some embodiments, a pH-responsive polymer component includes one or more moieties whose protonation state changes at the relevant pH or in response to the relevant pH change. For example, in some embodiments, a pH responsive polymer component includes one or more amine moieties that become protonated upon exposure to a relevant pH or pH chance.

Polyphenols: As used herein, the term “polyphenol” is used to refer to naturally occurring organic compounds, comprising one or multiple aromatic groups with one or more hydroxyl groups or hydroxyl derivatives (e.g., methoxyl, ethoxyl, acetyl, etc.) and/or deriving from the shikimate, phenylpropanoid, and/or polyketide pathways. For example, a polyphenol may be phenolic acids, flavonoids, stilbenes, and lignans, antioxidants, tannins, and/or combinations thereof.

Prebiotic: As used herein, the term “prebiotic” is used to refer to a nondigestible food ingredient that promotes the growth of beneficial microorganisms in the intestines.

Reference: As used herein describes a standard or control relative to which a comparison is made. For example, in some embodiments, an agent, animal, individual, population, sample, sequence or value of interest is compared with a reference or control agent, animal, individual, population, sample, sequence or value. In some embodiments, a reference or control is tested and/or determined substantially simultaneously with the testing or determination of interest. In some embodiments, a reference or control is a historical reference or control, optionally embodied in a tangible medium. Typically, as would be understood by those skilled in the art, a reference or control is determined or characterized under comparable conditions or circumstances to those under assessment. Those skilled in the art will appreciate when sufficient similarities are present to justify reliance on and/or comparison to a particular possible reference or control.

Residual solvent: As used herein, the term “residual solvent” refers to a solvent that remains in a material after manufacture or processing of the material. In some embodiments, level of residual solvent is assessed by HPLC, mass spec, NMR, FTTR, and/or gas chromatography.

Satiety: As used herein, the term “satiety” refers to being full and/or sated; for example, feeling satisfied due to ingestion of a food and/or beverage composition or having a desire removed following ingestion of a food and/or beverage composition.

Stable: The term “stable,” when applied to compositions herein, means that the compositions maintain (e.g., as determined by one or more analytical assessments) one or more aspects of their physical structure and/or performance characteristic(s) (e.g., activity) over a period of time and/or under a designated set of conditions. When an assessed composition is a particle composition, in some embodiments, as will be clear from context to those skilled in the art, the term “stable” refers to maintenance of a characteristic such as average particle size, maximum and/or minimum particle size, range of particle sizes, and/or distribution of particle sizes (i.e., the percentage of particles above a designated size and/or outside a designated range of sizes) over a period of time and/or under a designated set of conditions. For food and/or beverage compositions, stable often refers to maintenance or preservation of delivery functions (e.g., controlled release, sustained release, controlled residence time, sustained residence time, etc.).

Temperature-responsive: As used herein, the term “temperature-responsive” is used to refer to certain polymer component(s) as described herein, and in particular means that the relevant polymer component is characterized in that one or more aspects of its structure or arrangement is altered when exposed to a change in temperature condition (e.g., to a particular temperature and/or to a temperature change of particular magnitude). In some embodiments, a polymer component is considered to be “temperature-responsive” if, when the relevant polymer component is associated with a payload component in a particle preparation as described herein, amorphous regions of the polymer component experience a transition from a rigid state (e.g., glassy state) to a more fluid-like flexible state (e.g., more conducive to flow), at a temperature close to the point of transition from the solid state to rubbery state (e.g., glass transition).

Water activity: As used herein, “water activity” of a material is an indication (e.g., a measurement) of how much free (i.e., available to bind or react) water is present in the material, and is typically determined as the ratio of the vapor pressure of water in a material (p) to the vapor pressure of pure water (p0) at the same temperature. For example, a water activity of 0.80 means the vapor pressure is 80 percent of that of pure water. Water activity typically increases with temperature. Those skilled in the art will be familiar with three basic water activity measurement systems: Preventive Electrolytic Hygrometers (REH), Capacitance Hygrometers, and Dew Point Hygrometers (sometimes called chilled mirror).

### B. OVERVIEW

Disclosed herein, among other things, are compositions (e.g., food and/or beverage compositions (e.g., formulated ingestibles)) comprised of food component(s), comprising at least one of a nutrient, a nutraceutical, a macronutrient, a carbohydrate, a sugar, a monosaccharide, a polysaccharide, a dietary fiber, a fat, a fatty acid, a lipid, a protein, an amino acid, a peptide, a micronutrient, a vitamin, a mineral, a polypeptide, a carotenoid, an element, a ketone body, a prebiotic (e.g., a prebiotic fiber), a polyphenol, a flavonoid, an antioxidant, an electrolyte, a salt, a circadian rhythm modulator, a supplement, a nootropic, and/or a source of energy, one or more excipient component(s), means for the controlled release of food component(s) from one or more food composition(s), and methods of manufacture, maintenance (e.g., storage), and/or use (e.g., administration or delivery) of one or more food and/or beverage composition(s).

In some embodiments, provided food and/or beverage compositions (e.g., formulated ingestibles) are comprised of food component(s) and/or excipient component(s) physically or chemically arranged in a predetermined configuration. In some embodiments, provided food and/or beverage compositions (e.g., formulated ingestibles) are comprised of food component(s) and/or excipient component (s) physically or chemically arranged in an indeterminate configuration. In some embodiments, a predetermined physical configuration is a core-shell preparation and/or a matrix preparation and/or a layered preparation. In some embodiments, a predetermined chemical configuration is a salt, a linear oligomer, a linear polymer, a star-shaped oligomer, and/or a star-shaped polymer. In some embodiments, the configuration of one or more food component(s) establishes the means of controlled release of food component(s) from food composition(s).

In some embodiments, provided food and/or beverage compositions (e.g., formulated ingestibles) are comprised, on a dry weight basis, of a majority of food component(s), comprising at least one of a carbohydrate, a fat, a protein, a vitamin, a ketone body, and/or a polyphenol. In some embodiments, provided food and/or beverage compositions (e.g., formulated ingestibles) are comprised, on a dry weight basis, of at least 90% of food component(s), comprising at least one of a carbohydrate, a fat, a protein, a vitamin, a ketone body, and/or an antioxidant. In some embodiments, provided food and/or beverage compositions (e.g., formulated ingestibles) are comprised, on a dry weight basis, of at least 99% of food component(s), comprising at least one of a carbohydrate, a fat, a protein, a vitamin, a ketone body, and/or an antioxidant. In some embodiments, one or more food component(s) establishes the means of controlled release of food component(s) from food composition(s).

In some embodiments according to the present disclosure, a combination of one or more food component(s) and their configuration establishes the means of controlled release of food component(s) from food composition(s).

The present disclosure provides one or more food composition(s) characterized as providing a means of controlled release of one or more food component(s) comprising one or more food component(s) and their arrangement. The present disclosure leverages (e.g., understanding and repurposing) the physical and/or chemical traits of one or more food component(s) to control the interaction of one or more food composition(s) in one or more animal(s).

In some embodiments, one or more nutrients, nutraceuticals, macronutrients, carbohydrates (e.g., one or more carbohydrate components), proteins (e.g., one or more protein components), fats (e.g., one or more fat components), micronutrients, vitamins, minerals, polyphenols, electrolytes, salts, ketone bodies, prebiotics, polymers, or combinations thereof are used to encapsulate a food component and/or core-shell and/or matrix preparations comprising one or more food composition(s).

In some embodiments, one or more hydrophobic materials, hydrophilic materials, and/or amphiphilic materials are used to encapsulate a food component and/or core-shell and/or matrix preparations comprising one or more food composition(s).

In some embodiments, one or more responsive properties of one or more food component(s) enables the means of controlled release of food component(s) from food composition(s). In some embodiments, properties of one or more food component(s) advantageous to establishing means of controlled release include, but are not limited to, response to pH, response to temperature, response to water, response to mechanical forces, response to endogenous chemical or enzymatic triggers, response to exogenous chemical or enzymatic triggers, response to osmotic pressure, and/or response to time.

In some embodiments, one or more interfacial properties of one or more food component(s) enables the means of controlled release of food component(s) from food composition(s). In some embodiments, properties of one or more food component(s) advantageous to establishing means of controlled release include, but are not limited to, mucoadhesion, bioadhesion, buoyancy, size, and/or shape.

In some embodiments, a combination of one or more responsive properties and one or more interfacial properties of one or more food component(s) establishes the means of controlled release of food component(s) from food composition(s).

Disclosed herein, among other things, are means for reducing daily meal frequency, further comprising a means of providing satisfaction and/or satiety, and/or a means of providing a nutritional benefit, further comprising an effective daily dose of one or more food component(s), excipient component(s), and/or food composition(s). Without wishing to be bound by any particular theory, it is contemplated that the disclosed means of reducing daily meal frequency are of particular advantage in reducing the time necessary to prepare and consume one or more meal(s) while simultaneously providing satiety and/or nutrition.

In certain embodiments, a means of providing satisfaction and/or satiety is one or more food component(s), one or more excipient component(s), and/or one or more food composition(s) further characterized by pleasing taste, pleasing texture, controlled release, modulation of physiological satiety response, or combinations thereof. In certain embodiments, a means of providing nutritional benefit is one or more food component(s), one or more excipient component(s), and/or one or more food composition(s) further characterized by caloric value and/or mass (e.g., grams, lbs/pounds), as enzyme inhibitors, and/or as absorption enhancers.

In certain embodiments, the caloric value and/or mass of one or more food component(s), excipient component(s), and/or food composition(s) is sufficient to provide for the nutritional benefit, as described herein, of one or more animal(s). In certain embodiments, the caloric value one of or more food component(s), excipient component(s), and/or food composition(s) is at least about 250, at least about 500, about 1000, about 1500, about 2500, about 3500, and/or about 4500 calories. For example, in certain embodiments the total mass of protein provided by one or more food composition(s) is characterized as at least about 100, at least about 200, about 300, about 400, about 500, about 600, and/or about 700 g. Without wishing to be bound by any particular theory, it is contemplated that a caloric value and/or mass of macronutrients provided represents the theoretical maximum energy comprised in one or more food component(s), excipient component(s), and/or food composition(s). Additionally, without wishing to be bound by any particular theory, it is contemplated that, while correlated, the caloric value and/or mass of one or more food component(s), excipient component(s), and/or food composition(s) is not necessarily indicative of a nutritional benefit. Accordingly, the present disclosure provides a means of reducing daily meal frequency by providing a means of nutritional benefit comprising an unexpectedly low caloric value and/or mass.

In certain embodiments, the present disclosure provides one or more food composition(s), ingested in one meal, characterized by sufficient satisfaction, satiety, and nutritional benefit for a 24-hour period.

### C. FOOD COMPOSITIONS AND MEANS OF CONTROLLED RELEASE OF ONE OR MORE FOOD COMPONENT(S) FROM ONE OR MORE FOOD COMPOSITION(S)

### 1. Food Composition(s)

In some aspects, the provided food composition(s) are comprised of one or more food component(s), as described herein, in a predetermined physical and/or chemical configuration, as described herein. In some aspects, the provided food composition(s) are comprised of one or more food component(s), as described herein, in an indeterminate physical and/or chemical configuration. In some aspects, the configuration of the food component(s) comprising a food composition establishes a means of controlled release of food component(s). In some aspects, the selection of food component(s) comprising one or more food and/or beverage compositions (e.g., formulated ingestibles) establish a means of controlled release of food component(s).

In some embodiments, the provided food composition(s) are comprised of one food component. In some embodiments, the provided food composition(s) are comprised of several food components. In some embodiments, the arrangement of a single food component is used as a means of controlling the release of one or more food component(s). In some embodiments, the arrangement of several food components is used as a means of controlling the release of one or more food component(s).

In some embodiments, the provided food composition(s) are comprised of one or more food component(s), as described herein, characterized by their nutritional benefits. In certain embodiments, one or more food component(s) characterized as material(s) providing a nutritional benefit upon consumption (e.g., an advantage conferred upon consumption) are additionally characterized as providing a means for the controlled release of one or more food component(s).

### (i) Food Component(s) Providing a Nutritional Benefit

In certain embodiments, one or more food composition(s) are comprised of one or more food component(s). In certain embodiments, one or more food component(s) are characterized as material(s) providing a nutritional benefit upon consumption (e.g., an advantage conferred upon consumption) by one or more animals. In certain embodiments, a nutritional benefit is maintaining the health of one or more animals. In certain embodiments, a nutritional benefit is maintaining the microbiome health of one or more animals. In certain embodiments, a nutritional benefit is the provision of energy (e.g., caloric content). In certain embodiments, a nutritional benefit is the provision of metabolic intermediates (e.g., metabolic support). In certain embodiments, a nutritional benefit is the provision of osmotic stabilizers (e.g., osmotic balance). In certain embodiments, one or more food composition(s) comprised of one or more food component(s) provide one, two, several, or all, of the following subset of nutritional benefits: maintenance of health, maintenance of microbiome health, provision of energy, provision of metabolic intermediates, and/or provision of osmotic stability.

In certain embodiments, one or more food composition(s) are comprised of one or more food component(s). In certain embodiments, one or more food component(s) are characterized as material(s) providing a nutritional benefit upon consumption (e.g., an advantage conferred upon consumption) by one or more animals. In certain embodiments, a nutritional benefit is controlling satiety. In certain embodiments, a nutritional benefit is controlling fullness. In certain embodiments, a nutritional benefit is controlling feeling of fullness. In certain embodiments, a nutritional benefit is controlling concentration of nutrients in the stomach and/or intestines. In certain embodiments, a nutritional benefit is controlling concentration of nutrients at the epithelial surface. In certain embodiments, a nutritional benefit is controlling concentration of nutrients in the mucus. In certain embodiments, a nutritional benefit is controlling residence time of nutrients in the gastrointestinal tract. In certain embodiments, a nutritional benefit is controlling absorption time of nutrients in the stomach and/or intestine. In certain embodiments, a nutritional benefit is increasing energy acquisition, increased nutrient acquisition. In certain embodiments, a nutritional benefit is increasing bioavailability. In certain embodiments, a nutritional benefit is reducing frequency of meal intake.

In certain aspects of the disclosed food composition(s), one or more food composition(s) are comprised of one or more food component(s) that provide for the maintenance of health of one or more animals. In certain embodiments, maintenance of health of one or more animals is supporting at least one of endogenous enzymatic or metabolic processes (e.g., metals, cofactors, vitamins), resisting oxidation (e.g., antioxidants), supporting bone and/or tooth health (e.g., minerals), supporting growth (e.g., amino acids, peptides, proteins), supporting digestive function (e.g., dietary fiber), supporting sensory tissue (e.g., carotenoids), supporting microbiome health (e.g., polyphenols, prebiotics), supporting circadian rhythm, supporting psychological well-being (e.g., lipids), and/or supporting energy requirements (e.g., caloric intake).

In certain aspects of the disclosed food composition(s), one or more food composition(s) are comprised of one or more food component(s) that provide for the microbiome health of one or more animals. In certain embodiments, microbiome health of one or more animals is supporting the growth, proliferation, and/or diversity of the endogenous gut microbiota of one or more animals. In certain embodiments, the microbiome health of one or more animals is supported by one or more food component(s) comprised of at least one of a probiotic, a probiotic food ingredient, a probiotic composition, a prebiotic, and/or essential microbial nutrients (e.g., simple sugar, amino acid, fatty acid).

In certain aspects of the disclosed food composition(s), one or more food composition(s) are comprised of one or more food component(s) that provide for the energy of one or more animals. In certain embodiments, the energy content as provided by one or more food component(s) is characterized by caloric content (e.g., measured by calorimetry). In certain embodiments, the caloric content of one or more food component(s) is a measure of the theoretical maximum carbon content available for oxidation (e.g., to metabolically harness via aerobic respiration). Those skilled in the art will recognize that the caloric content of one or more food component(s) is a surrogate measure for the energetic provision of one or more food component(s).

In certain aspects, the disclosed food composition(s) are comprised of one or more food component(s) that are characterized by total caloric content. In some embodiments, the total caloric content of one or more food component(s) comprising a food composition is at least about 500 kcal, at least about 750 kcal, at least about 1000 kcal, at least about 1500 kcal, at least about 2000 kcal, at least about 2500 kcal, at least about 3000 kcal, at least about 4000 kcal, at least about 5000 kcal.

In certain aspects of the disclosed food composition(s), one or more food composition(s) are comprised of one or more food component(s) that provide metabolic intermediates (e.g., ketone bodies) of one or more animals. Those skilled in the art will appreciate that metabolic intermediates (e.g., ketone bodies) offer an alternative energy source to traditional food sources (e.g., digestible carbohydrates, fats, and proteins). Without wishing to be bound by any particular theory, it is contemplated that consumption of food component(s) comprised of metabolic intermediates, thus avoiding exposure to traditional food sources (e.g., digestible carbohydrates, fats, and proteins), correspondingly provides energy while mitigating metabolic response to food consumption (e.g., insulin release, drowsiness, fat storage).

In certain aspects of the disclosed food composition(s), one or more food composition(s) are comprised of one or more food component(s) that provide for the osmotic balance of one or more animals. In certain embodiments, osmotic balance of one or more animals is maintaining the content of electrolytes in the fluids (e.g., interstitial fluid, luminal fluid, blood, urine, tears, and/or sweat) in one or more animals. In certain embodiments, the osmotic balance of one or more animals is supported by one or more food component(s) comprised of at least one of a dietary salt and/or monosaccharide.

In certain embodiments, the provided food composition(s) are comprised of one or more food component(s) that each individually exhibit one nutritional benefit upon consumption. In certain embodiments, the provided food composition(s) are comprised of one or more food component(s) that each individually exhibit one or more nutritional benefits upon consumption.

### (ii) Food Component(s) Providing for the Health of an Animal

In certain embodiments, one or more food component(s) comprising the provided food composition(s) provide for the health of one or more animal(s). Typically, as described herein, one or more food component(s) providing for the health of one or more animal(s) is or are characterized as being at least one of: a nutrient, a nutraceutical, a macronutrient, a micronutrient, a polyphenol, a metal, a cofactor, a vitamin, an antioxidant, a mineral, an amino acid, a peptide, a ketone, an electrolyte, a salt, a protein, a carbohydrate, a sugar, a polysaccharide, a fat, a lipid, a fatty acid, a prebiotic, a dietary fiber, a carotenoid, a circadian rhythm modulator, a supplement, a nootropic, and/or a source of energy.

In some embodiments, one or more food component(s) comprising the provided food composition(s) may comprise a formulated nutrient component (e.g., food ingredient, ingredient, formulated nutrient, encapsulated nutrient).

As provided herein, one or more food component(s) characterized as being a metal may be or comprises at least one metal. In some instances, food component(s) characterized as being a metal can be a combination of metals, each of which may or may not individually provide for the health of one or more animal(s).

For example, in some instances, one or more food component(s) characterized as being a metal may comprise calcium, chromium, cobalt, copper, iodine, iron, magnesium, manganese, molybdenum, potassium, selenium, sodium, and/or zinc.

As provided herein, one or more food component(s) characterized as being a cofactor may be or comprises at least one cofactor. In some instances, food component(s) characterized as being a cofactor can be a combination of cofactors, each of which may or may not individually provide for the health of one or more animal(s).

For example, in some instances, one or more food component(s) characterized as being a cofactor may comprise nicotinamide adenine dinucleotide, flavin adenine dinucleotide, adenosine triphosphate, S-adenosylmethionine, Coenzyme Q, glutathione, heme, lipoamide, molybdopterin, and/or tetrahydrobiopterin.

As provided herein, one or more food component(s) characterized as being a vitamin may be or comprises at least one vitamin. In some instances, food component(s) characterized as being a vitamin can be a combination of vitamins, each of which may or may not individually provide for the health of one or more animal(s).

For example, in some instances, one or more food component(s) characterized as being a vitamin may comprise trans-retinol, trans-β-carotene, thiamine, riboflavin, niacin, niacinamide, nicotinamide riboside, pantothenic acid, pyridoxine, pyridoxamine, pyridoxal, biotin, folic acid, cyanocobalamin, hydroxocobalamin, methylcobalamin, adenosylcobalamin, ascorbic acid, cholecalciferol, ergocalciferol, tocopherol, tocotrienol, phylloquinone, and/or menaquinone.

As provided herein, one or more food component(s) characterized as being an antioxidant may be or comprises at least one antioxidant. In some instances, food component(s) characterized as being an antioxidant can be a combination of antioxidants, each of which may or may not individually provide for the health of one or more animal(s).

For example, in some instances, one or more food component(s) characterized as being a polyphenol and/or an antioxidant may comprise tannic acid, ellagitannin, apigenin, luteolin, tangeritin, isorhamnetin, kaempferol, myricetin, quercetin, rutin, eriodictyol, genipin, hesperetin, naringenin, catechin, gallocatechin, epicatechin, epigallocatechin, theaflavin, daidzein, genistein, glycitein, resveratrol, pterostilbene, hydroxytyrosol, cyanidin, delphinidin, malvidin, pelargonidin, peonidin, petunidin, chicoric acid, chlorogenic acid, cinnamic acid, ellagic acid, gallic acid, sinapic acid, rosmarinic acid, salicylic acid, curcumin, piperine, silymarin, silybin, eugenol, and/or betanin.

As provided herein, one or more food component(s) characterized as being a mineral may be or comprises at least one mineral. In some instances, food component(s) characterized as being a mineral can be a combination of minerals, each of which may or may not individually provide for the health of one or more animal(s).

For example, in some instances, one or more food component(s) characterized as being a mineral may comprise iron oxide, calcium chloride, calcium carbonate, and/or calcium hydroxyapatite.

As provided herein, one or more food component(s) characterized as being an amino acid may be or comprises at least one amino acid. In some instances, food component(s) characterized as being an amino acid can be a combination of amino acids, each of which may or may not individually provide for the health of one or more animal(s).

For example, in some instances, one or more food component(s) characterized as being an amino acid may comprise alanine, arginine, asparagine, aspartic acid, cysteine, selenocysteine, glutamine, glutamic acid, glycine, histidine, isoleucine, leucine, lysine, methionine, phenylalanine, proline, serine, threonine, tryptophan, tyrosine, valine, norvaline, norleucine, pipecolic acid, ornithine, homocysteine, homoserine, isovaline, and/or sarcosine.

As provided herein, one or more food component(s) characterized as being a branched chain amino acid may be or comprises at least one branched chain amino acid. In some instances, food component(s) characterized as being a branched chain amino acid can be a combination of branched chain amino acids, each of which may or may not individually provide for the health of one or more animal(s).

For example, in some instances, one or more food component(s) characterized as being a branched chain amino acid may comprise isoleucine, leucine, and/or valine.

As provided herein, one or more food component(s) characterized as being a peptide may be or comprises at least one peptide. In some instances, food component(s) characterized as being a peptide can be a combination of peptides, each of which may or may not individually provide for the health of one or more animal(s).

For example, in some instances, one or more food component(s) characterized as being a peptide may comprise aspartame, GLP-1, GLP-2, collagen, sermorelin, tesamorelin, lenomorelin, anamorelin, ipamorelin, macimorelin, ghrelin, tabimorelin, alexamorelin, GHRP-1, GHRP-2, GHRP-3, GRP-4, GHRP-5, GRP-6, and/or hexarelin.

As provided herein, one or more food component(s) characterized as being a dietary fiber may be or comprises at least one dietary fiber. In some instances, food component(s) characterized as being a dietary fiber can be a combination of dietary fibers, each of which may or may not individually provide for the health of one or more animal(s).

For example, in some instances, one or more food component(s) characterized as being a dietary fiber may comprise cellulose, dextrins, amylose, amylopectin, pectin, inulin, lignin, chitin, xanthan gum, sodium alginate, potassium alginate, calcium alginate, ammonium alginate, propylene glycol alginate, sodium hyaluronate, potassium hyaluronate, calcium hyaluronate, agar, agarose, carrageenan, raffinose, cellulose acetate, methyl cellulose, ethyl cellulose, cellulose acetate propionate, cellulose acetate butyrate, cellulose acetate succinate, hydroxypropyl methylcellulose, hydroxypropyl cellulose, and/or sodium carboxymethylcellulose.

As provided herein, one or more food component(s) characterized as being at least one macronutrient. In some instances, a macronutrient is or comprises at least one carbohydrate, at least one fat, at least one protein, or a combination thereof.

As provided herein, one or more food component(s) characterized as being at least one fatty acid. In some instances, a fatty acid is or comprises at least one of medium-chain triglyceride, docosahexaenoic acid, eicosapentaenoic acid, or combinations thereof.

As provided herein, one or more food component(s) characterized as being at least one short chain fatty acid. In some instances, a short chain fatty acid is or comprises acetate, propionate, and butyrate, or a combination thereof.

As provided herein, one or more food component(s) characterized as being a carotenoid may be or comprises at least one carotenoid. In some instances, food component(s) characterized as being a carotenoid can be a combination of carotenoids, each of which may or may not individually provide for the health of one or more animal(s).

For example, in some instances, one or more food component(s) characterized as being a carotenoid may comprise alpha-lipoic acid, lycopene, β-carotene, lutein, zeaxanthin, adonixxanthin, adonirubin, meso-zeaxanthin, astaxanthin, capsanthin, citroxanthin, echinenone, astacein, bixin, crocetin, and/or peridin.

As provided herein, one or more food component(s) characterized as being a circadian rhythm modulator may be or comprises at least one circadian rhythm modulator. In some instances, food component(s) characterized as being a circadian rhythm modulator can be a combination of circadian rhythm modulators, each of which may or may not individually provide for the health of one or more animal(s).

For example, in some instances, one or more food component(s) characterized as being a circadian rhythm modulator may comprise melatonin, methylcobalamin, adrafinil, cathine, cathinone, dextroamphetamine, ephedrine, epinephrine, armodafinil, modafinil, phenylethylamine, synephrine, theanine, 5-hydroxytryptophan, caffeine, theobromine, and/or taurine.

(iii) Food Component(s) Providing Energy

In certain embodiments, one or more food component(s) comprising the provided food composition(s) provide energy. Typically, as described herein, one or more food component(s) providing energy is or are characterized as being at least one of: a carbohydrate, a protein, a fat, and/or a ketone body.

As provided herein, one or more food component(s) characterized as being a carbohydrate may be or comprises at least one carbohydrate. In some instances, food component(s) characterized as being a carbohydrate can be a combination of carbohydrates, each of which may or may not individually provide energy.

For example, in some instances, one or more food component(s) characterized as being a carbohydrate may comprise glucose, fructose, mannitol, allulose, sorbitol, xylitol, erythritol, lactitol, galactose, sucrose, maltodextrin, isomaltulose, glycogen, chitosan, guar gum, pullulan, cellulose, dextrins, amylose, amylopectin, pectin, inulin, lignin, chitin, xanthan gum, sodium alginate, potassium alginate, calcium alginate, ammonium alginate, propylene glycol alginate, sodium hyaluronate, potassium hyaluronate, calcium hyaluronate, agar, agarose, carrageenan, raffinose, cellulose acetate, methyl cellulose, ethyl cellulose, cellulose acetate propionate, cellulose acetate butyrate, cellulose acetate succinate, hydroxypropyl methylcellulose, hydroxypropyl cellulose, and/or sodium carboxymethylcellulose.

As provided herein, one or more food component(s) characterized as being a protein may be or comprises at least one protein. In some instances, food component(s) characterized as being a protein can be a combination of proteins, each of which may or may not individually provide energy.

For example, in some instances, one or more food component(s) characterized as being a protein may comprise pea protein isolate, whey protein isolate, oat protein isolate, soy protein isolate, wheat protein isolate, egg protein isolate, casein, bovine serum albumin, ovalbumin, α-lactalbumin, β-lactoglobulin, collagen, glutanin, gliadin, kefirin, avenin, zein, silk, gelatin, hordein, and/or legumin.

As provided herein, one or more food component(s) characterized as being a fat may be or comprises at least one fat. In some instances, food component(s) characterized as being a fat can be a combination of fats, each of which may or may not individually provide energy.

For example, in some instances, one or more food component(s) characterized as being a fat may comprise paraffin wax, montan wax, microcrystalline wax, polyethylene wax, petrolatum wax, ozokerite wax, ceresin wax, beeswax, lanolin wax, spermaceti wax, tallow wax, lac wax, chinese insect wax, ambergris wax, soy wax, carnauba wax, candelilla wax, coconut wax, palm kernel wax, rice bran wax, butyric acid, n-butanol, pentanoic acid, n-pentanol, hexanoic acid, n-hexanol, heptanoic acid, n-heptanol, caprylic acid, n-octanol, nonanoic acid, n-nonanol, capric acid, n-decanol, lauric acid, n-dodecanol, myristic acid, n-tetradecanol, palmitic acid, n-hexadecanol, stearic acid, n-octadecanol, arachidonic acid, n-icosanol, fatty alcohol monoglyceride ethers, fatty acid monoglyceride esters, fatty alcohol diglyceride ethers, fatty acid diglyceride esters, fatty alcohol triglyceride ethers, fatty acid triglyceride esters, fatty alcohol glycol monoether, fatty acid glycol monoesters, fatty alcohol glycol diethers, fatty acid glycol diesters, fatty alcohol poly(glycerol) ethers, fatty acid poly(glycerol) esters, fatty alcohol poly(glycol) ethers, fatty acid poly(glycol) esters, coconut oil, corn oil, cottonseed oil, olive oil, palm oil, peanut oil, rapeseed oil, safflower oil, sesame oil, soybean oil, sunflower oil, almond oil, pine nut oil, cashew oil, fully hydrogenated palm oil, partially hydrogenated palm oil, fully hydrogenated sunflower oil, partially hydrogenated sunflower oil, fully hydrogenated soybean oil, partially hydrogenated soybean oil, fully hydrogenated vegetable oil, partially hydrogenated vegetable oil, fully hydrogenated cottonseed oil, partially hydrogenated cottonseed oil, cholesterol, cholenic acid, ursolic acid, or betulinic acid.

As provided herein, one or more food component(s) characterized as being a polyunsaturated fatty acid may be or comprises at least one polyunsaturated fatty acid. In some instances, food component(s) characterized as being a polyunsaturated fatty acid can be a combination of polyunsaturated fatty acids, each of which may or may not individually provide energy.

For example, in some instances, one or more food component(s) characterized as being a polyunsaturated fatty acid may comprise at least one of medium-chain triglyceride, docosahexaenoic acid, eicosapentaenoic acid, arachidonic acid, linoleic acid, linolenic acid, oleic acid, parinaric acid, rumenic acid, or combinations thereof.

As provided herein, one or more food component(s) characterized as being a ketone body may be or comprises at least one ketone body. In some instances, food component(s) characterized as being a ketone body can be a combination of ketone bodies, each of which may or may not individually provide energy.

For example, in some instances, one or more food component(s) characterized as being a ketone body may comprise acetoacetate, R-β-hydroxybutyl R-β-hydroxybutyrate, β-hydroxybutyrate, R-3-hydroxybutyl R-3-hydroxybutyrate monoester, and/or 1,3-butanediol.

### (iv) Food Component (v) Providing for Microbiome Health

In certain embodiments, one or more food component(s) comprising the provided food composition(s) provide for microbiome health. Typically, as described herein, one or more food component(s) providing for microbiome health is or are characterized as being at least one of: a probiotic, a probiotic food ingredient, a probiotic composition, a prebiotic, a polyphenol, and/or essential microbial nutrients (e.g., simple sugar, amino acid, fatty acid, iron).

As provided herein, one or more food component(s) characterized as being a probiotic, a probiotic food ingredient, and/or a probiotic composition may be or comprises at least one probiotic, a probiotic food ingredient, and/or a probiotic composition. In some instances, food component(s) characterized as being a probiotic, a probiotic food ingredient, and/or a probiotic composition can be a combination of probiotic, a probiotic food ingredient, and/or a probiotic composition (e.g., probiotic compositions), each of which may or may not individually provide for microbiome health.

For example, in some instances, one or more food component(s) characterized as being a probiotic, a probiotic food ingredient, and/or a probiotic composition may be essentially comprised of Bacillus coagulans, Bacillus licheniformis, Bacillus subtilis, Bifidobacterium angulatum, Bifidobacterium animalis, Bifidobacterium bifidum, Bifidobacterium breve, Bifidobacterium infantis, Bifidobacterium Bifidobacterium longum, Enterococcus faecium, Enterococcus faecalis, Lactobacillus acidophilus, Lactobacillus amylovorus, Lactobacillus alimentarius, Lactobacillus bulgaricus, Lactobacillus casei subsp. casei, Lactobacillus casei Shirota, Lactobacillus curvatus, Lactobacillus delbrueckii subsp lactis, Lactobacillus fermentum, Lactobacillus farciminis, Lactobacillus gasseri, Lactobacillus helveticus, Lactobacillus johnsonii, Lactobacillus lacti, Lactobacillus paracasei, Lactobacillus pentosaceus, Lactobacillus plantarum, Lactobacillus reuteri, Lactobacillus rhamnosus (Lactobacillus GG), Lactobacillus sake, Lactobacillus salivarius, Lactococcus lactis, Micrococcus varians, Pediococcus acidilactici Pediococcus pentosaceus, Pediococcus acidilactici, Pediococcus halophilus, Streptococcus faecalis, Streptococcus thermophilus, Staphylococcus carnosus, or Staphylococcus xylosus Lactobacillus acidophilus, Lactobacillus bulgaricus, Lactobacillus rhamnosus, Lactobacillus reuteri, Streptococcus thermophilus, Bifidobacterium animalis, Bifidobacterium bifidum, Bifidobacterium lactis, Bacillus subtilis, and/or a combination thereof.

As provided herein, one or more food component(s) characterized as being a prebiotic may be or comprises at least one prebiotic. In some instances, food component(s) characterized as being a prebiotic can be a combination of prebiotics, each of which may or may not individually provide for microbiome health.

For example, in some instances, one or more food component(s) characterized as being a prebiotic may comprise galactooligosaccharides, inulin, fructan, β-glucan, xylan, and/or pectin.

As provided herein, one or more food component(s) characterized as being a postbiotic may be or comprises at least one postbiotic. In some instances, food component(s) characterized as being a postbiotic can be a combination of postbiotic, each of which may or may not individually provide for microbiome health.

For example, in some instances, one or more food component(s) characterized as being a postbiotic may comprise lactic acid, butyrate, propionate, and/or acetate.

### (v) Food Component(s) Providing Osmotic Balance

In certain embodiments, one or more food component(s) comprising the provided food composition(s) provide osmotic balance. Typically, as described herein, one or more food component(s) providing osmotic balance is or are characterized as being at least one of a salt and/or monosaccharide.

As provided herein, one or more food component(s) characterized as being a salt may be or comprises at least one salt. In some instances, food component(s) characterized as being a salt can be a combination of salts, each of which may or may not individually provide osmotic balance.

For example, in some instances, one or more food component(s) characterized as being a salt may comprise sodium chloride, potassium chloride, sodium fluoride, potassium fluoride, sodium iodide, potassium iodide, calcium chloride, and/or calcium carbonate.

### (vi) Excipient Components

In certain embodiments, one or more component(s) comprising one or more food composition(s) may be further characterized as an excipient component.

In some embodiments, an excipient component utilized in accordance with the present disclosure is or comprises components that are not one or more food component(s) as described herein.

In some embodiments, an excipient component is or comprises at least one anti-caking (e.g., anti-agglomerating, anti-clumping, anti-aggregating) component, surfactant component, plasticizing component, acid scavenger (e.g., buffering agent), moisture scavenger, water scavenger, oxygen scavenger, a desiccant, a polymer, a preservative, a colorant, a flavoring, an antioxidant, a humectant, a solvent, or a combination thereof. In some embodiments, an excipient component imparts a benefit (e.g., reduced caking, increased stability, increased solubility, improved physical properties, improved taste, improved longevity, increased biocompatibility) on one or more food composition(s). In some embodiments, an excipient component imparts a change to the environment within the food composition (e.g., pH change, color change, oxygen concentration change, water concentration change). In some embodiments, an excipient component imparts a change (e.g., pH change, oxygen concentration change, flavor change, water concentration change) to the local environment (e.g., stomach, food matrix, beverage) where the food composition resides at a point in time. In some embodiments, an excipient component increases and/or decreases the solubility of one or more food component(s) in one or more food composition(s) upon mixing in one or more dissolution solvent(s).

Excipient components exhibiting one or more of anti-caking (e.g., anti-agglomerating, anti-clumping, anti-aggregating), surfactant, plasticizing, acid scavenger (e.g., buffering agent), moisture scavenger, water scavenger, desiccant, polymer, preservative, colorant, flavoring, antioxidant, humectant, and/or solvent properties may be comprised of substance(s) identified by one or more governing bodies as safe (e.g., generally regarded as safe and/or food additives). In some instances, those skilled in the art will appreciate that excipient component(s) are or may be selected from those excipient(s) recognized as Generally Regarded as Safe (i.e., GRAS) by the U.S. Food and Drug Administration. In some instances, those skilled in the art will appreciate that excipient component(s) are or may be selected from those excipient(s) recognized in 21 C.F.R. 184. In some instances, those skilled in the art will appreciate that excipient component(s) are or may be selected from those excipient(s) recognized in GB2760-2014 by the National Health and Family Planning Commission of the People's Republic of China.

In some cases, an excipient component is or comprises a single excipient species. In some instances, an excipient component can comprise multiple excipients and combinations thereof.

In some embodiments, excipients are added to one or more food composition(s) during a manufacturing process. In some embodiments, one or more shell component(s), core component(s), matrix component(s), and/or solute component(s) further comprise an excipient component. In certain embodiments, excipients are added to one or more food composition(s) prior to consumption.

In some cases, an excipient component is at least about 10 wt %, at least about 5 wt %, at least about 1 wt %, at least about 0.8 wt %, at least about 0.5 wt %, and/or at least about 0.1 wt % of one or more food composition(s).

In some cases, an excipient component can lower water activity of food and/or beverage compositions (e.g., formulated ingestibles).

In some cases, an excipient component can lower moisture content of food and/or beverage compositions (e.g., formulated ingestibles).

In some cases, an excipient component can lower residual solvent content of food and/or beverage compositions (e.g., formulated ingestibles).

In some cases, an excipient component can reduce the friability of food and/or beverage compositions (e.g., formulated ingestibles).

In some cases, an excipient component can improve the flowability of food and/or beverage compositions (e.g., formulated ingestibles).

In some cases, an excipient component can reduce clumping upon storage of food and/or beverage compositions (e.g., formulated ingestibles).

In some cases, an excipient component can improve the solubility of one or more food component(s) comprising one or more food composition(s).

In some cases, an excipient component can improve the mixing of one or more food component(s) with one or more dissolution solvent(s).

In some cases, an excipient component can improve the mixing of one or more food component(s) with one or more food products(s).

In some cases, an excipient component can improve the mixing of one or more food component(s) with one or more beverage products(s).

In some cases, an excipient component can improve the mixing of one or more food component(s) with one or more supplement products(s).

In some cases, an excipient component can improve the mixing of one or more food component(s) with other food component(s).

In some cases, an excipient component can either raise or lower the elastic modulus of food and/or beverage compositions (e.g., formulated ingestibles). In some cases, this may enable or facilitate methods of formulating or manufacturing food and/or beverage compositions (e.g., formulated ingestibles).

In some cases, an excipient component can either raise or lower the crystallinity of food and/or beverage compositions (e.g., formulated ingestibles).

In some cases, an excipient component can either alter and/or maintain the pH of a food composition. In some embodiments, excipient components used as a means of maintaining pH are additionally used as a means of gas generation. Without wishing to be bound by any particular theory, generation of gas within one or more food composition(s) may reduce the density of a food composition and introduce buoyancy leading to increased residence time in one or more gastrointestinal compartments.

In some cases, an excipient component can either react with environmental molecular oxygen or introduce molecular oxygen towards one or more food composition(s).

In some cases, an excipient component is essential to triggered release, as described herein, for one or more food component(s) from one or more food and/or beverage compositions (e.g., formulated ingestibles).

In some cases, an excipient component can alter pH within the microenvironment (e.g., stomach, food matrix, beverage) where the food composition resides.

In some cases, an excipient component affects response of the food composition to heat.

In some cases, an excipient component affects response of the food composition to shear.

In some cases, an excipient component affects response of the food composition to elevated pressure.

In some cases, an excipient component prevents fouling (e.g., microbial growth) of one or more food and/or beverage compositions (e.g., formulated ingestibles) over a period of at least 4 weeks, at least 12 weeks, at least 6 months, at least 1 year, at least 2 years, at least 5 years, and/or at least 10 years.

In some cases, an excipient component improves the taste and/or fragrance of one or more food composition(s).

In some cases, an excipient component maintains the water activity of one or more food composition(s).

In some cases, an excipient component provides a visually pleasing appearance to one or more food composition(s).

In some cases, an excipient component can affect the stability of one or more food composition(s) towards light, heat, pressure, shear, enzymes, bacteria, and/or one or more dissolution solvent(s) as described herein.

### 2. Food Component(s) Providing a Means for Controlled Release of Food Component(s)

In certain embodiments, one or more food composition(s) are comprised of one or more food component(s). In certain embodiments, one or more food component(s) are characterized as material(s) providing a means of controlled release. In certain embodiments, release of one or more food component(s) from one or more food composition(s) is characterized by physical and/or chemical dissociation. In some cases, release of one or more food component(s) from one or more food composition(s) is characterized by the amount of one or more food component(s) released from one or more food composition(s) in the presence of one or more dissolution solvent(s) (e.g., dissolution). In some cases, release of one or more food component(s) from one or more food composition(s) is characterized by the rate of one or more food component(s) released from one or more food composition(s) in the presence of one or more dissolution solvent(s) (e.g., release rate). In some cases, the release of one or more food component(s) from one or more food composition(s) is characterized by a combination of amount of dissolution and/or release rate (e.g., release profile).

Those skilled in the art will appreciate that one or more food component(s) may be essentially characterized by solubility. Those skilled in the art will further appreciate that one or more food component(s) may be characterized as slightly soluble, partially soluble, and/or completely soluble in one or more dissolution solvent(s). Those skilled in the art will further appreciate that solubility of one or more food component(s) may be achieved by physical and/or chemical dispersal of one more food component(s) within one or more dissolution solvent(s). Those skilled in the art will further appreciate that the dispersal (e.g., dissolution) of one or more food component(s) in one or more dissolution solvent(s) relevant to a useful (e.g., to provide a health benefit) application of one or more technologies may be further characterized as release.

Without wishing to be bound by any particular theory, it is contemplated that the solubility characteristic(s) of one more food component(s) is or are important factor(s) determining their gastrointestinal absorption. Without wishing to be bound by any particular theory, it is contemplated that the solubility characteristic(s) of one more food component(s) is or are important factor(s) determining their nutritional content. Without wishing to be bound by any particular theory, a means of controlling the solubility characteristic(s) of one or more food component(s) is of particular benefit (e.g., to improve the health or performance of an animal) through influence of the gastrointestinal absorption and/or nutritional content of one or more food component(s). Without wishing to be bound by any particular theory, a means of controlling the release of one or more food component(s) may be characterized as a means of controlling the solubilization of one or more food component(s) (e.g., release modifier).

In certain embodiments of the present disclosure, means of controlling the release of one or more food component(s) from one or more food composition(s) are provided. In certain embodiments, one or more food component(s) provides a means of controlling the release of one or more food component(s) from one or more food composition(s).

In some embodiments, a means of controlling the release of one or more food component(s) from one or more food composition(s) may be characterized by at least one of: (i) controlling access of one or more dissolution solvent(s) to one or more food component(s) (e.g., core-shell preparation) and/or (ii) diffusivity of one or more food component(s) (e.g., matrix preparation),

In certain embodiments, a means of controlling the release of one or more food component(s) from one or more food composition(s) characterized as core-shell and/or matrix preparations is further characterized as controlling the chemical properties and/or chemical structure of one or more food component(s), modulators of gastrointestinal residence time, and/or trigger-responsive materials.

In certain embodiments of the present disclosure, one or more means of controlling release of one or more food component(s) from one or more food composition(s), as provided herein, provide a benefit (e.g., for the improvement of health, performance, satiety, taste, and/or energy) of one or more animals.

### (i) Core-Shell Preparations

Among other things, the present disclosure provides core-shell preparations (e.g., food and/or beverage compositions (e.g., formulated ingestibles)) as a means of controlling the release of one or more food component(s) from one or more food composition(s). For example, in some embodiments, one or more food composition(s) are or comprise core-shell preparations. For example, core-shell preparations may comprise a core component (e.g., interior component) and/or a shell component (e.g., coating, exterior component), each of which are essentially comprised of one or more food component(s), as described herein. In some embodiments, a core component is comprised of one or more food component(s) and/or one or more excipient component(s). In some embodiments, a shell component is comprised of one or more food component(s) and/or one or more excipient component(s).

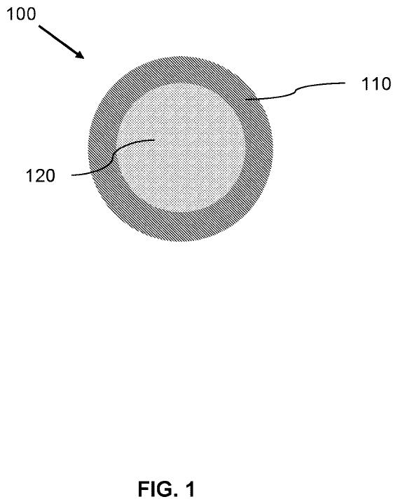

As depicted in a non-limiting schematic in FIG. 1, in some embodiments, an exemplary core-shell preparation may comprise a formulation comprising at least one food component and/or one excipient component arranged as a core component and at least one food component and/or one excipient component arranged as a shell component. In some embodiments, the at least one food component and/or one excipient component comprising a core component are additionally the at least one food component and/or one excipient component comprising a shell component. In some embodiments, the at least one food component and/or one excipient component comprising a core component are different from the at least one food component and/or one excipient comprising a shell component.

As depicted in a non-limiting schematic in FIG. 1, in some embodiments, an exemplary core-shell preparation 100 may comprise a core component 120 comprising at least one food component and/or at least one excipient component. In some embodiments, an exemplary core-shell preparation 100 may comprise a shell component 110 comprising at least one food component and/or at least one excipient component.

In some embodiments, the at least one food component and/or at least one excipient component comprising exemplary core component 120 is different from the at least one food component and/or at least one excipient component comprising exemplary shell component 110. In some embodiments, the at least one food component and/or at least one excipient component comprising exemplary core component 120 is the same as the at least one food component and/or at least one excipient component comprising exemplary shell component 110.

In some embodiments, the exemplary core component 120 is comprised of a single food component and/or excipient component. In some embodiments, the exemplary core component 120 is comprised of several food components and/or excipient components. In some embodiments, the exemplary shell component 110 is comprised of a single food component and/or excipient component. In some embodiments, the exemplary shell component 110 is comprised of several food components and/or excipient components.

In some embodiments, at least one food component and/or excipient component 120 may be described as being dispersed within (e.g., embedded within) at least one shell component 110.

In some embodiments, at least one shell component 110 may be described as encapsulating at least one core component 120, comprising at least one food component and/or excipient component.

In some embodiments, one or more core component(s) and/or a shell component(s) may be further characterized as a matrix preparation. In some embodiments one or more core component(s) and/or shell component(s) comprise a matrix preparation.

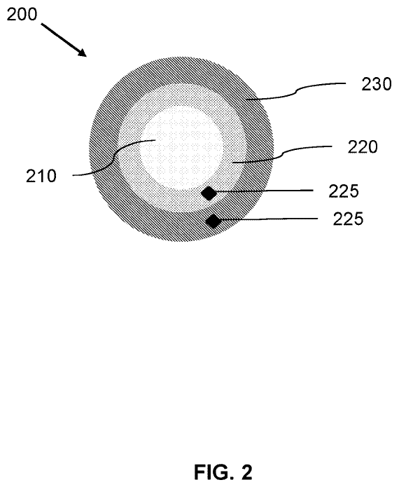

As depicted in a non-limiting schematic in FIG. 2, in some embodiments, an exemplary core-shell preparation may comprise a formulation comprising multiple layers of at least one food component and/or one excipient component arranged as a core component and at least one food component and/or one excipient component arranged as at least one shell component.

As depicted in a non-limiting schematic in FIG. 2, in some embodiments, an exemplary core-shell preparation 200 may comprise a core component 210 comprising at least one food component and/or excipient component, at least one shell component 220 comprising at least one food component and/or excipient component 225 and/or a second shell component 230 comprising at least one food component and/or excipient component 225.

In some embodiments, at least one core-shell composition 220, 210 may be described as being dispersed within (e.g., embedded within) at least one shell component 230.

In some embodiments, at least one shell component 230 may be described as encapsulating at least one core-shell preparation and/or matrix preparation 210 and 220.

In some embodiments, at least one payload or core component 210, at least one excipient or food component 225, at least one shell component (for example, an inner shell component) 220, or a combination thereof may be described as being dispersed within (e.g., encapsulated in) at least one carrier or shell component 230 (for example, an outer shell component 230).

In some embodiments, one or more core-shell preparation(s) are encapsulated in a range of 1-15, 1-10, 1-8, 1-6, 1-4, and/or 1-2 distinct shell component(s). In some embodiments, one or more core component(s) may be characterized as a core-shell preparation. In some embodiments, a core-shell preparation is further encapsulated in 1 shell component. In other embodiments, a core-shell preparation is encapsulated in 2 layered shell components.

In certain embodiments, a core-shell preparation is encapsulated in a range of 1-15, 1-10, 1-8, 1-6, 1-4, and/or 1-2 shell component(s) that are homogeneously blended. In certain embodiments, the core-shell preparations are encapsulated in a range of 1-15, 1-10, 1-8, 1-6, 1-4, and/or 1-2 shell components that are subsequently encapsulated in a range of 1-15, 1-10, 1-8, 1-6, 1-4, and/or 1-2 shell components.

In some embodiments, one or more food component(s) comprising a shell component and/or a core component is characterized as being a liquid. In some embodiments, one or more food component(s) comprising a shell component and/or a core component is characterized as being a solid.

In some embodiments, provided core-shell preparations may be characterized as a particle (e.g., particle preparation), an emulsion, a suspension, a powder, a bar, a gel, a capsule, a tablet, a fiber, an extrudate, a hard candy, a chip, and/or a mesh.

In certain aspects, one or more core-shell preparation(s) comprising one or more food composition(s) may be further characterized as an emulsion. In certain embodiments, one or more emulsion(s) present in one or more food composition(s) comprise one or more shell component(s), one or more core component(s), or both shell component(s) and core component(s) characterized by low solubility (e.g., miscibility) in water. Additionally, or alternatively, one or more emulsion(s) present in one or more food composition(s) comprise one or more shell component(s), one or more core component(s), or both shell component(s) and core component(s) of amphiphilic nature. In certain embodiments, one or more core-shell preparation(s) further characterized as an emulsion may be described as having one or more core component(s) of low solubility (e.g., miscibility) in water and one or more shell component(s) of amphiphilic nature. In certain embodiments, one or more core-shell preparation(s) further characterized as an emulsion may be described as having one or more core component(s) of high solubility (e.g., miscibility) in water and one or more shell component(s) of amphiphilic nature. In certain embodiments, one or more emulsion(s) are prepared prior to consumption by one or more animal(s). In certain embodiments, one or more emulsion(s) form spontaneously upon addition to one or more dissolution solvent(s). In certain embodiments, one or more emulsion(s) form spontaneously upon exposure to one or more triggers. For example, in certain embodiments, one or more emulsion(s) form spontaneously in response to cross-linkers, pH, bile salts, surfactants, reducing and/or oxidizing agents, osmotic pressure, proteases, amylases, lipases, bacteria, yeast, transglutaminases, thrombin, temperature, time, and/or mechanical forces.

In certain embodiments, core-shell preparations (e.g., food and/or beverage compositions) are characterized as a means of controlling the release of one or more food component(s). In certain embodiments, one or more shell component(s) controls the release profile of one or more core component(s). In certain embodiments, one or more core component(s) controls the release profile of one or more shell component(s). In certain embodiments, control of the release of one more core component(s) is achieved by one or more shell component(s) providing a physical barrier to a dissolution solvent, controlling the diffusivity of one or more core component(s), controlling the chemical properties of one or more core component(s), controlling residence time of one or more core component(s) in the dissolution medium, and/or responsiveness to one or more triggers, as described herein. In certain embodiments, control of the release of one more shell component(s) is achieved by one or more core component(s) controlling the diffusivity of one or more shell component(s), controlling the chemical properties of one or more shell component(s), controlling residence time of one or more shell component(s) in the dissolution medium, and/or responsiveness to one or more triggers, as described herein.

In certain embodiments, one or more shell component(s) provides a physical barrier between a dissolution solvent and one or more core component(s). For example, in some embodiments, one or more shell component(s) may be characterized as insoluble in aqueous media (e.g., water, phosphate buffered saline solution, simulated intestinal fluid, simulated gastric fluid, simulated tear fluid, simulated urine, HEPES buffered saline solution, Dulbecco's Modified Eagle Medium, Hank's balanced salt solution, biological intestinal fluid, biological gastric fluid, plasma, saliva, urine, feces, sweat, tear fluid, and/or Kreb's buffer). For example, in some embodiments, one or more shell component(s) may be characterized by slow and/or zero-order solubilization in aqueous media. Without wishing to be bound by any particular theory, it is contemplated that one or more shell component(s) characterized by insolubility, slow, and/or zero-order solubilization in aqueous media prevent access of such aqueous media to one or more core component(s), thus preventing dissolution (e.g., release) of one or more core component(s).

In certain embodiments, one or more shell component(s) controls the chemical properties of one or more core component(s). In certain embodiments, one or more core component(s) controls the chemical properties of one or more shell component(s). For example, in some embodiments, one or more shell component(s) may be ionically and/or covalently bonded (i.e., associated, complexed) to itself (e.g., a polymer and/or a crystal) and/or one or more core component(s). Additionally, or alternatively, one or more core component(s) may be ionically and/or covalently bonded (i.e., associated, complexed) to itself (e.g., a polymer and/or a crystal) and/or one or more shell component(s). Without wishing to be bound by any particular theory, it is contemplated that ionic and/or covalent bonding of one or more core component(s) with itself and/or one or more shell component(s) may reduce its solubility, increase hydrophobicity, and/or increase molecular weight of the core component, thereby reducing diffusivity and release. Without wishing to be bound by any particular theory, it is contemplated that ionic and/or covalent bonding of one or more shell component(s) with itself and/or one or more core component(s) may reduce its solubility, increase hydrophobicity, and/or increase molecular weight of the shell component, thereby reducing diffusivity and release. In some embodiments, one or more shell component(s) performs a chemical reaction on one or more core component(s) to change its molecular weight and/or introduce a new chemical functionality. In some embodiments, one or more core component(s) performs a chemical reaction on one or more shell component(s) to change its molecular weight and/or introduce a new chemical functionality. Without wishing to be bound by any particular theory, it is contemplated that one or more component(s) performing chemical reactions to reduce the molecular weight of a core component or a shell component may increase the release of one or more component(s) from a core-shell preparation.

In certain embodiments, one or more shell component(s) controls the chemical properties of one or more core component(s). In certain embodiments, one or more core component(s) controls the chemical properties of one or more shell component(s). For example, in some embodiments, one or more shell component(s) may be non-covalently bonded (e.g., hydrogen bonding, Van der Waals forces, electrostatic interactions, hydrophobic interactions, etc.) to itself (e.g., a polymer and/or a crystal) and/or one or more core component(s). Additionally, or alternatively, one or more core component(s) may be non-covalently bonded (i.e., associated, complexed) to itself (e.g., a polymer and/or a crystal) and/or one or more shell component(s). Without wishing to be bound by any particular theory, it is contemplated that non-covalent bonding of one or more core component(s) with itself and/or one or more shell component(s) may reduce its solubility, increase hydrophobicity, and/or increase molecular weight of the core component, thereby reducing diffusivity and release. Without wishing to be bound by any particular theory, it is contemplated that non-covalent bonding of one or more shell component(s) with itself and/or one or more core component(s) may reduce its solubility, increase hydrophobicity, and/or increase molecular weight of the shell component, thereby reducing diffusivity and release. In some embodiments, one or more shell component(s) performs a chemical reaction on one or more core component(s) to change its molecular weight and/or introduce a new chemical functionality. In some embodiments, one or more core component(s) performs a chemical reaction on one or more shell component(s) to change its molecular weight and/or introduce a new chemical functionality. Without wishing to be bound by any particular theory, it is contemplated that one or more component(s) performing chemical reactions to reduce the molecular weight of a core component or a shell component may increase the release of one or more component(s) from a core-shell preparation.

In certain embodiments, one or more shell component(s) controls the residence time of one or more core component(s) in a biological compartment. In certain embodiments, one or more core-shell preparation(s) (e.g., food and/or beverage compositions), as provided herein, are characterized by retention in a biological compartment. In certain embodiments, one or more core-shell preparation(s) (e.g., food and/or beverage compositions), as provided herein, are characterized by lack of retention in a biological compartment. In certain embodiments, one or more shell component(s) is or are characterized as being mucoadhesive (e.g., affinity and/or adhesion to one or more mucosal interfaces through interaction with the mucus, glycocalyx, extracellular matrix, cell membrane proteins, and/or cell membranes). In certain embodiments, one or more shell component(s) is or are characterized as being mucopenetrative (e.g., lack of interaction with the mucus, glycocalyx, extracellular matrix, cell membrane proteins, and/or cell membranes).

In some embodiments, mucoadhesive component(s) are further characterized as pH-responsive carbohydrates, as described herein. In certain embodiments, pH-responsive carbohydrates are carbohydrate materials that are characterized by their water solubility at a predetermined pH. In some embodiments, pH-responsive carbohydrates are characterized by their water solubility at low pH (e.g., pH<about 5, pH<about 4, pH<about 3, pH<about 2, pH<about 1). In some embodiments, pH-responsive carbohydrates exhibit low water solubility at low pH and higher water solubility at moderate (e.g., pH of about 5.5, about 6, about 6.5, about 7, about 7.5, about 8) to high (e.g., pH >8, pH >9, pH >10, pH >11, pH >12) pH. In other embodiments, pH-responsive carbohydrates exhibit higher water solubility at low pH and lower water solubility at moderate to high pH.

For example, in some embodiments, pH-responsive carbohydrate component(s) may comprise sodium alginate, potassium alginate, calcium alginate, magnesium alginate, zinc alginate, sodium pectinate, potassium pectinate, calcium pectinate, zinc pectinate, sodium hyaluronate, potassium hyaluronate, calcium hyaluronate, magnesium hyaluronate, zinc hyaluronate, cellulose acetate succinate, cellulose acetate butyrate, cellulose acetate phthalate, hydroxypropyl methylcellulose acetate succinate, heparin sodium, sodium carboxymethylcellulose, chitosan, and/or combinations thereof.

In some embodiments, mucoadhesive component(s) are considered mucoadhesive carbohydrates. In certain embodiments, mucoadhesive carbohydrates are carbohydrate materials that are characterized by their ability to interact with the mucosal interface (e.g., mucus, mucins, glycocalyx, proteoglycans, cell membrane, phospholipids). Without wishing to be bound by any particular theory, mucoadhesive carbohydrates may utilize a combination of hydrogen bonding, charge-charge interaction, and hydrophobic effect to prolong residence time of formulations (e.g., particle preparations) on a mucosal surface.

For example, in some embodiments, mucoadhesive carbohydrate component(s) may comprise sodium alginate, potassium alginate, calcium alginate, magnesium alginate, zinc alginate, sodium pectinate, potassium pectinate, calcium pectinate, zinc pectinate, sodium hyaluronate, potassium hyaluronate, calcium hyaluronate, magnesium hyaluronate, zinc hyaluronate, sodium carboxymethylcellulose, chitosan, and/or combinations thereof.

In some embodiments, mucoadhesive component(s) are considered mucoadhesive proteins. In certain embodiments, mucoadhesive proteins are protein materials that are characterized by their ability to interact with the mucosal interface (e.g., mucus, mucins, glycocalyx, proteoglycans, cell membrane, phospholipids). Without wishing to be bound by any particular theory, mucoadhesive proteins may utilize a combination of hydrogen bonding, charge-charge interaction, and hydrophobic effect to prolong residence time of formulations (e.g., particle preparations) on a mucosal surface.

For example, in some embodiments, mucoadhesive protein component(s) may comprise Lycopersicon esculentum agglutinin, wheat germ agglutinin, Urtica dioica agglutinin, and/or combinations thereof.

In some embodiments, mucoadhesive component(s) are considered catechols. In certain embodiments, mucoadhesive catechols are polyphenol (e.g., as described herein) that are characterized by their ability to interact with the mucosal interface (e.g., mucus, mucins, glycocalyx, proteoglycans, cell membrane, phospholipids). Without wishing to be bound by any particular theory, mucoadhesive catechols may utilize a combination of hydrogen bonding, 71-stacking, chemical cross-linking, and hydrophobic effect to prolong residence time of formulations (e.g., particle preparations) on a mucosal surface.

For example, in some embodiments, mucoadhesive catechols may comprise L-dopamine, poly(L-dopamine), hydroxytyrosol, catechol, caffeic acid, vanillin, veratraldehyde, eugenol, tannic acid, syringaldehyde, and/or protocatechuic aldehyde.

In some embodiments, mucoadhesive component(s) are further characterized as charged polymers (e.g., polymers exhibiting charge depending on pH of one or more dissolution solvent(s)). In some embodiments, a charged polymer may be an anionic mucoadhesive polymer component (e.g., polymers exhibiting a negative charge depending on pH of one or more dissolution solvent(s)). In some embodiments, a charged polymer may be cationic mucoadhesive polymer component (e.g., polymers exhibiting a positive charge depending on pH of one or more dissolution solvent(s)). Without wishing to be bound by any particular theory, it is contemplated that charged polymers facilitate interaction with the mucosal interface (e.g., mucus, mucins, glycocalyx, proteoglycans, cell membrane, phospholipids) thereby enabling greater retention time of one or more core-shell preparation(s).

For example, in some embodiments anionic mucoadhesive polymer component(s) may comprise poly(acrylic acid), poly(methacrylic acid), and/or poly(glycerol citrate)

For example, in some embodiments cationic mucoadhesive polymer component(s) may comprise poly(ethyleneimine), trimethylchitosan, and/or poly(L-arginine).

In some embodiments, mucopenetrative component(s) are characterized by lack of interaction with the mucus, glycocalyx, extracellular matrix, cell membrane proteins, and/or cell membranes. Without wishing to be bound by any particular theory, one or more shell component(s) comprising a mucopenetrative component is contemplated to increase the diffusion of one or more core-shell preparation(s) at a mucosal interface. For example, in some embodiments, mucopenetrative component(s) may comprise poly(ethylene glycol), poly(propylene glycol), poly(vinyl alcohol), and/or poly(ethylene oxide-co-propylene oxide).

In certain embodiments, one or more shell component(s) controls the release of one or more core component(s) by responding to a trigger. In certain embodiments, one or more core component(s) controls the release of one or more shell component(s) by responding to a trigger. In certain embodiments, a trigger is characterized as a chemical trigger, enzymatic trigger, and/or a physical trigger. For example, a chemical trigger may be further characterized as a cross-linker, pH, bile salts, reducing and/or oxidizing agents, and/or osmotic pressure. For example, an enzymatic trigger may be further characterized as exposure to proteases, amylases, lipases, bacteria, transglutaminases, and/or thrombin. For example, a physical trigger may be further characterized as temperature, time, and/or mechanical forces. Without wishing to be bound by any particular theory, it is contemplated that one or more trigger(s) may act to alter the physical and/or chemical properties of one or more core component(s) and/or one or more shell component(s). It is further contemplated that alteration of one or more physical properties (e.g., increasing porosity, reducing molecular weight) acts to increase the release rate of one or more food component(s). It is further contemplated that alteration of one or more chemical properties (e.g., increasing charge, increasing polarity) acts to increase the release rate of one or more food component(s).

### (ii) Matrix Preparations

Among other things, the present disclosure provides matrix preparations (e.g., food and/or beverage compositions (e.g., formulated ingestibles)) as a means of controlling the release of one or more food component(s) from one or more food composition(s). For example, in some embodiments, one or more food composition(s) are or comprise matrix preparations. For example, matrix preparations may comprise a solute component and/or a matrix component, each of which are essentially comprised of one or more food component(s), as described herein. In some embodiments, a solute component is comprised of one or more food component(s) and/or one or more excipient component(s). In some embodiments, a matrix component is comprised of one or more food component(s) and/or one or more excipient component(s).

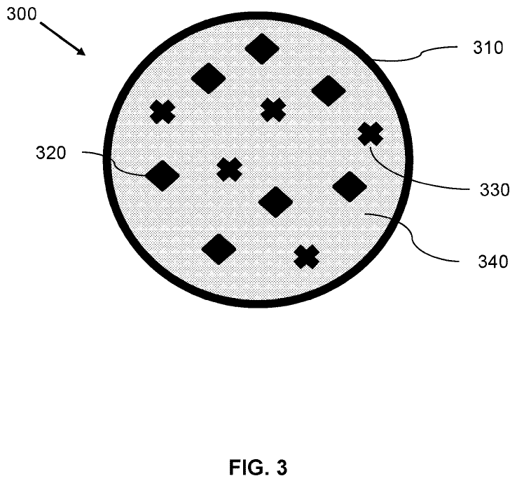

As depicted in a non-limiting schematic in FIG. 3, in some embodiments, an exemplary matrix preparation may comprise a formulation comprising at least one food component and/or one excipient component arranged as a solute component and at least one food component and/or one excipient component arranged as a matrix component. In some embodiments, the at least one food component and/or one excipient component comprising a solute component are additionally the at least one food component and/or one excipient component comprising a matrix component. In some embodiments, the at least one food component and/or one excipient component comprising a solute component are different from the at least one food component and/or one excipient comprising a matrix component. In some embodiments, one or more solute component(s) are distributed homogeneously within a matrix preparation (e.g., food composition). In some embodiments, one or more solute component(s) are distributed heterogeneously within a matrix preparation (e.g., food composition).

As depicted in a non-limiting schematic in FIG. 3, in some embodiments, an exemplary matrix preparation 300 may comprise one or more solute components 320 and/or 330 further comprising one or more food component(s) and/or excipient component(s). In some embodiments, an exemplary matrix preparation 300 may comprise one or more matrix components 340 further comprising one or more food component(s) and/or excipient component(s). In some embodiments, the matrix components 340 hold the food component and/or excipient components in place at a pre-defined spatial distribution. In some embodiments, the both the matrix component 340 and the solute 320 or excipient components 330 are comprised of food components. The matrix preparation, in some embodiments, may also include an outer shell 310.

In some embodiments, at least one food component 320 and/or an at least one excipient component 330 may be described as being dispersed within (e.g., embedded within) at least one matrix component 340.

In some embodiments, at least one matrix component 340 may be described as encapsulating (i) at least one food component 320, and/or at least one excipient component 330.

In some embodiments, at least one food component 320, at least one excipient component 330, at least one matrix component 340, or a combination thereof may be described as being dispersed within (e.g., encapsulated in) at least one matrix preparation 300 (for example, radially contained within an outer shell 310).

In some embodiments, at least one food component 320, at least one excipient component 330, at least one matrix component 340, or a combination thereof comprising one or more matrix preparations 300 may be described as being dispersed within (e.g., encapsulated or embedded within) a shell component 310, as a core-shell preparation.

In some embodiments, one or more solute component(s) and/or matrix component(s) may be further characterized as a core-shell preparation. In some embodiments, one or more solute component(s) and/or matrix component(s) comprise a core-shell preparation.

In some embodiments, one or more food component(s) comprising a matrix component and/or a solute component is characterized as being a liquid. In some embodiments, one or more food component(s) comprising a matrix component and/or a solute component is characterized as being a solid.

In some embodiments, provided matrix preparations may be characterized as a particle (e.g., particle preparation), a bar, a gel, a capsule, a tablet, a fiber, an extrudate, a hard candy, a chip, and/or a mesh.

In certain embodiments, matrix preparations (e.g., food and/or beverage compositions (e.g., formulated ingestibles)) are characterized as a means of controlling the release of one or more food component(s). In certain embodiments, one or more matrix component(s) controls the release profile of one or more solute component(s). In certain embodiments, one or more solute component(s) controls the release profile of one or more matrix component(s). In certain embodiments, control of the release of one more solute component(s) is achieved by one or more matrix component(s) providing a physical barrier to a dissolution solvent, controlling the diffusivity of one or more solute component(s), controlling the chemical properties of one or more solute component(s), controlling residence time of one or more solute component(s) in the dissolution medium, and/or responsiveness to one or more triggers, as described herein. In certain embodiments, control of the release of one more matrix component(s) is achieved by one or more solute component(s) controlling the chemical properties of one or more matrix component(s), and/or responsiveness to one or more triggers, as described herein.

In certain embodiments, one or more matrix component(s) controls the diffusivity of one or more solute component(s). In certain embodiments, one or more solute component(s) controls the diffusivity of one or more matrix component(s). For example, in some embodiments, one or more matrix component(s) and/or one or more solute component(s) may be characterized by at least one of porosity, chain length, and/or electric charge. Without wishing to be bound by any particular theory, it is contemplated that one or more matrix component(s) characterized by reduced porosity and/or increased chain length and/or complementary charge to one or more solute component(s) reduce free movement (e.g., diffusivity) of one or more solute component(s) by presenting a physical obstruction and/or an electric field, thus preventing dissolution (e.g., release) of one or more solute component(s). Without wishing to be bound by any particular theory, it is contemplated that one or more solute component(s) characterized by increased chain length and/or complementary charge to one or more matrix component(s) reduce free movement (e.g., diffusivity) of one or more matrix component(s) by presenting a physical obstruction and/or an electric field, thus preventing dissolution (e.g., release) of one or more matrix component(s).

In certain embodiments, one or more matrix component(s) controls the chemical properties of one or more solute component(s). In certain embodiments, one or more solute component(s) controls the chemical properties of one or more matrix component(s). For example, in some embodiments, one or more matrix component(s) may be ionically and/or covalently bonded (i.e., associated, complexed) to itself (e.g., a polymer) and/or one or more solute component(s). Additionally, or alternatively, one or more solute component(s) may be ionically and/or covalently bonded (i.e., associated, complexed) to itself (e.g., a polymer) and/or one or more matrix component(s). Without wishing to be bound by any particular theory, it is contemplated that ionic and/or covalent bonding of one or more solute component(s) with itself and/or one or more matrix component(s) may reduce its solubility, increase hydrophobicity, and/or increase molecular weight of the solute component, thereby reducing diffusivity and release. Without wishing to be bound by any particular theory, it is contemplated that ionic and/or covalent bonding of one or more matrix component(s) with itself and/or one or more solute component(s) may reduce its solubility, increase hydrophobicity, and/or increase molecular weight of the matrix component, thereby reducing diffusivity and release. In some embodiments, one or more matrix component(s) performs a chemical reaction on one or more solute component(s) to change its molecular weight and/or introduce a new chemical functionality. In some embodiments, one or more solute component(s) performs a chemical reaction on one or more matrix component(s) to change its molecular weight and/or introduce a new chemical functionality. Without wishing to be bound by any particular theory, it is contemplated that one or more component(s) performing chemical reactions to reduce the molecular weight of a solute component or a matrix component may increase the release of one or more component(s) from a matrix preparation.

In certain embodiments, one or more matrix component(s) controls the chemical properties of one or more solute component(s). In certain embodiments, one or more solute component(s) controls the chemical properties of one or more matrix component(s). For example, in some embodiments, one or more matrix component(s) may be non-covalently bonded (e.g., hydrogen bonding, Van der Waals forces, electrostatic interactions, hydrophobic interactions, etc.) to itself (e.g., a polymer) and/or one or more solute component(s). Additionally, or alternatively, one or more solute component(s) may be non-covalently bonded (e.g., hydrogen bonding, Van der Waals forces, electrostatic interactions, hydrophobic interactions, etc.) to itself (e.g., a polymer) and/or one or more matrix component(s). Without wishing to be bound by any particular theory, it is contemplated that non-covalent bonds (e.g., hydrogen bonding, Van der Waals forces, electrostatic interactions, hydrophobic interactions, etc.) of one or more solute component(s) with itself and/or one or more matrix component(s) may reduce its solubility, increase hydrophobicity, and/or increase molecular weight of the solute component, thereby reducing diffusivity and release. Without wishing to be bound by any particular theory, it is contemplated that non-covalent bonds (e.g., hydrogen bonding, Van der Waals forces, electrostatic interactions, hydrophobic interactions, etc.) of one or more matrix component(s) with itself and/or one or more solute component(s) may reduce its solubility, increase hydrophobicity, and/or increase molecular weight of the matrix component, thereby reducing diffusivity and release. In some embodiments, one or more matrix component(s) performs a chemical reaction on one or more solute component(s) to change its molecular weight and/or introduce a new chemical functionality. In some embodiments, one or more solute component(s) performs a chemical reaction on one or more matrix component(s) to change its molecular weight and/or introduce a new chemical functionality. Without wishing to be bound by any particular theory, it is contemplated that one or more component(s) performing chemical reactions to reduce the molecular weight of a solute component or a matrix component may increase the release of one or more component(s) from a matrix preparation.

In certain embodiments, one or more matrix component(s) controls the release of one or more solute component(s) by responding to a trigger. In certain embodiments, one or more solute component(s) controls the release of one or more matrix component(s) by responding to a trigger. In certain embodiments, a trigger is characterized as a chemical trigger, enzymatic trigger, and/or a physical trigger. For example, a chemical trigger may be further characterized as a cross-linker, pH, bile salts, reducing and/or oxidizing agents, and/or osmotic pressure. For example, an enzymatic trigger may be further characterized as exposure to proteases, amylases, lipases, bacteria, transglutaminases, and/or thrombin. For example, a physical trigger may be further characterized as temperature, time, and/or mechanical forces. Without wishing to be bound by any particular theory, it is contemplated that one or more trigger(s) may act to alter the physical and/or chemical properties of one or more solute component(s) and/or one or more matrix component(s). It is further contemplated that alteration of one or more physical properties (e.g., increasing porosity, reducing molecular weight) acts to increase the release rate of one or more food component(s). It is further contemplated that alteration of one or more chemical properties (e.g., increasing charge, increasing polarity) acts to increase the release rate of one or more food component(s).

(iii) Release Profiles

In certain embodiments, the release of one or more food component(s) is characterized by the amount (e.g., concentration) of one or more food component(s) solubilized in one or more dissolution solvent(s) over a predetermined period of time (e.g., incubation period). In certain embodiments, the present disclosure provides for a means of controlled release of one or more food component(s) (e.g., core-shell preparations and/or matrix preparations). In certain embodiments, controlled release of one or more food component(s) is control of the amount (e.g., concentration) of one or more food component(s) released over an incubation period (e.g., release rate). In many embodiments, the concentration and release rate comprise the release profile of one or more food component(s).

In certain embodiments, control of the release profile of one or more food component(s) provides a benefit (e.g., for the improvement of health, performance, satiety, taste, and/or energy) of one or more animal(s). For example, in certain embodiments, the release of one or more food component(s) may be held at a constant release rate for at least about 1, about 2, about 4, about 6, about 12, about 24, and/or about 48 hours. For example, in certain embodiments, the release of one or more food component(s) may occur in intervals (e.g., bolus dose) every about 30 minutes, about 1 hour, about 2 hours, about 4 hours, about 6 hours, about 8 hours, about 12 hours, and/or about 24 hours. For example, in certain embodiments, the release of one or more food component(s) may occur with a release rate that increases after at least about 1, about 2, about 4, about 6, about 12, about 24, and/or about 48 hours. For example, in certain embodiments, the release of one or more food component(s) may occur with a release rate that decreases after at least about 1, about 2, about 4, about 6, about 12, about 24, and/or about 48 hours.

### (iv) Dissolution Solvents

In certain embodiments, the release of one or more food component(s) from one or more food composition(s) is characterized by quantification of solubilization in one or more dissolution solvent(s), as provided herein.

In certain embodiments, one or more dissolution solvent(s) may be characterized by their miscibility with water. In certain embodiments, one or more dissolution solvent(s) may be characterized by their salinity. In certain embodiments, one or more dissolution solvent(s) may be characterized by their pH. In certain embodiments, one or more dissolution solvent(s) may be characterized as being a native biological fluid (i.e., a fluid characterized as essential to a living organism). In certain embodiments, one or more dissolution solvent(s) may be characterized as being a surrogate of a native biological fluid (i.e., a surrogate of a fluid characterized as essential to a living organism). In certain embodiments, one or more dissolution solvent(s) may be characterized by a combination of at least one of their miscibility with water, pH, and/or salinity, as being a native biological fluid, and/or resembling a native biological fluid.

In certain embodiments, one or more food composition(s) is added to an excess quantity, by weight, of one or more dissolution solvent(s) to characterize solubility. In certain embodiments, one or more food composition(s) is added to at least about 5 fold, at least about 10 fold, at least about 20 fold, at least about 50 fold, at least about 100 fold, at least about 200 fold, at least about 1000 fold, at least about 5000 fold, and/or at least about 10000 fold, by weight, excess of one or more dissolution solvent(s) to characterize solubility.

In certain embodiments, one or more food composition(s) is added to one or more dissolution solvent(s) at a controlled temperature to characterize solubility. In certain embodiments, one or more food composition(s) is added to one or more dissolution solvent(s) held at least at about −20 °C, at least at about 0 °C, at least at about 4 °C, at least at about 20 °C, at least at about 37 °C, and/or at least at about 50 °C to characterize solubility.

In certain embodiments, one or more food composition(s) is added to one or more dissolution solvent(s) for a predetermined period of time (e.g., incubation period) to characterize solubility. In certain embodiments, one or more food composition(s) is added to one or more dissolution solvent(s) for at least about 30 seconds, at least about 1 minute, at least about 5 minutes, and/or at least about 10 minutes to characterize solubility.

In certain embodiments, one or more food composition(s) is added to one or more dissolution solvent(s) for a predetermined period of time (e.g., incubation period) to characterize solubility. In certain embodiments, one or more food composition(s) is added to one or more dissolution solvent(s) for at least about 10 minutes, at least about 30 minutes, at least about 60 minutes, and/or at least about 120 minutes to characterize solubility.

In certain embodiments, one or more food composition(s) is added to one or more dissolution solvent(s) for a predetermined period of time (e.g., incubation period) to characterize solubility. In certain embodiments, one or more food composition(s) is added to one or more dissolution solvent(s) for at least about 120 minutes, at least about 6 hours, at least about 12 hours, and/or at least about 24 hours to characterize solubility.

In certain embodiments, one or more food composition(s) is added to one or more dissolution solvent(s) at a particular combination of weight ratio, temperature, and/or period of time, as described herein, to characterize solubility.

In certain embodiments, one or more dissolution solvent(s) is characterized as being miscible with water. In certain embodiments, one or more dissolution solvent(s) is characterized as being immiscible with water.

For example, one or more dissolution solvent(s) characterized as being miscible with water may be water, phosphate buffered saline solution, simulated intestinal fluid, simulated gastric fluid, simulated tear fluid, simulated urine, HEPES buffered saline solution, Dulbecco's Modified Eagle Medium, Hank's balanced salt solution, Cyrene, Glycofurol, furfural, Kreb's buffer, acetone, tetrahydrofuran, ethanol, methanol, dimethylformamide, and/or dimethyl sulfoxide.

For example, one or more dissolution solvent(s) characterized as being immiscible with water may be n-octanol, n-nonanol, n-decanol, n-dodecanol, n-tetradecanol, n-hexadecanol, n-octadecanol, n-icosanol, fatty alcohol monoglyceride ethers, fatty acid monoglyceride esters, fatty alcohol diglyceride ethers, fatty acid diglyceride esters, fatty alcohol triglyceride ethers, fatty acid triglyceride esters, fatty alcohol glycol monoether, fatty acid glycol monoesters, fatty alcohol glycol diethers, fatty acid glycol diesters, coconut oil, corn oil, cottonseed oil, olive oil, palm oil, peanut oil, rapeseed oil, safflower oil, sesame oil, soybean oil, sunflower oil, almond oil, pine nut oil, cashew oil, fully hydrogenated palm oil, partially hydrogenated palm oil, fully hydrogenated sunflower oil, partially hydrogenated sunflower oil, fully hydrogenated soybean oil, partially hydrogenated soybean oil, fully hydrogenated vegetable oil, partially hydrogenated vegetable oil, fully hydrogenated cottonseed oil, partially hydrogenated cottonseed oil, dichloromethane, hexanes, toluene, 2-methyltetrahydrofuran, and/or ethyl acetate.

In certain embodiments, one or more dissolution solvent(s) is characterized by salinity. For example, one or more dissolution solvent(s) characterized by salinity may be water, phosphate buffered saline solution, simulated intestinal fluid, simulated gastric fluid, simulated tear fluid, simulated urine, HEPES buffered saline solution, Dulbecco's Modified Eagle Medium, Hank's balanced salt solution, biological intestinal fluid, biological gastric fluid, plasma, saliva, urine, feces, sweat, tear fluid, and/or Kreb's buffer.

In certain embodiments, one or more dissolution solvent(s) is characterized by pH. For example, one or more dissolution solvent(s) characterized by pH may be water, phosphate buffered saline solution, simulated intestinal fluid, simulated gastric fluid, simulated tear fluid, simulated urine, HEPES buffered saline solution, Dulbecco's Modified Eagle Medium, Hank's balanced salt solution, biological intestinal fluid, biological gastric fluid, plasma, saliva, urine, feces, sweat, tear fluid, and/or Kreb's buffer.

In certain embodiments, one or more dissolution solvent(s) is characterized as being a native biological fluid. For example, one or more dissolution solvent(s) characterized as being a native biological fluid may be water, biological intestinal fluid, biological gastric fluid, plasma, saliva, urine, feces, sweat, oral fluid, cecum fluid, bile, and/or tear fluid.

In certain embodiments, one or more dissolution solvent(s) is characterized as being a surrogate of native biological fluid. For example, one or more dissolution solvent(s) characterized as being a surrogate of native biological fluid may be water, phosphate buffered saline solution, simulated intestinal fluid, simulated gastric fluid, simulated tear fluid, simulated urine, HEPES buffered saline solution, Dulbecco's Modified Eagle Medium, Hank's balanced salt solution, and/or Kreb's buffer.

### 3. Moisture Content

In some embodiments, provided food composition(s) is or are characterized by low moisture content. In some embodiments, the present disclosure provides technologies for preparing and/or characterizing food and/or beverage compositions (e.g., formulated ingestibles) comprising low moisture content.

In some embodiments, the present disclosure provides one or more food composition(s) with low moisture content. Disclosed technologies provide benefits over existing products because high moisture content formulations may lead to rapid degradation of food component(s).

In some embodiments, the present disclosure provides one or more food composition(s) with low moisture content. In some instances, provided food and/or beverage compositions (e.g., formulated ingestibles) may have a moisture content of <8 wt %, <6 wt %, <4 wt %, <2 wt %, <1 wt %, or <0.5 wt %.

In some embodiments, provided food and/or beverage compositions (e.g., formulated ingestibles) are characterized by resistance or mitigation of water absorption or moisture absorption when exposed to high humidity or moisture content. In some embodiments, the present disclosure provides technologies for preventing uptake of water or moisture.

In some embodiments, the present disclosure provides one or more food composition(s) that resist or mitigate moisture absorption when exposed to high humidities or moisture. In some instances, provided food and/or beverage compositions (e.g., formulated ingestibles) resist absorption of less than about 0.25%, less than about 0.5%, less than about 1%, and/or less than about 5% (w/w) moisture content, as compared to initial moisture content, after incubation in relative humidities of about 33%, about 53%, and/or about 75%.

### 4. Water Activity

Without wishing to be bound by any particular theory, food component(s) may exhibit poor stability in environments with high water activity. In certain aspects of the present embodiments, a food composition of low water activity exhibits a water activity of <about 0.4, <about 0.3, <about 0.2, and/or <about 0.1.

In certain embodiments, the disclosed invention provides one or more food composition(s) of water activity <about 0.4, <about 0.3, <about 0.2, and/or <about 0.1. In certain embodiments, the disclosed invention provides one or more food composition(s) of low water activity. In some embodiments, the present disclosure provides technologies for preparing and/or characterizing food composition(s) comprising low water activity.

In some embodiments, the present disclosure provides one or more food composition(s) with low water activity. Disclosed technologies provide benefits over existing products because high water activity formulations lead to rapid degradation of food component(s).

### 5. Particle Preparations

Among other things, the present disclosure provides particle preparations (e.g., food and/or beverage compositions, e.g., nutrient particle preparations). For example, in some embodiments, food and/or beverage compositions (e.g., formulated ingestibles) are or comprise particles (e.g., particle preparations, e.g., nutrient particle preparations). For example, particles may comprise a payload component (e.g., macronutrients, micronutrients, nutrients, etc.) and/or a carrier component.

In some embodiments, one or more food composition(s) are or comprise particles (e.g., particle preparations). In some embodiments, the present disclosure provides particle preparations in which particles have a particular shape or form, for example, having a cross-section shape of a circle, an oval, a triangle, a square, a hexagon, or an irregular shape. In some embodiments, a preparation includes particles of different shapes or forms. In some embodiments, most or substantially all or all particles in a preparation have a common shape.

In some embodiments, particles in a provided particle preparation may have a distribution of diameters (e.g., Dv(10), Dv(20), Dv(30), Dv(40), Dv(50), Dv(60), Dv(70), Dv(80), Dv(90), Dv(99), etc.). In some embodiments, particles in a provided particle preparation may have an average diameter (e.g., D[3,2], D[4,3], etc.). Regardless of the shape of the particle, the “diameter” (i.e., size) of a particle is the longest distance from one end of the particle to another end of the particle.

In some instances, particles in a particle preparation as described and/or utilized herein may have a distribution of diameters (e.g., Dv(10), Dv(20), Dv(30), Dv(40), Dv(50), Dv(60), Dv(70), Dv(80), Dv(90), Dv(99), etc.) of up to about 10000 μm, up to about 5000 μm, up to about 2500 μm, up to about 1250 μm, up to about 800 μm, up to about 400 μm, up to about 200 μm, up to about 100 μm, up to about 50 μm, up to about 40 μm, up to about 30 μm, up to about 20 μm, up to about 10 μm, or up to about 5 μm.

### 6. Release of Food Component(s)

In certain embodiments of the present disclosure, a means for controlled release of one or more food component(s) from one or more food composition(s) is provided. In certain embodiments, the controlled release of one or more food components is characterized by at least one of release profile (e.g., as described herein), total amount (e.g., mass and/or weight) of one or more food component(s) released, total amount of one or more food component(s) released relative to initial loading (e.g., percent release), total amount of energy provided (e.g., calories released), total amount of nutrients provided, and/or location of release in a given incubation period in one or more dissolution solvent(s).

In certain embodiments, a total amount (e.g., mass and/or weight) of one or more food component(s), percent release, calories released, total amount of nutrients provided, and/or location of release is characterized by one or more release profiles (e.g., as described herein). In certain embodiments, the release of one or more food component(s) is characterized by release over a given time frame. In certain embodiments, release is characterized over a time period of at least about 10 seconds, at least about 30 seconds, at least about 1 minute, at least about 5 minutes, at least about 10 minutes, at least about 30 minutes, at least about 60 minutes, at least about 2 hours, at least about 4 hours, at least about 8 hours, at least about 16 hours, and/or at least about 24 hours. In certain embodiments, release is characterized over a time period relevant to time periods between one or more meals. For example, in certain embodiments, release is characterized over a time period of at least about 8 hours, at least about 16 hours, and/or at least about 24 hours. In certain embodiments, release profiles of one or more food component(s) may be characterized (e.g., as described herein) as held at a constant release rate, bolus dose in intervals, with increasing release rate, and/or decreasing release rate for at least about 30 minutes, about 1 hour, about 2 hours, about 4 hours, about 6 hours, about 8 hours, about 12 hours, about 24 hours, and/or about 48 hours. In some embodiments, one or more food component(s) comprising one or more food composition(s) exhibit the same release (e.g., release profile). In some embodiments, one or more food component(s) comprising one or more food composition(s) exhibit differing release (e.g., release profile).

In certain embodiments, controlled release of one or more food component(s) is characterized by the total amount (e.g., mass and/or weight) of food component(s) provided to one or more animal(s) in a given incubation period in one or more dissolution solvent(s). In certain embodiments, at least about 0 g, about 50 g, about 125 g, about 250 g, about 500 g, about 1000 g, about 1500 g, and/or about 2000 g of one or more food component(s) are released over an 8 hour period. In certain embodiments, at least about 125 g, about 250 g, about 500 g, about 750 g, about 1250 g, about 1750 g, and/or about 2250 g of one or more food component(s) are released over a 16 hour period. In certain embodiments, at least about 1000 g, about 1500 g, about 2000 g, about 2500 g, and/or about 3000 g of one or more food component(s) are released over a 24 hour period.

In certain embodiments, controlled release of one or more food component(s) is characterized by the percent release in a given incubation period in one or more dissolution solvent(s). In certain embodiments, at least about 0%, about 10%, about 25%, about 50%, about 75%, and/or about 100% of one or more food component(s) are released over an 8 hour period. In certain embodiments, at least about 0%, about 10%, about 25%, about 50%, about 75%, and/or about 100% of one or more food component(s) are released over a 16 hour period. In certain embodiments, at least about 0%, about 10%, about 25%, about 50%, about 75%, and/or about 100% of one or more food component(s) are released over a 24 hour period.

In certain embodiments, controlled release of one or more food component(s) is characterized by the total amount of calories released in a given incubation period in one or more dissolution solvent(s). In certain embodiments, at least about 0, at least about 250, at least about 500, about 1000, about 1500, about 2500, about 3500, and/or about 4500 kcal of one or more food component(s) are released over an 8 hour period. In certain embodiments, at least about 500, about 1000, about 1500, about 2500, about 3500, and/or about 4500 kcal of one or more food component(s) are released over a 16 hour period. In certain embodiments, at least about 1500, about 2500, about 3500, and/or about 4500 kcal of one or more food component(s) are released over a 24 hour period.

In certain embodiments, controlled release of one or more food component(s) is characterized by the total amount of macronutrients (e.g., carbohydrates, fats, and/or proteins) released in a given incubation period in one or more dissolution solvent(s). In certain preferred embodiments, the total amount (e.g., weight) of macronutrients released is selected in order to confer a benefit (e.g., for the improvement of health, performance, satiety, taste, and/or energy) to the consumer. In certain preferred embodiments, the relative amount (e.g. weight) of macronutrients released is selected in order to confer a benefit (e.g., for the improvement of health, performance, satiety, taste, and/or energy) to the consumer. In certain embodiments, at least about 0, at least about 25, at least about 50, about 100, about 200, about 300, about 400, and/or about 500 g of one or more carbohydrate(s) are released over an 8 hour period. In certain embodiments, at least about 50, about 100, about 200, about 300, about 400, and/or about 500 g of one or more carbohydrate(s) are released over a 16 hour period. In certain embodiments, at least about 200, about 300, about 400, and/or about 500 g of one or more carbohydrate(s) are released over a 24 hour period. In certain embodiments, at least about 0, at least about 12, at least about 25, about 50, about 100, about 200, about 300, and/or about 400 g of one or more fat(s) are released over an 8 hour period. In certain embodiments, at least about 25, about 50, about 100, about 200, about 300, and/or about 400 g of one or more fat(s) are released over a 16 hour period. In certain embodiments, at least about 100, about 200, about 300, and/or about 400 g of one or more fat(s) are released over a 24 hour period. In certain embodiments, at least about 0, at least about 100, at least about 200, about 300, about 400, about 500, about 600, and/or about 700 g of one or more protein(s) are released over an 8 hour period. In certain embodiments, at least about 200, about 300, about 400, about 500, about 600, and/or about 700 g of one or more protein(s) are released over a 16 hour period. In certain embodiments, at least about 400, about 500, about 600, and/or about 700 g of one or more protein(s) are released over a 24 hour period. In certain embodiments, the ratio of carbohydrates to fats, by dry weight, is between about 3 and about 12. In certain embodiments, the ratio of proteins to fats, by dry weight, is between about 0.5 and about 5. In certain embodiments, the ratio of carbohydrates to proteins, by dry weight, is between about 0.5 and about 10.

In certain embodiments, controlled release of one or more food component(s) is characterized by a targeted gastrointestinal location of release. In certain embodiments, one or more food component(s) is characterized by release in at least one of the buccal cavity, stomach, duodenum, jejunum, ileum, colon, and/or rectum. In certain embodiments, one or more food component(s) comprising one or more core component(s) and/or shell component(s) is characterized as controlling release in at least one of the buccal cavity, stomach, duodenum, jejunum, ileum, colon, and/or rectum. In certain embodiments, one or more food component(s) comprising one or more solute component(s) and/or matrix component(s) is characterized as controlling release in at least one of the buccal cavity, stomach, duodenum, jejunum, ileum, colon, and/or rectum. In certain aspects, the at least one food component controlling release in at least one of the buccal cavity, stomach, duodenum, jejunum, ileum, colon, and/or rectum is further characterized as triggered by pH. In certain embodiments, one or more food component(s) is characterized by release at a pH of at about 1-2, about 2-3, about 3-4, about 4-5, about 5-6, about 6-7, about 7-8, about 8-9, and/or about 9-10. In certain aspects, the at least one food component controlling release in at least one of the buccal cavity, stomach, duodenum, jejunum, ileum, colon, and/or rectum is further characterized as enzymatically triggered. In certain embodiments, one or more food component(s) is characterized by susceptibility to amylases, lipases, proteases, and/or bacteria. In certain aspects, the at least one food component controlling release in at least one of the buccal cavity, stomach, duodenum, jejunum, ileum, colon, and/or rectum is further characterized as triggered by physical forces. In certain embodiments, one or more food component(s) is characterized by release upon application of physical pressure and/or shear forces. In certain aspects, the at least one food component controlling release in at least one of the buccal cavity, stomach, duodenum, jejunum, ileum, colon, and/or rectum is further characterized as triggered by temperature. In certain embodiments, one or more food component(s) is characterized by release at a temperature of at least about 20 °C, about 25 °C, about 28 °C, about 30 °C, about 35 °C, about 37 °C, about 40 °C, about 45 °C, and/or about 50 °C. In certain aspects, the at least one food component controlling release in at least one of the buccal cavity, stomach, duodenum, jejunum, ileum, colon, and/or rectum is further characterized as triggered by time. In certain embodiments, one or more food component(s) is characterized by release after an incubation period of at least about 10 minutes, about 30 minutes, about 60 minutes, about 2 hours, about 4 hours, about 8 hours, about 12 hours, about 24 hours, and/or about 36 hours.

7. Incorporation of Food and/or Beverage Compositions into Food and/or Beverage Products

In certain embodiments, the current disclosure provides for the incorporation of one or more food and/or beverage composition(s) into food and/or beverage products.

In some cases, one or more food and/or beverage composition(s) are incorporated into food and/or beverage products in the food and/or beverage manufacturing process. In some cases, one or more food composition(s) are incorporated into food and/or beverage products in the food and/or beverage packaging process. In some cases, one or more food composition(s) are incorporated prior to pasteurization of a food and/or beverage product. In some cases, one or more food composition(s) are incorporated prior to mixing of a food and/or beverage product. In some cases, one or more food composition(s) are incorporated into finished food and/or beverage products. In some cases, one or more food composition(s) are incorporated into food and/or beverage products immediately prior to consumption.

In certain embodiments, incorporation of food and/or beverage composition(s) (e.g., core-shell and/or matrix preparations) into food and/or beverage products utilizes size reduction techniques and/or homogenization. In some cases, size reduction techniques are applied to food composition(s) prior to incorporation. Alternatively or additionally, size reduction techniques are applied to food and/or beverage products during incorporation of the food composition(s). Alternatively or additionally, size reduction techniques are applied to food and/or beverage products after incorporation of the food composition(s). The present disclosure provides for size reduction using, for example, planetary milling, ball milling, burr milling, roller milling, media milling, impact milling, jet milling, high-pressure homogenization, cryo milling, hammer milling, conical milling, hand screening, or granulation/extrusion, extrusion, spray drying, lyophilization/milling, fluid bed agglomeration, spray congealing, high-shear granulation, tableting, pouring, roller compaction, crosslinking, prilling, spinning disc atomization, and/or combinations thereof.

In certain embodiments, homogenization is applied to food and/or beverage composition(s) following incorporation into food and/or beverage products. The present disclosure provides for homogenization using, for example, overhead stirrer, manual stirring, stir bar, high pressure homogenization, low pressure homogenization, sonication, ultrasonication, vortexing, or combinations thereof.

In certain embodiments, incorporation of food and/or beverage composition(s) into food and/or beverage products significantly affects the visual appearance, texture, and/or taste of the food and/or beverage products. In other embodiments, incorporation of food composition(s) into food and/or beverage products minimally affects the visual appearance, texture, and/or taste of the food and/or beverage products.

In some embodiments, disclosed food and/or beverage composition(s) minimally affect visual appearance, texture, and/or taste when incorporated, as provided herein, into a protein beverage (e.g., Ensure). In some instances, disclosed food composition(s) minimally affect visual appearance, texture, and/or taste when incorporated, as provided herein, into dehydrated peanut butter. In some instances, disclosed food composition(s) minimally affect visual appearance, texture, and/or taste when incorporated, as provided herein, into a MRE (i.e., meal ready-to-eat).

Some aspects of the current disclosure provide methods of promoting health or longevity in an animal, comprising providing an effective amount of food and/or beverage compositions described herein in combination with a consumable composition (e.g., a food product, a beverage product, an animal-consumable product, etc.) to an animal. In some cases, consumable compositions comprise core-shell preparations and/or matrix preparations.

In some embodiments, an animal is a human, for example, an adult, an elder, a teenager, an adolescent, or an infant. In some cases, an animal is an agricultural animal, for example, a horse, a cow, a pig, a sheep, a goat, a domesticated bird (e.g., chicken, duck, goose), a non-domesticated (e.g., wild) bird, etc. In some cases, an animal is a pet animal, for example, a dog, a cat, a rabbit, and/or a fish.

Some aspects of the current disclosure provide consumable compositions (e.g., food products, beverage products, animal-consumable compositions) comprising disclosed food and/or beverage compositions. In some cases, consumable compositions comprising food and/or beverage compositions is or comprises a food product. In some cases, a food product is characterized by high water activity. In some cases, a food product is or comprises at least one of agricultural seed, baby formula, bread, candy, capsule, cake, cereal, chip, cookie, dry powder, fertilizer, food additive, ice cream, kefir, nutrition supplement, packaged food, pet feed, pet food, protein bar, protein powder, sachet, salad dressing, smoothie, spice, sprinkle packet, tablet, and/or yogurt. In some cases, consumable compositions comprising food compositions are provided to an animal in a mixture with a food or food ingredient.

Some aspects of the current disclosure provide non-consumable compositions that are applied for agricultural applications (e.g., agricultural seed, fertilizer). In some cases, non-consumable compositions comprising food compositions is or comprises an agricultural product for plant growth or plant nutrient delivery. In some cases, an agricultural product is characterized by high water activity. In some cases, non-consumable compositions comprising food compositions are provided to seeds or plants in a mixture with a seed or fertilizer or plant ingredient.

Some aspects of the current disclosure provide consumable compositions (e.g., food products, beverages, animal-consumable compositions) comprising disclosed food compositions. In some cases, consumable compositions comprising food compositions is or comprises a beverage product. In some cases, a beverage product is characterized by high water activity. In some cases, a beverage product is or comprises at least one of liquid supplement formulation, beer, seltzer, kefir, coffee, juice, liquid pharmaceutical formulation, milk, soda, sports drink (e.g., Gatorade, sports drinks, Vitamin beverage), tea, water, liquor (e.g., vodka, whiskey, rum, etc.) and/or wine. In some cases, the formulation is provided to an animal in a mixture with a beverage or beverage ingredient.

Some aspects of the current disclosure provide powder-based supplement, food, and/or beverage-mix products comprising food compositions disclosed herein. In some cases, the powder-based supplement, food, and/or beverage-mix products are characterized by high water activity. In some cases, the powder-based supplement, food, and/or beverage-mix products is a pre-workout powder, post-workout powder or pill, pre-workout capsule/pill, baby formula, whey powder, milk powder, protein powder, drink powder mix (e.g., Kool-Aid type mix), or a powder-based supplement, food, or beverage-mix products.

8. Stability of Nutrient Payload Component in Food and/or Beverage Products

Those skilled in the art will recognize that incorporation of one or more food component(s) into food and/or beverage products may be associated with significant reduction in its stability. As defined herein, the stability of one or more food component(s) may refer to a chemical stability, a physical stability, a stability of function, a stability of benefit, and/or combinations thereof. The present disclosure provides stability of one or more food component(s) via one or more food composition(s) upon standing, upon incorporation into one or more food and/or beverage products, and/or upon mixing with one or more dissolution solvent(s) at a predetermined temperature, a predetermined humidity, and/or a predetermined period of time (e.g., incubation period). In some instances, a food composition provides for stability of a food component in a liquid (e.g., water, simulated gastric fluid, simulated intestinal fluid), food and/or beverage product(s) (e.g., sachet, yogurt, milk powder, seltzer, alcoholic beverage, vitamin beverage, sprinkle packet, meals ready-to-eat, protein drink) or environment (e.g., elevated humidity, temperature).

In some embodiments, food composition(s) may be or are effective at protecting food component(s) against a physical change, a chemical change, a functional change, a change in benefit or combinations thereof. In some instances, a physical, chemical, functional change or change in benefit may be induced by one or more of heat, light, shear, water, acid, enzymes, bacteria, or combinations thereof.

In some embodiments, stability of one or more food component(s) in one or more food composition(s) refers to the percentage of change of a measured stability characteristic (e.g., stability properties) after a period of storage relative to the measured property immediately after formulation. In some embodiments, stability of one or more food component(s) is defined as <about 40%, <about 30%, <about 20%, <about 10%, <about 5%, <about 2%, and/or <about 1% change in one or more measured stability properties. In some cases, the chemical stability of one or more food component(s) may be determined by a chemical quantity (e.g., mol, g, lbs) of one or more food component(s) relative to initial formulation. In some cases, the physical stability of one or more food component(s) may be determined by a physical quantity (e.g., diameter, morphology, porosity) of one or more food component(s) relative to initial formulation. In some cases, the functional stability of one or more food component(s) may be determined by comparison of release profile, as described herein, of one or more food component(s) relative to initial formulation. In some cases, the stability of benefit of one or more food component(s) may be determined by a comparison of maintenance of health, maintenance of microbiome health, provision of energy, provision of metabolic intermediates, and/or provision of osmotic stability relative to initial formulation.

In some embodiments, stability of one or more food components(s) in a provided food composition (e.g., as described above), is assessed over a period of time at a particular environmental condition. In some embodiments, stability is assessed after 6 months at ambient temperature.

In some embodiments, a provided food composition is stable in that percent change of a stability property is minimized after passage of a period of time (e.g., at least about 1, 2, 3, 4, 5, 6, 7, or 8 weeks) under a particular environmental condition (e.g., ambient temperature). In some embodiments, stability is a measured change of <about 40%, <about 30%, <about 20%, <about 10%, <about 5%, <about 2%, and/or <about 1% of a food component over a period of time under the environmental condition. In some embodiments, the period of time is up to about 8 weeks and the environmental condition is or comprises ambient temperature. In some embodiments, the period of time is up to about 2 weeks and the environmental condition is or comprises presence of water (e.g., in aqueous solution). In some embodiments, the period of time is up to about 72 hours and the environmental condition is or comprises exposure to light at elevated temperatures (e.g., about 37 °C).

In some embodiments, a provided food composition is stable in that percent change of a stability property is minimized after passage of a period of time (e.g., at least about 1, 2, 3, 4, 5, 6, 7, or 8 weeks) under a particular environmental condition (e.g., ambient temperature). In some embodiments, stability is a measured change of <about 40%, <about 30%, <about 20%, <about 10%, <about 5%, <about 2%, and/or <about 1% of a food component over a period of time under the environmental condition. In some embodiments, the period of time is up to about 36 months and the environmental condition is or comprises ambient temperature. In some embodiments, the period of time is up to about 12 months and the environmental condition is or comprises presence of food product (e.g., in a mixture with a food product). In some embodiments, the period of time is up to about 1 month and the environmental condition is or comprises exposure to a food product (e.g., in a mixture with yogurt).

In some instances, stability of one or more food component(s) (<about 20% change in one or more stability properties) is maintained after storage in a solid food (e.g., bread, rice, baked goods, etc.) at ambient temperatures for time periods between 0-1 week, 0-1 month, 0-1 years, or 1-5 years of storage.

In some instances, stability of one or more food component(s) (<about 20% change in one or more stability properties) is maintained after storage in a dry powder (e.g., supplement powder, milk powder, baby formula, flour, etc.) at ambient temperatures for time periods between 0-1 week, 0-1 month, 0-1 years, or 1-5 years of storage.

In some instances, stability of one or more food component(s) (<about 20% change in one or more stability properties) is maintained after storage in a liquid beverage (e.g., coffee, drinkable yogurt, protein beverage, water, soda, Gatorade, sports drinks, etc.) at ambient temperatures for time periods between 0-1 week, 0-1 month, 0-1 years, or 1-5 years of storage.

In some embodiments, disclosed food compositions are stable (<about 20% change in one or more stability properties) up to 2 weeks, up to 1 month, up to 6 months, up to 1 year, up to 2 years, up to 5 years, etc. in water at ambient temperature.

In some embodiments, disclosed food compositions are stable (<about 20% change in one or more stability properties) up to 2 weeks in yogurt at ambient temperature.

In some embodiments, disclosed food compositions are stable (<about 20% change in one or more stability properties) up to 2 weeks in milk powder at ambient temperature.

In some embodiments, disclosed food compositions are stable (<about 20% change in one or more stability properties) up to 2 weeks in baby formula at ambient temperature.

In some embodiments, disclosed food compositions are stable (<about 20% change in one or more stability properties) up to 2 weeks in milk powder at ambient temperature.

In some embodiments, disclosed food compositions are stable (<about 20% change in one or more stability properties) up to 2 weeks in high dry powders at ambient temperature.

In some embodiments, disclosed food compositions are stable (<about 20% change in one or more stability properties) up to 2 weeks in a sachet at ambient temperature.

In some embodiments, disclosed food compositions are stable (<about 20% change in one or more stability properties) up to 2 weeks when combined with animal feed (e.g., total meal ration, animal feed pellets, etc.) at ambient temperature.

In some embodiments, food compositions may be effective to protect food component(s) against humidity-induced degradation. In some instances, food component(s) dispersed in food product(s) is or are stable (<about 20% change in one or more stability properties) when exposed to ambient humidity (e.g., 30% relative humidity) at ambient temperatures (e.g., 25 °C) for up to 6 weeks.

In some embodiments, food compositions are incorporated into a food and/or beverage product in the presence of humidity (e.g., water, moisture content, water activity). In some instances, food compositions are effective to protect food component(s) against humidity-induced degradation. In some instances, food component(s) is or are stable (<about 20% change in one or more stability properties) when exposed to >15%, >20%, >25%, and/or >30% relative humidity, at >−20 °C and/or >4 °C and/or >25 °C and/or >30 °C and/or >35 °C and/or >37 °C and/or >50 °C, for >1, >2, >3, >4, >6, and/or >8 weeks.

In some instances, stability of the food component (<about 20% change in one or more stability properties) is maintained after storage in a freezer (−85 C to 0 °C), a refrigerator (1-10 °C), or atmospheric temperature (−10 °C-40 °C) for time periods between 0-1 week, 0-1 month, 0-1 years, or 1-5 years of storage.

In some instances, protection against oxygen, heat, light, and water of a food component is maintained after storage in a freezer (−85 °C to 0 °C), a refrigerator (1-10 °C), or atmospheric temperature (−10 °C-40 °C) for time periods ranging from 0-1 week, 0-1 month, 0-1 year, and/or 1-5 years of storage.

In certain embodiments, the disclosed food compositions provide protection against degradation (e.g., oxidation, hydrolysis, isomerization, fragmentation, lysis, or a combination thereof) of food component(s). In some embodiments, the disclosed food compositions comprise core-shell and/or matrix preparations wherein food components are protected from environmental factors (e.g., water, humidity, moisture, water activity, light, heat, and/or acid).

It is contemplated that provided food compositions disclosed herein are suitable for use in varying consumable compositions (e.g., a food product, a beverage product, an animal-consumable product). It is further contemplated that provided food compositions disclosed herein are suitable for use in consumable compositions of high water activity. In some instances, disclosed food compositions provide for stability of food component(s) further characterized as core components, shell components, matrix components, solute components, or a combination thereof when used with consumable compositions (e.g., a food product, a beverage product, an animal-consumable product).

### D. METHODS OF MANUFACTURING FOOD COMPOSITION(S)

The present disclosure provides a method of manufacturing (e.g., formulating) one or more food composition(s) that comprises, on a dry weight basis, at least about 90%, at least about 95%, and/or at least about 99% of one or more food component(s), as described herein. Additionally, or alternatively, the disclosure provides a means of controlling the release of one or more food component(s) from one or more food composition(s). In certain embodiments, a means of controlling the release of one or more food component(s) is characterized as being a physical arrangement (e.g., formulation) of one or more food component(s) comprising one more food composition(s). In certain embodiments, the physical arrangement (e.g., formulation) of one or more food component(s) comprising one or more food composition(s) is further characterized as a core-shell preparation and/or a matrix preparation. In certain embodiments, one or more core-shell and/or matrix preparations are further characterized as particle preparations.

In some aspects, the disclosure provides a method of manufacture for food and/or beverage compositions (e.g., formulated ingestibles) for improving health. In certain embodiments, one or more matrix preparation(s) are formulated using one or more matrix component(s) and one or more solute component(s). In certain embodiments, one or more core-shell preparation(s) are formulated using one or more shell component(s) and one or more core component(s). In certain embodiments, one or more solute component(s) are characterized as a core-shell preparation. In certain embodiments, one or more core component(s) are characterized as a matrix preparation. Among other things, the present disclosure provides a method of formulating one or more matrix, solute, core, and/or shell component(s). Among other things, the present disclosure provides a method of formulating one or more core-shell preparations and/or matrix preparations.

In certain embodiments, food and/or beverage compositions (e.g., formulated ingestibles) are characterized by average particle diameter. In some cases, food and/or beverage compositions (e.g., formulated ingestibles) are characterized as having an average particle diameter of <10000 μm, <5000 μm, <1000 μm, <500 μm, <250 μm, <125 μm, <50 μm, <20 μm, and/or <5 μm. In certain preferred embodiments, one or more food composition(s) are characterized as having an average particle diameter between about 10 μm-200 μm.

In certain preferred embodiments, one or more food composition(s) are characterized as having an average particle diameter between about 50 μm-800 μm. In certain preferred embodiments, one or more food composition(s) are characterized as having an average particle diameter in a range from about 90 μm-400 μm.

### (i) Methods of Size Reduction

In some cases, one or more core, shell, matrix, solute, core-shell, and/or matrix preparation component(s), as described herein, are reduced to a size (e.g., size reduction) amenable to homogeneous formulation. In some cases, one or more core, shell, matrix, solute, core-shell, and/or matrix preparation component(s) is reduced to a size (e.g., size reduction) amenable to mitigate any sensory aspects (e.g., texture, grit, taste, etc.). In some cases, one or more core, shell, matrix, solute, core-shell, and/or matrix preparation component(s) undergoing one or more size reduction processes are characterized as a particle preparation, as described herein. In some cases, one or more core, shell, matrix, solute, core-shell, and/or matrix preparation component(s) characterized as particle preparation(s) are further characterized by particle diameter, morphology, and/or porosity.

For example, in some embodiments, methods of size reduction of food and/or beverage compositions (e.g., formulated ingestibles) include, but are not limited to, planetary milling, ball milling, burr milling, roller milling, media milling, impact milling, jet milling, high-pressure homogenization, cryo milling, hammer milling, conical milling, hand screening, or granulation/extrusion, extrusion, spray drying, fluid bed agglomeration, spray congealing, high-shear granulation, tableting, pouring, roller compaction, crosslinking, prilling, spinning disc atomization, and/or combinations thereof.

### (ii) Methods of Mixing

In some cases, one or more core, shell, matrix, solute, core-shell, and/or matrix preparation component(s), as described herein, are mixed within a homogeneous formulation. In some cases, mixing is between solid food component(s) in liquid food component(s), solid food component(s) in solid food component(s), liquid food component(s) in liquid food component(s), and/or liquid food component(s) in solid food component(s). In some cases, mixing of one or more core, shell, matrix, solute, core-shell, and/or matrix component(s) enables uniformity of sensory aspects (e.g., texture, grit, taste, etc.). In some cases, mixing of one or more core, shell, matrix, solute, core-shell, and/or matrix component(s) enables a uniform distribution in a formulation. In some cases, mixed core, shell, matrix, solute, core-shell, and/or matrix preparation component(s) are characterized by concentration as a function of sampling location.

For example, in some embodiments, methods of mixing of food and/or beverage compositions (e.g., formulated ingestibles) include, but are not limited to, stir-bar, overhead stirring, ultrasonic mixing, high-shear mixing, and/or combinations thereof.

(iii) Methods of Preparing Matrix Component(s) and or Matrix Preparation(s)

In some cases, methods of preparation of one or more matrix component(s) and/or matrix preparation(s) are provided. In certain embodiments, one or more matrix component(s) and/or matrix preparation(s) is characterized as a solid, a gel, a particle, a liquid, or combinations thereof. In certain embodiments, one or more matrix component(s) and/or matrix preparation(s) is characterized as having partial, high, and/or complete solubility in water (e.g., hydrophilic). In certain embodiments, one or more matrix component(s) and/or matrix preparation(s) are characterized as having no, low, and/or moderate solubility in water (e.g., hydrophobic). In certain embodiments, one or more matrix component(s) and/or matrix preparation(s) are characterized as being amphiphilic. In certain embodiments, the preparation of one or more matrix component(s) and/or matrix preparation(s) is characterized as solidification, crystallization, self-assembly, gelation, and/or hydration.

In certain embodiments, the preparation of one or more matrix component(s) and/or matrix preparation(s), characterized as solidification, crystallization, self-assembly, gelation, and/or hydration, is achieved through heating, in a range of about 20 °C to about 200 °C, mixing of one or more food composition(s), and subsequent cooling in a range of about −40 °C to about 20 °C. In certain embodiments, the preparation of one or more matrix component(s) and/or matrix preparation(s), characterized as solidification, crystallization, self-assembly, gelation, and/or hydration, is achieved through the action of a trigger (e.g., exposure to water, pH, light, physical forces, chemical reaction, enzymatic reaction) as provided herein.

In certain embodiments, the preparation of one or more matrix component(s) and/or matrix preparation(s) further includes size reduction, as provided herein.

(iv) Methods of Preparing Shell Component(s) and/or Core-Shell Preparation(s)

In some cases, methods of preparation of one or more shell component(s) and/or core-shell preparation(s) are provided. In certain embodiments, one or more shell component(s) and/or core-shell preparation(s) is characterized as a solid, a gel, a particle, a liquid, or combinations thereof. In certain embodiments, one or more shell component(s) and/or core-shell preparation(s) is characterized as having partial, high, and/or complete solubility in water (e.g., hydrophilic). In certain embodiments, one or more shell component(s) and/or core-shell preparation(s) are characterized as having no, low, and/or moderate solubility in water (e.g., hydrophobic). In certain embodiments, one or more shell component(s) and/or core-shell preparation(s) are characterized as being amphiphilic. In certain embodiments, the preparation of one or more shell component(s) and/or core-shell preparation(s) is further characterized as a coating process and/or layering process.

As provided herein, methods of coating and/or layering may be or comprise a single method of coating and/or layering. In some instances, methods of coating and/or layering may be or comprise at least 1, 2, or 3 successive methods of coating and/or layering. In some instances, methods of coating and/or layering may be or comprise several successive methods of coating and/or layering.

For example, in some embodiments, methods of coating comprise, but are not limited to, spray pan coating, fluidized bed coating, dip coating, roller coating, sputter coating, self-assembly, or combinations thereof.

For example, in some embodiments, methods of layering comprise, but are not limited to, dip coating, roller coating, layered deposition, vapor deposition, physical arrangement, or combinations thereof.

In certain embodiments, one or more shell component(s) and/or core-shell preparation(s) are prepared by homogenous coating and/or layering of one or more core component(s), solute component(s), and/or matrix preparation(s) with an aqueous solution of one or more shell component(s) and/or core-shell preparation(s). In certain embodiments, one or more shell component(s) and/or core-shell preparation(s) are prepared by heterogeneous coating and/or layering of one or more core component(s), solute component(s), and/or matrix preparation(s) with an aqueous solution of one or more shell component(s) and/or core-shell preparation(s). In certain embodiments, one or more shell component(s) and/or core-shell preparation(s) are prepared by homogenous coating and/or layering of one or more core component(s), solute component(s), and/or matrix preparation(s) with an organic solution of one or more shell component(s) and/or core-shell preparation(s). In certain embodiments, one or more shell component(s) and/or core-shell preparation(s) are prepared by heterogeneous coating and/or layering of one or more core component(s), solute component(s), and/or matrix preparation(s) with an organic solution of one or more shell component(s) and/or core-shell preparation(s).

In some embodiments, a method of coating a food and/or beverage compositions (e.g., formulated ingestibles) uses or may utilize materials that improve (e.g., protect, or improve the functionality of) the food and/or beverage compositions (e.g., formulated ingestibles). In some cases, a method of coating a food and/or beverage compositions (e.g., formulated ingestibles) improves resistance to moisture (e.g., humidity, water, water activity). In some cases, a method of coating a food and/or beverage compositions (e.g., formulated ingestibles) improves resistance to acidity (e.g., pH responsive materials). In some cases, a method of coating a food and/or beverage composition reduces porosity. In some cases, a method of coating a food and/or beverage compositions (e.g., formulated ingestibles) reduces agglomeration, aggregation, and/or tackiness. In some cases, a method of coating a food composition increases gastrointestinal residence time (e.g., mucoadhesive components). In some cases, a method of coating a food composition improves taste and/or fragrance.

In certain embodiments, the preparation of one or more shell component(s) and/or core-shell preparation(s) further includes size reduction, as provided herein.

### (v) Methods of Dying Food Composition(s)

In certain embodiments, a method of drying food and/or beverage compositions (e.g., formulated ingestibles) is provided. In some cases, drying of a food and/or beverage compositions (e.g., formulated ingestibles) comprises reduction of moisture content. In some cases, drying of a food and/or beverage compositions (e.g., formulated ingestibles) comprises reduction of water activity.

The disclosed method of drying certain food and/or beverage compositions (e.g., formulated ingestibles), as provided herein, improves upon the prior art by further eliminating exposure of food components (e.g., micronutrients, macronutrients, etc.) to moisture and/or presence of water.

In certain embodiments, drying of certain food and/or beverage compositions (e.g., formulated ingestibles) is achieved by the use of chemical drying agents, elevated temperature, vacuum, or combinations thereof.

For example, in some embodiments, drying of food and/or beverage compositions (e.g., formulated ingestibles) is achieved by use of drierite, heating, vacuum, molecular sieves, sodium sulfate, magnesium sulfate, calcium carbonate, calcium chloride, or combinations thereof.

### (vi) Method of Quantifying Amount of Food Component(s) in One or More Food Composition(s)

In certain aspects, the present disclosure provides methods for the quantification of food component(s) present in one or more disclosed food composition(s) (e.g., loading). In certain embodiments, quantifying loading is beneficial to understanding the efficiency of the manufacturing process. In certain embodiments, quantifying loading is beneficial to understanding the relative composition of nutrients in one or more food composition(s). In certain embodiments, quantifying loading is beneficial to understanding the nutritional content of one or more food composition(s).

In certain embodiments, loading of one or more food composition(s) is quantification of amount of one food component. In certain embodiments, loading of one or more food composition(s) is quantification of amount of several distinct food components. In certain embodiments, quantification of one or more food component(s) within one or more food composition(s) is quantification of the concentration (e.g., amount) of one or more food component(s) following complete release (e.g., 100%) from one or more food composition(s).

In certain embodiments, loading of one or more food composition(s) is quantified by subjecting one or more food composition(s) to one or more dissolution solvent(s) and/or trigger(s) to effect complete release.

In certain embodiments, quantification of one or more food component(s) is achieved using at least one of nuclear magnetic resonance, mass spectrometry, liquid chromatography, intrinsic colorimetry, intrinsic fluorimetry, enzymatic colorimetry, enzymatic fluorimetry, enzymatic amperometry, and/or antibody-mediated recognition (e.g., ELISA, Western blot).

### E. MEANS FOR REDUCING MINIMUM DAILY MEAL FREQUENCY

Among other things, the present disclosure provides one or more means for reducing daily meal frequency. As provided herein, one or more meal(s) refers to a particular combination of one or more food component(s) ingested by one or more animal(s) in a singular portion at regular intervals (e.g., meal frequency) over a 24-hour period (e.g., daily). In some cases, a meal is comprised of a particular combination of one or more food component(s) that is ingested by one or more animal(s) and characterized as providing satisfaction and/or satiety (e.g., a pleasurable taste, a pleasurable fragrance, comfort, mitigate hunger). In some cases, a meal is comprised of a particular combination of one or more food component(s) that is ingested by one or more animal(s) and characterized as providing a nutritional benefit (e.g., maintaining the health of one or more animals, maintaining the microbiome health of one or more animals, provision of caloric content, provision of metabolic intermediates, and/or provision of osmotic stabilizers).

As defined herein, a meal is comprised of a particular combination of one or more food component(s) ingested by one or more animal(s), an effective daily dose characterized as providing satisfaction, satiety, and/or a nutritional benefit in a 24-hour period (e.g., daily), In some cases, an effective daily dose of one or more food component(s) is provided with 1 meal in a 24-hour period. In some cases, an effective daily dose of one or more food component(s) is provided with several meals in a 24-hour period.

Those skilled in the art will appreciate that one or more animal(s) are characterized as consuming one or more meals, as provided herein, in regular intervals (e.g., meal frequency) over a 24-hour period (e.g., daily). In some cases, one or more animal(s) consume at least 1, 2, 3, 4, 5, 6, 7, 8, 9, and/or at least 10 meals in a 24-hour period (e.g., daily). Without wishing to be bound by any particular theory, one or more animal(s) generally consume about 2 to about 5 meals daily. Without wishing to be bound by any particular theory, it is contemplated that the consumption of one or more meals by one or more animals is primarily driven by a need for satisfaction and/or satiety and secondarily driven by a need for nutritional benefit.

Without wishing to be bound by any particular theory, it is contemplated that a meal characterized as providing satisfaction and/or satiety is not necessarily characterized as providing a nutritional benefit. Similarly, without wishing to be bound by any particular theory, it is contemplated that a meal characterized as providing a nutritional benefit is not necessarily satisfying and/or satiating. It is similarly contemplated that an effective daily dose of one or more food component(s) such as to provide for satisfaction and/or satiety may be an insufficient daily dose of one or more food component(s) such as to provide for nutritional benefit. It is similarly contemplated that an effective daily dose of one or more food component(s) such as to provide for satisfaction and/or satiety may be an excessive daily dose of one or more food component(s) such as to provide for nutritional benefit.

Without wishing to be bound by any particular theory, it is contemplated that the consumption of several meals in a 24-hour period facilitates provision of satisfaction, satiety, and/or nutritional benefit at the cost of meal preparation time and meal consumption time. Moreover, it is contemplated that consumption of several meals in a 24-hour period is associated with an increased risk of an error in selection of one or more food component(s), such as to provide an insufficient and/or excessive daily dose of one or more food component(s). Without wishing to be bound by any particular theory, conversely as provided in the prior art, reduction of meal frequency mitigates meal preparation time and meal consumption time at the cost of satisfaction, satiety, and/or nutritional benefit.

Provided herein are means of reducing daily meal frequency comprising a means of providing satisfaction, satiety, and/or a means of providing a nutritional benefit further comprising an effective daily dose of one or more food component(s).

In certain embodiments, one or more food composition(s), as described herein comprise a means of reducing daily meal frequency. In certain embodiments, one or more food component(s), as described herein, comprise a means of providing satisfaction, a means of providing satiety, and/or a means of providing a nutritional benefit. In certain embodiments, one or more excipient component(s), as described herein, comprise a means of providing satisfaction, a means of providing satiety, and/or a means of providing a nutritional benefit. In certain embodiments, the physical arrangement of one or more food component(s) (e.g., food composition(s)), as described herein, comprise a means of providing satisfaction, a means of providing satiety, and/or a means of providing a nutritional benefit.

In certain embodiments, a means of providing satiety is also a means of providing satisfaction and/or nutritional benefit. In certain embodiments, a means of providing satisfaction is also a means of providing satiety and/or nutritional benefit. In certain embodiments, a means of nutritional benefit is also a means of providing satisfaction and/or satiety.

1. Means of Providing Satisfaction and/or Satiety

As provided herein, one or more means of providing satisfaction and/or satiety provide a means of reducing daily meal frequency. In certain embodiments, one or more means of providing satisfaction and/or satiety include, but are not limited to, combinations of providing a pleasing taste, providing a pleasing texture, controlling the release profile(s), as provided herein, of one or more food component(s), and/or controlling the physiological response of one or more animal(s). In certain embodiments, one or more means of providing satisfaction and/or satiety further comprise one or more food component(s), excipient component(s), and/or food composition(s). In certain embodiments, one or more food component(s), excipient component(s), and/or food composition(s) provide the same means of providing satisfaction and/or satiety. In certain embodiments, one or more food component(s), excipient component(s), and/or food composition(s) provide differing means of providing satisfaction and/or satiety.

### (i) Means of Providing a Pleasing Taste

In certain embodiments, one or more food component(s), excipient component(s), and/or food composition(s) are characterized by pleasing taste (e.g., taste modifier) as a means of providing satisfaction and/or satiety as a means of reducing daily meal frequency.

As provided herein, one or more taste modifier(s) are characterized as providing a sweet, sour, salty, bitter, and/or savory taste. In certain embodiments, one or more taste modifier(s) directly provides a pleasing taste. In certain embodiments, one or more taste modifier(s) are characterized by modulating the taste of other food component(s).

For example, in certain embodiments, one or more taste modifier(s) include, but are not limited to, glucose, vanillin, acetic acid, chlorogenic acid, cafestol, and/or sodium chloride.

Having read the present disclosure, one skilled in the art will appreciate that one or more taste modifier(s) further include, but are not limited to, substance(s) identified by one or more governing bodies as safe (e.g., generally regarded as safe and/or food additives). In some instances, those skilled in the art will appreciate that taste modifier(s) are or may be selected from those substance(s) recognized as Generally Regarded as Safe (i.e., GRAS) by the U.S. Food and Drug Administration. In some instances, those skilled in the art will appreciate that taste modifier(s) are or may be selected from those substance(s) recognized in 21 C.F.R. 184. In some instances, those skilled in the art will appreciate that taste modifier(s) are or may be selected from those substance(s) recognized in GB2760-2014 by the National Health and Family Planning Commission of the People's Republic of China.

In certain embodiments, one or more taste modifier(s) comprise, on a dry weight basis, at least about 0%, about 1%, about 5%, about 10%, about 15%, about 20%, about 25%, about 50%, about 75%, about 90%, about 95%, about 99%, and/or about 100% of one or more means of providing a pleasing taste. In certain embodiments, one or more taste modifier(s) comprise, on a dry weight basis, at least about 0%, about 1%, about 5%, about 10%, about 15%, about 20%, about 25%, about 50%, about 75%, about 90%, about 95%, about 99%, and/or about 100% of one or more means of providing satisfaction and/or satiety.

### (ii) Means of Providing a Pleasing Texture

In certain embodiments, one or more food component(s), excipient component(s), and/or food composition(s) are characterized by pleasing texture (e.g., texture modifier) as a means of providing satisfaction and/or satiety as a means of reducing daily meal frequency.

As provided herein, one or more texture modifier(s) are characterized as providing a mechanically, geometrically, or chemically pleasing texture. In certain embodiments, one or more texture modifier(s) directly provides a pleasing texture. In certain embodiments, one or more texture modifier(s) are characterized by modulating the texture of other food component(s).

For example, in certain embodiments, one or more texture modifier(s) controls mechanical properties to influence hardness, cohesiveness, viscosity, elasticity, brittleness, chewiness, and/or gumminess. For example, in certain embodiments, one or more texture modifier(s) controls geometric properties to influence particle size and/or morphology. For example, in certain embodiments, one or more texture modifier(s) controls chemical properties to influence adhesiveness, oiliness, and/or greasiness.

In certain embodiments, one or more texture modifier(s) is further characterized by the geometric properties (e.g., size, morphology) of one or more food compositions. In certain embodiments, one or more texture modifier(s) is characterized as being a core-shell preparation and/or a matrix preparation. In certain embodiments, one or more texture modifier(s) is further characterized as a particle preparation, characterized by a morphology and/or particle diameter. Without wishing to be bound by any particular theory, selection of particle diameters may elicit a sensation of smoothness, lack of cohesiveness, and/or grittiness depending on particle diameter.

Having read the present disclosure, one skilled in the art will appreciate that one or more texture modifier(s) further include, but are not limited to, substance(s) identified by one or more governing bodies as safe (e.g., generally regarded as safe and/or food additives). In some instances, those skilled in the art will appreciate that texture modifier(s) are or may be selected from those substance(s) recognized as Generally Regarded as Safe (i.e., GRAS) by the U.S. Food and Drug Administration. In some instances, those skilled in the art will appreciate that texture modifier(s) are or may be selected from those substance(s) recognized in 21 C.F.R. 184. In some instances, those skilled in the art will appreciate that texture modifier(s) are or may be selected from those substance(s) recognized in GB2760-2014 by the National Health and Family Planning Commission of the People's Republic of China.

In certain embodiments, the selection of one or more food component(s), excipient component(s), and/or food composition(s) is a means of providing a pleasing texture. For example, without wishing to be bound by any particular theory, the usage of lipid (e.g., hydrophobic, fats) food component(s) may elicit a sensation of oiliness or greasiness.

In certain embodiments, one or more texture modifier(s) comprise, on a dry weight basis, at least about 0%, about 1%, about 5%, about 10%, about 15%, about 20%, about 25%, about 50%, about 75%, about 90%, about 95%, about 99%, and/or about 100% of one or more means of providing a pleasing texture. In certain embodiments, one or more texture modifier(s) comprise, on a dry weight basis, at least about 0%, about 1%, about 5%, about 10%, about 15%, about 20%, about 25%, about 50%, about 75%, about 90%, about 95%, about 99%, and/or about 100% of one or more means of providing satisfaction and/or satiety.

(iii) Means of Controlling Release Profiles of One or More Food Component(s)

In certain embodiments, one or more food component(s), excipient component(s), and/or food composition(s) are characterized by controlling release of one or more food component(s) (e.g., satiety profile) as a means of providing satisfaction and/or satiety as a means of reducing daily meal frequency.

As provided herein, one or more satiety profile(s) are characterized by the release profile(s) of one or more food component(s) and/or relative release profile(s) of one or more food component(s). In certain embodiments, one or more release profile(s) of one or more food component(s) is achieved using one or more food composition(s), as provided herein. In certain embodiments, one or more food component(s) comprising one or more food composition(s) exhibits one release profile. In certain embodiments, one or more food component(s) comprising one or more food composition(s) exhibits several release profiles.

In certain embodiments, one or more satiety profile(s) are characterized by the release profile of one or more carbohydrates as described herein. For example, in certain embodiments, one or more satiety profile(s) are characterized by the release profile of glucose, amylose, allulose, xylitol, and/or cellulose.

In certain embodiments, one or more satiety profile(s) are characterized by the release profile of one or more proteins as described herein. For example, in certain embodiments, one or more satiety profile(s) are characterized by the release profile of whey protein, casein, soy protein, pea protein, corn protein, zein, gliadin, gelatin, and/or collagen.

In certain embodiments, one or more satiety profile(s) are characterized by the release profile of one or more fats as described herein. For example, in certain embodiments, one or more satiety profile(s) are characterized by the release profile of soybean oil, palm oil, carnauba wax, and/or lecithin.

In certain embodiments, one or more satiety profile(s) provided by one or more food composition(s) are characterized as extending the release of one or more food component(s) relative to unformulated food component(s). In certain embodiments, extending (e.g., extended) release prolongs the incubation period required for 100% release of one or more food component(s) from one or more food composition(s) in one or more dissolution solvent(s). In certain embodiments, extending (e.g., extended) release prolongs the residence time of one or more food component(s) in one or more food composition(s) in one or more gastrointestinal compartment(s). In certain embodiments, extended release is achieved using a core-shell preparation, and/or a matrix preparation as described herein.

In certain embodiments, means of controlled release of one or more food component(s) from one or more food composition(s), as provided herein, are utilized as means of controlling satiety profile(s). For example, in some embodiments, a multilayered core-shell preparation is utilized to elicit sequentially bolus dose of sucrose in 8-hour intervals, such that 15 g of sucrose is released after 8 hours, 30 g of sucrose is released after 16 hours, and 60 g of sucrose is released after 24 hours. For example, in some embodiments, a mucoadhesive core-shell preparation extends the jejunal residence time of one or more food composition(s) exhibiting sustained release of sucrose such that 60 g of sucrose is released over a 24-hour period. Without wishing to be bound by any particular theory, it is contemplated that provision of one or more food component(s) as a bolus in 8-hour intervals or sustained over a 24-hour period improves satiety relative to unformulated food component(s).

In certain embodiments, a combination of release profiles of one or more carbohydrates, proteins, and/or fats comprises one or more satiety profile(s). In certain embodiments, the release profile(s) of one or more food component(s) are temporally arranged to elicit maximum satiety. For example, in certain embodiments, one or more means of providing satiety may comprise a food composition comprised of carbohydrates, released with constant rate over a 24-hour period, proteins, released in bolus dose in 8-hour intervals, and fats, released in a bolus dose within the first hour post-ingestion.

In certain embodiments, one or more combinations of release profile(s) are temporally arranged to provide satiety for at least about 8 hours, about 10 hours, about 12 hours, about 16 hours, about 20 hours, and/or about 24 hours.

In certain embodiments, a means of controlling release comprise, on a dry weight basis, at least about 0%, about 1%, about 5%, about 10%, about 15%, about 20%, about 25%, about 50%, about 75%, about 90%, about 95%, about 99%, and/or about 100% of one or more means of providing satisfaction and/or satiety.

### (iv) Means of Controlling Physiological Response of One or More Food Component(s)

In certain embodiments, one or more food component(s), excipient component(s), and/or food composition(s) are characterized as controlling physiological response (e.g., physiological modulator) as a means of providing satisfaction and/or satiety.

As provided herein, one or more physiological modulator(s) are characterized by the modulation of an endogenous physiological satiety response. In certain embodiments, one or more physiological modulator(s) elicits an endogenous physiological satiety response to provide satisfaction and/or satiety. In some embodiments, an endogenous physiological satiety response may be characterized by factors including, but not limited to, providing a feeling of fullness, reducing the desire to eat, reduced serum ghrelin, and/or increased serum leptin. In certain embodiments, physiological modulation of satiety is achieved through physical means. In certain embodiments, physiological modulation of satiety is achieved through chemical means.

In certain embodiments, physical means of modulating a physiological response to satiety include application of pressure or interaction with a surface area of one or more gastrointestinal compartments. In certain embodiments, one or more food composition(s) characterized as a core-shell preparation and/or a matrix preparation provides a physical means of modulating a physiological response to satiety.

For example, in certain embodiments, one or more food composition(s) characterized as a core-shell preparation and/or a matrix preparation provides a physical means of modulating a physiological response to satiety by increasing size, and/or increasing surface area. For example, in certain embodiments, one or more food composition(s) characterized as a core-shell preparation and/or a matrix preparation increases size by swelling and uptake of one or more dissolution solvent(s), self-assembly in response to a trigger, or combinations thereof. For example, in certain embodiments, one or more food composition(s) characterized as a core-shell preparation and/or a matrix preparation increases surface area by unfolding (e.g., denaturing) in response to a trigger, increased porosity in response to a trigger, or combinations thereof.

In certain embodiments, chemical means of modulating a physiological response to satiety include selection of food component(s) and/or selection of food component release profile(s), In certain embodiments, one or more food composition(s) characterized as a core-shell preparation and/or a matrix preparation provides a chemical means of modulating a physiological response to satiety.

For example, in certain embodiments, one or more food component(s) characterized as a chemical modulator of physiological response to satiety include micronutrients, macronutrients, or combinations thereof. For example, in certain embodiments, a micronutrient is tannic acid, ellagitannin, apigenin, luteolin, tangeritin, isorhamnetin, kaempferol, myricetin, quercetin, genipin, rutin, eriodictyol, hesperetin, naringenin, catechin, gallocatechin, epicatechin, epigallocatechin, theaflavin, daidzein, genistein, glycitein, resveratrol, pterostilbene, hydroxytyrosol, cyanidin, delphinidin, malvidin, pelargonidin, peonidin, petunidin, chicoric acid, chlorogenic acid, cinnamic acid, ellagic acid, gallic acid, sinapic acid, rosmarinic acid, salicylic acid, curcumin, piperine, silymarin, silybin, eugenol, melatonin, methylcobalamin, adrafinil, cathine, cathinone, dextroamphetamine, ephedrine, epinephrine, armodafinil, modafinil, phenylethylamine, synephrine, theanine, 5-hydroxytryptophan, caffeine, theobromine, and/or taurine. For example, in certain embodiments, a macronutrient is aspartame, GLP-1, GLP-2, collagen, sermorelin, tesamorelin, lenomorelin, anamorelin, ipamorelin, macimorelin, ghrelin, leptin, tabimorelin, alexamorelin, GHRP-1, GHRP-2, GHRP-3, GHRP-4, GHRP-5, GHRP-6, hexarelin, cellulose, dextrins, amylose, amylopectin, pectin, inulin, lignin, chitin, xanthan gum, sodium alginate, potassium alginate, calcium alginate, ammonium alginate, propylene glycol alginate, sodium hyaluronate, potassium hyaluronate, calcium hyaluronate, agar, agarose, carrageenan, raffinose, cellulose acetate, methyl cellulose, ethyl cellulose, cellulose acetate propionate, cellulose acetate butyrate, cellulose acetate succinate, hydroxypropyl methylcellulose, hydroxypropyl cellulose, pea protein isolate, whey protein isolate, oat protein isolate, soy protein isolate, wheat protein isolate, egg protein isolate, casein, bovine serum albumin, ovalbumin, α-lactalbumin, β-lactoglobulin, collagen, glutanin, gliadin, kefirin, avenin, zein, silk, gelatin, hordein, and/or sodium carboxymethylcellulose.

In certain embodiments, a release profile of one or more micronutrient(s) and/or macronutrient(s) is a chemical means of modulating a physiological response to satiety. For example, in certain embodiments, the release profile(s) of one or more macronutrients (e.g., carbohydrates, proteins, fats) is controlled in order to maximize satiety. For example, without wishing to be bound by any particular theory, in certain embodiments, the release profile(s) of one or more carbohydrates (e.g., glucose, sucrose) are characterized as slow, constant release to provide a continuous energy source. For example, without wishing to be bound by any particular theory, in certain embodiments, the release profile(s) of one or more proteins (e.g., whey protein, soy protein) are characterized as bolus dose in 8 hour intervals to sufficiently stimulate growth hormone secretion.

In certain embodiments, one or more physical and/or chemical means of modulating a physiological response to satiety provide satiety for at least about 8 hours, about 10 hours, about 12 hours, about 16 hours, about 20 hours, and/or about 24 hours.

In certain embodiments, one or more physical and/or chemical means of modulating a physiological response to satiety comprise, on a dry weight basis, at least about 0%, about 1%, about 5%, about 10%, about 15%, about 20%, about 25%, about 50%, about 75%, about 90%, about 95%, about 99%, and/or about 100% of one or more means of providing satisfaction and/or satiety.

### 2. Means of Providing Sufficient Nutritional Benefit

In certain embodiments, one or more means of reducing daily meal frequency is comprised of a means of providing sufficient nutritional benefit, as described herein. In certain embodiments, a means of providing sufficient nutritional benefit further comprises providing a sufficient total amount (e.g., cal, g) of one or more food component(s), a sufficient amount (e.g., cal, g) of one or more macronutrients, a sufficient balance of one or more macronutrients, one or more enzyme inhibitors, and/or one or more absorption enhancers. In certain embodiments, one or more means of providing sufficient nutritional benefit further comprise one or more food component(s), excipient component(s), and/or food composition(s). In certain embodiments, one or more food component(s), excipient component(s), and/or food composition(s) provide the same means of providing nutritional benefit. In certain embodiments, one or more food component(s), excipient component(s), and/or food composition(s) provide differing means of providing nutritional benefit.

### (i) Total Amount of Food Component(s)

In certain embodiments, a means of providing sufficient nutritional benefit is characterized as one or more food component(s), excipient component(s), and/or food composition(s) further characterized by a total amount of food component(s), as provided herein. In certain embodiments, a total amount of food component(s) is total caloric content (e.g., kcal) and/or mass (e.g., g). Without wishing to be bound by any particular theory, it is contemplated that a total caloric content and/or mass represent the theoretical energy (e.g., a nutritional benefit) provided by one or more meals. Without wishing to be bound by any particular theory, it is contemplated that effective daily meal consumption is characterized by a sufficient caloric content and/or mass for a nutritional benefit.

In certain embodiments, one or more food component(s), excipient component(s), and/or food composition(s) is characterized by a total mass of at least about 50 g, about 125 g, about 250 g, about 500 g, about 750 g, about 1000 g, about 1250 g about 1500 g, about 1750 g, about 2000 g, about 2500 g, and/or about 3000 g. In certain embodiments, one or more food component(s), excipient component(s), and/or food composition(s) is characterized by a total caloric content of at least about 250, at least about 500, about 1000, about 1500, about 2500, about 3500, and/or about 4500 kcal.

In certain embodiments, the total caloric content and/or mass of one or more food component(s), excipient component(s), and/or food composition(s) refers to that which is present upon manufacture. In certain embodiments, the total caloric content and/or mass of one or more food component(s), excipient component(s), and/or food composition(s) refers to that which is released over a given period of time in one or more dissolution solvent(s). In certain embodiments, the total caloric content and/or mass of one or more food component(s), excipient component(s), and/or food composition(s) refers to that which is absorbed by one or more animals.

In certain embodiments, the total caloric content and/or mass of food component(s) comprise, on a dry weight basis, at least about 0%, about 1%, about 5%, about 10%, about 15%, about 20%, about 25%, about 50%, about 75%, about 90%, about 95%, about 99%, and/or about 100% of one or more means of providing a nutritional benefit.

### (ii) Total Amount and Balance of One or More Macronutrients

In certain embodiments, a means of providing sufficient nutritional benefit is characterized as one or more food component(s), excipient component(s), and/or food composition(s) further characterized by a total amount and balance of macronutrients, as provided herein. In certain embodiments, a total amount of macronutrients is mass (e.g., g), and balance is caloric ratio between carbohydrates, fats, proteins, or combinations thereof. Without wishing to be bound by any particular theory, it is contemplated that a total amount of macronutrients and their ratio represent support of growth and maintenance (e.g., a nutritional benefit) provided by one or more meals. Without wishing to be bound by any particular theory, it is contemplated that effective daily meal consumption is characterized by a sufficient total amount of macronutrients and caloric ratio for a nutritional benefit.

In certain embodiments, one or more food component(s), excipient component(s), and/or food composition(s) is characterized by a total carbohydrate content of at least about 25, at least about 50, about 100, about 200, about 300, about 400, and/or about 500 g. In certain embodiments, one or more food component(s), excipient component(s), and/or food composition(s) is characterized by a total protein content of at least about 100, at least about 200, about 300, about 400, about 500, about 600, and/or about 700 g. In certain embodiments, one or more food component(s), excipient component(s), and/or food composition(s) is characterized by a total fat content of at least about 12, at least about 25, about 50, about 100, about 200, about 300, and/or about 400 g.

In certain embodiments, one or more food component(s), excipient component(s), and/or food composition(s) is characterized by a ratio of carbohydrates to fats, by dry weight, is between about 3 and about 12. In certain embodiments, one or more food component(s), excipient component(s), and/or food composition(s) is characterized by a ratio of proteins to fats, by dry weight, is between about 0.5 and about 5. In certain embodiments, one or more food component(s), excipient component(s), and/or food composition(s) is characterized by a ratio of carbohydrates to proteins, by dry weight, is between about 0.5 and about 10.

In certain embodiments, the total amount of macronutrients and/or macronutrient balance comprising one or more food component(s), excipient component(s), and/or food composition(s) refers to that which is present upon manufacture. In certain embodiments, the total amount of macronutrients and/or macronutrient balance comprising one or more food component(s), excipient component(s), and/or food composition(s) refers to that which is released over a given period of time in one or more dissolution solvent(s). In certain embodiments, the total amount of macronutrients and/or macronutrient balance comprising one or more food component(s), excipient component(s), and/or food composition(s) refers to that which is absorbed by one or more animals.

(iii) Enzyme Inhibitors

In certain embodiments, a means of providing a nutritional benefit comprises an effective dose of one or more enzyme inhibitor(s). In certain embodiments, one or more enzyme inhibitor(s) is characterized by reducing the activity of gastrointestinal enzymes. Without wishing to be bound by any particular theory, it is contemplated that one or more enzyme inhibitor(s) prolongs the digestion of one or more food component(s), thereby prolonging absorption and reducing daily meal frequency. In certain embodiments, means of reducing the activity of gastrointestinal enzymes (e.g., enzyme inhibitors) are comprised of one or more food component(s), excipient component(s), and/or food composition(s), as provided herein.

In certain embodiments, an effective dose of one or more enzyme inhibitor(s) comprising one or more food component(s), excipient component(s), and/or food composition(s) is characterized by an increased stability of one or more food component(s) in one or more dissolution solvent(s) comprising a digestive enzyme. For example, in certain embodiments, an effective dose of one or more enzyme inhibitor(s) increases the half-life of one or more food component(s) by at least about 10%, about 20%, about 30%, about 40%, about 50%, about 60%, about 75%, about 90%, and/or about 100% in simulated intestinal fluid comprising pancreatin. For example, in certain embodiments, an effective dose of one or more enzyme inhibitor(s) increases the half-life of one or more food component(s) by at least about 1-fold, 2-fold, 3-fold, 5-fold, 10-fold, 20-fold, and/or 50-fold in simulated intestinal fluid comprising pancreatin.

In certain embodiments, one or more enzyme inhibitor(s) is comprised of at least one or more food component(s), excipient component(s), and/or food composition(s). In certain embodiments, one or more enzyme inhibitor(s) is characterized by one or more release profile(s), as described herein. Without wishing to be bound by any particular theory, it is contemplated that the release profile of one or more enzyme inhibitor(s) is critical to its function. In certain embodiments, controlled release, as provided herein, is applied to one or more food component(s), excipient component(s), and/or food composition(s) comprising an enzyme inhibitor.

For example, an enzyme inhibitor may be comprised of at least one of amylostatin Y, amylostatin S-AI, adiposin, gurmarin, zeamatin, helianthamide, lipstatin, orlistat, esterastin, valilactone, panclicin D, ebelactone, vibralactone, soybean trypsin inhibitor, serpin A1, serpin A3, serpin A4, serpin E1, serpin C1, Elafin, TIMP-1, TIMP-2, TIMP-3, TIMP-4, and/or an antioxidant, as described herein

Having read the present disclosure, one skilled in the art will appreciate that one or more texture modifier(s) further include, but are not limited to, substance(s) identified by one or more governing bodies as safe (e.g., generally regarded as safe and/or food additives). In some instances, those skilled in the art will appreciate that texture modifier(s) are or may be selected from those substance(s) recognized as Generally Regarded as Safe (i.e., GRAS) by the U.S. Food and Drug Administration. In some instances, those skilled in the art will appreciate that texture modifier(s) are or may be selected from those substance(s) recognized in 21 C.F.R. 184. In some instances, those skilled in the art will appreciate that texture modifier(s) are or may be selected from those substance(s) recognized in GB2760-2014 by the National Health and Family Planning Commission of the People's Republic of China.

In certain embodiments, one or more absorption enhancers comprise, on a dry weight basis, at least about 0%, about 1%, about 5%, about 10%, about 15%, about 20%, about 25%, about 50%, about 75%, about 90%, about 95%, about 99%, and/or about 100% of one or more means of reducing daily meal frequency.

In some aspects, one or more enzyme inhibitor(s) reduces the caloric content and/or mass, as provided herein, characterizing one or more food component(s), excipient component(s), and/or food composition(s). Without wishing to be bound by any particular theory, it is contemplated that one or more food composition(s) comprising one or more enzyme inhibitor(s) provides a means of reducing daily meal frequency by providing a means of inducing satisfaction and satiety further characterized by caloric restriction. Without wishing to be bound by any particular theory, it is contemplated that the provided disclosure is of particular benefit to one or more animal(s) requiring body weight management and/or characterized as diabetic.

### (iv) Absorption Enhancers

In certain embodiments, a means of providing a nutritional benefit comprises an effective dose of one or more absorption enhancer(s). In certain embodiments, one or more absorption enhancer(s) is characterized by increasing the gastrointestinal absorption of one or more food component(s). Without wishing to be bound by any particular theory, it is contemplated that a means of increasing nutrient absorption reduces the required caloric density, meal size, and reduces daily meal frequency. In certain embodiments, means of increasing the absorption of one or more food component(s) (e.g., absorption enhancers) are comprised of one or more food component(s), excipient component(s), and/or food composition(s), as provided herein.

In certain embodiments, an effective dose of one or more absorption enhancer(s) comprising one or more food component(s), excipient component(s), and/or food composition(s) is characterized by an increase in the oral bioavailability of one or more food component(s). For example, in certain embodiments, an effective dose of one or more absorption enhancer(s) increases the bioavailability of one or more food component(s) by at least about 10%, about 20%, about 30%, about 40%, about 50%, about 60%, about 75%, about 90%, and/or about 100%. For example, in certain embodiments, an effective dose of one or more absorption enhancer(s) increases the bioavailability of one or more food component(s) by at least about 1-fold, 2-fold, 3-fold, 5-fold, 10-fold, 20-fold, and/or 50-fold.

In certain embodiments, one or more absorption enhancers is comprised of at least one or more food component(s), excipient component(s), and/or food composition(s). In certain embodiments, one or more absorption enhancers is characterized by one or more release profile(s), as described herein. Without wishing to be bound by any particular theory, it is contemplated that the release profile of one or more absorption enhancer(s) is critical to its function. In certain embodiments, controlled release, as provided herein, is applied to one or more food component(s), excipient component(s), and/or food composition(s) comprising an absorption enhancer.

For example, an absorption enhancer may be comprised of at least one of sodium caprylate, sodium caprate, sodium laurate, sodium oleate, sodium linoleate, propyl gallate, propyl syringate, propyl shikimate, octyl gallate, octyl syringate, octyl shikimate, ammoniated glycyrrhizin, quillaia extract, tocopherol PEG succinate, lauroyl polyoxylglycerides, polysorbate 80, ethanol, propylene glycol, poly(ethylene glycol), diethylene glycol monoethyl ether, sodium citrate, medium chain triglycerides, lipase, sodium lauryl sulfate, and/or ascorbyl palmitate.

Having read the present disclosure, one skilled in the art will appreciate that one or more texture modifier(s) further include, but are not limited to, substance(s) identified by one or more governing bodies as safe (e.g., generally regarded as safe and/or food additives). In some instances, those skilled in the art will appreciate that texture modifier(s) are or may be selected from those substance(s) recognized as Generally Regarded as Safe (i.e., GRAS) by the U.S. Food and Drug Administration. In some instances, those skilled in the art will appreciate that texture modifier(s) are or may be selected from those substance(s) recognized in 21 C.F.R. 184. In some instances, those skilled in the art will appreciate that texture modifier(s) are or may be selected from those substance(s) recognized in GB2760-2014 by the National Health and Family Planning Commission of the People's Republic of China.

In certain embodiments, one or more absorption enhancers comprise, on a dry weight basis, at least about 0%, about 1%, about 5%, about 10%, about 15%, about 20%, about 25%, about 50%, about 75%, about 90%, about 95%, about 99%, and/or about 100% of one or more means of reducing daily meal frequency.

### F. CHARACTERIZING COMPOSITIONS AND/OR COMPONENTS THEREOF

In some embodiments, provided composition(s), and/or component(s) thereof, are subjected to one or more assessments, for example to characterize one or more structural features and/or functional properties thereof (e.g., for quality control and/or after storage under particular conditions and for a particular period of time). In some embodiments, batches that do not meet designated criteria may be discarded or not further utilized.

### EXEMPLIFICATION

The following examples are intended to illustrate but not limit the disclosed embodiments. The following examples are useful to confirm aspects of the disclosure described above and to exemplify certain embodiments of the disclosure.

These non-limiting examples demonstrate particular features and advantages of provided technologies—e.g., of provided food and/or beverage composition(s).

Among other things, provided food and/or beverage compositions may be characterized by significant improvements, including, for example, (i) improved absorption and/or bioavailability of payloads, (ii) improved shelf-life and resistance to degradation at decreased temperatures (e.g., −80 °C, −20 °C, and/or 4 °C), elevated temperatures (e.g., 22 °C, 25 °C, 30 °C, 35 °C, and/or 40 °C), in food and/or food products, in beverages and/or beverage products, in supplements, in dry powders, in the presence of high relative humidity (e.g., up to 100%) or moisture, or a combination thereof; (iii) prolonged residence time or transit time in the gastrointestinal tract or gastrointestinal tract compartments, (iv) controlled release or sustained release of payload components in the gastrointestinal tract, (v) controlled spatial distribution of payloads in and/or on the gastrointestinal tract, (vi) controlled concentration of payloads in the gastrointestinal tract (e.g., in the stomach, in the intestines, at the epithelial surface, in the mucus, etc.); (vii) improved shelf-life in food or beverage matrices (e.g., protein bars, dry powders, milk powders, whey powders, yogurt, drinkable yogurt, water, etc.); (viii) improved compatibility with other components of nutraceutical products and/or compositions that include them (e.g., supplements, foods, drinks, or other edible materials), (ix) stability of particles and payload in an aqueous liquid against heat, acid, protons, salt, light, water, oxidation, and/or elevated temperatures; (x) improved payload resistance to losses during manufacturing processes such as pasteurization, shear mixing, elevated pressurized processes, elevated temperature processes, etc.; (xi) stability of payloads in, or as, a dry powder against heat, acid, protons, salt, light, water, moisture, humidity, oxidation, antimicrobial peptides, and/or elevated temperatures; (xii) tunable properties including size, coating thickness, morphology, geometry, loading, dose, interactions with the surrounding environment, and release conditions, etc.; (xiii) improved anti-caking, anti-clumping, anti-agglomerating, and/or anti-aggregating functionality at elevated temperatures; (xiv) maintenance and preservation of composition morphology (e.g., particle geometry) when exposed to typically degrading conditions, such as: decreased temperatures (e.g., −80 °C, −20 °C, and/or 4 °C), elevated temperatures (e.g., 22 °C, 25 °C, 30 °C, 35 °C, and/or 40 °C), in foods and/or food products, in beverages and/or beverage products, in supplements, in dry powders, in the presence of high relative humidity (e.g., up to 100%) or moisture, or a combination thereof, (xv) mitigation of changes to taste, texture, or scents upon addition, storage, or ingestion of the food and beverage compositions (e.g., formulated ingestibles); (xiii) controlled satiety.

### A. Example 1: Caloric and Macronutrient Constituents in Example Food Composition(s)

In one exemplary embodiment of the provided food and/or beverage composition(s), a food composition is comprised of one or more macronutrient(s), one or more micronutrient(s), and/or one or more excipient component(s).

For example, in one non-limiting instance, the provided food composition is comprised of a caloric content suitable for the needs of one or more animal(s) for a 24-hour period. For example, as presented in Table 1 in one non-limiting instance, the provided food composition is comprised of one or more of a protein, a carbohydrate, and/or a fat. For example, in one non-limiting instance, a provided food composition is comprised of a caloric content of 1500 kcal with 112 g of carbohydrate, 150 g of protein, 50 g of fat, 2.5 μg of vitamin B12, 15 μg of vitamin D, 15 mg of vitamin E. For example, in one non-limiting instance, a provided food composition is comprised of a caloric content of 2000 kcal with 250 g of carbohydrate, 100 g of protein, 67 g of fat, 2.5 g of vitamin B12, 15 g of vitamin D, 15 mg of vitamin E. For example, in one non-limiting instance, a provided food composition is comprised of a caloric content of 2500 kcal with 250 g of carbohydrate, 125 g of protein, 111 g of fat, 2.5 μg of vitamin B12, 15 μg of vitamin D, 15 mg of vitamin E. Therefore, the relative ratios of calories that are derived from carbohydrates vs. proteins vs. fats may vary from one composition to the next.

TABLE 1
Nutritional values of exemplary food composition(s).

| Composition | Carbohydrates (g) | Proteins (g) | Fats (g) | Calories (kcal) |
|---|---|---|---|---|
| 1 | 112 | 150 | 50 | 1500 |
| 2 | 250 | 100 | 67 | 2000 |
| 3 | 250 | 125 | 111 | 2500 |

### B. Example 2: Encapsulation of Macronutrients

In certain embodiments, one or more food component(s) characterized as a macronutrient are encapsulated in one or more core-shell preparations and/or matrix preparations. In one exemplary embodiment, one or macronutrients is encapsulated in a core-shell preparation further characterized as a particle preparation.

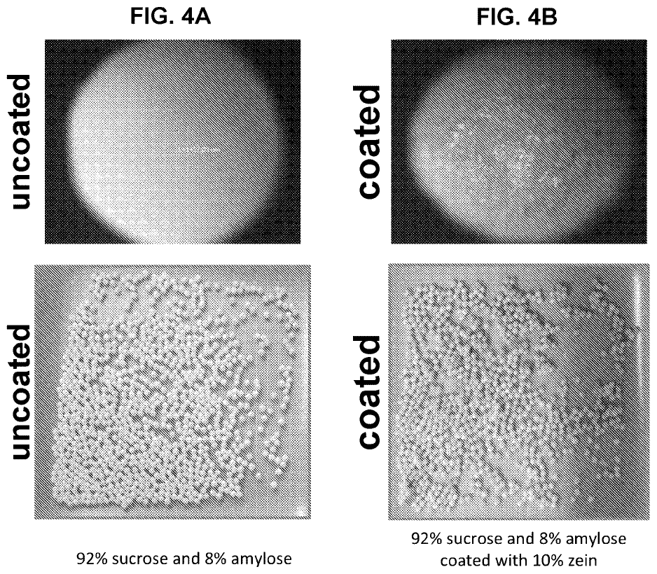

For example, in one non-limiting instance, a food composition comprised of a carbohydrate (e.g., a solute component) is embedded within a carbohydrate (e.g., a matrix component), further characterized as encapsulation of a carbohydrate. For example, in one non-limiting instance, a food composition comprised of an encapsulated carbohydrate (e.g., a matrix preparation) is encapsulated by a protein (e.g., a core-shell preparation). In one non-limiting instance, a core-shell preparation is further characterized as a particle preparation. For example, in FIG. 4A, sucrose is dispersed within a wet amylose matrix, the slurry sprayed into cool air to generate particles of controlled diameter. The encapsulation of sucrose within amylose is calculated to be 92%, on a dry weight basis. For example, in FIG. 4B, particles comprising encapsulated sucrose (92% loading, 1 mm diameter) are further coated (e.g., spray pan coating) with a 10% ethanolic solution of Zein with a colorant (e.g., excipient component). Brightfield micrographs reveal increased surface roughness and a red coloring, indicative of successful coating.

### C. Example 3: Encapsulation of Micronutrients

In certain embodiments, one or more food component(s) characterized as a micronutrient are encapsulated in one or more core-shell preparations and/or matrix preparations.

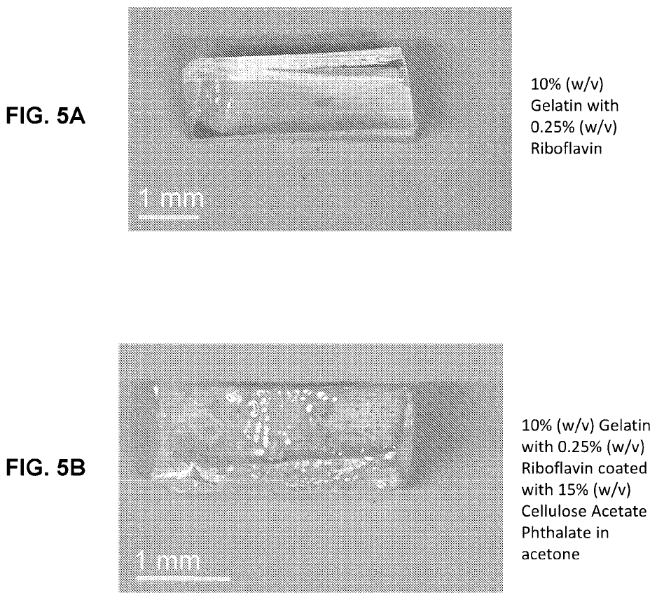

For example, in one non-limiting instance, a food composition comprised of a vitamin (e.g., a solute component) is embedded within a protein (e.g., a matrix component), further characterized as encapsulation of a vitamin. For example, in FIG. 5A, riboflavin (0.25% w/v) is dispersed within a 10% gelatin solution, the slurry heated to 65 °C, homogenized, and subsequently cooled for 1 hour at 20 °C. For example, in FIG. 5B, matrix preparations comprising encapsulated riboflavin (0.25% w/v loading, 4 cm³) are further coated (e.g., dip coating) with a 15% acetone solution of cellulose acetate phthalate. Photographs (FIG. 5B) reveal increased surface smoothness and reflectivity, indicative of successful coating.

### D. Example 4: Exemplary Combination Matrix and Core-Shell Preparations

In certain embodiments, one or more food composition(s) are characterized as one or more of a core-shell preparation, matrix preparation, and/or particle preparation. In certain embodiments, one or more food composition(s) are characterized as a core-shell preparation and a matrix preparation.

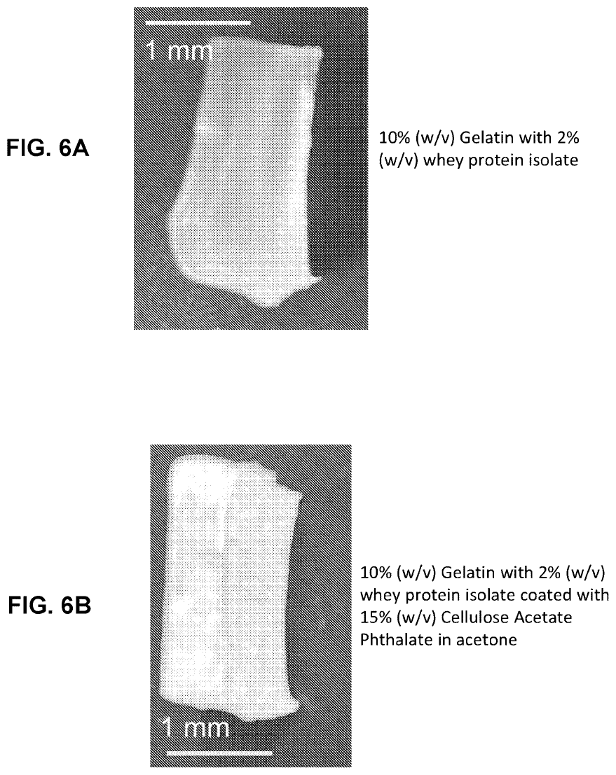

For example, in one non-limiting instance, a food composition is comprised of a matrix preparation, further characterized as a core component, coated with one or more shell components. In one non-limiting instance, one or more core component(s) is comprised of, on a dry weight basis, at least 90% of one or more food component(s) and/or one or more shell component(s). The non-limiting instance of an exemplary combination matrix and core-shell preparation, as provided in this example, is comprised of a matrix preparation further comprised of 10% (w/w) gelatin and 2% (w/w) whey protein. This non-limiting instance of a matrix preparation is coated 4 times, allowing for drying, with a 15% (w/v) solution of cellulose acetate phthalate in acetone to yield an exemplary core-shell preparation. Photographs (FIGS. 6A and 6B) illustrate the gross morphology of the non-limiting exemplary food composition prior to and following coating.

### E. Example 5: Exemplary Multi-Layered Core-Shell Preparations

In certain embodiments, one or more food composition(s) are characterized as a multi-layered core-shell preparation. Described herein is a non-limiting example of one multi-layered core-shell preparation comprising a food composition.

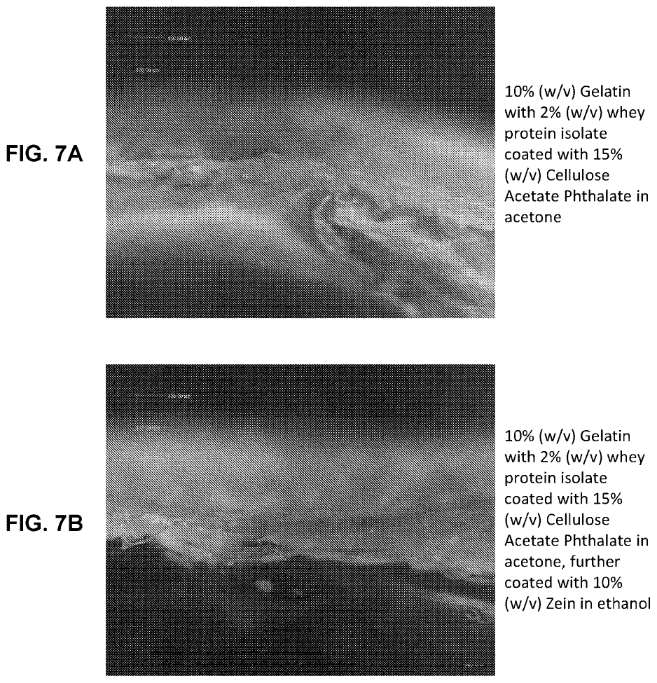

For example, in one non-limiting instance, a food composition is comprised of a core-shell preparation, as shown in FIG. 6B, comprised of gelatin, whey protein isolate, and cellulose acetate phthalate. This food composition is subsequently coated 4 times (e.g., dip coating), allowing for drying, in a 10% ethanolic solution of Zein with a colorant (e.g., excipient component). Importantly, in this non-limiting example, the solubility of the polymer in the first layer (e.g, cellulose acetate phthalate) is limited in the solution comprising the second coating polymer (e.g., Zein). As a result, deposition of a second layer is achieved without loss of the first layer. Brightfield micrographs (FIGS. 7A and 7B) illustrate the cross-sectional morphology of the non-limiting exemplary food composition prior to and following coating with a second layer.

### F. Example 6: Exemplary Coating Formulation Protocols

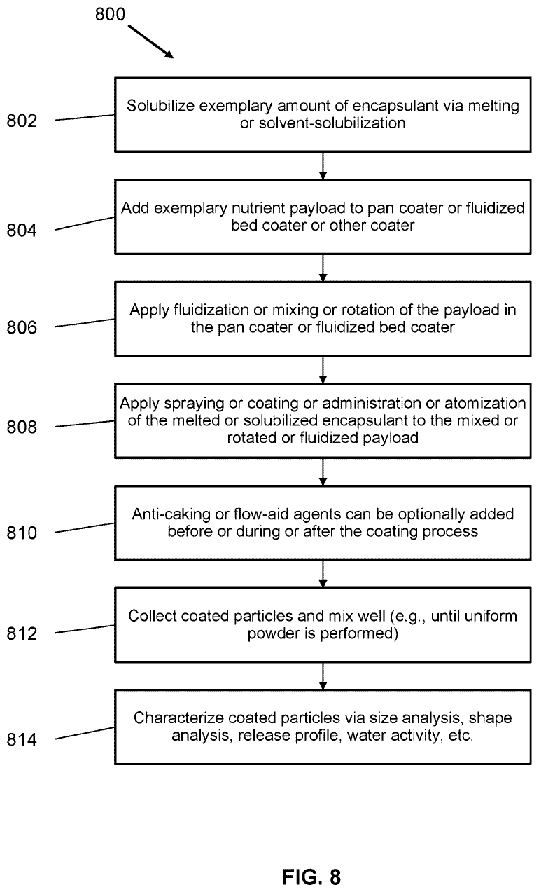

This example describes two non-limiting processes of arranging one or more food component(s) as a shell component to one or more food component(s) characterized as a core component via spray pan coating and/or fluidized bed spray coating. A schematic of an exemplary coating procedure, method, or protocol 800 is presented in FIG. 8. At step 802, the method 800 may include solubilizing an exemplary amount of encapsulant via melting or solvent-solubilization. At step 804, the method 800 may include adding an exemplary nutrient payload to pan coater or fluidized bed coater or other coater. At step 806, the method 800 may include applying fluidization or mixing or rotation of the payload in the pan coater or fluidized bed coater. At step 808, the method 800 may include applying spraying or coating or administration or atomization of the melted or solubilized encapsulant to the mixed, rotated and/or fluidized payload. At step 810, the method 800 may include adding anti-caking or flow-aid agents before, during and/or after the coating process. At step 812, the method 800 may include collecting the coated particles and thoroughly mixing (e.g., until uniform powder is achieved). At step 814, the method 800 may include characterizing the coated particles via size analysis, shape analysis, release profile, water activity, etc.

In one non-limiting example, food composition(s) are prepared in core-shell preparations using the procedure described below. Particle preparations comprising sucrose encapsulated in amylose (10 g) are coated using a spray pan coater with an inlet air temperature of 80 °C, pan temperature of 70 °C, rotation speed of 2 Hz, and spray rate of 0.5 mL/s. A 10% (w/v) ethanolic (90% ethanol) solution of Zein with 1% (v/v) Propylene Glycol and 0.5% (w/v) Talc powder is applied as a thin film over 5 minutes to the encapsulated sucrose. The volume-normalized weight gain due to coating is 120%]. The concentration of formulated food product in this embodiment, on a dry weight basis, is 100% (w/w).

Whey protein isolate powder (100 g) is coated using a fluidized bed spray coater (Glatt) with a 67 °C inlet temperature, 45 °C outlet temperature, a spray rate of 3 g/min, and a flow rate of 25 mL/min. A 20% (w/v) aqueous suspension of ethyl cellulose is applied as a thin film over 5 min to the fluidized whey protein powder. The volume-normalized weight gain due to coating is 110%. The concentration of formulated food product in this embodiment is 100% (w/w).

### G. Example 7: Exemplary Matrix Formulation Protocol

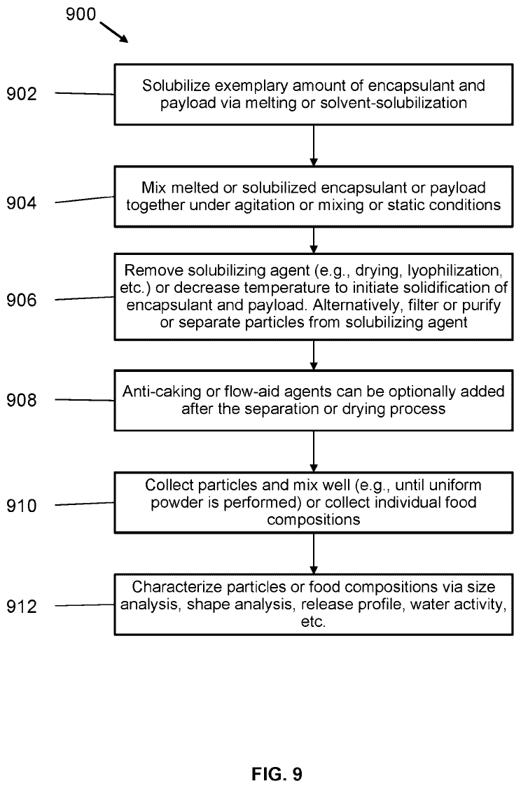

This example describes two non-limiting processes of arranging one or more food component(s) as a matrix component to one or more food component(s) characterized as a solute component via melt-gelation. A schematic of an exemplary matrix formulation procedure, method, or protocol 900 is presented in FIG. 9. At step 902, the method 900 may include solubilizing an exemplary amount of encapsulant and payload via melting or solvent-solubilization. At step 904, the method 900 may include mixing melted or solubilized encapsulant or payload together under agitation or mixing or static conditions. At step 906, the method 900 may include removing the solubilizing agent (e.g., drying, lyophilization, etc.) or decreasing the temperature to initiate solidification of the encapsulant and payload. Alternatively, (or in addition), step 906 may include filtering, purifying and/or separating particles from the solubilizing agent. At step 908, the method 900 may include adding anti-caking or flow-aid agents after the separation and/or drying process(es). At step 910, the method 900 may include collecting particles and mixing (e.g., until uniform powder is achieved) and/or collecting individual food compositions. At step 912, the method 900 may include characterizing particles or food compositions via size analysis, shape analysis, release profile, water activity, etc.

In one non-limiting example, food composition(s) are prepared in matrix preparation using the procedure described below. Gelatin (10 g) is suspended in 100 mL of stirring deionized water and the suspension is heated to 65 °C. Following complete solubilization of the gelatin at elevated temperature, 2 g of whey protein isolate powder are added and allowed to dissolve for 5 minutes. The resulting clear solution is poured into a polypropylene mold and allowed to cool for 1 hour at 20 °C. The density of the cooled gel is measured to be 0.87 g/cm³. The concentration of formulated food product in this non-limiting embodiment, on a dry weight basis, is 100% (w/w).

### H. Example 8: Exemplary Dissolution Protocol

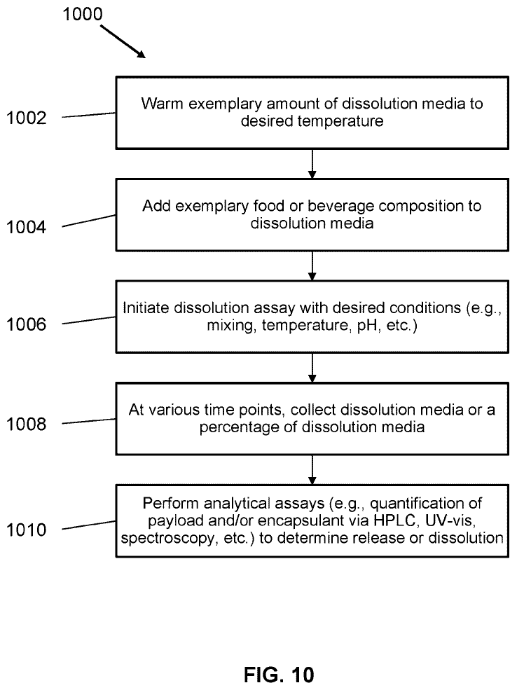

This example describes one non-limiting process of assessing the release (e.g., controlled release) of one or more food component(s) from one or more dissolution solvent(s). A schematic of an exemplary dissolution procedure, method, or protocol 1000 is presented in FIG. 10. At step 1002, the method 1000 may include warming an exemplary amount of dissolution media to a desired temperature. At step 1004, the method 1000 may include adding an exemplary food or beverage composition to the dissolution media. At step 1006, the method 1000 may include initiating dissolution assay with one or more desired conditions (e.g., via mixing, temperature, pH, etc.). At step 1008, the method 1000 may include collecting dissolution media and/or a percentage of dissolution media at various time points. At step 1010, the method 1000 may include performing analytical assays (e.g., quantification of payload and/or encapsulant via HPLC, UV-vis, spectroscopy, etc.) to determine release or dissolution characteristics.

In one non-limiting example, a food composition characterized as a core-shell preparation (e.g., Zein-coated amylose encapsulating sucrose) is assessed for controlled release in an aqueous dissolution solvent (e.g., 10 mM phosphate buffered saline, pH 7.4). 12 mL of 10 mM phosphate buffered saline are added to a polypropylene 15 mL centrifuge tube and allowed to equilibrate for 30 min while rotating at 10 rpm on a laboratory rotator. Exemplary core-shell preparations comprising Zein, sucrose, and amylose (500 mg) are added to the rotating tube. 100 μL aliquots are sampled at time points of 1 minute, 2 minutes, 5 minutes, 10 minutes, 15 minutes, 20 minutes, 30 minutes, 40 minutes, 50 minutes, and 60 minutes following addition of core-shell preparations and stored in 1.5 mL centrifuge tubes. The concentration of sucrose in collected aliquots is assayed using an enzymatic electrochemical method. Sucrose concentration, mass, and percent release is plotted with respect to incubation period to construct a release profile.

### I. Example 9: Exemplary Controlled Release Profiles

As provided herein, one or more food and/or beverage composition(s) is characterized by controlled release of one or more food component(s). Selection of release profile, as described herein, is intended to confer a benefit (as described herein) one or more animal(s). The following example depicts anticipated (e.g., theoretical) non-limiting release profiles exhibited by one or more food composition(s).

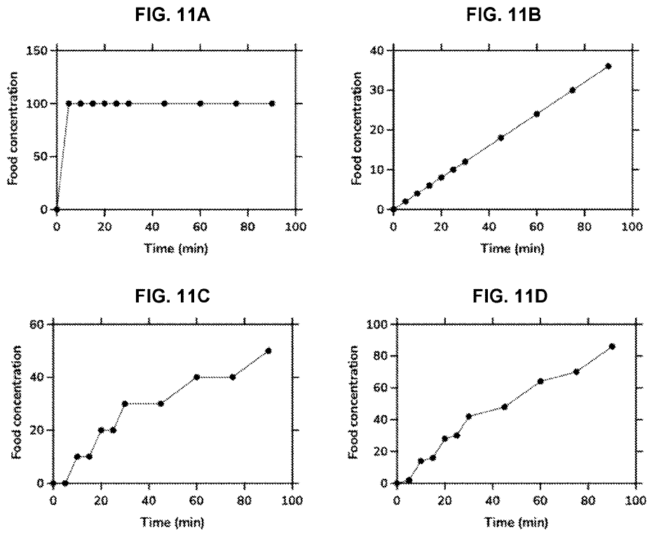

In one non-limiting example, the release of one or more food component(s) is characterized as a single bolus release, as measured by concentration present in one or more dissolution solvent(s) over time, as shown in FIG. 11A. In one non-limiting example, the release of one or more food component(s) is characterized as release with constant rate, as measured by concentration present in one or more dissolution solvent(s) over time, as shown in FIG. 11B. In one non-limiting example, the release of one or more food component(s) is characterized as multiple bolus dose (e.g., pulsatile) release, as measured by concentration present in one or more dissolution solvent(s) over time, as shown in FIG. 11C. In one non-limiting example, the release of one or more food component(s) is characterized as a combination of multiple bolus dose and constant release rate, as measured by concentration present in one or more dissolution solvent(s) over time, as shown in FIG. 11D.

### J. Example 10: Exemplary Controlled Release Profile from a Food Composition

Controlled release of one or more food component(s) from a formulated food and/or beverage composition is demonstrated using the procedure described below.

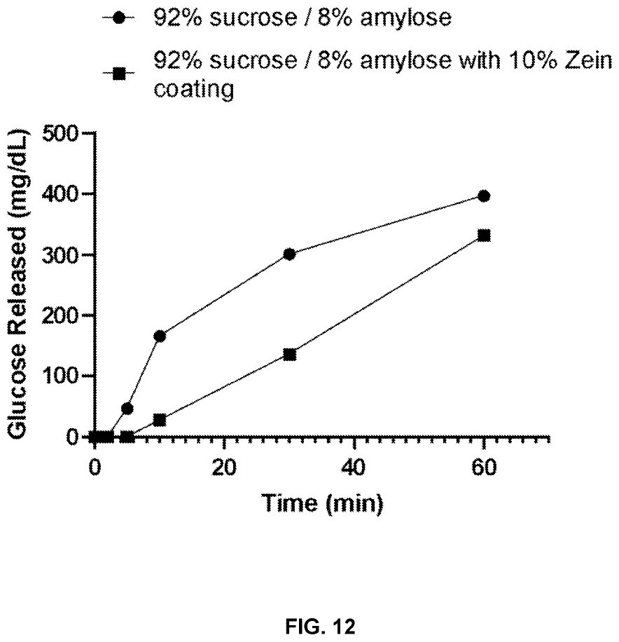

In one non-limiting example, sucrose-containing food composition(s) (500 mg) coated with Zein (see Example 6) were added to a 15 mL conical centrifuge tube filled (12 mL) with 10 mM phosphate buffered saline solution. The centrifuge tube was allowed to rotate at 10 rpm at 20 °C, and 100 μL samples were collected every 15 minutes. Release of sucrose was quantified by a dual enzymatic electrochemical assay, first converting sucrose to glucose using Invertase from Yeast, followed by application to a glucometer. As shown in FIG. 12, the Zein coated sucrose particle preparations exhibited slower (<50 mg/dL) release of sucrose over 15 minutes relative to uncoated sucrose particle preparations (>150 mg/dL) over 15 minutes.

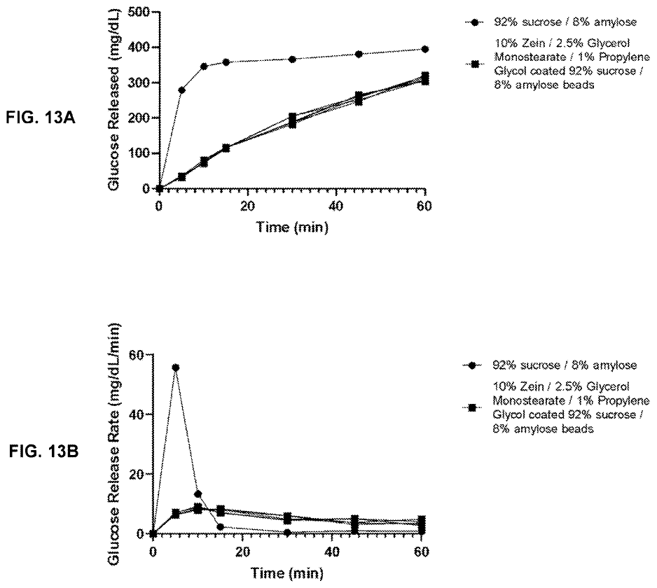

In another non-limiting example, sucrose-containing food composition(s) (500 mg) coated with, on a dry weight basis, 77% Zein (e.g., protein component), 21% Glycerol Monostearate (e.g., fat component), and 2% propylene glycol (e.g., excipient component) were added to a 15 mL conical centrifuge tube filled (12 mL) with 10 mM phosphate buffered saline solution. The centrifuge tube was allowed to rotate at 10 rpm at 20 °C and 100 μL samples were collected every 15 minutes. Release of sucrose was quantified by a dual enzymatic electrochemical assay, first converting sucrose to glucose using Invertase from Yeast, followed by application to a glucometer. As shown in FIG. 13A, the coated sucrose particle preparations exhibited slower (<50%) release of sucrose over 30 minutes relative to uncoated sucrose particle preparations (>90% in 10 minutes). Additionally, examination of release rate, shown in FIG. 13B, indicates that uncoated particle preparations exhibit bolus release while coated particle preparations exhibit constant sucrose release.

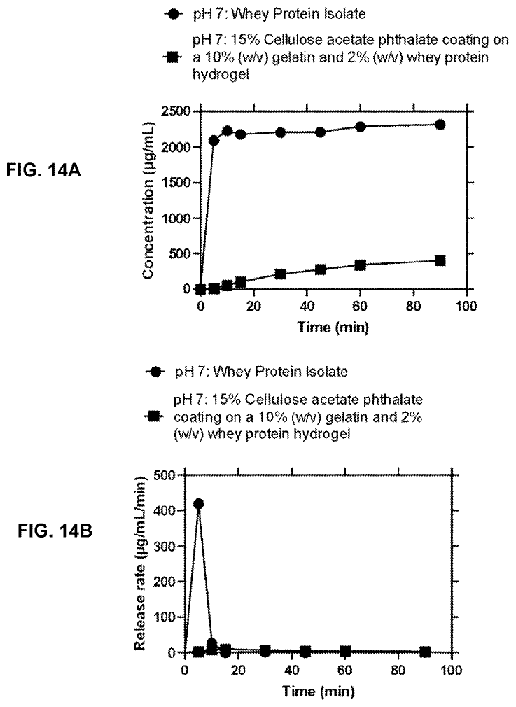

In another non-limiting example, whey protein-containing food composition(s) (2 cm³) coated with cellulose acetate phthalate (see Example 4) were added to a 15 mL conical centrifuge tube filled (12 mL) with simulated intestinal fluid (SIF) at pH 6.8. The centrifuge tube was allowed to rotate at 10 rpm at 20 °C and 100 μL samples were collected at 5, 10, 15, 30, 45, 60, and 90 minutes. Release of protein (e.g., whey protein and Zein) was quantified by BCA assay at each time point to construct a release profile. As shown in FIG. 14A, food composition(s) comprising whey protein isolate and gelatin coated with cellulose acetate phthalate exhibit significantly reduced release (<30% in 90 minutes) relative to uncoated whey protein isolate (~100% in 5 minutes). Moreover, as shown in FIG. 14B, release from uncoated whey protein isolate exhibits bolus release, while release from coated whey protein isolate exhibits a controlled, constant release rate over the incubation period.

### K. Example 11: Food Compositions Exhibiting Low Water Activity and Moisture Content

The presence of water and/or water activity is a common factor underlying instability in one or more food and/or beverage composition(s). The following example illustrates the ability of one or more food components in the provided food compositions to retain integrity in high-moisture conditions, resist water uptake, and thereby mitigate instability of the food component(s) included therein.

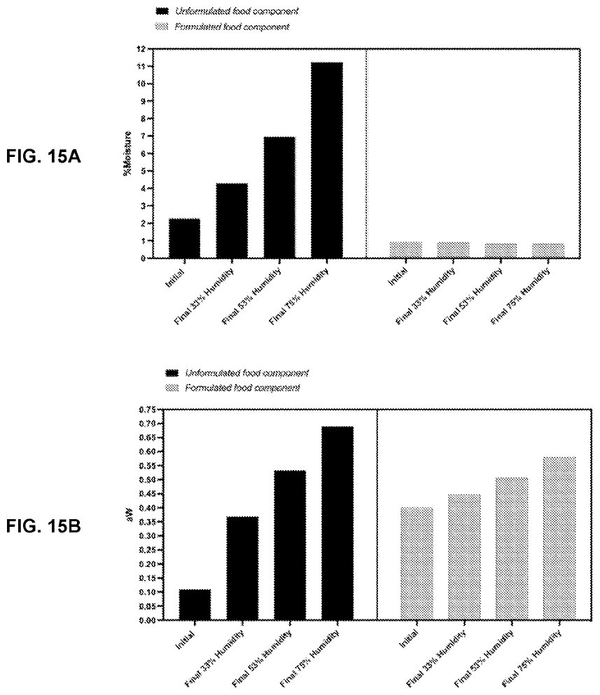

For example, FIG. 15A demonstrates that food compositions herein provided do not gain moisture content, even when exposed to controlled relative humidity of 33%, 53%, or 75% for 4 days. Unformulated food (e.g., dehydrated milk powder), on the other hand, demonstrates a 2-5 fold increase in moisture content. FIG. 15B reveals that formulated food compositions exhibit a smaller increase in water activity as compared to un-encapsulated food. For example, even when the initial level of water activity is higher, as shown in FIG. 15B, the encapsulated food compositions demonstrate a lower level of water activity increase when exposed to increasing amounts of humidity. As such, even when exposed to 75% relative humidity, the water activity of the exemplary food compositions demonstrate lower water activity levels than un-encapsulated food,

### L. Example 12: Incorporation of Food Composition(s) into Food and/or Beverage Products

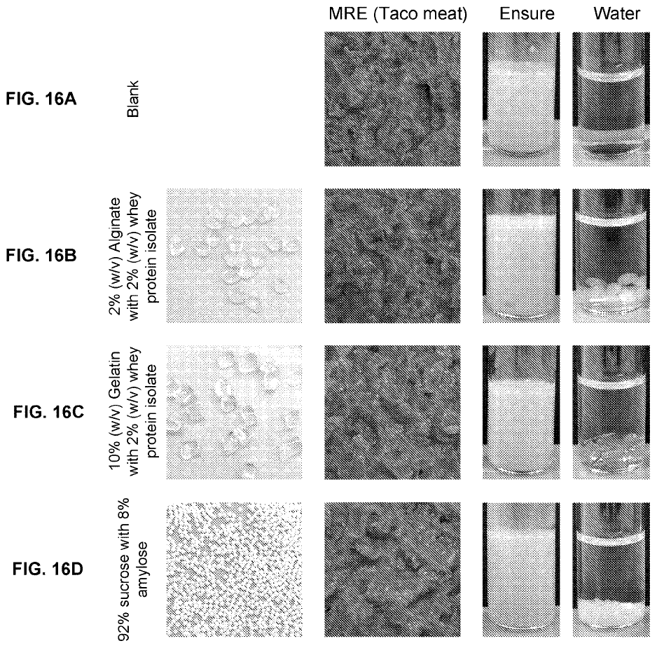

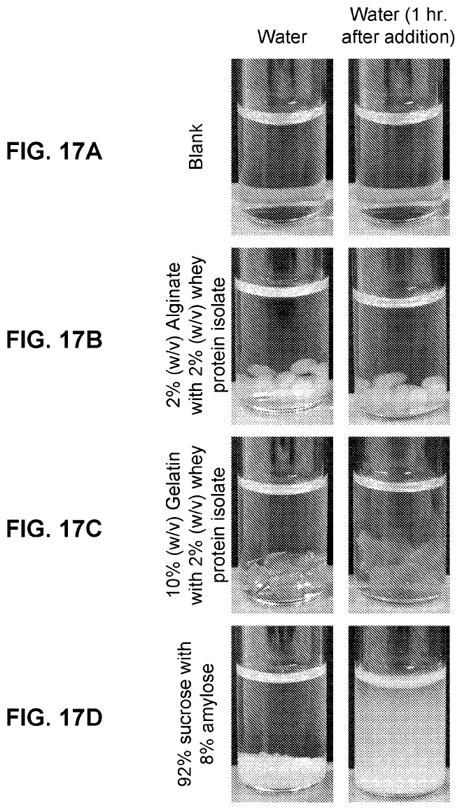

This example illustrates homogeneous mixtures of disclosed food composition(s) within food and/or beverage products (e.g., MRE, nutritional beverage, water) as demonstrated in FIGS. 16A-D. It is contemplated that non-limiting exemplary embodiments of food and beverage compositions (e.g., formulated ingestibles) can be homogeneously mixed with other food products such as freeze dried powder, protein powder, solid bars, domestic pet food (pellets), liquid shakes, pudding, etc. Homogenization can be achieved without additional processing aid or improved through addition of processing aid/excipients, through the use of mixing apparatuses such as a homogenizer, stand mixer, paddle blender, stir bar, spatula, etc. Without wishing to be bound by any particular theory, the present disclosure proposes that size characteristics and/or compositions of certain provided food composition(s) may surprisingly contribute desirable and/or useful attribute(s) to such particles, specifically including, for example, amenability to homogenous combination with other component(s). As shown in FIGS. 16B-D, incorporation of alginate beads, gelatin beads, each encapsulating whey protein isolate, and/or sucrose-encapsulating beads into MRE and Ensure is homogeneous and associated with minimal change in visual appearance. In certain embodiments, incorporation of food composition(s) within one or more food and/or beverage products is associated with structural changes. In one non-limiting example (FIGS. 17A-D), food composition(s) are shown to change morphology over a 1-hour incubation period, with gelatin and alginate beads exhibiting expansion and sucrose-encapsulating beads exhibiting dissolution.

### M. Example 13: Food Compositions Exhibiting Triggered Release

Controlled release of one or more food component(s) from a formulated food and/or beverage composition, in certain embodiments, is characterized as triggered release. The following example demonstrates controlled release of one or more food component(s) in response to a trigger.

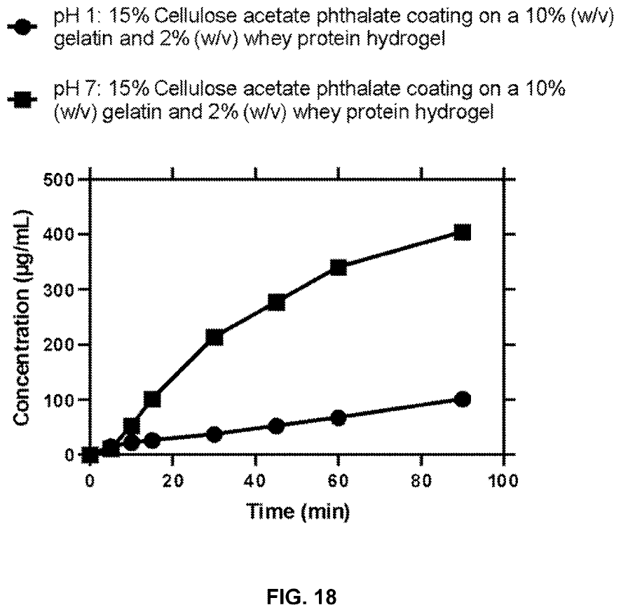

In one non-limiting example, whey protein-containing food composition(s) (2 cm³) coated with cellulose acetate phthalate (see Example 6) were added to a 15 mL conical centrifuge tube filled (12 mL) with simulated intestinal fluid (SIF) at pH 6.8 and a 15 mL conical centrifuge tube filled (12 mL) with simulated gastric fluid (SGF) at pH 1.2. The centrifuge tubes were allowed to rotate at 10 rpm at 20 °C and 100 μL samples were collected at 5, 10, 15, 30, 45, 60, and 90 minutes. Release of protein (e.g., whey protein and zein) was quantified by BCA assay at each time point to construct a release profile. In this non-limiting example, protein release is triggered, as shown in FIG. 18, by changes in pH, as negligible release is observed in SGF (pH 1.2) while constant release is observed in SIF (pH 6.8).

### N. Example 14: One or More Food Component(s) and/or Excipient Component(s) Establishes a Means of Controlling the Release of One or More Food Component(s)

As provided herein, one or more food and/or beverage composition(s) is characterized by controlled release of one or more food component(s). In some embodiments, one or more food component(s) and/or excipient component(s) establishes a means of controlling the release of one or more food component(s). In certain instances, the release rate of whey protein isolate from one or more food and/or beverage composition(s) comprising one or more food component(s) establishing a means of controlling release is reduced relative to food and/or beverage composition(s) comprising one or more food component(s) not establishing a means of controlling release. In certain preferred embodiments, the release of one or more food component(s) in one or more release environment(s) is measured to quantify establishment of a means of controlling release.

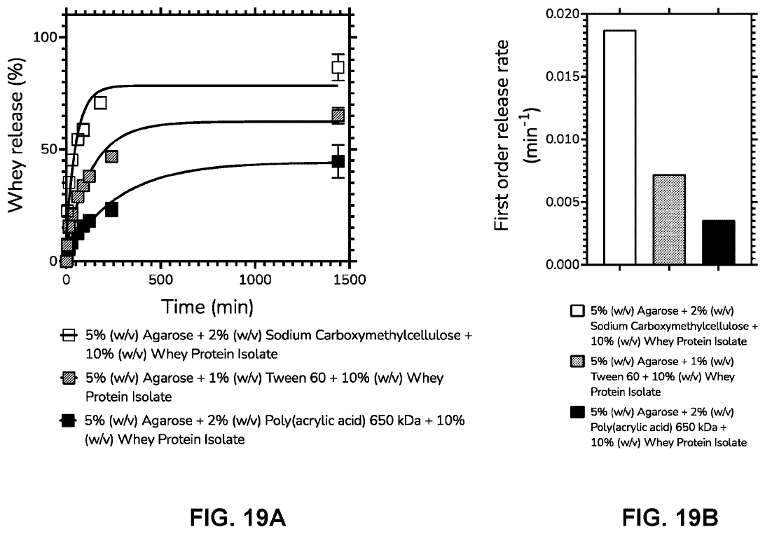

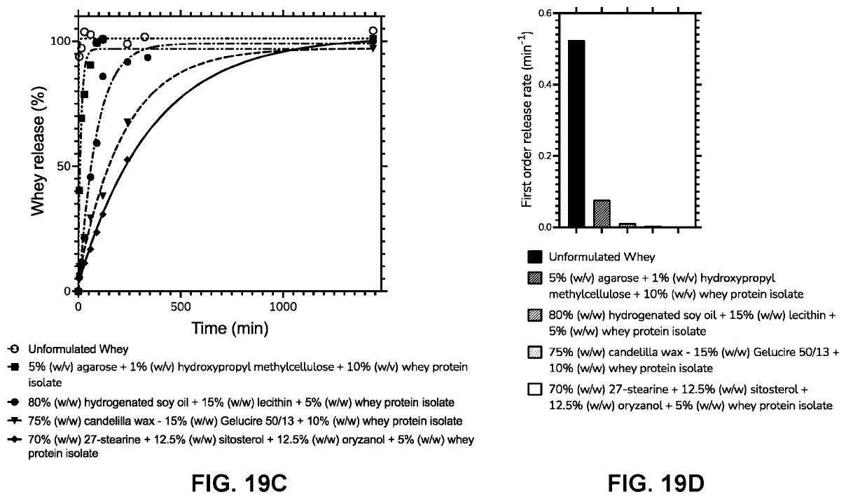

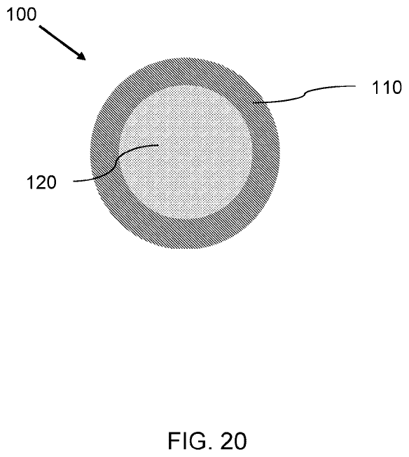

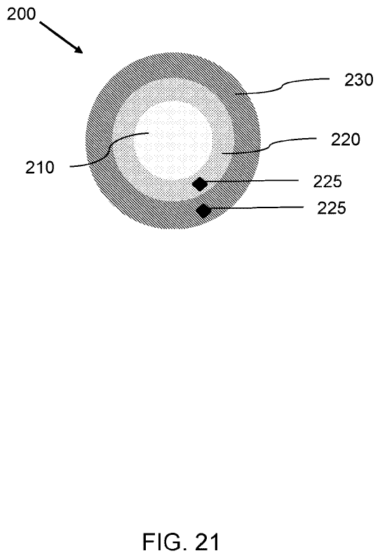

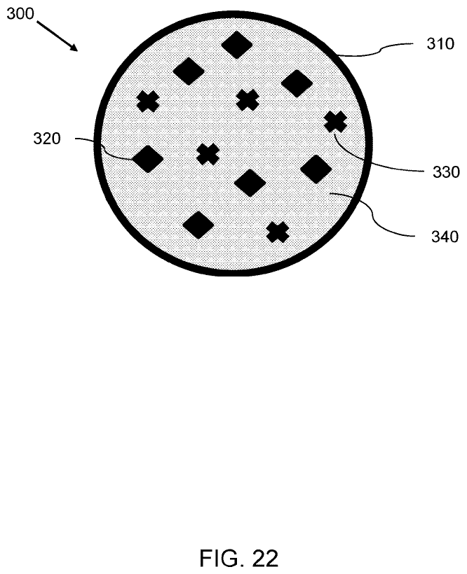

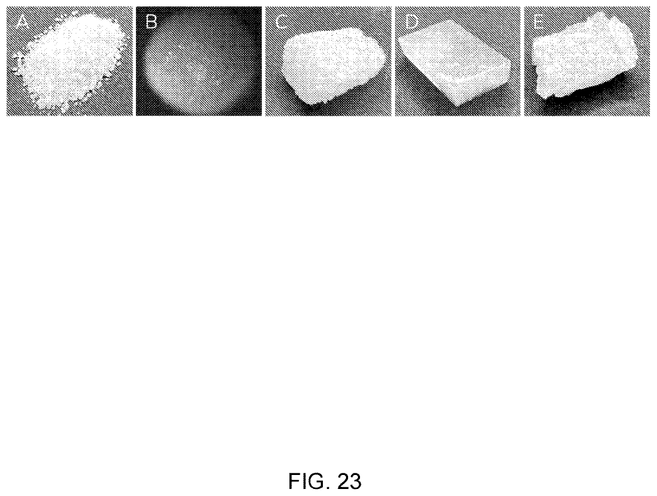

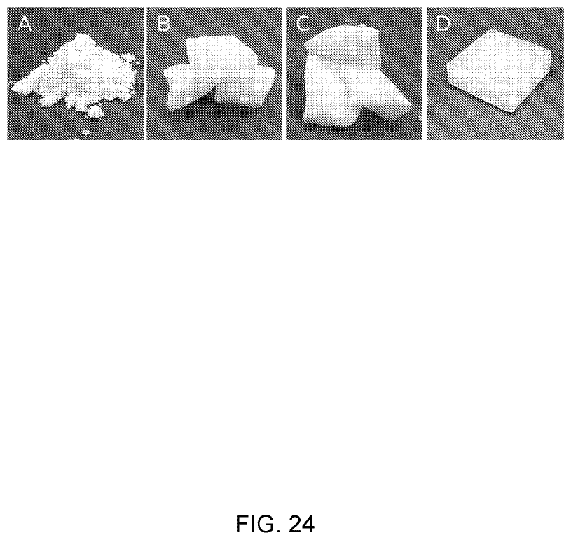

As illustrated in a non-limiting example, one or more food composition(s) further characterized as matrix preparations comprising 5% (w/v) agarose and 10% (w/v) whey protein isolate exhibit substantial differences in protein release depending on included excipient component(s) (FIG. 19A). For example, these exemplary matrix preparations further comprising 2% (w/v) sodium carboxymethylcellulose (white squares) exhibit nearly 75% release of loaded whey protein isolate over 24 hours, while preparations comprising 1% (w/v) Tween 60 (grey squares) or 2% (w/v) poly(acrylic acid) (black squares) exhibit only 60% and 45% release at 24 hours, respectively. Comparisons of release kinetics (FIG. 19B) indicate inclusion of 2% (w/v) poly(acrylic acid) substantially reduces whey protein isolate release rate to <0.005%/min relative to inclusion of 2% (w/v) sodium carboxymethylcellulose (>0.015%/min) in 3% (w/v) agarose matrix formulations. In another non-limiting example (FIG. 19C), formulation of whey in matrices comprising different matrix component(s) influences the release of whey, demonstrating that matrix component(s) are a means of controlling whey release. In this example, unformulated whey releases rapidly, with nearly 100% dissolution in under 5 minutes while 100% release of whey is prolonged to about 30 minutes when formulated in a matrix comprising agarose and hydroxypropyl methylcellulose. Similarly, formulation of whey protein in either hydrogenated oils, waxes, or oleogels further prolongs whey protein release from 30 minutes to almost 24 hours in the case of a matrix preparation comprising 27-stearine, sitosterol, and oryzanol. These differences in release rate are evident by a several orders of magnitude reduction in release rate constant (FIG. 19D) from unformulated whey (0.52%/min) to whey formulated in the provided matrix preparation(s) (as low as 0.0028%/min). This example demonstrates how matrix component(s) selection may be useful in tuning the controlled release of one or more food component(s) from one or more food composition(s).

### O. Example 15: Caloric and Macronutrient Constituents in Example Food Composition(s)

In one exemplary embodiment of the provided food and/or beverage composition(s), a food composition is comprised of one or more macronutrient(s), one or more micronutrient(s), and/or one or more excipient component(s).

For example, in one non-limiting instance, the provided food composition is comprised of a caloric content suitable for the needs of one or more animal(s) for a 24-hour period. For example, as presented in Table 2 in one non-limiting instance, the provided food composition is comprised of one or more of a protein, a carbohydrate, and/or a fat. For example, in one non-limiting instance, a provided food composition is comprised of a caloric content of 1500 kcal with 112 g of carbohydrate, 150 g of protein, 50 g of fat, 2.5 μg of vitamin B12, 15 μg of vitamin D, 15 mg of vitamin E. For example, in one non-limiting instance, a provided food composition is comprised of a caloric content of 2000 kcal with 250 g of carbohydrate, 100 g of protein, 67 g of fat, 2.5 μg of vitamin B12, 15 μg of vitamin D, 15 mg of vitamin E. For example, in one non-limiting instance, a provided food composition is comprised of a caloric content of 2500 kcal with 250 g of carbohydrate, 125 g of protein, 111 g of fat, 2.5 μg of vitamin B12, 15 μg of vitamin D, 15 mg of vitamin E. Therefore, the relative ratios of calories that are derived from carbohydrates vs. proteins vs. fats may vary from one composition to the next.

TABLE 2
Nutritional values of exemplary food composition(s).

| Composition | Carbohydrates (g) | Proteins (g) | Fats (g) | Calories (kcal) |
|---|---|---|---|---|
| 1 | 112 | 150 | 50 | 1500 |
| 2 | 250 | 100 | 67 | 2000 |
| 3 | 250 | 125 | 111 | 2500 |

### P. Example 16: Encapsulation of Carbohydrates

In certain embodiments, one or more food component(s) characterized as a carbohydrate is or are encapsulated in one or more core-shell preparations and/or matrix preparations. In one exemplary embodiment, one or more carbohydrate(s) is or are encapsulated in a core-shell preparation further characterized as a particle preparation.

For example, in one non-limiting instance, a food composition comprised of a carbohydrate (e.g., a solute component) further characterized as a monosaccharide is embedded within a carbohydrate (e.g., a matrix component) further characterized as a polysaccharide, demonstrating exemplary encapsulation of a carbohydrate. For example, in one non-limiting instance, a food composition comprised of a carbohydrate (e.g., a solute component) further characterized as a polysaccharide is embedded within a carbohydrate (e.g., a matrix component) further characterized as a polysaccharide, demonstrating exemplary encapsulation of a carbohydrate. For example, in one non-limiting instance, a food composition comprised of an encapsulated carbohydrate (e.g., a matrix preparation) is encapsulated by a polymer (e.g., excipient component) (e.g., a core-shell preparation). For example, in one non-limiting instance, a food composition comprised of an encapsulated carbohydrate (e.g., a matrix preparation) is encapsulated by a protein (e.g., a core-shell preparation). In one non-limiting instance, a core-shell preparation is further characterized as a particle preparation.

FIG. 4 illustrates a comparison between gross morphologies of unencapsulated (FIG. 4A) and encapsulated (FIGS. 4B-E) carbohydrates. For example, in FIG. 4B, sucrose is dispersed within a wet amylose matrix, the slurry sprayed into cool air to generate particles of controlled diameter. The encapsulation of sucrose within amylose is calculated to be 92%, on a dry weight basis. For example, in FIG. 4B, particles comprising encapsulated sucrose (92% loading, 1 mm diameter) are further coated (e.g., spray pan coating) with a 90% (v/v) solution of Zein with a colorant (e.g., excipient component). Brightfield micrographs reveal increased surface roughness and a red coloring, indicative of successful coating. For example, in FIG. 4C, 14 g of glucose is added to 6 mL of a stirring 5% (w/v) pectin solution held at 110 °C and the resulting mixture is stirred for 3 minutes, or until all glucose is dissolved. 1.0 mL of 1 M citric acid in distilled water is added to the stirring mixture, which is further mixed for 15 seconds before pouring into molds coated with loose glucose crystals and setting for 1 hour at 20 °C. For example, in FIG. 4D, 100 mg of inulin (from dahlia tubers) is dissolved in 5 mL of distilled water and warmed to 60 °C while stirring. 5 mL of a 5% (w/v) solution of agarose at 130 °C is added to the stirring mixture, which is further mixed for 15 seconds before pouring into molds and setting for 1 hour at 20 °C. For example, in FIG. 4E, 10 mL of a stirring 20% (w/v) suspension of calcium caseinate is added to 10 mL of a stirring 60 °C mixture of 5% (w/v) solution of sodium alginate and 2% (w/v) inulin (from dahlia tuber). The resulting mixture is allowed to stir for 15 seconds before pouring into molds and setting for 1 hour at 20 °C. Unlike the free-flowing powder depicted in FIG. 4A, the formulations generated using the methods of manufacture outlined for FIG. 4C-E are cohesive particle preparation(s) indicating successful encapsulation.

### Q. Example 17: Encapsulation of Proteins

In certain embodiments, one or more food component(s) characterized as a protein is or are encapsulated in one or more core-shell preparations and/or matrix preparations. In one exemplary embodiment, one or more protein(s) is or are encapsulated in a core-shell preparation further characterized as a particle preparation.

For example, in one non-limiting instance, a food composition comprised of a protein (e.g., a solute component) is embedded within a lipid (e.g., a matrix component), demonstrating exemplary encapsulation of a protein. For example, in one non-limiting instance, a food composition comprised of a protein (e.g., a solute component) is embedded within a carbohydrate (e.g., a matrix component) further characterized as a polysaccharide, demonstrating exemplary encapsulation of a protein. For example, in one non-limiting instance, a food composition comprised of an encapsulated protein (e.g., a matrix preparation) is encapsulated by a polymer (e.g., excipient component) (e.g., a core-shell preparation). For example, in one non-limiting instance, a food composition comprised of an encapsulated protein (e.g., a matrix preparation) is encapsulated by a carbohydrate (e.g., a core-shell preparation). In one non-limiting instance, a core-shell preparation is further characterized as a particle preparation.

FIG. 24 illustrates a comparison between gross morphologies of unencapsulated (FIG. 24A, whey protein isolate) and encapsulated (FIGS. 24B-D, encapsulated) protein. For example, in FIG. 24B, whey protein isolate powder is dispersed at 10000 rpm using a high-shear homogenizer within molten beeswax and the resulting dispersion is poured into a mold to set for 1 hour at 20 °C. For example, in FIG. 24C, whey protein isolate powder is dispersed at 10000 rpm using a high-shear homogenizer within molten hydrogenated soy oil and the resulting dispersion is poured into a mold to set for 1 hour at 20 °C. For example, in FIG. 24D, 5 ml of 5% (w/v) agarose solution at 130 °C is mixed with 5 mL of a solution comprising 20% (w/v) whey protein isolate and 2% (w/v) chitosan) at pH 5 and 60 °C. The resulting mixture is allowed to stir for 15 seconds before pouring into molds and setting for 1 hour at 20 °C. Unlike the free-flowing powder depicted in FIG. 24A, the formulations generated using the methods of manufacture outlined for FIG. 24B-D are cohesive particle preparation(s) indicating successful encapsulation.

### R. Example 18: Encapsulation of Lipids

In certain embodiments, one or more food component(s) characterized as a lipid is or are encapsulated in one or more core-shell preparations and/or matrix preparations. In one exemplary embodiment, one or more lipid(s) is or are encapsulated in a core-shell preparation further characterized as a particle preparation.

For example, in one non-limiting instance, a food composition comprised of a lipid (e.g., a solute component) is embedded within a lipid (e.g., a matrix component), demonstrating exemplary encapsulation of a lipid. For example, in one non-limiting instance, a food composition comprised of a lipid (e.g., a solute component) is embedded within a carbohydrate (e.g., a matrix component) further characterized as a polysaccharide, demonstrating exemplary encapsulation of a lipid. For example, in one non-limiting instance, a food composition comprised of an encapsulated lipid (e.g., a matrix preparation) is encapsulated by a polymer (e.g., excipient component) (e.g., a core-shell preparation). For example, in one non-limiting instance, a food composition comprised of an encapsulated lipid (e.g., a matrix preparation) is encapsulated by a carbohydrate (e.g., a core-shell preparation). In one non-limiting instance, a core-shell preparation is further characterized as a particle preparation.

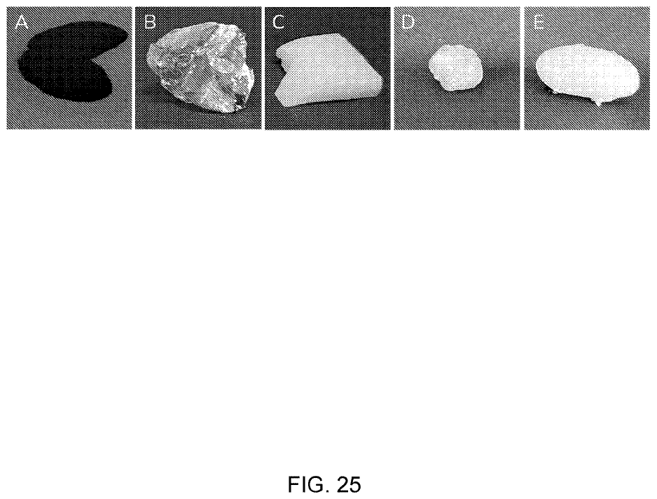

FIG. 25 illustrates a comparison between gross morphologies of unencapsulated (FIG. 25A, oleic acid) and encapsulated (FIGS. 25B-E, encapsulated) lipid. For example, in FIG. 25B, 8 mL of oleic acid is heated, while stirring, to 130 °C, followed by the addition of 2.0 g of ethyl cellulose (100 cP). The mixture is kept stirring at 130 °C for 10 minutes, or until all solids are dissolved, and the resulting clear solution is then poured into an aluminum pan to set at 20 °C for 1 hour. For example, in FIG. 25C, 8 mL of oleic acid is heated, while stirring, to 90 °C, followed by the addition of 2.0 g of beeswax. The mixture is kept stirring at 90 °C for 10 minutes, or until all solids are dissolved, and the resulting clear solution is poured into an aluminum pan to set at 20 °C for 1 hour. For example, in FIG. 25D, 6.5 mL of oleic acid is heated, while stirring, to 130 °C, followed by the addition of 1.0 g of carnauba wax and 1.5 g of ethyl cellulose. The mixture is kept stirring at 130 °C for 10 minutes, or until all solids are dissolved, and 1.0 g of whey protein isolate is added. After 15 seconds of stirring, the suspension is poured into an aluminum pan and allowed to set at 20 °C for 1 hour. The resulting waxy solid is then immersed and wrapped in an interfacial thin film comprised of chitosan-polyphosphate and allowed to dry at 50 °C for 6 hours. For example, in FIG. 25E, core component(s) prepared as described in FIG. 25D are instead coated by dipping into a 15% (w/v) solution of cellulose acetate phthalate in acetone and drying under air at 40 °C. Unlike the loose oil depicted in FIG. 25B, the formulations generated using the methods of manufacture outlined for FIG. 25B-E are solid, cohesive particle preparation(s) indicating successful encapsulation.

### S. Example 19: Release of Carbohydrates from One or More Food Composition(s)

In certain embodiments, one or more food component(s) characterized as a carbohydrate is or are encapsulated in one or more core-shell preparations and/or matrix preparations. In certain embodiments, the encapsulation of one or more carbohydrate(s) in one or more matrix and/or core-shell preparation(s) is further characterized by the release of encapsulated carbohydrate(s) in one or more release environment(s). In some instances, the release profile(s), as provided herein, of carbohydrate(s) encapsulated in one or more matrix and/or core-shell preparation(s) illustrate controlled release of carbohydrate(s).

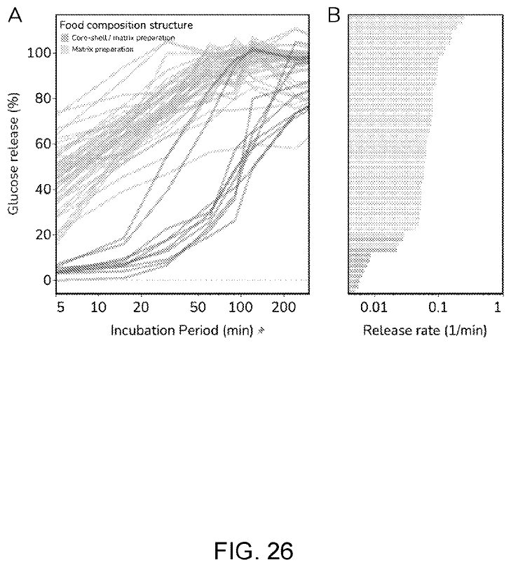

In some non-limiting instances, one or more food composition(s) comprising carbohydrate(s) further characterized as core-shell preparation(s) and/or matrix preparation(s) provide a means of controlling carbohydrate release. In certain embodiments, the selection of one or more core component(s), shell component(s), and/or matrix component(s) and their relative concentration(s) provide a means of controlling release of carbohydrate(s). In one non-limiting embodiment (FIG. 26), the average release profiles (n=3) of an exemplary carbohydrate encapsulated within food composition(s) comprising distinct core component(s), shell component(s), and/or matrix component(s) within a release environment comprising phosphate buffered saline, pH 7.4 at 37 °C are depicted. In this example, exemplary release profile(s) are provided by food composition(s) further characterized as matrix preparation(s), core-shell preparation(s), and/or combinations of matrix and core-shell preparation(s). In some instances, the release profile(s) provided by one or more food composition(s) changes in different release environment(s). In some instances, the release profile(s) provided by one or more food composition(s) remains constant in different release environment(s). In certain preferred embodiments, the release profile(s) provided by one or more food composition(s) illustrated in FIG. 26 enable the selection of food composition(s) conferring desirable release profile(s) upon one or more carbohydrates, for example, to reduce meal frequency in one or more mammal(s).

In some non-limiting instances, one or more food composition(s) providing for 80% release of encapsulated carbohydrate within 30 minutes is or may be advantageous. In some non-limiting instances, one or more food composition(s) providing for 80% release of encapsulated carbohydrate within 100 minutes is or may be advantageous. In some non-limiting instances, one or more food composition(s) providing for 80% release of encapsulated carbohydrate within 240 minutes is or may be advantageous.

As shown in FIG. 26, the time required to reach 80% (w/w) release of encapsulated carbohydrate(s) can vary from ~7 minutes to >280 min depending on the concentration(s) and/or identity of one or more core component(s), shell component(s), and/or matrix component(s) comprising one or more food composition(s). A complete list of exemplary food composition(s), their associated core component(s), shell component(s) and/or matrix component(s), their respective concentration(s), and release rates are provided in Appendix 1. In some cases, the exemplary release profiles provided in FIG. 26 aid in the selection of desirable food composition structure (e.g., core-shell preparation, matrix preparation, particle preparation). In some cases, the exemplary release profiles provided in FIG. 26 aid in the selection and relative concentration(s) of one or more core component(s), shell component(s), and/or matrix component(s).

As shown in FIG. 26, the release rate of glucose from one or more exemplary food composition(s) varies substantially by food composition structure (e.g., core-shell preparation, matrix preparation, particle preparation). Core-shell preparations wherein one or more core component(s) further comprise a matrix preparation generally offer slower release kinetics (<0.03 min⁻¹) relative to uncoated matrix preparations (>0.03 min⁻¹).

### T. Example 20: Release of Proteins from One or More Food Composition(s)

In certain embodiments, one or more food component(s) characterized as a protein is or are encapsulated in one or more core-shell preparations and/or matrix preparations. In certain embodiments, the encapsulation of one or more protein(s) in one or more matrix and/or core-shell preparation(s) is further characterized by the release of encapsulated protein(s) in one or more release environment(s). In some instances, the release profile(s), as provided herein, of protein(s) encapsulated in one or more matrix and/or core-shell preparation(s) illustrate controlled release of protein(s).

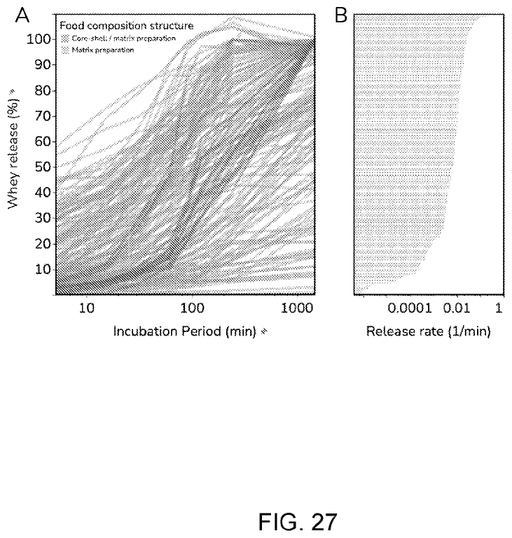

In some non-limiting instances, one or more food composition(s) comprising protein(s) further characterized as core-shell preparation(s) and/or matrix preparation(s) provide a means of controlling protein release. In certain embodiments, the selection of one or more core component(s), shell component(s), and/or matrix component(s) and their relative concentration(s) provide a means of controlling release of protein(s). In one non-limiting embodiment (FIG. 27), the average release profiles (n=3) of an exemplary protein encapsulated within food composition(s) comprising distinct core component(s), shell component(s), and/or matrix component(s) within a release environment comprising phosphate buffered saline, pH 7.4 at 37 °C are depicted. In this example, exemplary release profile(s) are provided by food composition(s) further characterized as matrix preparation(s), core-shell preparation(s), and/or combinations of matrix and core-shell preparation(s). In some instances, the release profile(s) provided by one or more food composition(s) changes in different release environment(s). In some instances, the release profile(s) provided by one or more food composition(s) remains constant in different release environment(s). In certain preferred embodiments, the release profile(s) provided by one or more food composition(s) illustrated in FIG. 27 enable the selection of food composition(s) conferring desirable release profile(s) upon one or more carbohydrates, for example, to reduce meal frequency in one or more mammal(s).

In some non-limiting instances, one or more food composition(s) providing for 80% release of encapsulated protein within 60 minutes is or may be advantageous. In some non-limiting instances, one or more food composition(s) providing for 80% release of encapsulated protein within 200 minutes is or may be advantageous. In some non-limiting instances, one or more food composition(s) providing for 80% release of encapsulated protein within 1000 minutes is or may be advantageous.

As shown in FIG. 27, the time required to reach 80% (w/w) release of encapsulated protein(s) can vary from ~30 minutes to >1000 min depending on the concentration(s) and/or identity of one or more core component(s), shell component(s), and/or matrix component(s) comprising one or more food composition(s). A complete list of exemplary food composition(s), their associated core component(s), shell component(s) and/or matrix component(s), their respective concentration(s), and release rates are provided in Appendix 1. In some cases, the exemplary release profiles provided in FIG. 27 aid in the selection of desirable food composition structure (e.g., core-shell preparation, matrix preparation, particle preparation). In some cases, the exemplary release profiles provided in FIG. 27 aid in the selection and relative concentration(s) of one or more core component(s), shell component(s), and/or matrix component(s).

As shown in FIG. 27, the release rate of protein from one or more exemplary food composition(s) remains consistent regardless of food composition structure (e.g., core-shell preparation, matrix preparation, particle preparation). Core-shell preparations wherein one or more core component(s) further comprise a matrix preparation offer comparable release kinetics (0.002-0.02 min⁻¹) relative to the majority of exemplary uncoated matrix preparations (0.001-0.03 min⁻¹).

### U. Example 21: Release of Lipids from One or More Food Composition(s)

In certain embodiments, one or more food component(s) characterized as a lipid is or are encapsulated in one or more core-shell preparations and/or matrix preparations. In certain embodiments, the encapsulation of one or more lipid(s) in one or more matrix and/or core-shell preparation(s) is further characterized by the release of encapsulated lipid(s) in one or more release environment(s). In some instances, the release profile(s), as provided herein, of lipid(s) encapsulated in one or more matrix and/or core-shell preparation(s) illustrate controlled release of lipid(s).

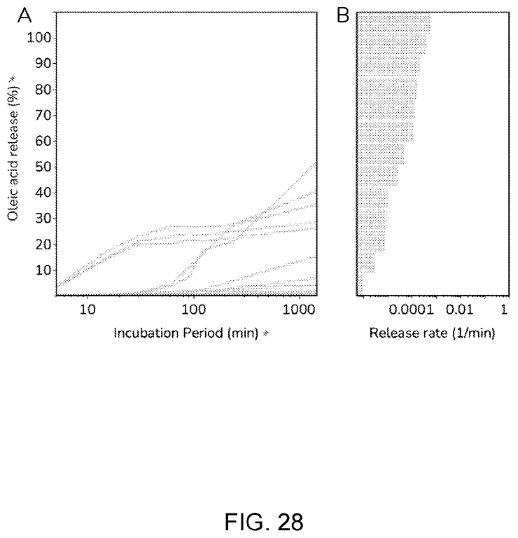

In some non-limiting instances, one or more food composition(s) comprising lipid(s) further characterized as core-shell preparation(s) and/or matrix preparation(s) provide a means of controlling lipid release. In certain embodiments, the selection of one or more core component(s), shell component(s), and/or matrix component(s) and their relative concentration(s) provide a means of controlling release of lipid(s). In one non-limiting embodiment (FIG. 28), the average release profiles (n=3) of an exemplary lipid encapsulated within food composition(s) comprising distinct core component(s), shell component(s), and/or matrix component(s) within a release environment comprising phosphate buffered saline, pH 7.4 at 37 °C are depicted. In this example, exemplary release profile(s) are provided by food composition(s) further characterized as matrix preparation(s), core-shell preparation(s), and/or combinations of matrix and core-shell preparation(s). In some instances, the release profile(s) provided by one or more food composition(s) changes in different release environment(s). In some instances, the release profile(s) provided by one or more food composition(s) remains constant in different release environment(s). In certain preferred embodiments, the release profile(s) provided by one or more food composition(s) illustrated in FIG. 28 enable the selection of food composition(s) conferring desirable release profile(s) upon one or more carbohydrates, for example, to reduce meal frequency in one or more mammal(s).

In some non-limiting instances, one or more food composition(s) providing for 20% release of encapsulated lipid within 20 minutes is or may be advantageous. In some non-limiting instances, one or more food composition(s) providing for 20% release of encapsulated lipid within 200 minutes is or may be advantageous. In some non-limiting instances, one or more food composition(s) providing for 20% release of encapsulated lipid within 1000 minutes is or may be advantageous.

As shown in FIG. 28, the time required to reach 20% (w/w) release of encapsulated lipid(s) can vary from ~30 minutes to >1000 min depending on the concentration(s) and/or identity of one or more core component(s), shell component(s), and/or matrix component(s) comprising one or more food composition(s). A complete list of exemplary food composition(s), their associated core component(s), shell component(s) and/or matrix component(s), their respective concentration(s), and release rates are provided in Appendix 1. In some cases, the exemplary release profiles provided in FIG. 28 aid in the selection of desirable food composition structure (e.g., core-shell preparation, matrix preparation, particle preparation). In some cases, the exemplary release profiles provided in FIG. 28 aid in the selection and relative concentration(s) of one or more core component(s), shell component(s), and/or matrix component(s).

As shown in FIG. 28, the release rate of lipid from one or more exemplary food composition(s) characterized as matrix preparation(s) varies depending on selected matrix component(s). Exemplary matrix preparation(s) comprising ethyl cellulose confer a release rate of ~0.001 min⁻¹, while matrix preparation(s) comprising sitosterol confer a release rate of ~0.000001 min⁻¹.

### V. Example 22: Encapsulation and Release of Food Component(s)

In certain embodiments, one or more food component(s) characterized as a lipid is or are encapsulated in one or more core-shell preparations and/or matrix preparations. In certain embodiments, the encapsulation of one or more lipid(s) in one or more matrix and/or core-shell preparation(s) is further characterized by the release of encapsulated lipid(s) in one or more release environment(s). In some instances, the release profile(s), as provided herein, of lipid(s) encapsulated in one or more matrix and/or core-shell preparation(s) illustrate controlled release of lipid(s). As illustrated in FIG. 6 and FIG. 28, an exemplary lipid encapsulated in provided food composition(s) may be oleic acid. Additionally, in some embodiments, linoleic acid, docosahexaenoic acid, and/or eicosapentaenoic acid may be encapsulated and exhibit controlled release within and from provided food composition(s), respectively.

In certain embodiments, one or more food component(s) characterized as a protein is or are encapsulated in one or more core-shell preparations and/or matrix preparations. In certain embodiments, the encapsulation of one or more protein(s) in one or more matrix and/or core-shell preparation(s) is further characterized by the release of encapsulated protein(s) in one or more release environment(s). In some instances, the release profile(s), as provided herein, of protein(s) encapsulated in one or more matrix and/or core-shell preparation(s) illustrate controlled release of protein(s). As illustrated in FIG. 24 and FIG. 27, an exemplary protein encapsulated in provided food composition(s) may be whey protein. Additionally, in some embodiments, gelatin, collagen, casein, oat protein isolate, soy protein isolate, and/or pea protein isolate may be encapsulated and exhibit controlled release within and from provided food composition(s), respectively.

In certain embodiments, one or more food component(s) characterized as a polyphenol is or are encapsulated in one or more core-shell preparations and/or matrix preparations. In certain embodiments, the encapsulation of one or more polyphenol(s) in one or more matrix and/or core-shell preparation(s) is further characterized by the release of encapsulated polyphenol(s) in one or more release environment(s). In some instances, the release profile(s), as provided herein, of polyphenol(s) encapsulated in one or more matrix and/or core-shell preparation(s) illustrate controlled release of polyphenol(s).

For example, in one non-limiting instance, a food composition comprised of a polyphenol (e.g., a solute component) is embedded within a protein (e.g., a shell component), demonstrating exemplary encapsulation of a polyphenol.

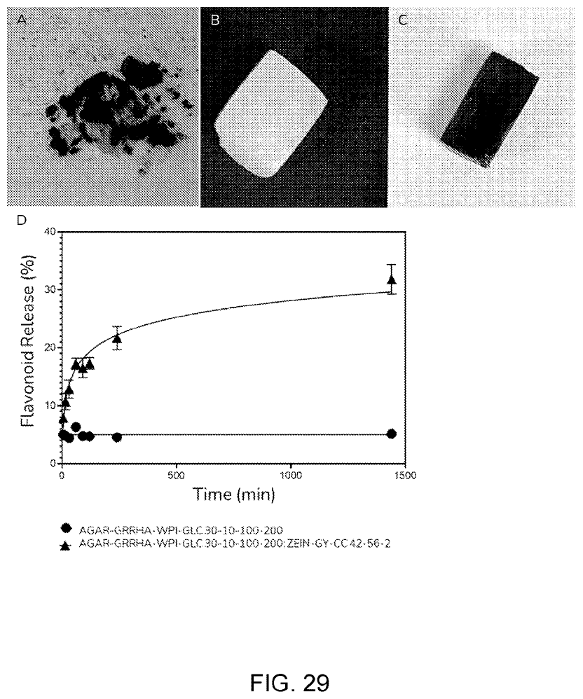

FIG. 29 illustrates a comparison between gross morphologies of unencapsulated (FIG. 29A, cyanidin chloride) and encapsulated (FIG. 29C, encapsulated) polyphenol. For example, an ethanol solution (90% (w/v)) of zein is prepared with the addition of 1% (w/w) cyanidin chloride to form a purple solution, the purple solution then applied to a matrix preparation comprising agarose and glucose (FIG. 29B) via paint coating. Unlike the loose powder depicted in FIG. 29A, the formulations generated using the methods of manufacture outlined are solid, cohesive particle preparation(s) with a smooth coating, indicating successful encapsulation.

In one non-limiting example, encapsulated polyphenol food composition(s) demonstrate controlled release. For example, FIG. 29D illustrates a comparison in flavonoid release from a formulation containing encapsulated cyanidin chloride (3% (w/w) agarose, 1% (w/w) glycyrrhetinic acid, 10% (w/w) whey protein isolate, and 20% (w/w) glucose in the core, 42% (w/w) Zein, 56% (w/w) glycerol, and 2% (w/w) cyanidin chloride in the shell) (black triangles) and a formulation containing no cyanidin chloride (3% (w/w) agarose, 1% (w/w) glycyrrhetinic acid, 10% (w/w) whey protein isolate, and 20% (w/w) glucose in the core) (black circles). In this example, flavonoid releases from the exemplary food composition(s), reaching 30% release by 24 hours in phosphate buffered saline, pH 7.4.

In certain embodiments, one or more food component(s) characterized as a carbohydrate is or are encapsulated in one or more core-shell preparations and/or matrix preparations. In certain embodiments, the encapsulation of one or more carbohydrate(s) in one or more matrix and/or core-shell preparation(s) is further characterized by the release of encapsulated carbohydrate(s) in one or more release environment(s). In some instances, the release profile(s), as provided herein, of carbohydrate(s) encapsulated in one or more matrix and/or core-shell preparation(s) illustrate controlled release of carbohydrate(s). As illustrated in FIG. 4 and FIG. 26, an exemplary carbohydrate encapsulated in provided food composition(s) may be glucose. Additionally, in some embodiments, sucrose, tagatose, psicose, and/or isomaltulose may be encapsulated and exhibit controlled release within and from provided food composition(s), respectively.

For example, in one non-limiting instance, a food composition comprised of inulin (e.g., a solute component) is embedded within a carbohydrate (e.g., a matrix component), demonstrating exemplary encapsulation of a carbohydrate.

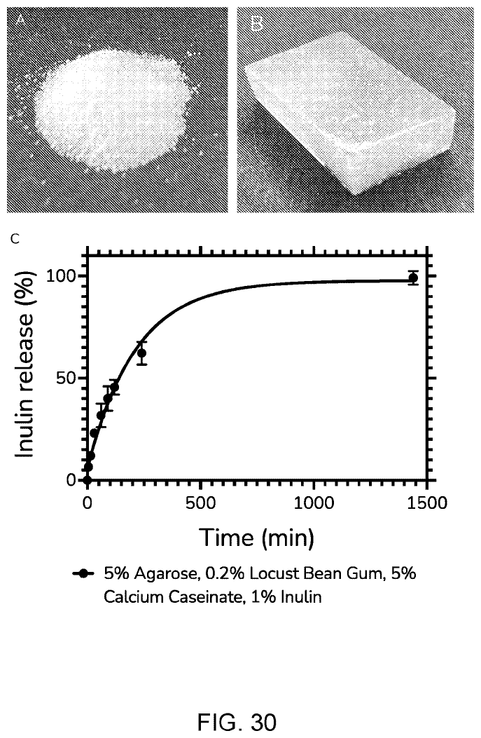

FIG. 30 illustrates a comparison between gross morphologies of unencapsulated (FIG. 30A, inulin) and encapsulated (FIG. 30B, encapsulated) carbohydrate. For example, an aqueous solution of 10% (w/w) inulin and 20% (w/w) glucose is prepared, followed by the addition of 3% (w/w) agarose powder. The mixture is heated to 75 °C to dissolve the agarose, which, upon cooling, forms a solid matrix preparation. Unlike the loose powder depicted in FIG. 30A, the formulations generated using the methods of manufacture outlined are solid, cohesive particle preparation(s) (11B), indicating successful encapsulation.

In one non-limiting example, encapsulated carbohydrate food composition(s) demonstrate controlled release. For example, FIG. 30C illustrates a carbohydrate release from a formulation containing encapsulated inulin. In this example, inulin releases from the exemplary food composition(s) (5% (w/w) agarose, 0.2% (w/w) locust bean gum, 5% (w/w) calcium caseinate, and 1% (w/w) inulin), reaching 100% release by 24 hours in phosphate buffered saline, pH 7.4.

In certain embodiments, one or more food component(s) characterized as a ketone is or are encapsulated in one or more core-shell preparations and/or matrix preparations. In certain embodiments, the encapsulation of one or more ketone(s) in one or more matrix and/or core-shell preparation(s) is further characterized by the release of encapsulated ketone(s) in one or more release environment(s). In some instances, the release profile(s), as provided herein, of ketone(s) encapsulated in one or more matrix and/or core-shell preparation(s) illustrate controlled release of ketone(s). In some embodiments, 3-hydroxybutyrate, acetoacetic acid, and/or 3-hydroxybutyl-3-hydroxybutyrate may be encapsulated and exhibit controlled release within and from provided food composition(s), respectively.

### W. Example 23: Cross-Sectional Morphology of One or More Food Composition(s)

In certain embodiments of the present disclosure, one or more food composition(s) is further characterized as matrix preparation(s) and/or core-shell preparation(s). In some non-limiting instances, microscopy is useful to illustrate the micro-scale morphology of one or more matrix preparation(s) and/or core-shell preparation(s). For example, in some instances, microscopy is or may be useful to quantify and/or qualify gross characteristics, surface characteristics, and/or cross-sectional characteristics of one or more food composition(s).

In some non-limiting instances, quantification and/or qualification of gross characteristics is or may refer to shape, morphology, and/or diameter of one or more particle preparation(s). In some non-limiting instances, quantification and/or qualification of surface characteristics is or may refer to color, texture, and/or extent of surface coating of one or more particle preparation(s). In some non-limiting instances, quantification and/or qualification of cross-sectional characteristics is or may refer to coating thickness, spatial arrangement, homogeneity, and/or porosity of one or more particle preparation(s).

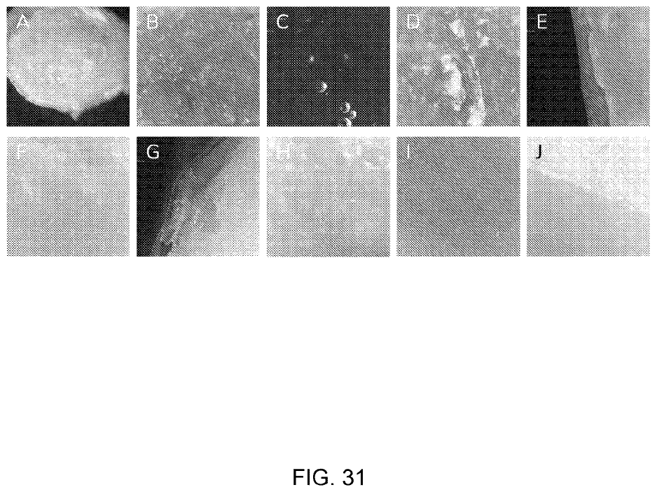

In some non-limiting instances, depicted in FIG. 31, cross-sectional micrographs of one or more food composition(s) enables quantification and/or qualification of gross, surface, and/or cross-sectional characteristics. For example, the spatial arrangement, coating thickness, and extent of surface coating of a core-shell preparation comprising sucrose, amylose, and Zein are clearly illustrated in the micrograph of FIG. 31A. For example, the porosity of a matrix preparation comprising inulin and alginate is clearly illustrated in the micrograph of FIG. 31B. For example, the color, homogeneity, and lack of porosity of a matrix preparation comprising inulin and agarose are clearly illustrated in the micrograph of FIG. 31C. For example, the spatial arrangement, porosity, and color of a core-shell preparation comprising a core component further characterized as a matrix of glucose, agarose, and inulin, coated with a shell component of cellulose acetate phthalate are clearly illustrated in the micrograph of FIG. 31D. For example, the spatial arrangement, color, extent of coating, and coating thickness of a core-shell preparation comprising a core component further characterized as a matrix of whey protein isolate and fully hydrogenated soy oil, coated with a shell component of cellulose acetate phthalate are clearly illustrated in the micrograph of FIG. 31E. For example, the color, homogeneity, and lack of porosity of a matrix formulation comprising whey protein isolate and beeswax are clearly illustrated in the micrograph of FIG. 31F. For example, the spatial arrangement, extent of coating, and coating thickness of a core-shell preparation comprising a core component further characterized as a matrix of whey protein isolate and agarose, coated with a shell component of cellulose acetate phthalate are clearly illustrated in the micrograph of FIG. 31G. For example, the color and homogeneity of a matrix preparation comprising oleic acid and ethyl cellulose are clearly illustrated in the micrograph of FIG. 31H. For example, the color and homogeneity of a matrix preparation comprising oleic acid and carnauba wax are clearly illustrated in the micrograph of FIG. 31I. For example, the color, homogeneity, lack of porosity, spatial arrangement, extent of coating, and coating thickness of a core-shell preparation comprising a core component further characterized as a matrix preparation comprising whey protein isolate, oleic acid, ethyl cellulose, and carnauba wax encapsulated in a shell component of cellulose acetate phthalate, are clearly illustrated in the micrograph of FIG. 31J.

### X. Example 24: Exemplary Coating Formulation Protocols

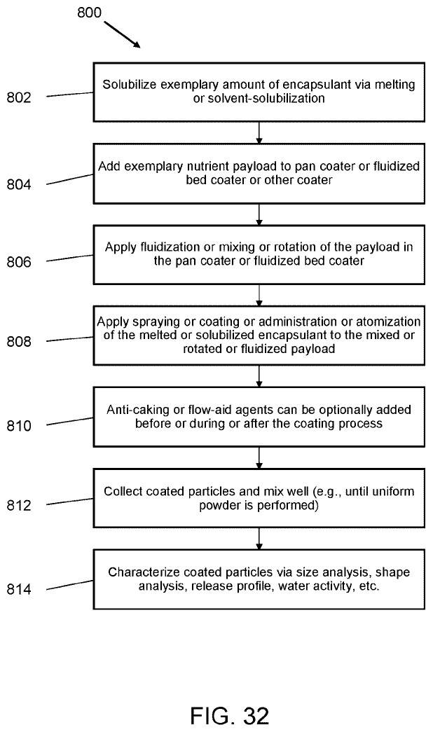

This example describes two non-limiting processes of arranging one or more food component(s) as a shell component to one or more food component(s) characterized as a core component via spray pan coating and/or fluidized bed spray coating. A schematic of an exemplary coating procedure, method, or protocol 800 is presented in FIG. 32. At step 802, the method 800 may include solubilizing an exemplary amount of encapsulant via melting or solvent-solubilization. At step 804, the method 800 may include adding an exemplary nutrient payload to pan coater or fluidized bed coater or other coater. At step 806, the method 800 may include applying fluidization or mixing or rotation of the payload in the pan coater or fluidized bed coater. At step 808, the method 800 may include applying spraying or coating or administration or atomization of the melted or solubilized encapsulant to the mixed, rotated and/or fluidized payload. At step 810, the method 800 may include adding anti-caking or flow-aid agents before, during and/or after the coating process. At step 812, the method 800 may include collecting the coated particles and thoroughly mixing (e.g., until uniform powder is achieved). At step 814, the method 800 may include characterizing the coated particles via size analysis, shape analysis, release profile, water activity, etc.

In one non-limiting example, food composition(s) are prepared in core-shell preparations using the procedure described below. Particle preparations comprising sucrose encapsulated in amylose (10 g) are coated using a spray pan coater with an inlet air temperature of 80 °C, pan temperature of 70 °C, rotation speed of 2 Hz, and spray rate of 0.5 mL/s. A 10% (w/v) ethanolic (90% ethanol) solution of Zein with 1% (v/v) Propylene Glycol and 0.5% (w/v) Talc powder is applied as a thin film over 5 minutes to the encapsulated sucrose. The volume-normalized weight gain due to coating is 120%. The concentration of formulated food product in this embodiment, on a dry weight basis, is 100% (w/w).

Whey protein isolate powder (100 g) is coated using a fluidized bed spray coater (Glatt) with a 67 °C inlet temperature, 45 °C outlet temperature, a spray rate of 3 g/min, and a flow rate of 25 mL/min. A 20% (w/v) aqueous suspension of ethyl cellulose is applied as a thin film over 5 min to the fluidized whey protein powder. The volume-normalized weight gain due to coating is 110%. The concentration of formulated food product in this embodiment is 100% (w/w).

### Y. Example 25: Core-Shell Preparation(s) as a Means of Controlling the Release of One or More Food Component(s)

In certain embodiments, the spatial arrangement of one or more food component(s) establishes a means of controlling the release of one or more food component(s). In certain embodiments, the spatial arrangement of one or more food component(s) comprising one or more food composition(s) is further characterized as a matrix preparation and/or a core-shell preparation. In some non-limiting instances, the spatial arrangement of one or more food composition(s) further characterized as a core-shell preparation establishes a means of controlling the release of one or more food component(s) from one or more food composition(s).

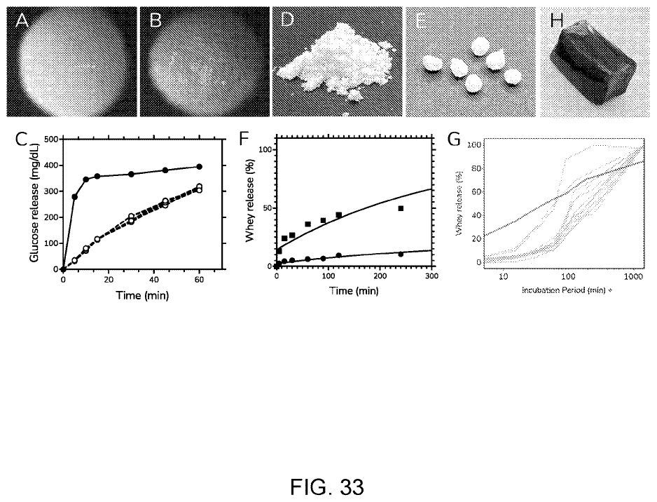

For example, in one non-limiting instance, a food composition comprised of a monosaccharide (e.g., sucrose) is embedded within a polysaccharide (e.g., amylose), further characterized as a matrix preparation. This matrix preparation, depicted in FIG. 33A, is subsequently coated with a solution of 10% (w/v) Zein, 1.5% (w/v) propylene glycol, and 2% (w/v) glycerol monostearate in a 90% (v/v) ethanolic solution using the methodology outlined in Example 9. Without wishing to be bound by any particular theory, it is contemplated that the applied shell component(s) comprising Zein, depicted in FIG. 33B, confer water-resistance towards one or more food composition(s) and reduce release. As shown in FIG. 33C, Zein-coated sucrose particle preparation(s) (denoted by empty circles) exhibit slower release than uncoated sucrose particle preparation(s) (denoted by filled circles) over a 60 minute period in 10 mM phosphate buffered saline pH 7.4.

For example, in one non-limiting instance, a food composition comprised of a protein (e.g., whey protein isolate, FIG. 33D) is encapsulated within a polysaccharide (e.g., chitosan polyphosphate), further characterized as a core-shell preparation (FIG. 33E). In this non-limiting example, a 1.25% (w/v) chitosan solution is prepared in 1% acetic acid in distilled water, followed by the addition of 10% (w/v) whey protein isolate. The resulting viscous solution is added dropwise to a 30% (w/v) solution of sodium hexametaphosphate at room temperature; formed particles are allowed to cross-link for 10 minutes and separated from the aqueous medium by filtration. The gelatinous chitosan polyphosphate particles comprising whey protein isolate are subsequently dried at 50 °C for 4 hours to yield hard, spherical particles (FIG. 33E). As shown in FIG. 33F, a shell component comprising chitosan polyphosphate exhibits slower release of encapsulated whey protein isolate in simulated gastric fluid (filled circles) vs simulated intestinal fluid (filled squares).

For example, in one non-limiting instance, food composition(s) comprised of a protein (e.g., whey protein isolate, FIG. 33D) is encapsulated within a polysaccharide (e.g., agarose), further characterized as a matrix preparation. In this example, to a 20% (w/v) aqueous solution of the exemplary protein at 50 °C is added an equal portion of 6% (w/v) agarose solution at 75 °C. The mixture is briefly homogenized at 50 °C before pouring into a mold. Subsequently, the gelatinous formulation is coated using an ethanolic solution of Zein with additives (e.g., chitosan, poly(vinyl acetate), citric acid esters of diglycerides) as provided in Example 9, thus demonstrating encapsulation of a protein within a protein, a carbohydrate, and/or a polymer. As shown in FIG. 33G, the result core-shell preparation(s) (light grey) delay the release of whey protein relative to uncoated whey/agarose matrix preparation(s) (dark grey).

For example, in one non-limiting instance, food composition(s) comprised of a protein (e.g., whey protein isolate, FIG. 33D) is encapsulated within a polysaccharide (e.g., agarose), further characterized as a matrix preparation. Subsequently, the gelatinous formulation is coated using an ethanolic solution of Zein with additives (e.g., linoleic acid, cyanidin chloride) as provided in Example 9, thus demonstrating encapsulation of a protein within a protein, a lipid, and/or a flavonoid.

### Z. Example 26: Exemplary Matrix Formulation Protocol

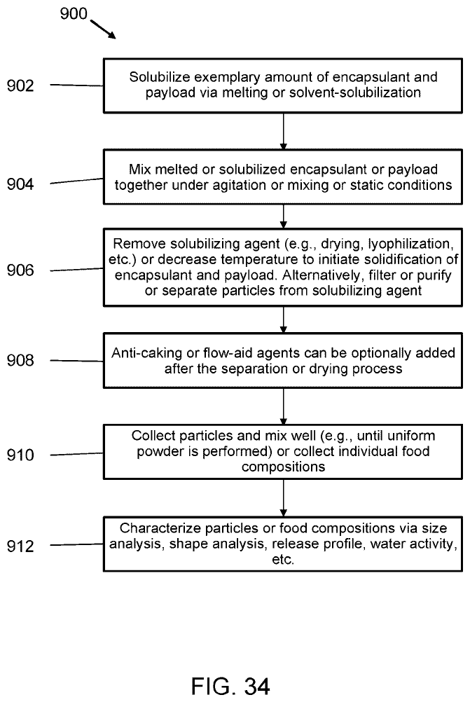

This example describes two non-limiting processes of arranging one or more food component(s) as a matrix component to one or more food component(s) characterized as a solute component via melt-gelation. A schematic of an exemplary matrix formulation procedure, method, or protocol 900 is presented in FIG. 34. At step 902, the method 900 may include solubilizing an exemplary amount of encapsulant and payload via melting or solvent-solubilization. At step 904, the method 900 may include mixing melted or solubilized encapsulant or payload together under agitation or mixing or static conditions. At step 906, the method 900 may include removing the solubilizing agent (e.g., drying, lyophilization, etc.) or decreasing the temperature to initiate solidification of the encapsulant and payload. Alternatively, (or in addition), step 906 may include filtering, purifying and/or separating particles from the solubilizing agent. At step 908, the method 900 may include adding anti-caking or flow-aid agents after the separation and/or drying process(es). At step 910, the method 900 may include collecting particles and mixing (e.g., until uniform powder is achieved) and/or collecting individual food compositions. At step 912, the method 900 may include characterizing particles or food compositions via size analysis, shape analysis, release profile, water activity, etc.

In one non-limiting example, food composition(s) are prepared in matrix preparation using the procedure described below. Gelatin (10 g) is suspended in 100 mL of stirring deionized water and the suspension is heated to 65 °C. Following complete solubilization of the gelatin at elevated temperature, 2 g of whey protein isolate powder are added and allowed to dissolve for 5 minutes. The resulting clear solution is poured into a polypropylene mold and allowed to cool for 1 hour at 20 °C. The density of the cooled gel is measured to be 0.87 g/cm³. The concentration of formulated food product in this non-limiting embodiment, on a dry weight basis, is 100% (w/w).

### AA. Example 27: Matrix Preparation(s) as a Means of Controlling the Release of One or More Food Component(s)

In certain embodiments, the spatial arrangement of one or more food component(s) establishes a means of controlling the release of one or more food component(s). In certain embodiments, the spatial arrangement of one or more food component(s) comprising one or more food composition(s) is further characterized as a matrix preparation and/or a core-shell preparation. In some non-limiting instances, the spatial arrangement of one or more food composition(s) further characterized as a matrix preparation establishes a means of controlling the release of one or more food component(s) from one or more food composition(s).

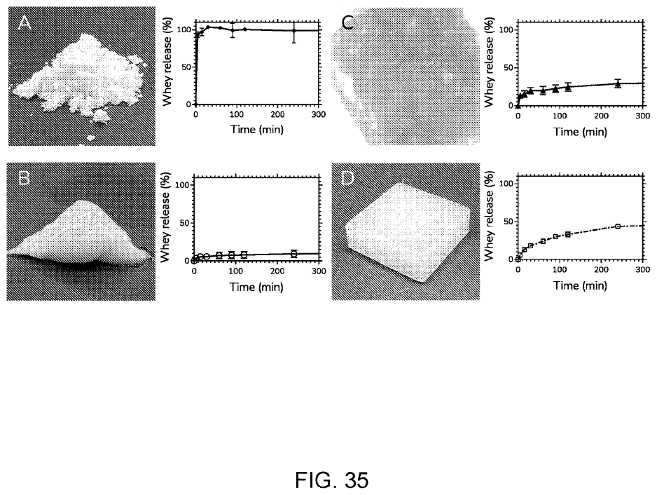

For example, in one non-limiting instance, one or more food composition(s) characterized as matrix preparation(s) is or are prepared by encapsulating whey protein isolate (FIG. 35A) within carbohydrate and/or lipid matrix component(s) (FIGS. 14B-D). For example, the matrix preparation illustrated in FIG. 35B comprises 70% (w/v) oleic acid, 20% (w/v) ethyl cellulose, and 10% (w/v) whey protein isolate, wherein, without wishing to be bound by any particular theory, the hydrophobic matrix preparation reduces solubilization of the entrapped whey protein isolate. As shown in FIG. 35B, <15% of loaded whey protein isolate is released after a 4-hour dissolution period. For example, the matrix preparation illustrated in FIG. 35C comprises 1.9% (w/v) chitosan, 10% (w/v) whey, and 1% (w/v) genipin, wherein, without wishing to be bound by any particular theory, chemical crosslinking of whey protein isolate to chitosan reduces solubilization of the entrapped whey protein isolate. As shown in FIG. 35C, <40% of loaded whey protein isolate is released after a 4-hour dissolution period. For example, the matrix preparation illustrated in FIG. 35D comprises 3% (w/v) agarose, 1% (w/v) chitosan, and 10% (w/v) whey protein isolate wherein, without wishing to be bound by any particular theory, a combination of agarose porosity and charge interactions with chitosan reduces solubilization of the entrapped whey protein isolate. As shown in FIG. 35D, <50% of loaded whey protein isolate is released after a 4-hour dissolution period.

### BB. Example 28: Exemplary Combination Matrix and Core-Shell Preparations

In certain embodiments, one or more food composition(s) are characterized as one or more of a core-shell preparation, matrix preparation, and/or particle preparation. In certain embodiments, one or more food composition(s) are characterized as a core-shell preparation and a matrix preparation.

For example, in one non-limiting instance, a food composition is comprised of a matrix preparation, further characterized as a core component, coated with one or more shell components. In one non-limiting instance, one or more core component(s) is comprised of, on a dry weight basis, at least 90% of one or more food component(s) and/or one or more shell component(s).

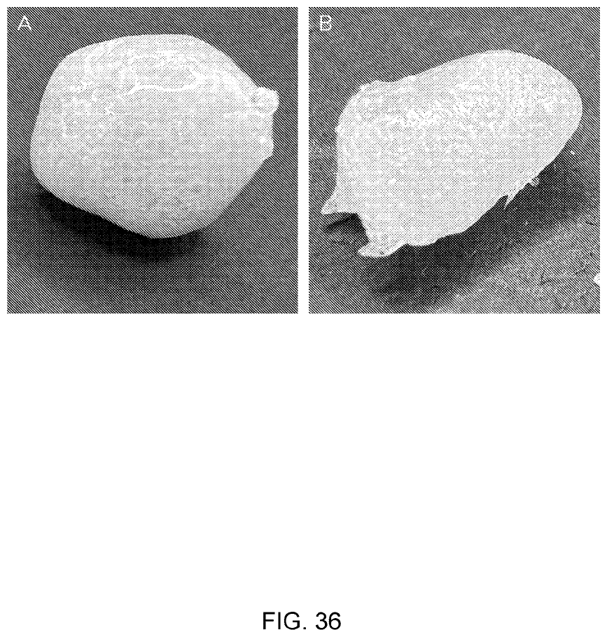

In one non-limiting instance, one or more core component(s) comprising oleic acid, ethyl cellulose, carnauba wax, and whey protein isolate (FIG. 36A) is coated 4 times with a 15% (w/v) solution of cellulose acetate phthalate in acetone. The resulting exemplary core-shell preparation exhibits a smooth, reflective, and non-tacky surface indicative of complete and successful coating.

In one non-limiting instance, one or more core component(s) comprising glucose and pectin (FIG. 36B) is coated 4 times with a 15% (w/v) solution of cellulose acetate phthalate in acetone. The resulting exemplary core-shell preparation exhibits a smooth, reflective, and non-tacky surface indicative of complete and successful coating.

### CC. Example 29: Exemplary Dissolution Protocol

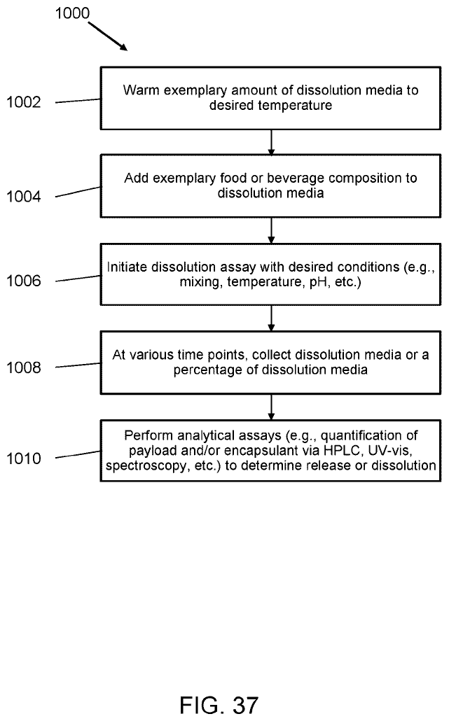

This example describes one non-limiting process of assessing the release (e.g., controlled release) of one or more food component(s) from one or more dissolution solvent(s). A schematic of an exemplary dissolution procedure, method, or protocol 1000 is presented in FIG. 37. At step 1002, the method 1000 may include warming an exemplary amount of dissolution media to a desired temperature. At step 1004, the method 1000 may include adding an exemplary food or beverage composition to the dissolution media. At step 1006, the method 1000 may include initiating dissolution assay with one or more desired conditions (e.g., via mixing, temperature, pH, etc.). At step 1008, the method 1000 may include collecting dissolution media and/or a percentage of dissolution media at various time points. At step 1010, the method 1000 may include performing analytical assays (e.g., quantification of payload and/or encapsulant via HPLC, UV-vis, spectroscopy, etc.) to determine release or dissolution characteristics.

In one non-limiting example, a food composition characterized as a core-shell preparation (e.g., Zein-coated amylose encapsulating sucrose) is assessed for controlled release in an aqueous dissolution solvent (e.g., 10 mM phosphate buffered saline, pH 7.4). 12 mL of 10 mM phosphate buffered saline are added to a polypropylene 15 mL centrifuge tube and allowed to equilibrate for 30 min while rotating at 10 rpm on a laboratory rotator. Exemplary core-shell preparations comprising Zein, sucrose, and amylose (500 mg) are added to the rotating tube. 100 μL aliquots are sampled at time points of 1 minute, 2 minutes, 5 minutes, 10 minutes, 15 minutes, 20 minutes, 30 minutes, 40 minutes, 50 minutes, and 60 minutes following addition of core-shell preparations and stored in 1.5 mL centrifuge tubes. The concentration of sucrose in collected aliquots is assayed using an enzymatic electrochemical method. Sucrose concentration, mass, and percent release is plotted with respect to incubation period to construct a release profile.

### DD. Example 30: Release of Food Component(s) in One or More Release Environment(s)

In certain embodiments, one or more food component(s) are released from one or more food composition(s) in one or more release environment(s). In some instances, one or more release environment(s) provides similar pH, ionic strength, solubilizers, and/or chemical components as in one or more biological compartment(s). In some instances, the release of one or more food component(s) from one or more food composition(s) in one or more release environment(s) predicts the release of one or more food component(s) from one or more food composition(s) in one or more biological compartment(s).

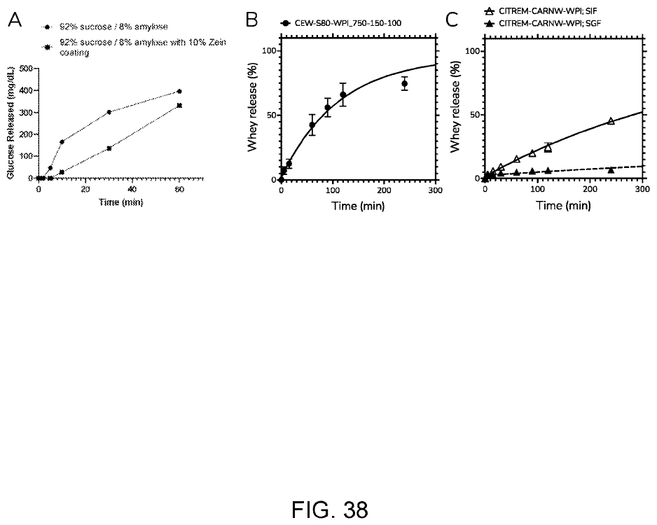

For example, in one non-limiting instance, the release of glucose from one or more food composition(s) is measured in 10 mM phosphate buffered saline solution at pH 7.4 with 1% (w/v) hydroxypropyl methylcellulose over a 60-minute period (FIG. 38A). For example, in one non-limiting instance, the release of whey protein isolate from one or more food composition(s) is measured in 10 mM phosphate buffered saline at pH 7.4 over a 240-minute period (FIG. 38B). For example, in one non-limiting instance, the release of whey protein isolate from one or more food composition(s) is measured in simulated intestinal fluid (i.e., SIF) and simulated gastric fluid (i.e., SGF) over a 240-minute period (FIG. 38C).

### EE. Example 31: Exemplary Control of Release of One or More Food Component(s) by One or More pH-Responsive Polymer(s)

As provided herein, the spatial arrangement of one or more food component(s) in one or more food composition(s) establishes a means of controlling the release of one or more food component(s). In some embodiments, the spatial arrangement of one or more food composition(s) is further characterized as a core-shell preparation. In some embodiments, the shell component(s) of one or more core-shell preparation(s) establishes a means of controlling the release of one or more food component(s). In some instances, the shell component(s) of one or more core-shell preparation(s) are further comprised of pH-responsive polymer(s).

As provided herein, one or more pH-responsive polymer(s) comprising the shell component(s) of one or more non-limiting core-shell preparation(s) provide for increased and/or decreased release of one or more food component(s) in response to the pH of one or more release environment(s). For example, in some instances, one or more pH-responsive polymer(s) may increase the release of one or more food component(s) in simulated intestinal fluid and/or simulated gastric fluid. For example, in some instances, one or more pH-responsive polymer(s) may decrease the release of one or more food component(s) in simulated intestinal fluid and/or simulated gastric fluid.

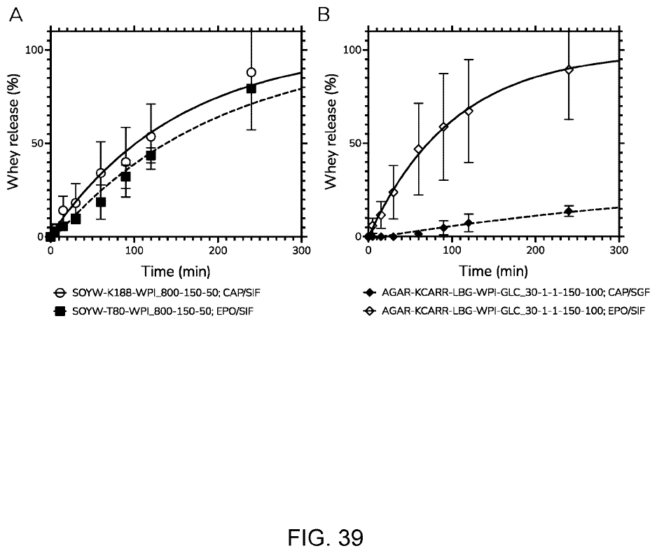

In one non-limiting example, one or more food composition(s) further characterized as a core-shell preparation wherein the shell component(s) comprise cellulose acetate phthalate exhibit responsiveness, and concomitant whey protein isolate release, to the pH of simulated intestinal fluid (FIG. 39A). Coating of the same food composition(s) with Eudragit E PO exhibit resistance, and concomitant reduction of whey protein isolate release relative to that of cellulose acetate phthalate-coated food composition(s), to the pH of simulated intestinal fluid (FIG. 39A).

In one non-limiting example, one or more food composition(s) further characterized as a core-shell preparation wherein the shell component(s) comprise cellulose acetate phthalate exhibit resistance, and concomitant reduction of whey protein isolate release, to the pH of simulated gastric fluid (FIG. 39B).

### FF. Example 32: Theoretical Release Profiles Provided by Exemplary Food and/or Beverage Composition(s)

As provided herein, one or more food and/or beverage composition(s) is characterized by controlled release of one or more food component(s). Selection of release profile, as described herein, is intended to confer a benefit (as described herein) one or more animal(s). The following example depicts anticipated (e.g., theoretical) non-limiting release profiles exhibited by one or more food composition(s).

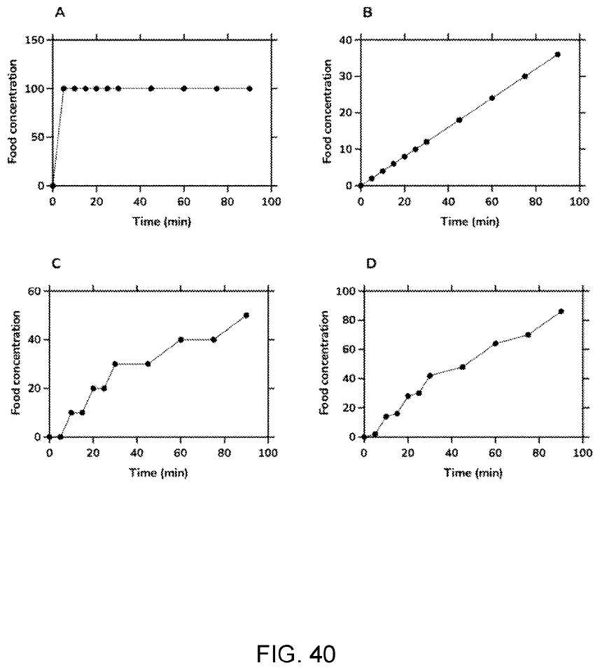

In one non-limiting example, the release of one or more food component(s) is characterized as a single bolus release, as measured by concentration present in one or more dissolution solvent(s) over time, as shown in FIG. 40A. In one non-limiting example, the release of one or more food component(s) is characterized as release with constant rate, as measured by concentration present in one or more dissolution solvent(s) over time, as shown in FIG. 40B. In one non-limiting example, the release of one or more food component(s) is characterized as multiple bolus dose (e.g., pulsatile) release, as measured by concentration present in one or more dissolution solvent(s) over time, as shown in FIG. 40C. In one non-limiting example, the release of one or more food component(s) is characterized as a combination of multiple bolus dose and constant release rate, as measured by concentration present in one or more dissolution solvent(s) over time, as shown in FIG. 40D.

### GG. Example 33: One or More Food Component(s) and/or Excipient Component(s) Establishes a Means of Controlling the Release of One or More Food Component(s)

Among other things, the present disclosure provides one or more means of controlling the release of one or more food component(s) from one or more food composition(s). In some instances, the spatial arrangement of one or more food component(s) provides one or more means of controlling the release of one or more food component(s) from one or more food composition(s). In some instances, the selection of one or more food component(s) release of one or more food component(s) from one or more food composition(s).

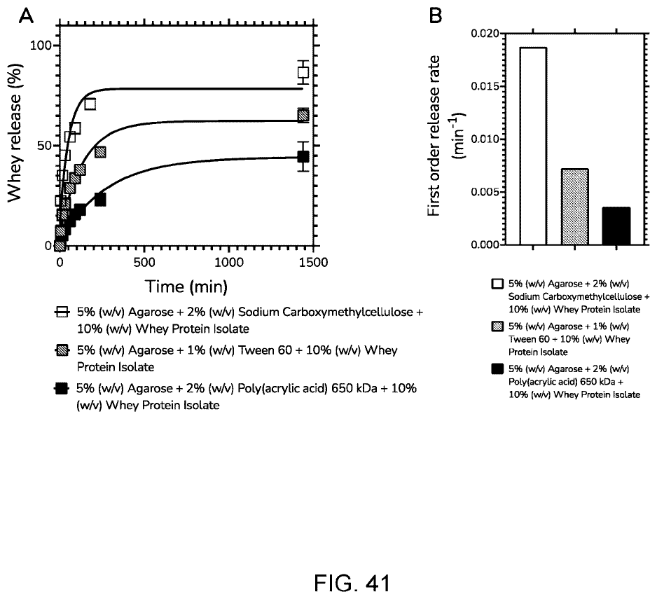

As illustrated in one non-limiting example, one or more food composition(s) further characterized as matrix preparations comprising 5% (w/v) agarose and 10% (w/v) whey protein isolate exhibit substantial differences in protein release depending on included excipient component(s) (FIG. 41A). For example, these exemplary matrix preparations further comprising 2% (w/v) sodium carboxymethylcellulose (white squares) exhibit nearly 75% release of loaded whey protein isolate over 24 hours, while preparations comprising 1% (w/v) Tween 60 (grey squares) or 2% (w/v) poly(acrylic acid) (black squares) exhibit only 60% and 45% release at 24 hours, respectively. This example demonstrates the importance of excipient selection in tuning the controlled release of one or more food component(s) from one or more food composition(s).

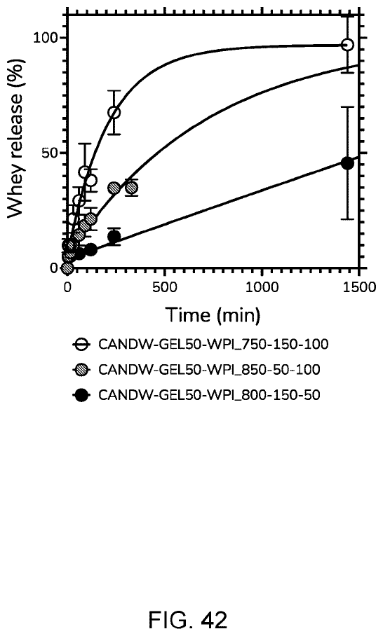

As illustrated in one non-limiting example, one or more food composition(s) further characterized as matrix preparations comprising candelilla wax, gelucire 50/13 and whey protein isolate exhibit substantial differences in protein release depending on the selected concentration(s) of food component(s) (FIG. 42). For example, these exemplary matrix preparations further comprising 75% (w/v) candelilla wax (white circles) exhibit nearly 100% release of loaded whey protein isolate over 24 hours, while preparations comprising 85% (w/v) (grey circles) or 80% (w/v) candelilla wax (black circles) exhibit only 80% and 45% release at 24 hours, respectively. This example demonstrates the importance of food component(s) concentration in tuning the controlled release of one or more food component(s) from one or more food composition(s).

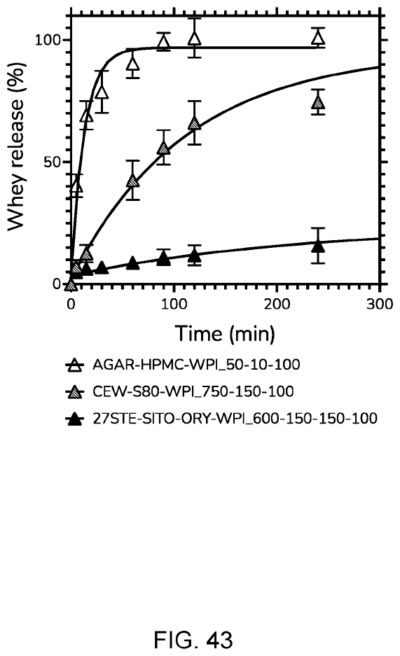

As illustrated in one non-limiting example, one or more food composition(s) further characterized as matrix preparations exhibit substantial differences in protein release depending on the selected matrix component(s) (FIG. 43). For example, these exemplary matrix preparations further comprising an agarose-based matrix (white triangles) exhibit nearly 100% release of loaded whey protein isolate over 240 minutes, while matrix preparations comprising lipid and surfactant (grey triangles) or oleogels (black triangles) exhibit only 80% and 45% release at 24 hours, respectively. This example demonstrates the importance of selecting food component(s) as matrix component(s) in tuning the controlled release of one or more food component(s) from one or more food composition(s) further characterized as a matrix preparation.

### HH. Example 34: Food Compositions Exhibiting Low Water Activity and Moisture Content

The presence of water and/or water activity is a common factor underlying instability in one or more food and/or beverage composition(s). The following example illustrates the ability of one or more food components in the provided food compositions to retain integrity in high-moisture conditions, resist water uptake, and thereby mitigate instability of the food component(s) included therein.

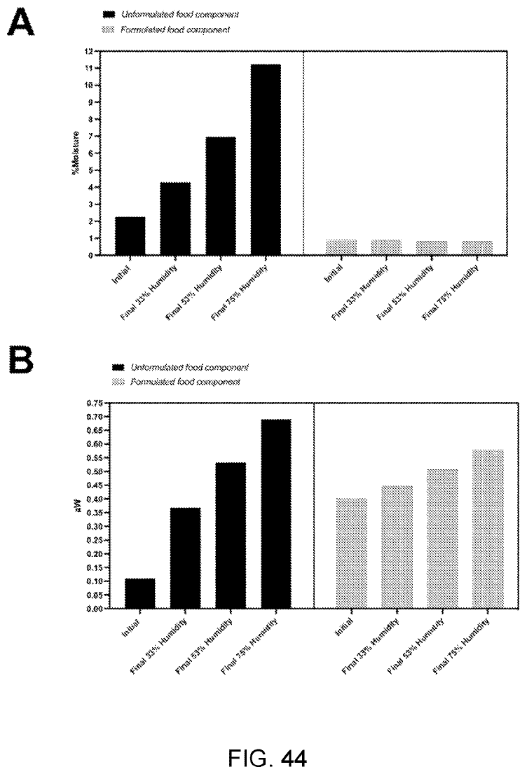

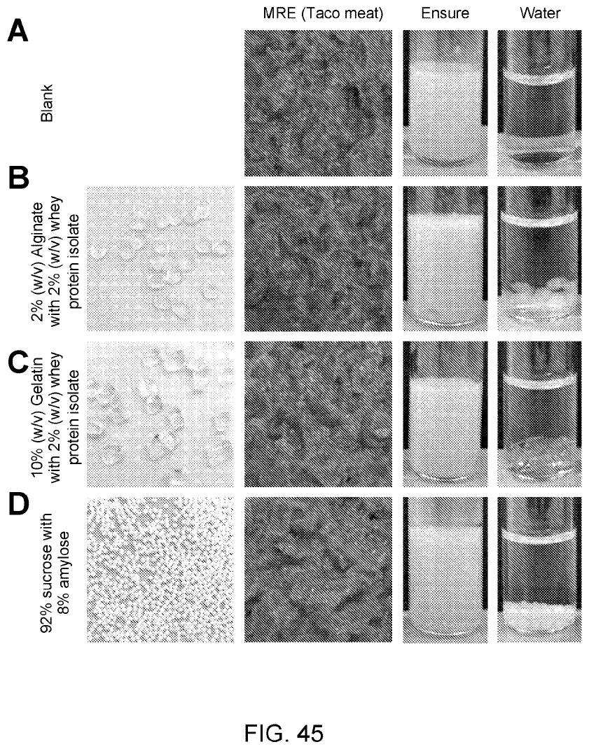

For example, FIG. 44A demonstrates that food compositions herein provided do not gain moisture content, even when exposed to controlled relative humidity of 33%, 53%, or 75% for 4 days. Unformulated food (e.g., dehydrated milk powder), on the other hand, demonstrates a 2-5 fold increase in moisture content. FIG. 44B reveals that formulated food compositions exhibit a smaller increase in water activity as compared to un-encapsulated food. For example, even when the initial level of water activity is higher, as shown in FIG. 44B, the encapsulated food compositions demonstrate a lower level of water activity increase when exposed to increasing amounts of humidity. As such, even when exposed to 75% relative humidity, the water activity of the exemplary food compositions demonstrate lower water activity levels than un-encapsulated food,

### II. Example 35: Incorporation of Food Composition(s) into Food and/or Beverage Products

This example illustrates homogeneous mixtures of disclosed food composition(s) within food and/or beverage products (e.g., MRE, nutritional beverage, water) as demonstrated in FIGS. 24A-D. It is contemplated that non-limiting exemplary embodiments of food and beverage compositions (e.g., formulated ingestibles) can be homogeneously mixed with other food products such as freeze dried powder, protein powder, solid bars, domestic pet food (pellets), liquid shakes, pudding, etc. Homogenization can be achieved without additional processing aid or improved through addition of processing aid/excipients, through the use of mixing apparatuses such as a homogenizer, stand mixer, paddle blender, stir bar, spatula, etc. Without wishing to be bound by any particular theory, the present disclosure proposes that size characteristics and/or compositions of certain provided food composition(s) may surprisingly contribute desirable and/or useful attribute(s) to such particles, specifically including, for example, amenability to homogenous combination with other component(s). As shown in FIGS. 24B-D, incorporation of alginate beads, gelatin beads, each encapsulating whey protein isolate, and/or sucrose-encapsulating beads into MRE and Ensure is homogeneous and associated with minimal change in visual appearance. In certain embodiments, incorporation of food composition(s) within one or more food and/or beverage products is associated with structural changes. In one non-limiting example (FIGS. 24A-D), food composition(s) are shown to change morphology over a 1-hour incubation period, with gelatin and alginate beads exhibiting expansion and sucrose-encapsulating beads exhibiting dissolution.

### JJ. Example 36: Exemplary Protocol for Matrix Preparation(s) Comprising One or More Fat(s), Protein(s) and Excipient Component(s)

The following non-limiting example describes the preparation of provided food composition(s) further characterized as matrix preparation(s) comprising one or more fat(s), one or more protein(s), and/or one or more excipient component(s).

100 g of beeswax was first added to a 500 mL beaker and heated to 130 °C, or until all solids were completely melted. 15 mL of molten beeswax was transferred to a 150 mL beaker held at 120 °C, stirring at 300 RPM. 3 mL of Tween-85 was transferred to the beaker and the solution was stirred for 5 minutes at 120 °C to ensure thorough mixing. Homogenization was visually confirmed via color change from clear to yellow of the solution. 2 g of whey protein isolate was added and the solution was stirred for 15 seconds at 120 °C and 300 rpm to fully disperse the added powder. The stirring suspension was poured into an aluminum pan and allowed to set at 20 °C for 1 hour. Solid formulations were segmented into sections of approximately 500 mg for future dissolution assays.

### KK. Example 37: Exemplary Protocol for Matrix Preparation(s) Comprising One or More Fat(s), Protein(s), and Excipient Component(s)

The following non-limiting example describes the preparation of provided food composition(s) further characterized as matrix preparation(s) comprising one or more fat(s), one or more protein(s), and/or one or more excipient component(s).

10 mL of oleic acid was added to a 150 mL beaker at 130 °C, mixed at 300 RPM. Oil temperature was allowed to equilibrate and verified using an Etekcity Lasergrip 1080 infrared thermometer. 2 g of ethyl cellulose (100 cP, 5% in toluene/ethanol 80:20 (lit)) was then added to the beaker and stirred for 10 minutes, or until all solids were dissolved. 1 g of whey protein isolate was then added and the suspension stirred for 15 seconds to fully disperse the added powder. The resulting dispersion was poured into an aluminum pan and allowed to set at 20 °C for 1 hour. The solid formulations were then cut into 500 mg segments and stored for future dissolution assays.

### LL. Example 38: Exemplary Protocol for Extrusion of One or More Food Composition(s)

The following non-limiting example describes the preparation of provided food composition(s) by a method of extrusion.

In this example, 7.5 g of carnauba wax, 1.5 g of soy lecithin, and 1.0 g of whey protein isolate powders were pre-mixed by manual shaking in a 50 mL centrifuge tube. The mixed contents were extruded using a ThermoFisher MiniLab3 held at 72 °C, 30 RPM. All contents were pneumatically loaded into the extruder which exited through a small, rectangular die. Bypass was set to OFF to ensure no circulation of the included formulation around the extruder channel. Extruded formulations were collected on a small metal ramp for rapid cooling and allowed to cool for 15 minutes at 20 °C until further processing. Formulations were segmented into approximately 0.5″ (1.26 cm) particles and stored for future dissolution analysis.

### MM. Example 39: Exemplary Protocol for Matrix Preparation(s) Comprising One or More Carbohydrate(s), Protein(s), and Excipient Component(s)

The following non-limiting example describes the preparation of provided food composition(s) further characterized as matrix preparation(s) comprising one or more carbohydrate(s), one or more protein(s), and/or one or more excipient component(s).

In this example, 50 mL of a 6% (w/v) agarose suspension is heated to 130 °C in a 100 mL glass beaker stirring at 300 rpm. Separately, 10 mL of a 6% (w/v) poly(acrylic acid) and 20% (w/v) whey protein isolate suspension is stirred at 70 °C and 300 rpm. 10 mL of the heated agarose suspension is transferred to the 10 mL whey protein isolate-containing suspension and stirred briefly at 70 °C for 15 seconds, or until homogenous. The warmed mixture was then poured into an aluminum pan to set at 20 °C for 1 hour. Segments of the cooled matrix omposition(s) were stored at 4 °C for future dissolution assays.

### NN. Example 40: Exemplary Protocol for Matrix Preparation(s) Comprising One or More Carbohydrate(s)

The following non-limiting example describes the preparation of provided food composition(s) further characterized as matrix preparation(s) comprising one or more carbohydrate(s)

In this example, 50 mL of a 5% (w/v) pectin suspension is heated to 150 °C in a 100 mL glass beaker stirring at 300 rpm. 6 mL of the stirring, heated pectin solution is transferred to a 150 mL glass beaker, followed by the addition of 14 g of glucose. Upon vigorous stirring at 130 °C, the added solids are solubilized, yielding a clear solution. To this clear solution is added 1.0 mL of a 1 M citric acid solution, further stirred for 15 seconds to ensure homogeneity. Stirring is stopped and the beaker is removed from heat and allowed to set at 20 °C for 1 hour. Segments of the cooled matrix composition(s) were stored at 4 °C for future dissolution assays.

### OO. Example 41: Exemplary Protocol for Quantification of Release of Protein(s) from One or More Food Composition(s)

Tubes filled with 12 mL of 10 mM phosphate buffered saline (PBS), pH were added to a rotating incubator set at 37 °C. An initial 100 μL sample was collected from each tube and transferred into a 96 well polypropylene plate. Then, each 500 mg sample was placed into its corresponding tube and the timer was promptly started. 100 μL samples were collected from the warmed, rotating tubes at subsequent timepoints of 5, 15, 30, 60, 90, 120, and 240 minutes. A BCA reagent mixture was prepared with reagent A (23228, Thermo Scientific Pierce, Waltham, MA) and reagent B (23224, Thermo Scientific Pierce, Waltham, MA) in a 50:1 ratio. 25 μL of each sample or standard was pipetted into a 96 well polystyrene plate followed by addition of 200 μL of BCA reagent mixture. The plate was then incubated for 25 minutes at 37 °C followed by measurement of absorbance at 567 nm.

### PP. Example 42: Exemplary Protocol for Quantification of Release of Protein(s) from One or More Food Composition(s)

Tubes filled with 12 mL of 10 mM phosphate buffered saline (PBS), pH were added to a rotating incubator set at 37 °C. An initial 100 μL sample was collected from each tube and transferred into a 96 well polypropylene plate. Then, each 500 mg sample was placed into its corresponding tube and the timer was promptly started. 100 μL samples were collected from the warmed, rotating tubes at subsequent timepoints of 5, 15, 30, 60, 90, 120, and 240 minutes. A BCA reagent mixture was prepared with reagent A (23228, Thermo Scientific Pierce, Waltham, MA) and reagent B (23224, Thermo Scientific Pierce, Waltham, MA) in a 50:1 ratio. 25 μL of each sample or standard was pipetted into a 96 well polystyrene plate followed by addition of 200 μL of BCA reagent mixture. The plate was then incubated for 25 minutes at 37 °C followed by measurement of absorbance at 567 nm.

### QQ. Example 43: Exemplary Protocol for Quantification of Release of Carbohydrate(s) from One or More Food Composition(s)

Tubes filled with 12 mL of 10 mM phosphate buffered saline (PBS), pH were added to a rotating incubator set at 37 °C. An initial 100 μL sample was collected from each tube and transferred into a 96 well polypropylene plate. Then, each 500 mg sample was placed into its corresponding tube and the timer was promptly started. 100 μL samples were collected from the warmed, rotating tubes at subsequent timepoints of 5, 15, 30, 60, 90, 120, and 240 minutes. An Amplex Red reagent mixture was prepared by mixing 4.75 mL of 50 mM phosphate buffer pH 7.4, 100 μL of 10 U/mL horseradish peroxidase, 100 μL of 100 U/mL glucose oxidase, and 50 μL of 2.5 mg/mL Amplex Red in DMSO. 50 μL of each sample or standard was pipetted into a 96 well polystyrene plate followed by addition of 50 μL of Amplex Red reagent mixture. The plate was then incubated for 25 minutes at 37 °C followed by measurement of fluorescence with excitation of 565 nm and emission of 590 nm.

### RR. Example 44: Exemplary Formulations

Non-limiting exemplary embodiments in accordance with the present disclosure (e.g., exemplary formulations, e.g., exemplary compositions) are presented in Table 3 and Table 4.

TABLE 3
Components of Exemplary Formulations

| Formulation ID | Analyte 1 | Analyte 2 | Excipient 1 | Excipient 2 | Excipient 3 | Excipient 4 | Coating |
|---|---|---|---|---|---|---|---|
| 27STE-EC: 100- | Whey | . | 27 Stearine | . | Ethyl cellulose | . | . |
| WPI_850-50-100 | | | | | 100 cP | | |
| 27STE-EC: 100- | Whey | . | 27 Stearine | . | Ethyl cellulose | . | . |
| WPI_900-50-50 | | | | | 100 cP | | |
| 27STE-LEC- | Whey | . | 27 Stearine | Lecithin | . | . | . |
| WPI_800-150-50 | | | | | | | |
| 27STE-LEC- | Whey | . | 27 Stearine | Lecithin | . | . | . |
| WPI_850-50-100 | | | | | | | |
| 27STE-LEC- | Whey | . | 27 Stearine | Lecithin | . | . | . |
| WPI_900-50-50 | | | | | | | |
| 27STE-SITO- | Whey | . | 27 Stearine | Sitosterol | Oryzanol | . | . |
| ORY-WPI_600- | | | | | | | |
| 150-150-100 | | | | | | | |
| 27STE-SITO- | Whey | . | 27 Stearine | Sitosterol | Oryzanol | . | . |
| ORY-WPI_650- | | | | | | | |
| 15-285-50 | | | | | | | |
| 27STE-SITO- | Whey | . | 27 Stearine | Sitosterol | Oryzanol | . | . |
| ORY-WPI_650- | | | | | | | |
| 60-240-50 | | | | | | | |
| 27STE-SITO- | Whey | . | 27 Stearine | Sitosterol | Oryzanol | . | . |
| ORY-WPI_700- | | | | | | | |
| 125-125-50 | | | | | | | |
| 27STE-SITO- | Whey | . | 27 Stearine | Sitosterol | Oryzanol | . | . |
| ORY-WPI_750- | | | | | | | |
| 100-100-50 | | | | | | | |
| 27STE-SITO- | Whey | . | 27 Stearine | Sitosterol | . | . | . |
| WPI_700-125- | | | | | | | |
| 125 | | | | | | | |
| 27STE-SITO- | Whey | . | 27 Stearine | Sitosterol | . | . | . |
| WPI_700-200- | | | | | | | |
| 100 | | | | | | | |
| 27STE-SITO- | Whey | . | 27 Stearine | Sitosterol | . | . | . |
| WPI_750-125- | | | | | | | |
| 125 | | | | | | | |
| 27STE-T85- | Whey | . | 27 Stearine | Tween 85 | Ethyl cellulose | . | . |
| EC: 100- | | | | | 100 cP | | |
| WPI_800-50-50- | | | | | | | |
| 100 | | | | | | | |
| 27STE-T85- | Whey | . | 27 Stearine | Tween 85 | . | . | . |
| WPI_850-50-100 | | | | | | | |
| 27STE-WPI_900- | Whey | . | 27 Stearine | . | . | . | . |
| 100 | | | | | | | |
| 27STE-WPI- | Whey | Oleic Acid | 27 Stearine | . | . | . | . |
| OLEA_150-100- | | | | | | | |
| 750 | | | | | | | |
| 27STE-WPI- | Whey | Oleic Acid | 27 Stearine | . | . | . | . |
| OLEA_200-100- | | | | | | | |
| 700 | | | | | | | |
| 27STE-WPI- | Whey | Oleic Acid | 27 Stearine | . | . | . | . |
| OLEA_200-200- | | | | | | | |
| 600 | | | | | | | |
| 27STE-WPI- | Whey | Oleic Acid | 27 Stearine | . | . | . | . |
| OLEA_400-200- | | | | | | | |
| 400 | | | | | | | |
| AGAR-C10- | Whey | . | Agarose | Sodium | . | . | . |
| WPI_30-3-100 | | | | caprate | | | |
| AGAR-C10- | Whey | . | Agarose | Sodium | . | . | . |
| WPI_30-30-100 | | | | caprate | | | |
| AGAR-C10- | Whey | . | Agarose | Sodium | . | . | . |
| WPI_30-40-100 | | | | caprate | | | |
| AGAR-C10- | Whey | . | Agarose | Sodium | . | . | . |
| WPI_30-100-100 | | | | caprate | | | |
| AGAR-C10-WPI- | Whey | Glucose | Agarose | Sodium | . | . | . |
| GLC_30-1-100- | | | | caprate | | | |
| 100 | | | | | | | |
| AGAR-C10-WPI- | Whey | Glucose | Agarose | Sodium | . | . | . |
| GLC_30-10-100- | | | | caprate | | | |
| 100 | | | | | | | |
| AGAR-C18-WPI- | Whey | Glucose | Agarose | Stearic Acid | . | . | . |
| GLC_30-1-100- | | | | | | | |
| 100 | | | | | | | |
| AGAR-C18-WPI- | Whey | Glucose | Agarose | Stearic Acid | . | . | . |
| GLC_30-10-100- | | | | | | | |
| 100 | | | | | | | |
| AGAR-CAP- | Whey | Glucose | Agarose | Cellulose | . | . | . |
| WPI-GLC_30-1- | | | | Acetate | | | |
| 100-100 | | | | Phthalate | | | |
| AGAR-CAP- | Whey | Glucose | Agarose | Cellulose | . | . | . |
| WPI-GLC_30-10- | | | | Acetate | | | |
| 100-100 | | | | Phthalate | | | |
| AGAR-CHIHI- | Whey | Glucose | Agarose | Chitosan | . | . | . |
| WPI-GLC_30-1- | | | | | | | |
| 100-100 | | | | | | | |
| AGAR-CHIHI- | Whey | Glucose | Agarose | Chitosan | . | . | . |
| WPI-GLC_30-10- | | | | | | | |
| 100-100 | | | | | | | |
| AGAR-CHILO- | Whey | . | Agarose | Chitosan | . | . | . |
| WPI_30-1-100 | | | | | | | |
| AGAR-CHILO- | Whey | . | Agarose | Chitosan | . | . | . |
| WPI_30-30-100 | | | | | | | |
| AGAR-CHILO- | Whey | . | Agarose | Chitosan | . | . | . |
| WPI_30-100-100 | | | | | | | |
| AGAR-CHILO- | Whey | . | Agarose | . | Chitosan | . | . |
| WPI_50-5-100 | | | | | | | |
| AGAR-CMC: 90- | Whey | . | Agarose | . | Sodium | . | . |
| WPI_50-20-100 | | | | | carboxymeth- | | |
| | | | | | ylcellulose | | |
| | | | | | 90 kDa | | |
| AGAR-CMC: 90- | Whey | Glucose | Agarose | Sodium | . | . | . |
| WPI-GLC_30-1- | | | | carboxymeth- | | | |
| 100-200 | | | | ylcellulose | | | |
| | | | | 90 kDa | | | |
| AGAR-CMC: 90- | Whey | Glucose | Agarose | Sodium | . | . | . |
| WPI-GLC_30-10- | | | | carboxymeth- | | | |
| 100-200 | | | | ylcellulose | | | |
| | | | | 90 kDa | | | |
| AGAR- | Whey | Glucose | Agarose | Sodium | | | |
| CMC: 250-WPI- | | | | carboxymeth- | . | . | . |
| GLC_30-1-100- | | | | ylcellulose | | | |
| 200 | | | | 250 kDa | | | |
| AGAR- | Whey | Glucose | Agarose | Sodium | . | . | . |
| CMC: 250-WPI- | | | | carboxymeth- | | | |
| GLC_30-10-100- | | | | ylcellulose | | | |
| 200 | | | | 250 kDa | | | |
| AGAR-CSCRM- | Whey | Glucose | Agarose | Croscarmellose | . | . | . |
| WPI-GLC_30-1- | | | | sodium | | | |
| 100-200 | | | | | | | |
| AGAR-CSCRM- | Whey | Glucose | Agarose | Croscarmellose | . | . | . |
| WPI-GLC_30-10- | | | | sodium | | | |
| 100-200 | | | | | | | |
| AGAR-EPO- | Whey | . | Agarose | Eudragit E | . | . | . |
| WPI_30-1-100 | | | | PO | | | |
| AGAR-EPO- | Whey | . | Agarose | Eudragit E | . | . | . |
| WPI_30-10-100 | | | | PO | | | |
| AGAR-EPO- | Whey | . | Agarose | Eudragit E | . | . | . |
| WPI_30-100-100 | | | | PO | | | |
| AGAR-EPO- | Whey | Glucose | Agarose | Eudragit E | . | . | . |
| WPI-GLC_30-1- | | | | PO | | | |
| 100-100 | | | | | | | |
| AGAR-ETGALT- | Whey | Glucose | Agarose | Ethyl gallate | . | . | . |
| WPI-GLC_30-1- | | | | | | | |
| 100-100 | | | | | | | |
| AGAR-FRUC- | Whey | . | Agarose | . | Fructose | . | . |
| WPI_50-200-100 | | | | | | | |
| AGAR-G4414- | Whey | Glucose | Agarose | Gelucire | . | . | . |
| WPI-GLC_30-1- | | | | 44/14 | | | |
| 100-100 | | | | | | | |
| AGAR-G4414- | Whey | Glucose | Agarose | Gelucire | . | . | . |
| WPI-GLC_30-10- | | | | 44/14 | | | |
| 100-100 | | | | | | | |
| AGAR-G5013- | Whey | Glucose | Agarose | Gelucire | . | . | . |
| WPI-GLC_30-5- | | | | 50/13 | | | |
| 100-200 | | | | | | | |
| AGAR-G5013- | Whey | Glucose | Agarose | Gelucire | . | . | . |
| WPI-GLC_30-50- | | | | 50/13 | | | |
| 100-200 | | | | | | | |
| AGAR-G5914- | Whey | Glucose | Agarose | Gelucire | . | . | . |
| WPI-GLC_30-5- | | | | 59/14 | | | |
| 100-200 | | | | | | | |
| AGAR-G5914- | Whey | Glucose | Agarose | Gelucire | . | . | . |
| WPI-GLC_30-50- | | | | 59/14 | | | |
| 100-200 | | | | | | | |
| AGAR-GELLG- | Whey | Glucose | Agarose | Gellan Gum | . | . | . |
| WPI-GLC_30-1- | | | | | | | |
| 100-100 | | | | | | | |
| AGAR-GELLG- | Whey | Glucose | Agarose | Gellan Gum | . | . | . |
| WPI-GLC_30-10- | | | | | | | |
| 100-100 | | | | | | | |
| AGAR-GHATG- | Whey | Glucose | Agarose | Ghatti Gum | . | . | . |
| WPI-GLC_30-1- | | | | | | | |
| 100-100 | | | | | | | |
| AGAR-GHATG- | Whey | Glucose | Agarose | Ghatti Gum | Ghatti Gum | . | . |
| WPI-GLC_30-10- | | | | | | | |
| 100-100 | | | | | | | |
| AGAR-GHATG- | Whey | Glucose | Agarose | . | Ghatti Gum | . | Chitosan, |
| WPI-GLC_30-10- | | | | | | | methyl |
| 100-100; CT-MC- | | | | | | | cellulose, |
| GY_9-23-63 | | | | | | | glycerol |
| AGAR-GHATG- | Whey | Glucose | Agarose | . | Ghatti Gum | . | Chitosan, |
| WPI-GLC_30-10- | | | | | | | methyl |
| 100-100; CT-MC- | | | | | | | cellulose, |
| PEG_9-23-63 | | | | | | | poly(ethylene |
| | | | | | | | glycol) |
| AGAR-GHATG- | Whey | Glucose | Agarose | . | Ghatti Gum | . | Poly(vinyl |
| WPI-GLC_30-10- | | | | | | | acetate), |
| 100-100; PVAC- | | | | | | | Propylene |
| PG-SA_40-40-20 | | | | | | | glycol, |
| | | | | | | | Stearic acid |
| AGAR-GHATG- | Whey | Glucose | Agarose | . | Ghatti Gum | . | poly(vinyl |
| WPI-GLC_30-10- | | | | | | | acetate), |
| 100-100; PVAC- | | | | | | | propylene |
| PG-SA_44-44-12 | | | | | | | glycol, |
| | | | | | | | stearic acid |
| AGAR-GRRHA- | Whey | Glucose | Agarose | Glycyrrhetinic | . | . | . |
| WPI-GLC_30-1- | | | | Acid | | | |
| 100-200 | | | | | | | |
| AGAR-GRRHA- | Whey | Glucose | Agarose | Glycyrrhetinic | | | |
| WPI-GLC_30-10- | | | | Acid | | | |
| 100-200 | | | | | | | |
| AGAR-HAP: 5U- | Whey | Glucose | Agarose | Hydroxyapatite | Ghatti Gum | . | . |
| GHATG-WPI- | | | | | | | |
| GLC_30-1-3-100- | | | | | | | |
| 200 | | | | | | | |
| AGAR-HAP: 5U- | Whey | Glucose | Agarose | Hydroxyapatite | Ghatti Gum | . | . |
| GHATG-WPI- | | | | | | | |
| GLC_30-10-3- | | | | | | | |
| 100-200 | | | | | | | |
| AGAR-HAP: 5U- | Whey | . | Agarose | Hydroxyapatite | . | . | . |
| WPI_30-10-100 | | | | | | | |
| AGAR-HAP: 5U- | Whey | . | Agarose | Hydroxyapatite | . | . | . |
| WPI_30-30-100 | | | | | | | |
| AGAR-HAP: 5U- | Whey | . | Agarose | Hydroxyapatite | . | . | . |
| WPI_30-100-100 | | | | | | | |
| AGAR-HPMC- | Whey | . | Agarose | Hydroxypropyl | . | . | . |
| WPI_50-10-100 | | | | methylcellulose | | | |
| AGAR-HPMC- | Whey | Glucose | Agarose | Hydroxypropyl | . | . | . |
| WPI-GLC_30-1- | | | | methylcellulose | | | |
| 100-100 | | | | | | | |
| AGAR-HPMC- | Whey | Glucose | Agarose | Hydroxypropyl | . | . | . |
| WPI-GLC_30-10- | | | | methylcellulose | | | |
| 100-100 | | | | | | | |
| AGAR-ICARR- | Whey | Glucose | Agarose | Iota | . | . | . |
| WPI-GLC_30-1- | | | | Carrageenan | | | |
| 100-100 | | | | | | | |
| AGAR-ICARR- | Whey | Glucose | Agarose | Iota | . | . | . |
| WPI-GLC_30-10- | | | | Carrageenan | | | |
| 100-100 | | | | | | | |
| AGAR-KARG- | Whey | . | Agarose | . | Karaya gum | . | . |
| WPI_50-10-100 | | | | | | | |
| AGAR-KARG- | Whey | Glucose | Agarose | Karaya | . | . | . |
| WPI-GLC_30-1- | | | | Gum | | | |
| 100-100 | | | | | | | |
| AGAR-KARG- | Whey | Glucose | Agarose | Karaya | . | . | . |
| WPI-GLC_30-10- | | | | Gum | | | |
| 100-100 | | | | | | | |
| AGAR-KCARR- | Whey | Glucose | Agarose | Kappa | Gum | Cellulose | . |
| LBG-CAP-WPI- | | | | Carrageenan | Locust Bean | Acetate | |
| GLC_30-1-1-150- | | | | | | Phthalate | |
| 100 | | | | | | | |
| AGAR-KCARR- | Whey | Glucose | Agarose | Kappa | Gum | Eudragit E | . |
| LBG-E PO-WPI- | | | | Carrageenan | Locust Bean | PO | |
| GLC_30-1-1-150- | | | | | | | |
| 100 | | | | | | | |
| AGAR-KCARR- | Whey | Glucose | Agarose | Kappa | . | . | . |
| WPI-GLC_30-1- | | | | Carrageenan | | | |
| 100-100 | | | | | | | |
| AGAR-KCARR- | Whey | Glucose | Agarose | Kappa | . | . | . |
| WPI-GLC_30-10- | | | | Carrageenan | | | |
| 100-100 | | | | | | | |
| AGAR-LBG- | Whey | Glucose | Agarose | Locust Bean | . | . | . |
| WPI-GLC_30-1- | | | | Gum | | | |
| 100-100 | | | | | | | |
| AGAR-LBG- | Whey | Glucose | Agarose | Locust Bean | . | . | . |
| WPI-GLC_30-10- | | | | Gum | | | |
| 100-100 | | | | | | | |
| AGAR-MC: 15- | Whey | Glucose | Agarose | Methyl | Ghatti Gum | . | . |
| GHATG-WPI- | | | | cellulose 15 | | | |
| GLC_30-5-3-100- | | | | CP | | | |
| 200 | | | | | | | |
| AGAR-MC: 15- | Whey | Glucose | Agarose | Methyl | Ghatti Gum | . | . |
| GHATG-WPI- | | | | cellulose 15 | | | |
| GLC_30-50-3- | | | | CP | | | |
| 100-200 | | | | | | | |
| AGAR-PAA: 450- | Whey | . | Agarose | Poly(acrylic | . | . | . |
| WPI_30-3-100 | | | | acid) 450 | | | |
| | | | | kDa | | | |
| AGAR-PAA: 450- | Whey | . | Agarose | Poly(acrylic | . | . | . |
| WPI_30-20-100 | | | | acid) 450 | | | |
| | | | | kDa | | | |
| AGAR-PAA: 450- | Whey | . | Agarose | Poly(acrylic | . | . | . |
| WPI_30-100-100 | | | | acid) 450 | | | |
| | | | | kDa | | | |
| AGAR-PAA: 450- | Whey | . | Agarose | Poly(acrylic | . | . | . |
| WPI_50-20-100 | | | | acid) 450 | | | |
| | | | | kDa | | | |
| AGAR-PAA: 450- | Whey | Glucose | Agarose | Poly(acrylic | . | . | . |
| WPI-GLC_30-1- | | | | acid) 450 | | | |
| 100-100 | | | | kDa | | | |
| AGAR-PAA: 450- | Whey | Glucose | Agarose | Poly(acrylic | . | . | Poly(vinyl |
| WPI-GLC_30-1- | | | | acid) 450 | | | acetate), |
| 100-100; PVAC- | | | | kDa | | | propylene |
| PG-SA_44-11-44 | | | | | | | glycol, |
| | | | | | | | stearic acid |
| AGAR-PAA: 450- | Whey | Glucose | Agarose | Poly(acrylic | . | . | Zein, |
| WPI-GLC_30-1- | | | | acid) 450 | | | glycerol |
| 100-100; ZEIN- | | | | kDa | | | |
| GY_60-40 | | | | | | | |
| AGAR-PAA: 450- | Whey | Glucose | Agarose | Poly(acrylic | . | . | . |
| WPI-GLC_30-1- | | | | acid) 450 | | | |
| 100-200 | | | | kDa | | | |
| AGAR-PAA: 450- | Whey | Glucose | Agarose | Poly(acrylic | . | . | . |
| WPI-GLC_30-10- | | | | acid) 450 | | | |
| 100-200 | | | | kDa | | | |
| AGAR-PGA- | Whey | Glucose | Agarose | Propylene | Gellan Gum | . | . |
| GELLG-WPI- | | | | glycol | | | |
| GLC_30-10-3- | | | | alginate | | | |
| 100-200 | | | | | | | |
| AGAR-PGA- | Whey | Glucose | Agarose | Propylene | Ghatti Gum | . | . |
| GHATG-WPI- | | | | glycol | | | |
| GLC_30-10-3- | | | | alginate | | | |
| 100-200 | | | | | | | |
| AGAR-PGA- | Whey | Glucose | Agarose | Propylene | . | . | . |
| WPI-GLC_30-1- | | | | glycol | | | |
| 100-200 | | | | alginate | | | |
| AGAR-PGA- | Whey | Glucose | Agarose | Propylene | . | . | . |
| WPI-GLC_30-10- | | | | glycol | | | |
| 100-200 | | | | alginate | | | |
| AGAR-PGA- | Whey | Glucose | Agarose | Propylene | Xanthan gum | . | . |
| XGUM-WPI- | | | | glycol | | | |
| GLC_30-10-3- | | | | alginate | | | |
| 100-200 | | | | | | | |
| AGAR-PHYTG- | Whey | Glucose | Agarose | Phytagel | . | . | . |
| WPI-GLC_30-1- | | | | | | | |
| 100-200 | | | | | | | |
| AGAR-PHYTG- | Whey | Glucose | Agarose | Phytagel | . | . | Zein, citric |
| WPI-GLC_30-1- | | | | | | | acid esters |
| 100-200; ZEIN- | | | | | | | of |
| CITREM-GY_44- | | | | | | | diglycerides, |
| 28-28 | | | | | | | Glycerol |
| AGAR-PHYTG- | Whey | Glucose | Agarose | Phytagel | . | . | Zein, citric |
| WPI-GLC_30-1- | | | | | | | acid esters |
| 100-200; ZEIN- | | | | | | | of |
| CITREM-GY_52- | | | | | | | diglycerides, |
| 32-16 | | | | | | | glycerol |
| AGAR-PHYTG- | Whey | Glucose | Agarosc | Phytagel | . | . | . |
| WPI-GLC_30-10- | | | | | | | |
| 100-200 | | | | | | | |
| AGAR- | Whey | Glucose | Agarose | Poly(vinylpyrrolidone) | Ghatti Gum | . | . |
| PVP: 1.3M- | | | | 1.3 MDa | | | |
| GHATG-WPI- | | | | | | | |
| GLC_30-1-3-100- | | | | | | | |
| 200 | | | | | | | |
| AGAR- | Whey | Glucose | Agarose | Poly(vinylpyrrolidone) | Ghatti Gum | . | . |
| PVP: 1.3M- | | | | 1.3 MDa | | | |
| GHATG-WPI- | | | | | | | |
| GLC_30-10-3- | | | | | | | |
| 100-200 | | | | | | | |
| AGAR-PVP: 10- | Whey | Glucose | Agarose | Poly(vinylpyrrolidone) | Ghatti Gum | . | . |
| GHATG-WPI- | | | | 10 kDa | | | |
| GLC_30-1-3-100- | | | | | | | |
| 200 | | | | | | | |
| AGAR-PVP: 10- | Whey | Glucose | Agarose | Poly(vinylpyrrolidone) | Ghatti Gum | . | . |
| GHATG-WPI- | | | | 10 kDa | | | |
| GLC_30-10-3- | | | | | | | |
| 100-200 | | | | | | | |
| AGAR-PVP: 40- | Whey | . | Agarose | Poly(vinylpyrrolidone) | . | . | . |
| WPI_30-30-100 | | | | 40 kDa | | | |
| AGAR- | Whey | . | Agarose | . | Poly(vinylpyrrolidone) | . | . |
| PVP: 1300- | | | | | 1.3 | | |
| WPI_50-10-100 | | | | | Mda | | |
| AGAR-QUILL- | Whey | . | Agarose | Quillaia | . | . | . |
| WPI_30-10-100 | | | | extract | | | |
| AGAR-RICO- | Whey | Glucose | Agarose | Soidum | . | . | . |
| WPI-GLC_30-50- | | | | ricinoleate | | | |
| 100-200 | | | | | | | |
| AGAR-SP60- | Whey | Glucose | Agarose | Span 60 | Tween 60 | . | . |
| T60-WPI- | | | | | | | |
| GLC_30-3.3-1.6- | | | | | | | |
| 100-200 | | | | | | | |
| AGAR-SP60- | Whey | Glucose | Agarose | Span 60 | Tween 60 | . | . |
| T60-WPI- | | | | | | | |
| GLC_30-33-16- | | | | | | | |
| 100-200 | | | | | | | |
| AGAR-SP60- | Whey | Glucose | Agarose | Span 60 | Tween 60. | . | . |
| TW60-WPI- | | | | | | | |
| GLC_30-33-16- | | | | | | | |
| 100-200 | | | | | | | |
| AGAR-SP60- | Whey | Glucose | Agarose | Span 60 | Tween 60. | . | Zein, citric |
| TW60-WPI- | | | | | | | acid esters |
| GLC_30-33-16- | | | | | | | of |
| 100-200; ZEIN- | | | | | | | diglycerides, |
| CIT-LA 26-8-66 | | | | | | | linoleic acid |
| AGAR-SP60- | Whey | Glucose | Agarose | Span 60 | Tween 60. | . | Zein, Citric |
| TW60-WPI- | | | | | | | acid esters |
| GLC_30-33-16- | | | | | | | of |
| 100-200; ZEIN- | | | | | | | diglycerides, |
| CIT-LA 28-18-54 | | | | | | | linoleic acid |
| AGAR-SP60- | Whey | Glucose | Agarose | Span 60 | Tween 60. | . | Zein, citric |
| TW60-WPI- | | | | | | | acid esters |
| GLC_30-33-16- | | | | | | | of |
| 100-200; ZEIN- | | | | | | | diglycercides, |
| CIT-LA_34-21-46 | | | | | | | Linoleic |
| | | | | | | | acid |
| AGAR-SP60- | Whey | Glucose | Agarose | Span 60 | Tween 60. | . | Zein, Citric |
| TW60-WPI- | | | | | | | acid esters |
| GLC_30-33-16- | | | | | | | of |
| 100-200; ZEIN- | | | | | | | diglycerides, |
| CIT-LA_40-12-48 | | | | | | | Linoleic acid |
| AGAR-T60- | Whey | . | Agarose | Tween 60 | . | . | . |
| WPI_50-10-100 | | | | | | | |
| AGAR-TRAGG- | Whey | Glucose | Agarose | Tragacanth | . | . | . |
| WPI-GLC_30-1- | | | | Gum | | | |
| 100-200 | | | | | | | |
| AGAR-TRAGG- | Whey | Glucose | Agarose | Tragacanth | . | . | . |
| WPI-GLC_30-10- | | | | Gum | | | |
| 100-200 | | | | | | | |
| AGAR-TSTE- | Whey | Glucose | Agarose | Tristearin | . | . | . |
| WPI-GLC_30-1- | | | | | | | |
| 100-100 | | | | | | | |
| AGAR-TSTE- | Whey | Glucose | Agarose | Tristearin | . | . | . |
| WPI-GLC_30-10- | | | | | | | |
| 100-100 | | | | | | | |
| AGAR-VC18- | Whey | . | Agarose | . | Ascorbyl | . | . |
| WPI_50-20-100 | | | | | palmitate | | |
| AGAR-WPI_20- | Whey | . | Agarose | . | . | . | . |
| 100 | | | | | | | |
| AGAR-WPI_50- | Whey | . | Agarose | . | . | . | . |
| 100 | | | | | | | |
| AGAR-WPI- | Whey | Glucose | Agarose | . | . | . | . |
| GLC_30-100-200 | | | | | | | |
| ALG-CHILO- | . | Glucose | Alginate | Chitosa | . | . | . |
| GLC-INLN_16- | | | | | | | |
| 10-200-50 | | | | | | | |
| ALG-GLC- | . | Glucose | Alginate | . | . | . | . |
| INLN_16-200-50 | | | | | | | |
| ALG-HAP: 5U- | . | Glucose | Alginate | Hydroxyapatite | . | . | . |
| GLC-INLN_16- | | | | | | | |
| 40-150-35 | | | | | | | |
| ALG-HPMC- | . | Glucose | Alginate | Hydroxypropyl | . | . | . |
| GLC-INLN_16-4- | | | | methylcellulose | | | |
| 150-35 | | | | | | | |
| ALG-MC-GLC- | . | Glucose | Alginate | Methyl | . | . | . |
| INLN_16-32-150- | | | | cellulose | | | |
| 35 | | | | 15 cP | | | |
| ALG-T85-GLC- | . | Glucose | Alginate | Tween 85 | . | . | . |
| INLN_16-40-150- | | | | | | | |
| 35 | | | | | | | |
| BSWX-EC: 100- | Whey | Oleic Acid | Beeswax | . | Ethyl cellulose | . | . |
| WPI-OLEA_150- | | | | | 100 cP | | |
| 50-100-700 | | | | | | | |
| BSWX-LEC- | Whey | . | Beeswax | Lecithin | . | . | . |
| WPI_750-150- | | | | | | | |
| 100 | | | | | | | |
| BSWX-LEC- | Whey | . | Beeswax | Lecithin | . | . | . |
| WPI_800-150-50 | | | | | | | |
| BSWX-T85- | Whey | . | Beeswax | Tween 85 | Ethyl cellulose | . | . |
| EC: 100- | | | | | 100 cP | | |
| WPI_800-50-50- | | | | | | | |
| 100 | | | | | | | |
| BSWX-T85- | Whey | . | Beeswax | Tween 85 | . | . | . |
| WPI_750-150- | | | | | | | |
| 100 | | | | | | | |
| BSWX-T85- | Whey | . | Beeswax | Tween 85 | . | . | . |
| WPI_800-150-50 | | | | | | | |
| BSWX-T85- | Whey | . | Beeswax | Tween 85 | . | . | . |
| WPI_850-50-100 | | | | | | | |
| BSWX-T85- | Whey | . | Beeswax | Tween 85 | . | . | . |
| WPI_900-50-50 | | | | | | | |
| BSWX-WPI_900- | Whey | . | Beeswax | . | . | . | . |
| 100 | | | | | | | |
| BSWX-WPI- | Whey | Oleic Acid | Beeswax | . | . | . | . |
| OLEA_150-100- | | | | | | | |
| 750 | | | | | | | |
| BSWX-WPI- | Whey | Oleic Acid | Beeswax | . | . | . | . |
| OLEA_200-100- | | | | | | | |
| 700 | | | | | | | |
| BSWX-WPI- | Whey | Triolein | Beeswax | . | . | . | . |
| TOLE_200-100- | | | | | | | |
| 700 | | | | | | | |
| CANDW- | Whey | . | Candelilla | . | Ethyl cellulose | . | . |
| EC: 100- | | | Wax | | 100 cP | | |
| WPI_850-50-100 | | | | | | | |
| CANDW-GEL50- | Whey | . | Candelilla | Gelucire | . | . | . |
| WPI_750-150- | | | Wax | 50/14 | | | |
| 100 | | | | | | | |
| CANDW-GEL50- | Whey | . | Candelilla | Gelucire | . | . | . |
| WPI_800-150-50 | | | Wax | 50/14 | | | |
| CANDW-GEL50- | Whey | . | Candelilla | Gelucire | . | . | . |
| WPI_850-50-100 | | | Wax | 50/14 | | | |
| CANDW-WPI- | Whey | Oleic Acid | Candelilla | . | . | . | . |
| OLEA_150-100- | | | Wax | | | | |
| 750 | | | | | | | |
| CANDW-WPI- | Whey | Oleic Acid | Candelilla | . | . | . | . |
| OLEA_200-150- | | | Wax | | | | |
| 650 | | | | | | | |
| CANDW-WPI- | Whey | Triolein | Candelilla | . | . | . | . |
| TOLE_200-100- | | | Wax | | | | |
| 700 | | | | | | | |
| CARNW-EC- | Whey | Oleic Acid | Carnauba | . | Ethyl cellulose | | Cellulose |
| WPI-OLEA_100- | | | Wax | | 100 cP | | Acetate |
| 150-100-650: CAP | | | | | | | Phthalate |
| CARNW-EC- | Whey | Oleic Acid | Carnauba | . | Ethyl cellulose | | Eudragit E |
| WPI-OLEA_100- | | | Wax | | 100 cP | | PO |
| 150-100-650: EPO | | | | | | | |
| CARNW-EC: 100- | Whey | Oleic Acid | Carnauba | . | Ethyl cellulose | | |
| WPI-OLEA_100- | | | Wax | | 100 cP | | |
| 150-100-650 | | | | | . | . | . |
| CARNW-LEC- | Whey | . | Carnauba | Lecithin | | | |
| WPI_750-150- | | | Wax | | | | |
| 100 | | | | | | | |
| CARNW-LEC- | Whey | . | Carnauba | Lecithin | . | . | . |
| WPI_800-150-50 | | | Wax | | | | |
| CARNW-LEC- | Whey | . | Carnauba | Lecithin | . | . | . |
| WPI_850-50-100 | | | Wax | | | | |
| CARNW-WPI- | Whey | Oleic Acid | Carnauba | . | . | . | . |
| OLEA_150-100- | | | Wax | | | | |
| 750 | | | | | | | |
| CARNW-WPI- | Whey | Oleic Acid | Carnauba | . | . | . | . |
| OLEA_200-100- | | | Wax | | | | |
| 700 | | | | | | | |
| CEW-EC: 100- | Whey | . | Cetyl Ester | . | Ethyl cellulose | . | . |
| WPI_750-150- | | | Wax | | 100 cP | | |
| 100 | | | | | | | |
| CEW-EC: 100- | Whey | . | Cetyl Ester | . | Ethyl cellulose | . | . |
| WPI_800-150-50 | | | Wax | | 100 cP | | |
| CEW-EC: 100- | Whey | . | Cetyl Ester | . | Ethyl cellulose | . | |
| WPI_850-50-100 | | | Wax | | 100 cP | | |
| CEW-EC: 100- | Whey | . | Cetyl Ester | . | Ethyl cellulose | . | . |
| WPI_900-50-50 | | | Wax | | 100 cP | | |
| CEW-GEL50- | Whey | . | Cetyl Ester | Gelucire | . | . | . |
| WPI_750-150- | | | Wax | 50/14 | | | |
| 100 | | | | | | | |
| CEW-GEL50- | Whey | . | Cetyl Ester | Gelucire | . | . | . |
| WPI_800-150-50 | | | Wax | 50/14 | | | |
| CEW-GEL50- | Whey | . | Cetyl Ester | Gelucire | . | . | . |
| WPI_850-50-100 | | | Wax | 50/14 | | | |
| CEW-GEL50- | Whey | . | Cetyl Ester | Gelucire | . | . | . |
| WPI_900-50-50 | | | Wax | 50/14 | | | |
| CEW-KARG- | Whey | . | Cetyl Ester | . | Karaya gum | . | . |
| WPI_800-150-50 | | | Wax | | | | |
| CEW-KARG- | Whey | . | Cetyl Ester | . | Karaya gum | . | . |
| WPI_900-50-50 | | | Wax | | | | |
| CEW-LEC- | Whey | . | Cetyl Ester | Lecithin | . | . | . |
| WPI_750-150- | | | Wax | | | | |
| 100 | | | | | | | |
| CEW-LEC- | Whey | . | Cetyl Ester | Lecithin | . | . | . |
| WPI_900-50-50 | | | Wax | | | | |
| CEW-S40- | Whey | . | Cetyl Ester | Span 40 | . | . | . |
| WPI_750-150- | | | Wax | | | | |
| 100 | | | | | | | |
| CEW-S40- | Whey | . | Cetyl Ester | Span 40 | . | . | . |
| WPI_900-50-50 | | | Wax | | | | |
| CEW-S80- | Whey | . | Cetyl Ester | Span 80 | . | . | . |
| WPI_750-150- | | | Wax | | | | |
| 100 | | | | | | | |
| CEW-S80- | Whey | . | Cetyl Ester | Span 80 | . | . | . |
| WPI_900-50-50 | | | Wax | | | | |
| CEW-SESO- | Whey | . | Cetyl Ester | Sesame Oil | . | . | . |
| WPI_750-150- | | | Wax | | | | |
| 100 | | | | | | | |
| CEW-SESO- | Whey | . | Cetyl Ester | Sesame Oil | . | . | . |
| WPI_800-150-50 | | | Wax | | | | |
| CEW-SESO- | Whey | . | Cetyl Ester | Sesame Oil | . | . | . |
| WPI_850-50-100 | | | Wax | | | | |
| CEW-SESO- | Whey | . | Cetyl Ester | Sesame Oil | . | . | . |
| WPI_900-50-50 | | | Wax | | | | |
| CEW-SITO- | Whey | . | Cetyl Ester | Sitosterol | . | . | . |
| WPI_700-200- | | | Wax | | | | |
| 100 | | | | | | | |
| CEW-T85- | Whey | . | Cetyl Ester | Tween 85 | . | . | . |
| WPI_750-150- | | | Wax | | | | |
| 100 | | | | | | | |
| CEW-WPI- | Whey | Triolein | Cetyl Ester | . | . | . | . |
| TOLE_200-100- | | | Wax | | | | |
| 700 | | | | | | | |
| CHILO-GENI- | Whey | . | Chitosan | Genipin | . | . | . |
| WPI_18-2-100 | | | | | | | |
| CHILO-WPI_12- | Whey | . | Chitosan | . | . | . | . |
| 100 | | | | | | | |
| CITREM- | Whey | . | Citric Acid | Carnauba | . | . | . |
| CARNW- | | | Esters of | Wax | | | |
| WPI_750-150- | | | Diglycerides | | | | |
| 100 | | | | | | | |
| COCOW-EC: 100- | Whey | . | Hydrogenated | . | Ethyl cellulose | . | . |
| WPI_750-150- | | | Coconut Oil | | 100 cP | | |
| 100 | | | | | | | |
| COCOW-EC: 100- | Whey | . | Hydrogenated | . | Ethyl cellulose | . | . |
| WPI_800-150-50 | | | Coconut Oil | | 100 cP | | |
| COCOW-EC: 100- | Whey | . | Hydrogenated | . | Ethyl cellulose | . | . |
| WPI_850-50-100 | | | Coconut Oil | | 100 cP | | |
| COCOW-EC: 100- | Whey | . | Hydrogenated | . | Ethyl cellulose | . | . |
| WPI_900-50-50 | | | Coconut Oil | | 100 cP | | |
| COCOW-SESO- | Whey | . | Hydrogenated | Sesame Oil | . | . | . |
| WPI_850-50-100 | | | Coconut Oil | | | | |
| COCOW-SESO- | Whey | . | Hydrogenated | Sesame Oil | . | . | . |
| WPI_900-50-50 | | | Coconut Oil | | | | |
| DTPS-T85- | Whey | . | Dritex Palm | Tween 85 | . | . | . |
| WPI_800-20-100 | | | Shortening | | | | |
| EC: 22-WPI- | Whey | Oleic Acid | . | . | Ethyl cellulose | . | . |
| OLEA_200-100- | | | | | 22 cP | | |
| 700 | | | | | | | |
| EC: 100-SIO2- | Whey | Oleic Acid | . | . | Ethyl cellulose | Silica | . |
| WPI-OLEA_150- | | | | | 100 cP | | |
| 50-200-60 | | | | | | | |
| EC: 100-WPI- | Whey | Glyceryl | . | . | Ethyl cellulose | . | . |
| GMO 200-100- | | monooleate | | | 100 cP | | |
| 700 | | | | | | | |
| EC: 100-WPI- | Whey | Oleic Acid | . | . | Ethyl cellulose | . | . |
| OLEA_100-100- | | | | | 100 cP | | |
| 800 | | | | | | | |
| EC: 100-WPI- | Whey | Oleic Acid | . | . | Ethyl cellulose | . | . |
| OLEA_150-100- | | | | | 100 cP | | |
| 750 | | | | | | | |
| EC: 100-WPI- | Whey | Oleic Acid | . | . | Ethyl cellulose | . | . |
| OLEA_200-100- | | | | | 100 cP | | |
| 700 | | | | | | | |
| EC: 100-WPI- | Whey | Oleic Acid | . | . | Ethyl cellulose | . | . |
| OLEA_200-200- | | | | | 100 cP | | |
| 600 | | | | | | | |
| EC: 100-WPI- | Whey | Oleic Acid | . | . | Ethyl cellulose | . | . |
| OLEA_200-250- | | | | | 100 cP | | |
| 550 | | | | | | | |
| EC: 100-WPI- | Whey | Oleic Acid | . | . | Ethyl cellulose | . | . |
| OLEA_200-300- | | | | | 100 cP | | |
| 500 | | | | | | | |
| EC: 100-WPI- | Whey | Oleic Acid | . | . | Ethyl cellulose | . | . |
| OLEA_250-100- | | | | | 100 cP | | |
| 650 | | | | | | | |
| EC: 100-WPI- | Whey | Triolein | . | . | Ethyl cellulose | . | . |
| TOLE_200-100- | | | | | 100 cP | | |
| 700 | | | | | | | |
| EC: 300-WPI- | Whey | Oleic Acid | . | . | Ethyl cellulose | . | . |
| OLEA_200-100- | | | | | 300 cP | | |
| 700 | | | | | | | |
| GMO-EC: 100- | Whey | Oleic Acid | . | Glyceryl | Ethyl cellulose | . | . |
| WPI-OLEA_50- | | | | monooleate | 100 cP | | |
| 150-100-700 | | | | | | | |
| GMS-EC: 100- | Whey | Oleic Acid | . | Glyceryl | Ethyl cellulose | . | . |
| WPI-OLEA_50- | | | | monostearate | 100 cP | | |
| 150-100-700 | | | | | | | |
| K188-WPI- | Whey | Oleic Acid | Kolliphor | . | . | . | . |
| OLEA_250-100- | | | P188 | | | | |
| 650 | | | | | | | |
| PEG: PPG-WPI- | Whey | Oleic Acid | Poly(ethylene | . | . | . | . |
| OLEA_250-100- | | | glycol)-co- | | | | |
| 650 | | | Poly (propylene | . | . | . | , |
| | | | glycol) | | | | |
| PEG: PPG-WPI- | Whey | Oleic Acid | Poly(ethylene | . | . | . | . |
| OLEA | | | glycol)-co- | | | | |
| 300-100- | | | Poly(propylene | . | . | . | . |
| 600 | | | glycol) | | | | |
| RBW-EC: 100- | Whey | Oleic Acid | Rice Bran | . | Ethyl cellulose | | . |
| WPI-OLEA_50- | | | Wax | | 100 cP | | |
| 150-100-700 | | | | | | | |
| RBW-WPI- | Whey | Oleic Acid | Rice Bran | . | . | . | . |
| OLEA_100-100- | | | Wax | | | | |
| 800 | | | | | | | |
| RBW-WPI- | Whey | Oleic Acid | Rice Bran | . | . | . | . |
| OLEA_200-100- | | | Wax | | | | |
| 700 | | | | | | | |
| RBW-WPI- | Whey | Oleic Acid | Rice Bran | . | . | . | . |
| OLEA_200-200- | | | Wax | | | | |
| 600 | | | | | | | |
| RBW-WPI- | Whey | Oleic Acid | Rice Bran | . | . | . | . |
| OLEA_200-300- | | | Wax | | | | |
| 500 | | | | | | | |
| RBW-WPI- | Whey | Oleic Acid | Rice Bran | . | . | . | . |
| OLEA_250-100- | | | Wax | | | | |
| 650 | | | | | | | |
| SESO-LEC- | Whey | . | Sesame Oil | Lecithin | Ethyl cellulose | . | . |
| EC: 100- | | | | | 100 cP | | |
| WPI_750-150-50- | | | | | | | |
| 50 | | | | | | | |
| SIO2-WPI- | Whey | Oleic Acid | . | . | . | Silica | . |
| OLEA_50-100- | | | | | | | |
| 850 | | | | | | | |
| SiO2-WPI- | Whey | Oleic Acid | Silica | . | . | . | . |
| OLEA_75-100- | | | | | | | |
| 825 | | | | | | | |
| SITO-ORY- | Whey | Oleic Acid | Sitosterol | Oryzanol | Ethyl cellulose | | |
| EC: 100-WPI- | | | | | 100 cP | | |
| OLEA_60-40- | | | | | | | |
| 100-100-700 | | | | | | | |
| SITO-ORY-WPI- | Whey | Oleic Acid | Sitosterol | Oryzanol | . | . | . |
| OLEA_40-60- | | | | | | | |
| 100-800 | | | | | | | |
| SITO-ORY-WPI- | Whey | Oleic Acid | Sitosterol | Oryzanol | . | . | . |
| OLEA_60-40- | | | | | | | |
| 100-800 | | | | | | | |
| SITO-ORY-WPI- | Whey | Oleic Acid | Sitosterol | Oryzanol | . | . | . |
| OLEA_80-120- | | | | | | | |
| 100-700 | | | | | | | |
| SITO-ORY-WPI- | Whey | Oleic Acid | Sitosterol | Oryzanol | . | . | . |
| OLEA_90-60- | | | | | | | |
| 100-750 | | | | | | | |
| SITO-ORY-WPI- | Whey | Oleic Acid | Sitosterol | Oryzanol | . | . | . |
| OLEA_120-80- | | | | | | | |
| 100-700 | | | | | | | |
| SOYW-GEL50- | Whey | . | Hydrogenated | Gelucire | . | . | |
| WPI_750-150- | | | Soy Oil | 50/14 | | | . |
| 100 | | | | | | | |
| SOYW-LEC- | Whey | . | Hydrogenated | Lecithin | . | . | . |
| WPI_800-150-50 | | | Soy Oil | | | | |
| SOYW-LEC- | Whey | . | Hydrogenated | Lecithin | . | . | . |
| WPI_900-50-50 | | | Soy Oil | | | | |
| SOYW-SESO- | Whey | . | Hydrogenated | Sesame Oil | . | . | . |
| WPI_900-50-50 | | | Soy Oil | | | | |
| SOYW-T85- | Whey | . | Hydrogenated | Tween 85 | Ethyl cellulose | . | . |
| EC: 100- | | | Soy Oil | | 100 cP | | |
| WPI_800-50-50- | | | | | | | |
| 100 | | | | | | | |
| SOYW-T85- | Whey | . | Hydrogenated | Tween 85 | . | . | . |
| WPI_850-50-100 | | | Soy Oil | | | | |
| SOYW-WPI- | Whey | Oleic Acid | Hydrogenated | . | . | . | . |
| OLEA_150-100- | | | Soy Oil | | | | |
| 750 | | | | | | | |
| SP60-EC: 100- | Whey | Oleic Acid | . | Span 60 | Ethyl cellulose | . | . |
| WPI-OLEA_50- | | | | | 100 cP | | |
| 150-100-700 | | | | | | | |
| SP60-WPI- | Whey | Oleic Acid | . | Span 60 | . | . | . |
| OLEA_200-100- | | | | | | | |
| 700 | | | Span 60 | | | | |
| TSTE-EC: 100- | Whey | . | Tristearin | . | Ethyl cellulose | . | |
| WPI_850-50-100 | | | | | 100 cP | | |
| WPI_1000 | Whey | . | · | · | . | | . |

TABLE 4
Compositions of Exemplary Formulations

| | Analyte | Analyte | Excipient | Excipient | Excipient | Excipient | Water | K-value | K-Value |
|---|---|---|---|---|---|---|---|---|---|
| Formulation ID | 1% (w/w) | 2% (w/w) | 1% (w/w) | 2% (w/w) | 3% (w/w) | 4% (w/w) | % (w/w) | Analyte 1 | Analyte 2 |
| 27STE-EC: 100- | 10 | 0 | 85 | 0 | 5 | 0 | 0 | 0.0006929 | |
| WPI_850-50-100 | | | | | | | | | |
| 27STE-EC: 100- | 5 | 0 | 90 | 0 | 5 | 0 | 0 | 0.01083 | |
| WPI_900-50-50 | | | | | | | | | |
| 27STE-LEC- | 5 | 0 | 80 | 15 | 15 | 0 | 0 | | |
| WPI_800-150-50 | | | | | | | | | |
| 27STE-LEC- | 10 | 0 | 85 | 5 | 5 | 0 | 0 | | |
| WPI_850-50-100 | | | | | | | | | |
| 27STE-LEC- | 5 | 0 | 90 | 5 | 0 | 0 | 0 | 0.02036 | |
| WPI_900-50-50 | | | | | | | | | |
| 27STE-SITO- | 10 | 0 | 60 | 15 | 15 | 0 | 0 | 0.004512 | |
| ORY-WPI_600- | | | | | | | | | |
| 150-150-100 | | | | | | | | | |
| 27STE-SITO- | 5 | 0 | 65 | 2 | 29 | 0 | 0 | 0.0003874 | |
| ORY-WPI_650- | | | | | | | | | |
| 15-285-50 | | | | | | | | | |
| 27STE-SITO- | 5 | 0 | 65 | 6 | 24 | 0 | 0 | 0.001438 | |
| ORY-WPI_650- | | | | | | | | | |
| 60-240-50 | | | | | | | | | |
| 27STE-SITO- | 5 | 0 | 70 | 13 | 13 | 0 | 0 | | |
| ORY-WPI_700- | | | | | | | | | |
| 125-125-50 | | | | | | | | | |
| 27STE-SITO- | 5 | 0 | 75 | 10 | 10 | 0 | 0 | 0.004769 | |
| ORY-WPI_750- | | | | | | | | | |
| 100-100-50 | | | | | | | | | |
| 27STE-SITO- | 13 | 0 | 70 | 13 | 0 | 0 | 0 | 0.008695 | |
| WPI_700-125-125 | | | | | | | | | |
| 27STE-SITO- | 10 | 0 | 70 | 0 | 20 | 0 | 0 | 0.1063 | |
| WPI_700-200-100 | | | | | | | | | |
| 27STE-SITO- | 13 | 0 | 75 | 13 | 0 | 0 | 0 | 0.001754 | |
| WPI_750-125-125 | | | | | | | | | |
| 27STE-T85- | 10 | 0 | 80 | 5 | 5 | 0 | 0 | 0.007037 | |
| EC: 100-WPI_800- | | | | | | | | | |
| 50-50-100 | | | | | | | | | |
| 27STE-T85- | 10 | 0 | 85 | 5 | 0 | 0 | 0 | 0.01379 | |
| WPI_850-50-100 | | | | | | | | | |
| 27STE-WPI_900- | 10 | 0 | 90 | 0 | 0 | 0 | 0 | 0.002242 | |
| 100 | | | | | | | | | |
| 27STE-WPI- | 10 | 75 | 15 | 0 | 0 | 0 | 0 | 0.003952 | |
| OLEA_150-100- | | | | | | | | | |
| 750 | | | | | | | | | |
| 27STE-WPI- | 10 | 70 | 20 | 0 | 0 | 0 | 0 | 0.0002138 | 0.0001148 |
| OLEA_200-100- | | | | | | | | | |
| 700 | | | | | | | | | |
| 27STE-WPI- | 20 | 60 | 20 | 0 | 0 | 0 | 0 | 0.0002495 | |
| OLEA_200-200- | | | | | | | | | |
| 600 | | | | | | | | | |
| 27STE-WPI- | 20 | 40 | 40 | 0 | 0 | 0 | 0 | 0.01075 | |
| OLEA_400-200- | | | | | | | | | |
| 400 | | | | | | | | | |
| AGAR-C10- | 10 | 0 | 3 | 0 | 0 | 0 | 87 | 0.375872 | |
| WPI_30-3-100 | | | | | | | | | |
| AGAR-C10- | 10 | 0 | 3 | 3 | 0 | 0 | 84 | 0.199205 | |
| WPI_30-30-100 | | | | | | | | | |
| AGAR-C10- | 10 | 0 | 3 | 4 | 0 | 0 | 83 | 0.172681 | |
| WPI_30-40-100 | | | | | | | | | |
| AGAR-C10- | 10 | 0 | 3 | 10 | 0 | 0 | 77 | 0.0262123 | |
| WPI_30-100-100 | | | | | | | | | |
| AGAR-C10-WPI- | 10 | 10 | 3 | 0 | 0 | 0 | 77 | 0.01483 | 0.09681 |
| GLC_30-1-100- | | | | | | | | | |
| 100 | | | | | | | | | |
| AGAR-C10-WPI- | 10 | 10 | 3 | 1 | 0 | 0 | 76 | 0.08807 | |
| GLC_30-10-100- | | | | | | | | | |
| 100 | | | | | | | | | |
| AGAR-C18-WPI- | 10 | 10 | 3 | 0 | 0 | 0 | 77 | 0.01283 | 0.06172 |
| GLC_30-1-100- | | | | | | | | | |
| 100 | | | | | | | | | |
| AGAR-C18-WPI- | 10 | 10 | 3 | 1 | 0 | 0 | 76 | 0.01487 | 0.04847 |
| GLC_30-10-100- | | | | | | | | | |
| 100 | | | | | | | | | |
| AGAR-CAP-WPI- | 10 | 10 | 3 | 0 | 0 | 0 | 77 | 0.02558 | 0.2554 |
| GLC_30-1-100- | | | | | | | | | |
| 100 | | | | | | | | | |
| AGAR-CAP-WPI- | 10 | 10 | 3 | 1 | 0 | 0 | 76 | 0.009587 | 0.09474 |
| GLC_30-10-100- | | | | | | | | | |
| 100 | | | | | | | | | |
| AGAR-CHIHI- | 10 | 10 | 3 | 0 | 0 | 0 | 77 | 0.00765 | |
| WPI-GLC_30-1- | | | | | | | | | |
| 100-100 | | | | | | | | | |
| AGAR-CHIHI- | 10 | 10 | 3 | 1 | 0 | 0 | 76 | 0.1544 | |
| WPI-GLC_30-10- | | | | | | | | | |
| 100-100 | | | | | | | | | |
| AGAR-CHILO- | 10 | 0 | 3 | 0 | 0 | 0 | 87 | 0.010076 | |
| WPI_30-1-100 | | | | | | | | | |
| AGAR-CHILO- | 10 | 0 | 3 | 3 | 0 | 0 | 84 | 0.032788 | |
| WPI_30-30-100 | | | | | | | | | |
| AGAR-CHILO- | 10 | 0 | 3 | 10 | 0 | 0 | 77 | 0.0128367 | |
| WPI_30-100-100 | | | | | | | | | |
| AGAR-CHILO- | 10 | 0 | 5 | 0 | 1 | 0 | 85 | 0.05856 | |
| WPI_50-5-100 | | | | | | | | | |
| AGAR-CMC: 90- | 10 | 0 | 5 | 0 | 2 | 0 | 83 | 0.01874 | |
| WPI_50-20-100 | | | | | | | | | |
| AGAR-CMC: 90- | 10 | 20 | 3 | 0 | 0 | 0 | 67 | 0.01355 | 0.2331 |
| WPI-GLC_30-1- | | | | | | | | | |
| 100-200 | | | | | | | | | |
| AGAR-CMC: 90- | 10 | 20 | 3 | 1 | 0 | 0 | 66 | 0.009649 | 0.1518 |
| WPI-GLC_30-10- | | | | | | | | | |
| 100-200 | | | | | | | | | |
| AGAR-CMC: 250- | 10 | 20 | 3 | 0 | 0 | 0 | 67 | 0.009799 | 0.06413 |
| WPI-GLC_30-1- | | | | | | | | | |
| 100-200 | | | | | | | | | |
| AGAR-CMC: 250- | 10 | 20 | 3 | 1 | 0 | 0 | 66 | 0.00848 | 0.1581 |
| WPI-GLC_30-10- | | | | | | | | | |
| 100-200 | | | | | | | | | |
| AGAR-CSCRM- | 10 | 20 | 3 | 0 | 0 | 0 | 67 | 0.01146 | 0.05442 |
| WPI-GLC_30-1- | | | | | | | | | |
| 100-200 | | | | | | | | | |
| AGAR-CSCRM- | 10 | 20 | 3 | 1 | 0 | 0 | 66 | 0.01069 | 0.05758 |
| WPI-GLC_30-10- | | | | | | | | | |
| 100-200 | | | | | | | | | |
| AGAR-EPO- | 10 | 0 | 3 | 0 | 0 | 0 | 87 | 0.448637 | |
| WPI_30-1-100 | | | | | | | | | |
| AGAR-EPO- | 10 | 0 | 3 | 1 | 0 | 0 | 86 | 0.0411863 | |
| WPI_30-10-100 | | | | | | | | | |
| AGAR-EPO- | 10 | 0 | 3 | 10 | 0 | 0 | 77 | 0.037227 | |
| WPI_30-100-100 | | | | | | | | | |
| AGAR-EPO-WPI- | 10 | 10 | 3 | 0 | 0 | 0 | 77 | 0.007869 | 0.05421 |
| GLC_30-1-100- | | | | | | | | | |
| 100 | | | | | | | | | |
| AGAR-ETGALT- | 10 | 10 | 3 | 0 | 0 | 0 | 77 | 0.03514 | 0.07622 |
| WPI-GLC_30-1- | | | | | | | | | |
| 100-100 | | | | | | | | | |
| AGAR-FRUC- | 10 | 0 | 5 | 0 | 20 | 0 | 65 | 0.03218 | |
| WPI_50-200-100 | | | | | | | | | |
| AGAR-G4414- | 10 | 10 | 3 | 0 | 0 | 0 | 77 | 0.01423 | 0.07799 |
| WPI-GLC_30-1- | | | | | | | | | |
| 100-100 | | | | | | | | | |
| AGAR-G4414- | 10 | 10 | 3 | 1 | 0 | 0 | 76 | 0.01386 | 0.08108 |
| WPI-GLC_30-10- | | | | | | | | | |
| 100-100 | | | | | | | | | |
| AGAR-G5013- | 10 | 20 | 3 | 1 | 0 | 0 | 67 | 0.0101 | 0.04971 |
| WPI-GLC_30-5- | | | | | | | | | |
| 100-200 | | | | | | | | | |
| AGAR-G5013- | 10 | 20 | 3 | 5 | 0 | 0 | 62 | 0.01219 | 0.07255 |
| WPI-GLC_30-50- | | | | | | | | | |
| 100-200 | | | | | | | | | |
| AGAR-G5914- | 10 | 20 | 3 | 1 | 0 | 0 | 67 | 0.008405 | 0.06745 |
| WPI-GLC_30-5- | | | | | | | | | |
| 100-200 | | | | | | | | | |
| AGAR-G5914- | 10 | 20 | 3 | 5 | 0 | 0 | 62 | 0.01513 | 0.09196 |
| WPI-GLC_30-50- | | | | | | | | | |
| 100-200 | | | | | | | | | |
| AGAR-GELLG- | 10 | 10 | 3 | 0 | 0 | 0 | 77 | 0.02084 | 0.08033 |
| WPI-GLC_30-1- | | | | | | | | | |
| 100-100 | | | | | | | | | |
| AGAR-GELLG- | 10 | 10 | 3 | 1 | 0 | 0 | 76 | 0.01825 | 0.1613 |
| WPI-GLC_30-10- | | | | | | | | | |
| 100-100 | | | | | | | | | |
| AGAR-GHATG- | 10 | 10 | 3 | 0 | 0 | 0 | 77 | 0.01568 | 0.06868 |
| WPI-GLC_30-1- | | | | | | | | | |
| 100-100 | | | | | | | | | |
| AGAR-GHATG- | 10 | 10 | 3 | 0 | 1 | 0 | 76 | 0.03317 | 0.2493 |
| WPI-GLC_30-10- | 10 | 10 | 3 | 1 | 0 | 0 | 76 | 0.01647 | 0.01013 |
| 100-100 | | | | | | | | | |
| AGAR-GHATG- | 10 | 10 | 3 | 0 | 1 | 0 | 76 | 0.002823 | 0.01909 |
| WPI-GLC_30-10- | | | | | | | | | |
| 100-100; CT-MC- | | | | | | | | | |
| GY_9-23-63 | | | | | | | | | |
| AGAR-GHATG- | 10 | 10 | 3 | 0 | 1 | 0 | 76 | 0.003684 | 0.01984 |
| WPI-GLC_30-10- | | | | | | | | | |
| 100-100; CT-MC- | | | | | | | | | |
| PEG_9-23-63 | | | | | | | | | |
| AGAR-GHATG- | 10 | 10 | 3 | 0 | 1 | 0 | 76 | 0.00297 | 0.006496 |
| WPI-GLC_30-10- | | | | | | | | | |
| 100-100; PVAC- | | | | | | | | | |
| PG-SA_40-40-20 | | | | | | | | | |
| AGAR-GHATG- | 10 | 10 | 3 | 0 | 1 | 0 | 76 | 0.002667 | 0.005892 |
| WPI-GLC_30-10- | | | | | | | | | |
| 100-100; PVAC- | | | | | | | | | |
| PG-SA_44-44-12 | | | | | | | | | |
| AGAR-GRRHA- | 10 | 20 | 3 | 0 | 0 | 0 | 67 | 0.01049 | 0.05238 |
| WPI-GLC_30-1- | | | | | | | | | |
| 100-200 | | | | | | | | | |
| AGAR-GRRHA- | 10 | 20 | 3 | 1 | 0 | 0 | 66 | 0.008465 | 0.05361 |
| WPI-GLC_30-10- | | | | | | | | | |
| 100-200 | | | | | | | | | |
| AGAR-HAP: 5U- | 10 | 20 | 3 | 0 | 0 | 0 | 67 | 0.01091 | 0.04267 |
| GHATG-WPI- | | | | | | | | | |
| GLC_30-1-3-100- | | | | | | | | | |
| 200 | | | | | | | | | |
| AGAR-HAP: 5U- | 10 | 20 | 3 | 1 | 0 | 0 | 66 | 0.01423 | 0.06465 |
| GHATG-WPI- | | | | | | | | | |
| GLC_30-10-3-100- | | | | | | | | | |
| 200 | | | | | | | | | |
| AGAR-HAP: 5U- | 10 | 0 | 3 | 1 | 0 | 0 | 86 | 0.329519 | |
| WPI_30-10-100 | | | | | | | | | |
| AGAR-HAP: 5U- | 10 | 0 | 3 | 3 | 0 | 0 | 84 | 0.198105 | |
| WPI_30-30-100 | | | | | | | | | |
| AGAR-HAP: 5U- | 10 | 0 | 3 | 10 | 0 | 0 | 77 | 0.365471 | |
| WPI_30-100-100 | | | | | | | | | |
| AGAR-HPMC- | 10 | 0 | 5 | 0 | 1 | 0 | 84 | 0.06992 | |
| WPI_50-10-100 | | | | | | | | | |
| AGAR-HPMC- | 10 | 10 | 3 | 0 | 0 | 0 | 77 | 0.01006 | 0.02914 |
| WPI-GLC_30-1- | | | | | | | | | |
| 100-100 | | | | | | | | | |
| AGAR-HPMC- | 10 | 10 | 3 | 1 | 0 | 0 | 76 | 0.0141 | 0.05511 |
| WPI-GLC_30-10- | | | | | | | | | |
| 100-100 | | | | | | | | | |
| AGAR-ICARR- | 10 | 10 | 3 | 0 | 0 | 0 | 77 | 0.01164 | |
| WPI-GLC_30-1- | | | | | | | | | |
| 100-100 | | | | | | | | | |
| AGAR-ICARR- | 10 | 10 | 3 | 1 | 0 | 0 | 76 | 0.01886 | |
| WPI-GLC_30-10- | | | | | | | | | |
| 100-100 | | | | | | | | | |
| AGAR-KARG- | 10 | 0 | 5 | 0 | 1 | 0 | 84 | 0.271 | |
| WPI_50-10-100 | | | | | | | | | |
| AGAR-KARG- | 10 | 10 | 3 | 0 | 0 | 0 | 77 | 0.005788 | 0.02387 |
| WPI-GLC_30-1- | | | | | | | | | |
| 100-100 | | | | | | | | | |
| AGAR-KARG- | 10 | 10 | 3 | 1 | 0 | 0 | 76 | 0.003353 | 0.05983 |
| WPI-GLC_30-10- | | | | | | | | | |
| 100-100 | | | | | | | | | |
| AGAR-KCARR- | 15 | 10 | 3 | 0 | 0 | 0 | 72 | 0.0230076 | |
| LBG-CAP-WPI- | | | | | | | | | |
| GLC_30-1-1-150- | | | | | | | | | |
| 100 | | | | | | | | | |
| AGAR-KCARR- | 15 | 10 | 3 | 0 | 0 | 0 | 72 | 0.054176 | |
| LBG-E PO-WPI- | | | | | | | | | |
| GLC_30-1-1-150- | | | | | | | | | |
| 100 | | | | | | | | | |
| AGAR-KCARR- | 10 | 10 | 3 | 0 | 0 | 0 | 77 | 0.01123 | 0.06378 |
| WPI-GLC_30-1- | | | | | | | | | |
| 100-100 | | | | | | | | | |
| AGAR-KCARR- | 10 | 10 | 3 | 1 | 0 | 0 | 76 | 0.04661 | 0.08143 |
| WPI-GLC_30-10- | | | | | | | | | |
| 100-100 | | | | | | | | | |
| AGAR-LBG-WPI- | 10 | 10 | 3 | 0 | 0 | 0 | 77 | 0.301 | 0.208 |
| GLC_30-1-100- | | | | | | | | | |
| 100 | | | | | | | | | |
| AGAR-LBG-WPI- | 10 | 10 | 3 | 1 | 0 | 0 | 76 | 0.1892 | |
| GLC_30-10-100- | | | | | | | | | |
| 100 | | | | | | | | | |
| AGAR-MC: 15- | 10 | 20 | 3 | 1 | 0 | 0 | 66 | 0.0114 | 0.03902 |
| GHATG-WPI- | | | | | | | | | |
| GLC_30-5-3-100- | | | | | | | | | |
| 200 | | | | | | | | | |
| AGAR-MC: 15- | 10 | 20 | 3 | 5 | 0 | 0 | 62 | 0.01024 | 0.05064 |
| GHATG-WPI- | | | | | | | | | |
| GLC_30-50-3-100- | | | | | | | | | |
| 200 | | | | | | | | | |
| AGAR-PAA: 450- | 10 | 0 | 3 | 0 | 0 | 0 | 87 | 0.0375111 | |
| WPI_30-3-100 | | | | | | | | | |
| AGAR-PAA: 450- | 10 | 0 | 3 | 2 | 0 | 0 | 85 | 0.0413748 | |
| WPI_30-20-100 | | | | | | | | | |
| AGAR-PAA: 450- | 10 | 0 | 3 | 10 | 0 | 0 | 77 | 0.0509346 | |
| WPI_30-100-100 | | | | | | | | | |
| AGAR-PAA: 450- | 10 | 0 | 5 | 0 | 2 | 0 | 83 | 0.00359 | |
| WPI_50-20-100 | | | | | | | | | |
| AGAR-PAA: 450- | 10 | 10 | 3 | 0 | 0 | 0 | 77 | 0.0113 | 0.02782 |
| WPI-GLC_30-1- | | | | | | | | | |
| 100-100 | | | | | | | | | |
| AGAR-PAA: 450- | 10 | 10 | 3 | 0 | 0 | 0 | 77 | 0.00275 | 0.005724 |
| WPI-GLC_30-1- | | | | | | | | | |
| 100-100; PVAC- | | | | | | | | | |
| PG-SA_44-11-44 | | | | | | | | | |
| AGAR-PAA: 450- | 10 | 10 | 3 | 0 | 0 | 0 | 77 | 0.003031 | 0.006915 |
| WPI-GLC_30-1- | | | | | | | | | |
| 100-100; ZEIN- | | | | | | | | | |
| GY_60-40 | | | | | | | | | |
| AGAR-PAA: 450- | 10 | 20 | 3 | 0 | 0 | 0 | 67 | 0.01604 | 0.06404 |
| WPI-GLC_30-1- | | | | | | | | | |
| 100-200 | | | | | | | | | |
| AGAR-PAA: 450- | 10 | 20 | 3 | 1 | 0 | 0 | 66 | 0.01121 | 0.05835 |
| WPI-GLC_30-10- | | | | | | | | | |
| 100-200 | | | | | | | | | |
| AGAR-PGA- | 10 | 20 | 3 | 1 | 0 | 0 | 66 | 0.01919 | 0.1255 |
| GELLG-WPI- | | | | | | | | | |
| GLC_30-10-3-100- | | | | | | | | | |
| 200 | | | | | | | | | |
| AGAR-PGA- | 10 | 20 | 3 | 1 | 0 | 0 | 66 | 0.02001 | 0.04648 |
| GHATG-WPI- | | | | | | | | | |
| GLC_30-10-3-100- | | | | | | | | | |
| 200 | | | | | | | | | |
| AGAR-PGA-WPI- | 10 | 20 | 3 | 0 | 0 | 0 | 67 | 0.02269 | 0.08364 |
| GLC_30-1-100- | | | | | | | | | |
| 200 | | | | | | | | | |
| AGAR-PGA-WPI- | 10 | 20 | 3 | 1 | 0 | 0 | 66 | 0.01993 | 0.0779 |
| GLC_30-10-100- | | | | | | | | | |
| 200 | | | | | | | | | |
| AGAR-PGA- | 10 | 20 | 3 | 1 | 0 | 0 | 66 | 1 | 1 |
| XGUM-WPI- | | | | | | | | | |
| GLC_30-10-3-100- | | | | | | | | | |
| 200 | | | | | | | | | |
| AGAR-PHYTG- | 10 | 20 | 3 | 0 | 0 | 0 | 67 | | |
| WPI-GLC_30-1- | | | | | | | | | |
| 100-200 | | | | | | | | | |
| AGAR-PHYTG- | 10 | 20 | 3 | 0 | 0 | 0 | 67 | 0.009682 | 0.02801 |
| WPI-GLC_30-1- | | | | | | | | | |
| 100-200; ZEIN- | | | | | | | | | |
| CITREM-GY_44- | | | | | | | | | |
| 28-28 | | | | | | | | | |
| AGAR-PHYTG- | 10 | 20 | 3 | 0 | 0 | 0 | 67 | 0.01557 | 0.02214 |
| WPI-GLC_30-1- | | | | | | | | | |
| 100-200; ZEIN- | | | | | | | | | |
| CITREM-GY_52- | | | | | | | | | |
| 32-16 | | | | | | | | | |
| AGAR-PHYTG- | 10 | 20 | 3 | 1 | 0 | 0 | 66 | 0.009641 | 0.04462 |
| WPI-GLC_30-10- | | | | | | | | | |
| 100-200 | | | | | | | | | |
| AGAR-PVP: 1.3M- | 10 | 20 | 3 | 0 | 0 | 0 | 67 | 0.005467 | 0.09756 |
| GHATG-WPI- | | | | | | | | | |
| GLC_30-1-3-100- | | | | | | | | | |
| 200 | | | | | | | | | |
| AGAR-PVP: 1.3M- | 10 | 20 | 3 | 1 | 0 | 0 | 66 | 0.008397 | 0.0496 |
| GHATG-WPI- | | | | | | | | | |
| GLC_30-10-3-100- | | | | | | | | | |
| 200 | | | | | | | | | |
| AGAR-PVP: 10- | 10 | 20 | 3 | 0 | 0 | 0 | 67 | 0.0101 | 0.05606 |
| GHATG-WPI- | | | | | | | | | |
| GLC_30-1-3-100- | | | | | | | | | |
| 200 | | | | | | | | | |
| AGAR-PVP: 10- | 10 | 20 | 3 | 1 | 0 | 0 | 66 | 0.01123 | 0.06823 |
| GHATG-WPI- | | | | | | | | | |
| GLC_30-10-3-100- | | | | | | | | | |
| 200 | | | | | | | | | |
| AGAR-PVP: 40- | 10 | 0 | 3 | 3 | 0 | 0 | 84 | 0.0361016 | |
| WPI_30-30-100 | | | | | | | | | |
| AGAR-PVP: 1300- | 10 | 0 | 5 | 0 | 1 | 0 | 84 | 0.08688 | |
| WPI_50-10-100 | | | | | | | | | |
| AGAR-QUILL- | 10 | 0 | 3 | 1 | 0 | 0 | 86 | 0.00833695 | |
| WPI_30-10-100 | | | | | | | | | |
| AGAR-RICO- | 10 | 20 | 3 | 5 | 0 | 0 | 62 | 0.2624 | 0.4936 |
| WPI-GLC_30-50- | | | | | | | | | |
| 100-200 | | | | | | | | | |
| AGAR-SP60-T60- | 10 | 20 | 3 | 0 | 0 | 0 | 67 | 0.01399 | 0.05291 |
| WPI-GLC_30-3.3- | | | | | | | | | |
| 1.6-100-200 | | | | | | | | | |
| AGAR-SP60-T60- | 10 | 20 | 3 | 3 | 2 | 0 | 62 | 0.01979 | 0.1578 |
| WPI-GLC_30-33- | | | | | | | | | |
| 16-100-200 | | | | | | | | | |
| AGAR-SP60- | 10 | 20 | 3 | 3 | 2 | 0 | 62 | | 0.02466 |
| TW60-WPI- | | | | | | | | | |
| GLC_30-33-16- | | | | | | | | | |
| 100-200 | | | | | | | | | |
| AGAR-SP60- | 10 | 20 | 3 | 3 | 2 | 0 | 62 | | 0.008864 |
| TW60-WPI- | | | | | | | | | |
| GLC_30-33-16- | | | | | | | | | |
| 100-200; ZEIN- | | | | | | | | | |
| CIT-LA 26-8-66 | | | | | | | | | |
| AGAR-SP60- | 10 | 20 | 3 | 3 | 2 | 0 | 62 | | 0.005005 |
| TW60-WPI- | | | | | | | | | |
| GLC_30-33-16- | | | | | | | | | |
| 100-200; ZEIN- | | | | | | | | | |
| CIT-LA 28-18-54 | | | | | | | | | |
| AGAR-SP60- | 10 | 20 | 3 | 3 | 2 | 0 | 62 | | 0.007772 |
| TW60-WPI- | | | | | | | | | |
| GLC_30-33-16- | | | | | | | | | |
| 100-200; ZEIN- | | | | | | | | | |
| CIT-LA 34-21-46 | | | | | | | | | |
| AGAR-SP60- | 10 | 20 | 3 | 3 | 2 | 0 | 62 | | 0.008459 |
| TW60-WPI- | | | | | | | | | |
| GLC_30-33-16- | | | | | | | | | |
| 100-200; ZEIN- | | | | | | | | | |
| CIT-LA 40-12-48 | | | | | | | | | |
| AGAR-T60- | 10 | 0 | 5 | 1 | 0 | 0 | 84 | 0.007242 | |
| WPI_50-10-100 | | | | | | | | | |
| AGAR-TRAGG- | 10 | 20 | 3 | 0 | 0 | 0 | 67 | 0.01794 | 0.08229 |
| WPI-GLC_30-1- | | | | | | | | | |
| 100-200 | | | | | | | | | |
| AGAR-TRAGG- | 10 | 20 | 3 | 1 | 0 | 0 | 66 | 0.02402 | 0.1016 |
| WPI-GLC_30-10- | | | | | | | | | |
| 100-200 | | | | | | | | | |
| AGAR-TSTE- | 10 | 10 | 3 | 0 | 0 | 0 | 77 | 0.0899 | 0.1057 |
| WPI-GLC_30-1- | | | | | | | | | |
| 100-100 | | | | | | | | | |
| AGAR-TSTE- | 10 | 10 | 3 | 1 | 0 | 0 | 76 | 0.1664 | 0.1102 |
| WPI-GLC_30-10- | | | | | | | | | |
| 100-100 | | | | | | | | | |
| AGAR-VC18- | 10 | 0 | 5 | 0 | 2 | 0 | 83 | 0.02671 | |
| WPI_50-20-100 | | | | | | | | | |
| AGAR-WPI_20- | 10 | 0 | 2 | 0 | 0 | 0 | 88 | 0.01673 | |
| 100 | | | | | | | | | |
| AGAR-WPI_50- | 10 | 0 | 5 | 0 | 0 | 0 | 85 | 0.006709 | |
| 100 | | | | | | | | | |
| AGAR-WPI- | 10 | 20 | 3 | 0 | 0 | 0 | 67 | 0.01157 | 0.06561 |
| GLC_30-100-200 | | | | | | | | | |
| ALG-CHILO- | 0 | 20 | 2 | 1 | 0 | 0 | 77 | | 0.2518 |
| GLC-INLN_16-10-0 | | | | | | | | | |
| 200-50 | | | | | | | | | |
| ALG-GLC- | 0 | 20 | 2 | 0 | 0 | 0 | 78 | | 0.4862 |
| INLN_16-200-50 | | | | | | | | | |
| ALG-HAP: 5U- | 0 | 15 | 2 | 4 | 0 | 0 | 79 | | 0.07952 |
| GLC-INLN_16-40- | | | | | | | | | |
| 150-35 | | | | | | | | | |
| ALG-HPMC-GLC- | 0 | 15 | 2 | 0 | 0 | 0 | 83 | | 0.09225 |
| INLN_16-4-150-35 | | | | | | | | | |
| ALG-MC-GLC- | 0 | 15 | 2 | 3 | 0 | 0 | 80 | | 0.1913 |
| INLN_16-32-150- | | | | | | | | | |
| 35 | | | | | | | | | |
| ALG-T85-GLC- | 0 | 15 | 2 | 4 | 0 | 0 | 79 | | 0.1199 |
| INLN_16-40-150- | | | | | | | | | |
| 35 | | | | | | | | | |
| BSWX-EC: 100- | 10 | 70 | 15 | 0 | 5 | 0 | 0 | 0.0004784 | 0.000009128 |
| WPI-OLEA_150- | | | | | | | | | |
| 50-100-700 | | | | | | | | | |
| BSWX-LEC- | 10 | 0 | 75 | 15 | 0 | 0 | 0 | 0.004747 | |
| WPI_750-150-100 | | | | | | | | | |
| BSWX-LEC- | 5 | 0 | 80 | 15 | 0 | 0 | 0 | 0.00356 | |
| WPI_800-150-50 | | | | | | | | | |
| BSWX-T85- | 10 | 0 | 80 | 5 | 5 | 0 | 0 | 0.0027 | |
| EC: 100-WPI_800- | | | | | | | | | |
| 50-50-100 | | | | | | | | | |
| BSWX-T85- | 10 | 0 | 75 | 15 | 0 | 0 | 0 | 0.003024 | |
| WPI_750-150-100 | | | | | | | | | |
| BSWX-T85- | 5 | 0 | 80 | 15 | 0 | 0 | 0 | 0.003309 | |
| WPI_800-150-50 | | | | | | | | | |
| BSWX-T85- | 10 | 0 | 85 | 5 | 0 | 0 | 0 | 0.005213 | |
| WPI_850-50-100 | | | | | | | | | |
| BSWX-T85- | 5 | 0 | 90 | 5 | 0 | 0 | 0 | 0.001274 | |
| WPI_900-50-50 | | | | | | | | | |
| BSWX-WPI_900- | 10 | 0 | 90 | 0 | 0 | 0 | 0 | 0.003661 | |
| 100 | | | | | | | | | |
| BSWX-WPI- | 10 | 75 | 15 | 0 | 0 | 0 | 0 | 0.003922 | |
| OLEA_150-100- | | | | | | | | | |
| 750 | | | | | | | | | |
| BSWX-WPI- | 10 | 70 | 20 | 0 | 0 | 0 | 0 | | |
| OLEA_200-100- | | | | | | | | | |
| 700 | | | | | | | | | |
| BSWX-WPI- | 10 | 70 | 20 | 0 | 0 | 0 | 0 | | |
| TOLE_200-100- | | | | | | | | | |
| 700 | | | | | | | | | |
| CANDW-EC: 100- | 10 | 0 | 85 | 0 | 5 | 0 | 0 | | |
| WPI_850-50-100 | | | | | | | | | |
| CANDW-GEL50- | 10 | 0 | 75 | 15 | 0 | 0 | 0 | 0.004734 | |
| WPI_750-150-100 | | | | | | | | | |
| CANDW-GEL50- | 5 | 0 | 80 | 15 | 0 | 0 | 0 | 0.00002082 | |
| WPI_800-150-50 | | | | | | | | | |
| CANDW-GEL50- | 10 | 0 | 85 | 5 | 0 | 0 | 0 | 0.0003986 | |
| WPI_850-50-100 | | | | | | | | | |
| CANDW-WPI- | 10 | 75 | 15 | 0 | 0 | 0 | 0 | 0.0005495 | |
| OLEA_150-100- | | | | | | | | | |
| 750 | | | | | | | | | |
| CANDW-WPI- | 15 | 65 | 20 | 0 | 0 | 0 | 0 | 0.0009048 | |
| OLEA_200-150- | | | | | | | | | |
| 650 | | | | | | | | | |
| CANDW-WPI- | 10 | 70 | 20 | 0 | 0 | 0 | 0 | 0.0005591 | |
| TOLE_200-100- | | | | | | | | | |
| 700 | | | | | | | | | |
| CARNW-EC-WPI- | 10 | 65 | 10 | 0 | 15 | 0 | 0 | | |
| OLEA_100-150- | | | | | | | | | |
| 100-650; CAP | | | | | | | | | |
| CARNW-EC-WPI- | 10 | 65 | 10 | 0 | 15 | 0 | 0 | | |
| OLEA_100-150- | | | | | | | | | |
| 100-650; EPO | | | | | | | | | |
| CARNW-EC: 100- | 10 | 65 | 10 | 0 | 15 | 0 | 0 | | |
| WPI-OLEA_100- | | | | | | | | | |
| 150-100-650 | | | | | | | | | |
| CARNW-LEC- | 10 | 0 | 75 | 0 | 15 | 0 | 0 | | |
| WPI_750-150-100 | | | | | | | | | |
| CARNW-LEC- | 5 | 0 | 80 | 15 | 0 | 0 | 0 | 0.00001213 | |
| WPI_800-150-50 | | | | | | | | | |
| CARNW-LEC- | 10 | 0 | 85 | 5 | 0 | 0 | 0 | 0.1405 | |
| WPI_850-50-100 | | | | | | | | | |
| CARNW-WPI- | 10 | 75 | 15 | 0 | 0 | 0 | 0 | 0.002074 | |
| OLEA_150-100- | | | | | | | | | |
| 750 | | | | | | | | | |
| CARNW-WPI- | 10 | 70 | 20 | 0 | 0 | 0 | 0 | 0.0005332 | |
| OLEA_200-100- | | | | | | | | | |
| 700 | | | | | | | | | |
| CEW-EC: 100- | 10 | 0 | 75 | 0 | 15 | 0 | 0 | 0.03451 | |
| WPI_750-150-100 | | | | | | | | | |
| CEW-EC: 100- | 5 | 0 | 80 | 0 | 15 | 0 | 0 | 0.00001372 | |
| WPI_800-150-50 | | | | | | | | | |
| CEW-EC: 100- | 10 | 0 | 85 | 0 | 5 | 0 | 0 | 0.007073 | |
| WPI_850-50-100 | | | | | | | | | |
| CEW-EC: 100- | 5 | 0 | 90 | 0 | 5 | 0 | 0 | 0.01618 | |
| WPI_900-50-50 | | | | | | | | | |
| CEW-GEL50- | 10 | 0 | 75 | 15 | 0 | 0 | 0 | 0.01036 | |
| WPI_750-150-100 | | | | | | | | | |
| CEW-GEL50- | 5 | 0 | 80 | 15 | 0 | 0 | 0 | 0.01098 | |
| WPI_800-150-50 | | | | | | | | | |
| CEW-GEL50- | 10 | 0 | 85 | 5 | 0 | 0 | 0 | 7.452E−07 | |
| WPI_850-50-100 | | | | | | | | | |
| CEW-GEL50- | 5 | 0 | 90 | 5 | 0 | 0 | 0 | 0.000001001 | |
| WPI_900-50-50 | | | | | | | | | |
| CEW-KARG- | 5 | 0 | 80 | 0 | 15 | 0 | 0 | 0.001463 | |
| WPI_800-150-50 | | | | | | | | | |
| CEW-KARG- | 5 | 0 | 90 | 5 | 0 | 0 | 0 | 0.01872 | |
| WPI_900-50-50 | | | | | | | | | |
| CEW-LEC- | 10 | 0 | 75 | 15 | 0 | 0 | 0 | 0.008048 | |
| WPI_750-150-100 | | | | | | | | | |
| CEW-LEC- | 5 | 0 | 90 | 5 | 0 | 0 | 0 | 0.008102 | |
| WPI_900-50-50 | | | | | | | | | |
| CEW-S40- | 10 | 0 | 75 | 15 | 0 | 0 | 0 | | |
| WPI_750-150-100 | | | | | | | | | |
| CEW-S40- | 5 | 0 | 90 | 5 | 0 | 0 | 0 | 0.0002294 | |
| WPI_900-50-50 | | | | | | | | | |
| CEW-S80- | 10 | 0 | 75 | 15 | 0 | 0 | 0 | 0.005248 | |
| WPI_750-150-100 | | | | | | | | | |
| CEW-S80- | 5 | 0 | 90 | 5 | 0 | 0 | 0 | | |
| WPI_900-50-50 | | | | | | | | | |
| CEW-SESO- | 10 | 0 | 75 | 15 | 0 | 0 | 0 | 0.007158 | |
| WPI_750-150-100 | | | | | | | | | |
| CEW-SESO- | 5 | 0 | 80 | 15 | 0 | 0 | 0 | 0.001934 | |
| WPI_800-150-50 | | | | | | | | | |
| CEW-SESO- | 10 | 0 | 85 | 5 | 0 | 0 | 0 | 0.004032 | |
| WPI_850-50-100 | | | | | | | | | |
| CEW-SESO- | 5 | 0 | 90 | 5 | 0 | 0 | 0 | 0.005689 | |
| WPI_900-50-50 | | | | | | | | | |
| CEW-SITO- | 10 | 0 | 70 | 20 | 0 | 0 | 0 | 0.005242 | |
| WPI_700-200-100 | | | | | | | | | |
| CEW-T85- | 10 | 0 | 75 | 15 | 0 | 0 | 0 | 0.01291 | |
| WPI_750-150-100 | | | | | | | | | |
| CEW-WPI- | 10 | 70 | 20 | 0 | 0 | 0 | 0 | | |
| TOLE_200-100- | | | | | | | | | |
| 700 | | | | | | | | | |
| CHILO-GENI- | 10 | 0 | 2 | 0 | 0 | 0 | 88 | | |
| WPI_18-2-100 | | | | | | | | | |
| CHILO-WPI_12- | 10 | 0 | 1 | 0 | 0 | 0 | 89 | | |
| 100 | | | | | | | | | |
| CITREM- | 10 | 0 | 75 | 0 | 15 | 0 | 0 | | |
| CARNW- | | | | | | | | | |
| WPI_750-150-100 | | | | | | | | | |
| COCOW-EC: 100- | 10 | 0 | 75 | 0 | 15 | 0 | 0 | 0.005566 | |
| WPI_750-150-100 | | | | | | | | | |
| COCOW-EC: 100- | 5 | 0 | 80 | 0 | 15 | 0 | 0 | 0.00449 | |
| WPI_800-150-50 | | | | | | | | | |
| COCOW-EC: 100- | 10 | 0 | 85 | 0 | 5 | 0 | 0 | 0.00823 | |
| WPI_850-50-100 | | | | | | | | | |
| COCOW-EC: 100- | 5 | 0 | 90 | 5 | 0 | 0 | 0 | 0.02678 | |
| WPI_900-50-50 | | | | | | | | | |
| COCOW-SESO- | 10 | 0 | 85 | 5 | 0 | 0 | 0 | | |
| WPI_850-50-100 | | | | | | | | | |
| COCOW-SESO- | 5 | 0 | 90 | 5 | 0 | 0 | 0 | 0.06061 | |
| WPI_900-50-50 | | | | | | | | | |
| DTPS-T85- | 10 | 0 | 80 | 2 | 0 | 0 | 0 | 0.01874 | |
| WPI_800-20-100 | | | | | | | | | |
| EC: 22-WPI- | 10 | 70 | 0 | 0 | 20 | 0 | 0 | 0.003922 | |
| OLEA_200-100- | | | | | | | | | |
| 700 | | | | | | | | | |
| EC: 100-SIO2- | 20 | 6 | 0 | 0 | 15 | 5 | 0 | 0.00002603 | |
| WPI-OLEA_150- | | | | | | | | | |
| 50-200-60 | | | | | | | | | |
| EC: 100-WPI- | 10 | 70 | 20 | 0 | 0 | 0 | 0 | | |
| GMO_200-100- | | | | | | | | | |
| 700 | | | | | | | | | |
| EC: 100-WPI- | 10 | 80 | 0 | 0 | 10 | 0 | 0 | 0.00373 | |
| OLEA_100-100- | | | | | | | | | |
| 800 | | | | | | | | | |
| EC: 100-WPI- | 10 | 75 | 0 | 0 | 15 | 0 | 0 | 0.000363 | |
| OLEA_150-100- | | | | | | | | | |
| 750 | | | | | | | | | |
| EC: 100-WPI- | 10 | 70 | 20 | 0 | 0 | 0 | 0 | | |
| OLEA_200-100- | | | | | | | | | |
| 700 | | | | | | | | | |
| EC: 100-WPI- | 20 | 60 | 0 | 0 | 20 | 0 | 0 | 0.000001753 | 0.0001269 |
| OLEA_200-200- | | | | | | | | | |
| 600 | | | | | | | | | |
| EC: 100-WPI- | 25 | 55 | 0 | 0 | 20 | 0 | 0 | 0.000001917 | 0.0001477 |
| OLEA_200-250- | | | | | | | | | |
| 550 | | | | | | | | | |
| EC: 100-WPI- | 30 | 50 | 0 | 0 | 20 | 0 | 0 | 0.000002954 | 0.0002068 |
| OLEA_200-300- | | | | | | | | | |
| 500 | | | | | | | | | |
| EC: 100-WPI- | 10 | 65 | 0 | 0 | 25 | 0 | 0 | 0.000001192 | |
| OLEA_250-100- | | | | | | | | | |
| 650 | | | | | | | | | |
| EC: 100-WPI- | 10 | 70 | 20 | 0 | 0 | 0 | 0 | | |
| TOLE_200-100- | | | | | | | | | |
| 700 | | | | | | | | | |
| EC: 300-WPI- | 10 | 70 | 0 | 0 | 20 | 0 | 0 | | |
| OLEA_200-100- | | | | | | | | | |
| 700 | | | | | | | | | |
| GMO-EC: 100- | 10 | 70 | 0 | 5 | 15 | 0 | 0 | 0.02903 | 0.00001047 |
| WPI-OLEA_50- | | | | | | | | | |
| 150-100-700 | | | | | | | | | |
| GMS-EC: 100- | 10 | 70 | 0 | 5 | 15 | 0 | 0 | 0.00004461 | 0.00004832 |
| WPI-OLEA_50- | | | | | | | | | |
| 150-100-700 | | | | | | | | | |
| K188-WPI- | 10 | 65 | 25 | 0 | 0 | 0 | 0 | 0.01931 | |
| OLEA_250-100- | | | | | | | | | |
| 650 | | | | | | | | | |
| PEG: PPG-WPI- | 10 | 65 | 25 | 0 | 0 | 0 | 0 | 0.03245 | 0.000387 |
| OLEA_250-100- | | | | | | | | | |
| 650 | | | | | | | | | |
| PEG: PPG-WPI- | 10 | 60 | 30 | 0 | 0 | 0 | 0 | 0.02357 | 0.0005404 |
| OLEA_300-100- | | | | | | | | | |
| 600 | | | | | | | | | |
| RBW-EC: 100- | 10 | 70 | 5 | 0 | 15 | 0 | 0 | 0.0002656 | |
| WPI-OLEA_50- | | | | | | | | | |
| 150-100-700 | | | | | | | | | |
| RBW-WPI- | 10 | 80 | 10 | 0 | 0 | 0 | 0 | 0.0001842 | |
| OLEA_100-100- | | | | | | | | | |
| 800 | | | | | | | | | |
| RBW-WPI- | 10 | 70 | 20 | 0 | 0 | 0 | 0 | | |
| OLEA_200-100- | | | | | | | | | |
| 700 | | | | | | | | | |
| RBW-WPI- | 20 | 60 | 20 | 0 | 0 | 0 | 0 | 0.0001799 | |
| OLEA_200-200- | | | | | | | | | |
| 600 | | | | | | | | | |
| RBW-WPI- | 30 | 50 | 20 | 0 | 0 | 0 | 0 | 0.0002597 | |
| OLEA_200-300- | | | | | | | | | |
| 500 | | | | | | | | | |
| RBW-WPI- | 10 | 65 | 25 | 0 | 0 | 0 | 0 | 0.002921 | |
| OLEA_250-100- | | | | | | | | | |
| 650 | | | | | | | | | |
| SESO-LEC- | 5 | 0 | 75 | 15 | 5 | 0 | 0 | 0.003104 | |
| EC: 100-WPI_750- | | | | | | | | | |
| 150-50-50 | | | | | | | | | |
| SIO2-WPI- | 10 | 85 | 0 | 0 | 0 | 5 | 0 | 7.769E−07 | |
| OLEA_50-100-850 | | | | | | | | | |
| SiO2-WPI- | 10 | 83 | 8 | 0 | 0 | 0 | 0 | 0.06679 | |
| OLEA_75-100-825 | | | | | | | | | |
| SITO-ORY- | 10 | 70 | 6 | 4 | 10 | 0 | 0 | 0.0004163 | 0.000007759 |
| EC: 100-WPI- | | | | | | | | | |
| OLEA_60-40-100- | | | | | | | | | |
| 100-700 | | | | | | | | | |
| SITO-ORY-WPI- | 10 | 80 | 4 | 6 | 0 | 0 | 0 | 0.03781 | |
| OLEA_40-60-100- | | | | | | | | | |
| 800 | | | | | | | | | |
| SITO-ORY-WPI- | 10 | 80 | 6 | 4 | 0 | 0 | 0 | 0.00333 | |
| OLEA_60-40-100- | | | | | | | | | |
| 800 | | | | | | | | | |
| SITO-ORY-WPI- | 10 | 70 | 8 | 12 | 0 | 0 | 0 | 0.00005237 | |
| OLEA_80-120- | | | | | | | | | |
| 100-700 | | | | | | | | | |
| SITO-ORY-WPI- | 10 | 75 | 9 | 6 | 0 | 0 | 0 | 0.003053 | |
| OLEA_90-60-100- | | | | | | | | | |
| 750 | | | | | | | | | |
| SITO-ORY-WPI- | 10 | 70 | 12 | 8 | 0 | 0 | 0 | | 0.000002916 |
| OLEA_120-80- | | | | | | | | | |
| 100-700 | | | | | | | | | |
| SOYW-GEL50- | 10 | 0 | 75 | 15 | 0 | 0 | 0 | 0.03505 | |
| WPI_750-150-100 | | | | | | | | | |
| SOYW-LEC- | 5 | 0 | 80 | 15 | 0 | 0 | 0 | 0.01152 | |
| WPI_800-150-50 | | | | | | | | | |
| SOYW-LEC- | 5 | 0 | 90 | 5 | 0 | 0 | 0 | 0.02226 | |
| WPI_900-50-50 | | | | | | | | | |
| SOYW-SESO- | 5 | 0 | 90 | 5 | 0 | 0 | 0 | 0.00208 | |
| WPI_900-50-50 | | | | | | | | | |
| SOYW-T85- | 10 | 0 | 80 | 5 | 5 | 0 | 0 | 0.02188 | |
| EC: 100-WPI_800- | | | | | | | | | |
| 50-50-100 | | | | | | | | | |
| SOYW-T85- | 10 | 0 | 85 | 5 | 0 | 0 | 0 | 0.003392 | |
| WPI_850-50-100 | | | | | | | | | |
| SOYW-WPI- | 10 | 75 | 15 | 0 | 0 | 0 | 0 | 0.1666 | |
| OLEA_150-100- | | | | | | | | | |
| 750 | | | | | | | | | |
| SP60-EC: 100- | 10 | 70 | 0 | 5 | 15 | 0 | 0 | 0.00009632 | 0.00002699 |
| WPI-OLEA_50- | | | | | | | | | |
| 150-100-700 | | | | | | | | | |
| SP60-WPI- | 10 | 70 | 0 | 20 | 0 | 0 | 0 | | |
| OLEA_200-100- | | | | | | | | | |
| 700 | 10 | 70 | 20 | 0 | 0 | 0 | 0 | 0.02005 | |
| TSTE-EC: 100- | 10 | 0 | 85 | 0 | 5 | 0 | 0 | 0.01078 | |
| WPI_850-50-100 | | | | | | | | | |
| WPI_1000 | 100 | 0 | 0 | 0 | 0 | 0 | 0 | 0.5559 | |

### EQUIVALENTS

Those skilled in the art will recognize, or be able to ascertain using no more than routine experimentation, many equivalents to the specific embodiments of the invention described herein. The scope of the present invention is not intended to be limited to the above Description, but rather is as set forth in the following claims:

What is claimed is:

1. An extended release preparation comprising a carrier component and a payload component, wherein:
the payload component is encapsulated in the carrier component and comprises at least one nutrient component; and
the payload component and/or the carrier component comprises at least one extended release component.

2. The preparation of claim 1, wherein the extended release component comprises:
a first release agent that releases the at least one nutrient component when the preparation is in an environment having a pH less than or equal to 2.0; and
a second release agent that releases at least one micronutrient component when the preparation is in an environment having a pH from about 6.0 to about 7.0.

3. The preparation of claim 2, wherein the at least one nutrient comprises one or more carbohydrates, one or more proteins, one or more fats, or a combination thereof.

4. The preparation of claim 2 or 3, wherein the at least one micronutrient is sodium, calcium, magnesium, iron, zinc, copper, or a combination thereof.

5. The preparation of claim 1, wherein the carrier component comprises at least one shell.

6. The preparation of claim 5, wherein the at least one shell comprises a slow release polymer.

7. The preparation of claim 6, wherein the slow release polymer comprises a polysaccharide.

8. The preparation of any one of claims 5-7, wherein the at least one shell encapsulates the payload component.

9. The preparation of any one of claims 1-8, further comprising a matrix component.

10. The preparation of claim 9, wherein the payload component is dispersed throughout the matrix component.

11. The preparation of claim 1-10, further comprising a slow release component encapsulated in the carrier component.

12. The preparation of claim 11, wherein the slow release component is buoyant and causes the preparation to float in gastric fluid.

13. The preparation of claim 11, wherein the slow release component generates gas.

14. The preparation of any one of claims 11-13, wherein the slow release component comprises polyvinyl acetate and polyvinylpyrrolidone.

15. The preparation of claim 12, wherein the slow release component comprises a controlled-release layer, a gas generation layer, and a blocking layer.

16. The preparation of claim 15, wherein the gas generation layer causes the preparation to float in gastric fluid.

17. The preparation of any one of claims 1-16, wherein the carrier component comprises an immediate-release layer.

18. The preparation of claim 17, wherein the carrier component further comprises an extended-release layer disposed beneath the immediate-release layer.

19. The preparation of claim 19, wherein the payload component is disposed beneath the extended-release layer.

20. The preparation of any one of claims 1-19, wherein the payload component is a powder.

21. The preparation of any one of claims 1-20, wherein the payload component and/or the carrier component comprises a self-assembling gel.

22. The preparation of claim 21, wherein the self-assembling gel self-assembles upon exposure to a food matrix, a beverage matrix, a physiological fluid, stomach acids, bile salts, or a combination thereof.

23. The preparation of claim 21 or 22, wherein the self-assembling gel traps water.

24. The preparation of any one of claims 21-23, wherein the self-assembling gel comprises a cross-linked peptide hydrogel.

25. The preparation of any one of claims 1-24, wherein the extended release component comprises at least one cross-linker.

26. The preparation of any one of claims 1-25, wherein the payload component and/or the carrier component comprises a binder that binds to a compound present in the stomach of an animal.

27. The preparation of claim 26, wherein the compound comprises acetaldehyde.

28. The preparation of any one of claims 1-27, wherein the at least one macronutrient component is released over a period of about 30 minutes to about 240 minutes following ingestion of the preparation by an animal.

29. The preparation of any one of claims 1-28, wherein the release of the at least one macronutrient component is delayed in the stomach and/or the intestine of an animal that has ingested the preparation as compared to the payload component alone.

30. The preparation of claim 1 or 2, wherein the at least one macronutrient component comprises a polysaccharide, a protein, a vitamin, a fat, or a combination thereof.

31. The preparation of any one of claims 1-30, wherein the payload component has a specific gravity of about 0.5 g/mL to about 1.5 g/mL.

32. The preparation of any one of claims 1-31, wherein the payload component has a dispersity of about 0.1 to about 0.7.

33. The preparation of any one of claims 1-32, wherein the preparation has a residual solvent concentration less than or equal to 50 parts per million (ppm).

34. The preparation of claim 33, wherein the residual solvent comprises hexane, ethanol, ethyl acetate, acetone, methylene chloride, methanol, isopropyl alcohol, and/or a combination thereof.

35. The preparation of claim 1 or 2, wherein the payload component comprises a carbohydrate, fat, protein, lipid, nutraceutical, a fiber, a fatty acid, a prebiotic, a ketone, a phenolic acid, an amino acids, a peptide, a sugar, a vitamin, a mineral, an element, a salt, an electrolyte, a flavonoid, a polyphenol, an antioxidants, and/or a metabolic intermediates.

36. The preparation of any one of claims 1-35, wherein the payload component comprises at least one fat, and wherein the at least one fat comprises a dietary fat, a polyunsaturated fatty acid, a medium chain fatty acid, a lipid, a fatty acid, a short-chain fatty acid, or a combination thereof.

37. The preparation of any one of claims 1-36, wherein the payload component comprises at least one protein, and wherein the at least one protein comprises a protein isolate, a proline-rich functional protein, an amino acids, a peptide, a branched-chain amino acid, or a combination thereof.

38. The preparation of any one of claims 1-37, wherein the carrier component and/or the payload component comprises at least one absorption modulator.

39. The preparation of claim 38, wherein the at least one absorption modulator reduces absorption of the payload component and/or carrier component upon ingestion of the preparation by an animal.

40. The preparation of claim 38, wherein the at least one absorption modulator enhances absorption of the payload component and/or carrier component upon ingestion of the preparation by an animal.

41. The preparation of claim 40, wherein the at least one absorption modulator sodium caprylate, sodium caprate, sodium laurate, sodium oleate, sodium linoleate, propyl gallate, propyl syringate, propyl shikimate, octyl gallate, octyl syringate, octyl shikimate, ammoniated glycyrrhizin, quillaia extract, tocopherol PEG succinate, lauroyl polyoxylglycerides, polysorbate 80, ethanol, propylene glycol, poly(ethylene glycol), diethylene glycol monoethyl ether, sodium citrate, medium chain triglycerides, lipase, sodium lauryl sulfate, ascorbyl palmitate, or a combination thereof.

42. The preparation of claim 1, wherein the at least one nutrient component comprises a macronutrient and/or a micronutrient.

43. The preparation of claim 42, wherein the macronutrient comprises aspartame, GLP-1, GLP-2, collagen, sermorelin, tesamorelin, lenomorelin, anamorelin, ipamorelin, macimorelin, ghrelin, leptin, tabimorelin, alexamorelin, GHRP-1, GHRP-2, GHRP-3, GHRP-4, GHRP-5, GHRP-6, hexarelin, cellulose, dextrins, amylose, amylopectin, pectin, inulin, lignin, chitin, xanthan gum, sodium alginate, potassium alginate, calcium alginate, ammonium alginate, propylene glycol alginate, sodium hyaluronate, potassium hyaluronate, calcium hyaluronate, agar, agarose, carrageenan, raffinose, cellulose acetate, methyl cellulose, ethyl cellulose, cellulose acetate propionate, cellulose acetate butyrate, cellulose acetate succinate, hydroxypropyl methylcellulose, hydroxypropyl cellulose, pea protein isolate, whey protein isolate, oat protein isolate, soy protein isolate, wheat protein isolate, egg protein isolate, casein, bovine serum albumin, ovalbumin, α-lactalbumin, β-lactoglobulin, collagen, glutanin, gliadin, kefirin, avenin, zein, silk, gelatin, hordein, sodium carboxymethylcellulose, or a combination thereof.

44. The preparation of claim 42, wherein the micronutrient is tannic acid, ellagitannin, apigenin, luteolin, tangeritin, isorhamnetin, kaempferol, myricetin, quercetin, rutin, eriodictyol, hesperetin, naringenin, catechin, gallocatechin, epicatechin, epigallocatechin, theaflavin, daidzein, genistein, glycitein, resveratrol, pterostilbene, hydroxytyrosol, cyanidin, delphinidin, malvidin, pelargonidin, peonidin, petunidin, chicoric acid, chlorogenic acid, cinnamic acid, ellagic acid, gallic acid, sinapic acid, rosmarinic acid, salicylic acid, curcumin, piperine, silymarin, silybin, eugenol, melatonin, methylcobalamin, adrafinil, cathine, cathinone, dextroamphetamine, ephedrine, epinephrine, armodafinil, modafinil, phenylethylamine, synephrine, theanine, 5-hydroxytryptophan, caffeine, theobromine, taurine, or a combination thereof.

45. The preparation of any one of claims 1-44, wherein the payload component comprises, on a dry weight basis, at least 50% carbohydrate, fat, protein, vitamin, ketone body, polyphenol, or a combination thereof.

46. The preparation of any one of claims 1-45, wherein the preparation comprises, on a dry weight basis, at least 50% payload component.

47. The preparation of any one of claims 1-46, wherein the the at least one nutrient component comprises at least one branched chain amino acid.

48. The preparation of claim 47, wherein the at least one branched chain amino acid comprises isoleucine, leucine, valine, or a combination thereof.

49. The preparation of any one of claims 1-48, wherein the at least one nutrient component comprises a dietary fiber.

50. The preparation of claim 49, wherein the dietary fiber comprises cellulose, dextrins, amylose, amylopectin, pectin, inulin, lignin, chitin, xanthan gum, sodium alginate, potassium alginate, calcium alginate, ammonium alginate, propylene glycol alginate, sodium hyaluronate, potassium hyaluronate, calcium hyaluronate, agar, agarose, carrageenan, raffinose, cellulose acetate, methyl cellulose, ethyl cellulose, cellulose acetate propionate, cellulose acetate butyrate, cellulose acetate succinate, hydroxypropyl methylcellulose, hydroxypropyl cellulose, sodium carboxymethylcellulose, or a combination thereof.

51. The preparation of any one of claims 1-50, wherein the at least one nutrient component comprises a medium-chain triglyceride, docosahexaenoic acid, eicosapentaenoic acid, or a combination thereof.

52. The preparation of any one of claims 1-51, wherein the at least one nutrient component comprises one or more short chain fatty acids.

53. The preparation of claim 52, wherein the one or more short chain fatty acids comprise acetate, propionate, butyrate, or a combination thereof.

54. The preparation of any one of claims 1-53, wherein the at least one nutrient component comprises at least one carotenoid comprising at least one of alpha-lipoic acid, lycopene, 3-carotene, lutein, zeaxanthin, adonixxanthin, adonirubin, meso-zeaxanthin, astaxanthin, capsanthin, citroxanthin, echinenone, astacein, bixin, crocetin, and peridin.

55. The preparation of any one of claims 1-54, wherein the at least one extended release component comprises one or more circadian rhythm modulators.

56. The preparation of claim 55, wherein the one or more circadian rhythm modulators comprise melatonin, methylcobalamin, adrafinil, cathine, cathinone, dextroamphetamine, ephedrine, epinephrine, armodafinil, modafinil, phenylethylamine, synephrine, theanine, 5-hydroxytryptophan, caffeine, theobromine, taurine, or a combination thereof.

57. The preparation of any one of claims 1-56, wherein the at least one nutrient component comprises at least one carbohydrate.

58. The preparation of claim 57, wherein the at least one carbohydrate comprises glucose, fructose, mannitol, allulose, sorbitol, xylitol, erythritol, lactitol, galactose, sucrose, maltodextrin, isomaltulose, glycogen, chitosan, guar gum, pullulan, cellulose, dextrins, amylose, amylopectin, pectin, inulin, lignin, chitin, xanthan gum, sodium alginate, potassium alginate, calcium alginate, ammonium alginate, propylene glycol alginate, sodium hyaluronate, potassium hyaluronate, calcium hyaluronate, agar, agarose, carrageenan, raffinose, cellulose acetate, methyl cellulose, ethyl cellulose, cellulose acetate propionate, cellulose acetate butyrate, cellulose acetate succinate, hydroxypropyl methylcellulose, hydroxypropyl cellulose, sodium carboxymethylcellulose, or a combination thereof.

59. The preparation of any one of claims 1-58, wherein the at least one nutrient component comprises at least one protein.

60. The preparation of claim 59, wherein the at least one protein comprises pea protein isolate, whey protein isolate, oat protein isolate, soy protein isolate, wheat protein isolate, egg protein isolate, casein, bovine serum albumin, ovalbumin, α-lactalbumin, β-lactoglobulin, collagen, glutanin, gliadin, kefirin, avenin, zein, silk, gelatin, hordein, legumin, or a combination thereof.

61. The preparation of any one of claims 1-60, wherein the carrier component comprises at least one fat.

62. The preparation of claim 61, wherein the at least one fat comprises paraffin wax, montan wax, microcrystalline wax, polyethylene wax, petrolatum wax, ozokerite wax, ceresin wax, beeswax, lanolin wax, spermaceti wax, tallow wax, lac wax, chinese insect wax, ambergris wax, soy wax, carnauba wax, candelilla wax, coconut wax, palm kernel wax, rice bran wax, butyric acid, n-butanol, pentanoic acid, n-pentanol, hexanoic acid, n-hexanol, heptanoic acid, n-heptanol, caprylic acid, n-octanol, nonanoic acid, n-nonanol, capric acid, n-decanol, lauric acid, n-dodecanol, myristic acid, n-tetradecanol, palmitic acid, n-hexadecanol, stearic acid, n-octadecanol, arachidonic acid, n-icosanol, fatty alcohol monoglyceride ethers, fatty acid monoglyceride esters, fatty alcohol diglyceride ethers, fatty acid diglyceride esters, fatty alcohol triglyceride ethers, fatty acid triglyceride esters, fatty alcohol glycol monoether, fatty acid glycol monoesters, fatty alcohol glycol diethers, fatty acid glycol diesters, fatty alcohol poly(glycerol) ethers, fatty acid poly(glycerol) esters, fatty alcohol poly(glycol) ethers, fatty acid poly(glycol) esters, coconut oil, corn oil, cottonseed oil, olive oil, palm oil, peanut oil, rapeseed oil, safflower oil, sesame oil, soybean oil, sunflower oil, almond oil, pine nut oil, cashew oil, fully hydrogenated palm oil, partially hydrogenated palm oil, fully hydrogenated sunflower oil, partially hydrogenated sunflower oil, fully hydrogenated soybean oil, partially hydrogenated soybean oil, fully hydrogenated vegetable oil, partially hydrogenated vegetable oil, fully hydrogenated cottonseed oil, partially hydrogenated cottonseed oil, cholesterol, cholenic acid, ursolic acid, betulinic acid, or a combination thereof.

63. The preparation of any one of claims 1-62, wherein the carrier component comprises at least one polyunsaturated fatty acid.

64. The preparation of claim 63, wherein the at least one polyunsaturated fatty acid comprises a medium-chain triglyceride, docosahexaenoic acid, eicosapentaenoic acid, arachidonic acid, linoleic acid, linolenic acid, oleic acid, parinaric acid, rumenic acid, or a combination thereof.

65. The preparation of any one of claims 1-64, wherein the at least one nutrient comprises at least one ketone.

66. The preparation of claim 65, wherein the at least one ketone comprises acetoacetate, R-β-hydroxybutyl R-β-hydroxybutyrate, β-hydroxybutyrate, R-3-hydroxybutyl R-3-hydroxybutyrate monoester, 1,3-butanediol, or a combination thereof.

67. The preparation of any one of claims 1-66, further comprising at least one excipient.

68. The preparation of claim 67, wherein the at least one excipient comprises an anti-caking component, a surfactant component, a plasticizing component, an acid scavenger, a moisture scavenger, a water scavenger, an oxygen scavenger, a taste modifier, a texture modifier, a desiccant, a polymer, a preservative, a colorant, a flavoring, an antioxidant, a humectant, a solvent, or a combination thereof.

69. The preparation of claim 68, wherein the preparation comprises, on a weight basis, about 0.5% to about 10% of the at least one excipient component.

70. The preparation of any one of claims 1-69, wherein the at least one extended release component comprises a mucoadhesive component.

71. The preparation of claim 70, wherein the mucoadhesive component comprises at least one catechol.

72. The preparation of claim 71, wherein the at least one catechol comprises L-dopamine, poly(L-dopamine), hydroxytyrosol, catechol, caffeic acid, vanillin, veratraldehyde, eugenol, tannic acid, syringaldehyde, protocatechuic aldehyde, or a combination thereof.

73. The preparation of claim 71 or 72, wherein the at least one catechol interacts with a mucosal interface upon ingestion by an animal.

74. The preparation of claim 70, wherein the mucoadhesive component comprises a charged polymer.

75. The preparation of claim 74, wherein the charged polymer comprises an anionic mucoadhesive polymer component.

76. The preparation of claim 75, wherein the anionic mucoadhesive polymer component comprises poly(acrylic acid), poly(methacrylic acid), poly(glycerol citrate), or a combination thereof.

77. The preparation of claim 74, wherein the charged polymer comprises a cationic mucoadhesive polymer component.

78. The preparation of claim 77, wherein the cationic mucoadhesive polymer component comprises poly(ethyleneimine), trimethylchitosan, poly(L-arginine), or a combination thereof.

79. The preparation of any one of claims 1-78, wherein the at least one extended release component comprises a mucopenetrative component.

80. The preparation of claim 79, wherein the mucopenetrative component comprises poly(ethylene glycol), poly(propylene glycol), poly(vinyl alcohol), poly(ethylene oxide-co-propylene oxide), or a combination thereof.

81. The preparation of claim 67, wherein the at least one excipient component comprises at least one taste modifier.

82. The preparation of claim 81, wherein the at least one taste modifier comprises glucose, vanillin, acetic acid, chlorogenic acid, cafestol, sodium chloride, or a combination thereof.

83. The preparation of claim 67, wherein the at least one excipient component comprises at least one texture modifier.

84. The preparation of any one of claims 1-83, wherein the at least one extended release component comprises at least one enzyme inhibitor.

85. The preparation of any one of claims 1-84, wherein the at least one extended release component comprises at least one absorption enhancer.

86. The preparation of any one of claims 1-85, wherein the preparation comprises:
at least one fat comprising soybean oil, palm oil, carnauba wax, lecithin, or a combination thereof;
at least one carbohydrate comprising glucose, amylose, allulose, xylitol, cellulose, or a combination thereof; and
at least one protein comprising whey protein, casein, soy protein, pea protein, corn protein, zein, gliadin, gelatin, collagen, or a combination thereof.

87. The preparation of claim 86, wherein the preparation comprises a ratio of the at least one carbohydrate to the at least one fat in a range from about 3:1 to 12:1.

88. The preparation of claim 86, wherein the preparation comprises a ratio of the at least one protein to the at least one fat in a range from about 0.5:1 to about 5:1.

89. The preparation of claim 86, wherein the preparation comprises a ratio of the at least one carbohydrate to the at least one protein in a range from about 0.5:1 to about 10:1.

90. The preparation of any one of claims 1-89, wherein the preparation comprises, on a dry weight basis, at least 90% payload component.

91. A food or beverage product, wherein a preparation of any one of claims 1-90 is embedded and/or incorporated therein.

92. The food or beverage product of claim 91, wherein the food or beverage product is a yogurt, carbonated beverage, sports drink, snack bar, or gummy.

93. A composition comprising:
a preparation of any one of claims 1-90;
at least one gallant coated particle;
at least one food-based solubilizers; and
at least one permeation enhancer.

94. A method of providing at least one nutrient to an animal comprising:
administering a preparation of any one of claims 1-90 to an animal.

95. The method of claim 94, wherein the preparation is administered via ingestion.

96. The method of claim 94 or 95, wherein the preparation is administered as a single bolus dose.

97. The method of any one of claims 94-96, wherein the animal is a human.

98. A method of preparing a preparation of any one of claims 1-90, comprising spray drying, extruding, milling, lyophilizing, fluidized bed spray coating, or a combination thereof.
